(19) United States
(12) Patent Application Publication
(10) Pub. No.: US 2026/0315195 A1
(43) Pub. Date: Oct. 15, 2026

(54) VIRTUAL DENTAL RESTORATION WORKFLOWS

(71) Applicant: BIOMET 3I, LLC, Palm Beach Gardens, FL (US)

(72) Inventors: Alessandro Motroni, Lentate sul Seveso (IT); Angelo Tocchetti, Bottanuco (IT)

(21) Appl. No.: 19/574,006

(22) Filed: Mar. 20, 2026

Related U.S. Application Data
(60) Provisional application No. 63/775,920, filed on Mar. 21, 2025.

(51) Int. Cl. A61C 8/00; A61C 13/00

(52) U.S. Cl. CPC A61C 8/009; A61C 13/0004

(57) ABSTRACT

A computing device is provided that includes a processor and memory including data that, when processed by the processor, enables the computing device to perform various digital dentistry workflows for different types of dental restorations.

### CROSS-REFERENCE TO RELATED APPLICATIONS

This application claims the benefit of U.S. Provisional Application No. 63/775,920, filed on Mar. 21, 2025, which is incorporated herein by reference in its entirety.

### FIELD OF THE DISCLOSURE

The present application is directed generally to dental reconstructions and specifically to various computer workflows for dental reconstruction.

### BACKGROUND

The present disclosure is generally directed to Computer-Aided Drafting (CAD), and relates more particularly to CAD tools used to support surgical procedures, such as dental procedures.

The use of surgical navigation in the head and neck has made significant advancements recently. Presently, systems are used in otolaryngology, neurosurgery, and oral and maxillofacial surgery for a variety of surgical procedures.

Recent advances allow dentists, oral and maxillofacial surgeons, and maxillofacial prosthodontists to place dental implants accurately or plan surgeries based on a patient's actual anatomy. Some CAD tools even support the creation of objects within the CAD environment based on images taken of a patient's anatomy. Most CAD tools, however, are limited in the types of objects or primitives they can create. Furthermore, existing CAD tools limit the manner in which objects or primitives can be manipulated, especially when dealing with overlapping volumes or complex volumes, which makes customized dental reconstruction planning more difficult. These limitations of existing CAD tools can lead to less-than-optimal reconstruction outcomes and/or extended patient time in the chair during dental reconstructions. Existing dental reconstruction workflows can be cumbersome due to a multiplicity of steps in digitally planning prosthetics for the dental reconstruction.

### BRIEF SUMMARY

Embodiments of the present disclosure were contemplated to address the above-noted issues of existing CAD tools and surgical procedures supported by inflexible CAD tools. Specifically, but without limitation, embodiments of the present disclosure propose an improved and highly-flexible CAD tool that supports the creation of freeform objects within a CAD environment. The freeform objects can be merged with other objects in the CAD environment and/or used as a cut-type object to remove certain portions of objects within the CAD environment. By way of illustration, freeform objects can be used to realize split volumes with complex shapes using one or more Boolean operations.

One aspect of the present disclosure provides a computing device having a processor and memory. The memory may include data and/or instructions that, when processed by the processor, enable the computing device to import overstructure and bar structure objects into a Computer-Aided Drafting (CAD) environment, the overstructure object corresponding to an overdenture and the bar structure corresponding to a bar to connect the overdenture to an oral cavity of a patient; facilitate a customization of a freeform cut-type object within the CAD environment by independent manipulation of one or more control points and/or rotation handles in at least two dimensions, wherein the one or more control points and/or rotation handles are defined at a surface of the freeform cut-type object and, when manipulated, result in a changed configuration of the freeform cut-type object in the at least two dimensions; determine an overlapping volume in the CAD environment that is shared between the freeform cut-type object and the bar structure object; remove the overlapping volume from a volume of the bar structure object to define an aperture in the bar structure object; in response to the determined overlapping volume, determine a portion of the overstructure object to be removed to enable the overstructure object to matingly engage the aperture in the bar structure object; and remove a volume of the portion of the overstructure object.

One aspect of the present disclosure provides a computing device having a processor and memory. The memory may include data and/or instructions that, when processed by the processor, enable the computing device to import selected implant, implant receiving structure, overstructure, and bar structure objects into a CAD environment, the implant object corresponding to a dental implant, the overstructure object corresponding to an overdenture, the bar structure object corresponding to a bar, and the implant receiving structure object corresponding to an implant receiving structure to engage the bar with the dental implant to connect the overdenture to an oral cavity of a patient; facilitate a customization of one or more of the implant, implant receiving structure, overstructure and bar structure objects within the CAD environment by independent manipulation of one or more control points and/or rotation handles in at least two dimensions, wherein the one or more control points and/or rotation handles are defined at a surface of the corresponding implant, implant receiving structure, overstructure and bar structure object and, when manipulated, result in a changed configuration of the corresponding implant, implant receiving structure, overstructure and bar structure object in the at least two dimensions; import a bonding object into the CAD environment, the bonding object corresponding to a bonding mechanism between an overdenture receiving structure and the implant receiving structure; position the bonding object on the implant receiving structure; and automatically change one or more dimensions of the bar structure object, overdenture receiving structure object, implant receiving structure object and/or overdenture based on a dimension of the bonding object to enable the bar structure to engage the overdenture.

One aspect of the present disclosure provides a computing device having a processor and memory. The memory may include data and/or instructions that, when processed by the processor, enable the computing device to import selected implant, implant receiving structure, overstructure, tool access, and bar structure objects into a CAD environment, the implant object corresponding to a dental implant, the overstructure object corresponding to an overdenture and/or prosthetic tooth, the bar structure object corresponding to a bar, the implant receiving structure object corresponding to an implant receiving structure to engage the bar with the dental implant to connect the overdenture to an oral cavity of a patient, and the tool access object corresponding to an interface in the implant receiving structure and/or bar for a screw and/or screw driver; and facilitate a customization of the tool access object within the CAD environment by independent manipulation of one or more control points and/or rotation handles in at least two dimensions, wherein the one or more control points and/or rotation handles are defined at a surface of the tool access object and, when manipulated, result in a changed configuration of the implant receiving structure and/or bar structure objects in the at least two dimensions.

One aspect of the present disclosure provides a computing device having a processor and memory. The memory may include data and/or instructions that, when processed by the processor, enable the computing device to import selected abutment and tooth-like objects into a CAD environment, the abutment object corresponding to an abutment and the tooth-like object corresponding to one of a crown and prosthetic tooth and facilitate a customization of a gingival margin contact profile on the prosthetic tooth-like object within the CAD environment by independent manipulation of one or more control points and/or rotation handles in at least two dimensions, wherein the one or more control points and/or rotation handles are defined at a lower surface of the prosthetic tooth-like object and, when manipulated, result in a changed configuration of the gingival margin contact profile on the lower surface; thereafter transfer the gingival margin contact profile to an upper surface of the abutment object; and based on the gingival margin contact profile, remove a volume from each of the prosthetic tooth-like and abutment objects to form, in proximity to the gingival margin contact profile, matching shapes of the lower portion of the prosthetic tooth-like object and upper portion of the abutment object, thereby defining a mating interface between the prosthetic tooth-like and abutment objects.

One aspect of the present disclosure provides a computing device having a processor and memory. The memory may include data and/or instructions that, when processed by the processor, enable the computing device to import selected abutment and tooth-like objects and model of a patient's oral cavity into a CAD environment, the abutment object corresponding to an abutment, the tooth-like object corresponding to one of a crown and prosthetic tooth and each of the abutment and tooth-like objects being a free-form object;, and the model of the patient's oral cavity being a 3D CAD model based on image data of the patient's oral cavity; facilitate, within the CAD environment and by independent manipulation of one or more control points and/or rotation handles in at least two dimensions, a customization of the position and orientation of the tooth-like object relative to the abutment object and the 3D CAD model of the patient's oral cavity; determine, relative to the abutment object, a gingival margin and/or emergence profile in the 3D CAD model; facilitate a customization of the gingival margin and/or emergence profile on the 3D CAD model by independent manipulation of one or more control points and/or rotation handles in at least two dimensions; thereafter transfer the gingival margin and/or emergence profile to an upper surface of the abutment object; facilitate a customization of the abutment object based on the gingival margin and/or emergence profile by independent manipulation of one or more control points and/or rotation handles in at least two dimensions to change a lower profile of a lower portion of the abutment object; and remove a volume from the prosthetic tooth-like to match the lower profile of the abutment object.

One aspect of the present disclosure provides a computing device having a processor and memory. The memory may include data and/or instructions that, when processed by the processor, enable the computing device to import a selected abutment object, bone graft object, and model of a patient's oral cavity into a CAD environment, the abutment object corresponding to an abutment, the model of the patient's oral cavity being a 3D CAD model based on image data of the patient's oral cavity, and the bone graft corresponding to a bone graft to restore bone in a portion of the patient's oral cavity; and facilitate, within the CAD environment and by independent manipulation of one or more control points and/or rotation handles in at least two dimensions, a customization of a position, dimension, and/or orientation of the bone graft object based on a position and configuration of the abutment object relative to the 3D CAD model of the patient's oral cavity.

One aspect of the present disclosure provides a computing device having a processor and memory. The memory may include data and/or instructions that, when processed by the processor, enable the computing device to convert image data of an oral cavity of a patient into a 3D Computer-Aided Drafting (CAD) model in a CAD environment; analyze the 3D CAD model layer by layer to identify an anatomical object corresponding to an anatomical feature in the 3D CAD model, the anatomical object corresponding to a plurality of anatomical object predictions, each prediction having an associated probability of being accurate; select an anatomical object prediction based on a comparison of the associated probability relative to the associated probabilities of others of the plurality of anatomical object predictions; based on the selected anatomical prediction, render the identified anatomical object in the CAD environment for review by a care provider; receive a sensed response of the care provider to the identified anatomical object; and based on the sensed response, modify a parameter of the data model to train the data model.

One aspect of the present disclosure provides a computing device having a processor and memory. The memory may include data and/or instructions that, when processed by the processor, enable the computing device to convert image data of an oral cavity of a patient into a CAD model in a CAD environment; generate a plurality of dental restoration objects based on one or more anatomical objects of the 3D CAD model, each of the plurality of dental restoration objects having an associated probability of being a correct dental restoration solution, each dental restoration object corresponding to one or more of a tool and prosthetic object; select one of the plurality of dental restoration objects based on a comparison of the associated probability relative to the associated probabilities of others of the plurality of dental restoration objects; render the selected dental restoration object in the CAD environment for review by the care provider; receive a sensed response of the care provider to the selected dental restoration object; and based on the sensed response, modify a parameter of the data model to train the data model.

One aspect of the present disclosure provides a computing device having a processor and memory. The memory may include data and/or instructions that, when processed by the processor, enable the computing device to convert image data of an oral cavity of a patient into a 3D Computer-Aided Drafting (CAD) model in a CAD environment; receive a first set of dental restoration objects associated with a dental restoration, the dental restoration requiring a second set of dental restoration objects different from the first set of dental restoration objects; generate, for each of the dental restoration objects in the second set, a plurality of possible dental restoration objects based on one or more anatomical objects of the 3D CAD model and the first set of objects, each of the plurality of possible dental restoration objects for having an associated probability of being a correct design for the corresponding dental restoration object in the second set, each dental restoration object corresponding to one or more of a tool and prosthetic object; for each of the dental restoration objects in the second set, select one of the plurality of possible dental restoration objects based on a comparison of the associated probability relative to the associated probabilities of others of the possible plurality of dental restoration objects; render the first aet of dental restoration objects and the selected possible dental restoration objects in the CAD environment for review by the care provider; receive a sensed response of the care provider to each of the selected possible dental restoration objects; and based on the sensed response, modify a parameter of the data model to train the data model.

It is to be appreciated that any feature described herein can be claimed in combination with any other feature(s) as described herein, regardless of whether the features come from the same described embodiment.

The details of one or more aspects of the disclosure are set forth in the accompanying drawings and the description below. Other features, objects, and advantages of the techniques described in this disclosure will be apparent from the description and drawings, and from the claims.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X1-Xn, Y1-Ym, and Z1-Zo, the phrase is intended to refer to a single element selected from X, Y, and Z, a combination of elements selected from the same class (e.g., X1 and X2) as well as a combination of elements selected from two or more classes (e.g., Y1 and Zo).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages of the present disclosure will become apparent to those skilled in the art upon consideration of the embodiment descriptions provided hereinbelow.

### BRIEF DESCRIPTION OF THE SEVERAL VIEWS OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a block diagram of a system according to at least one embodiment of the present disclosure;

FIG. 2 is a block diagram illustrating details of a computing device according to at least one embodiment of the present disclosure;

FIGS. 3A-3H illustrate a number of Graphical User Interface (GUI) views presented by a CAD tool during one or more workflows according to at least one embodiment of the present disclosure;

FIGS. 4A-4D illustrate a number of GUI views presented by a CAD tool during one or more additional workflows according to at least one embodiment of the present disclosure;

FIGS. 5A-5G illustrate a number of GUI views presented by a CAD tool during one or more additional workflows according to at least one embodiment of the present disclosure;

FIGS. 6A-6H illustrate a number of Graphical User Interface (GUI) views presented by a CAD tool during one or more workflows according to at least one embodiment of the present disclosure;

FIGS. 7A-7F illustrate a number of GUI views presented by a CAD tool during one or more additional workflows according to at least one embodiment of the present disclosure;

FIGS. 8A-8CC illustrate a number of GUI views presented by a CAD tool during one or more additional workflows according to at least one embodiment of the present disclosure;

FIGS. 9A-9K illustrate a number of Graphical User Interface (GUI) views presented by a CAD tool during one or more workflows according to at least one embodiment of the present disclosure;

FIGS. 10A-10F illustrate a number of GUI views presented by a CAD tool during one or more additional workflows according to at least one embodiment of the present disclosure;

FIGS. 11A-11H illustrate a number of GUI views presented by a CAD tool during one or more additional workflows according to at least one embodiment of the present disclosure;

FIGS. 12A-12G illustrate a number of Graphical User Interface (GUI) views presented by a CAD tool during one or more workflows according to at least one embodiment of the present disclosure;

FIGS. 13A-13U illustrate a number of GUI views presented by a CAD tool during one or more additional workflows according to at least one embodiment of the present disclosure;

FIGS. 14A-14M illustrate a number of GUI views presented by a CAD tool during one or more additional workflows according to at least one embodiment of the present disclosure;

FIGS. 15A-15EE illustrate a number of Graphical User Interface (GUI) views presented by a CAD tool during one or more workflows according to at least one embodiment of the present disclosure;

FIGS. 16A-16M illustrate a number of GUI views presented by a CAD tool during one or more additional workflows according to at least one embodiment of the present disclosure;

FIG. 17 is a flow diagram illustrating a first method according to at least one embodiment of the present disclosure;

FIG. 18 is a flow diagram illustrating a second method according to at least one embodiment of the present disclosure;

FIG. 18 is a flow diagram illustrating a third method according to at least one embodiment of the present disclosure;

FIG. 19 is a flow diagram illustrating a first method according to at least one embodiment of the present disclosure;

FIG. 20 is a flow diagram illustrating a second method according to at least one embodiment of the present disclosure;

FIG. 21 is a flow diagram illustrating a third method according to at least one embodiment of the present disclosure;

FIG. 22 is a flow diagram illustrating a first method according to at least one embodiment of the present disclosure;

FIG. 23 is a flow diagram illustrating a second method according to at least one embodiment of the present disclosure;

FIG. 24 is a flow diagram illustrating a third method according to at least one embodiment of the present disclosure; and

FIG. 25 is a flow diagram illustrating a third method according to at least one embodiment of the present disclosure.

### DETAILED DESCRIPTION

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

The terms proximal and distal are used in this disclosure with their conventional medical meanings, proximal being closer to the operator or user of the system, and further from the region of surgical or reconstruction interest in or on the patient, and distal being closer to the region of surgical or reconstruction interest in or on the patient, and further from the operator or user of the system.

Embodiments of the present disclosure provide solutions to a number of different problems associated with CAD tools and the use of CAD tools in connection with planning or performing surgical procedures and dental reconstructions. As an example, embodiments of the present disclosure provide CAD tools that are configured to generate and manipulate freeform objects across multiple dimensions. Embodiments of the present disclosure also provide CAD tools that enable volume splitting of complex shapes, which may or may not include the use of freeform objects created by a user. Embodiments of the present disclosure also provide CAD tools that can communicate with a manufacturing system, which can produce complex physical items according to the objects defined in the CAD tools. The flexibility and customization offered by the CAD tools proposed herein supports the ability to rapidly create customized surgical guides, stacked guides, stacked components, cutting templates, dental restoration systems and components thereof, or the like in real-time, which translates to improved patient outcomes and/or reduced chair time for a patient during a surgical procedure.

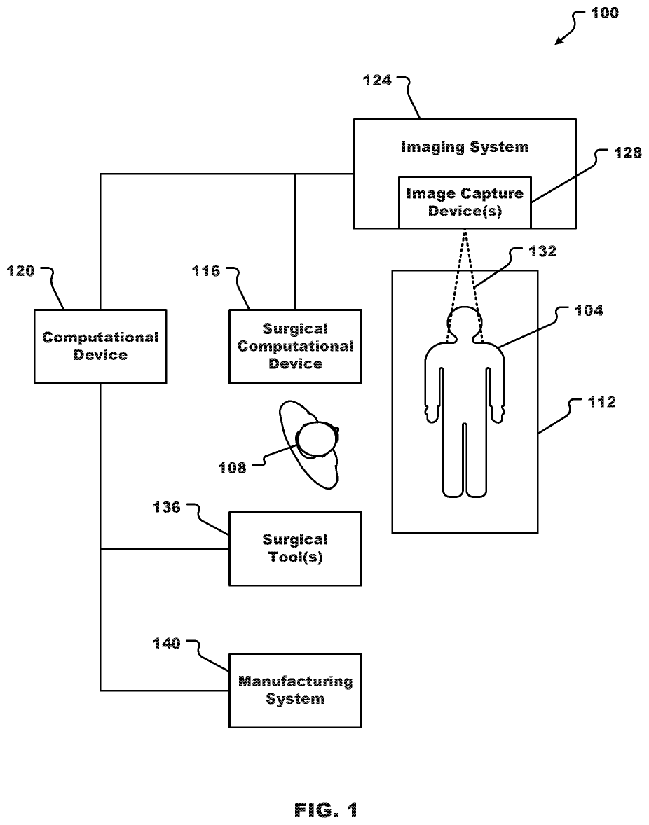

Turning initially to FIG. 1, a system 100 is illustrated in accordance with at least some embodiments of the present disclosure. The system 100 may correspond to a surgical system, computing system, communication system, or combination thereof. In some embodiments, the system 100 includes a surgical system that enables a care provider 108 to perform a surgical procedure on a patient 104. Illustratively, the system 100 may include a table or chair 112 that supports the patient 104 during the surgical procedure. The system 100 is also shown to include one or more computational devices 116, 120, an imaging system 124, surgical tool(s) 136, and a manufacturing system 140.

The computational devices 116, 120 may include one or more computational devices 116 that are accessible to the care provider 108 during the surgical procedure 116. The computational devices 116, 120 may also include one or more computational devices 120 that are remotely located with respect to the table or chair 112. Either computational device 116, 120 may be configured to provide CAD tools to the care provider 108 and may facilitate the planning of a surgical procedure. In some embodiments, the computational devices 116, 120 may enable the care provider 108 to plan a surgical procedure and/or dental reconstruction before the patient 104 is on the table or chair 112. Alternatively or additionally, the computational devices 116, 120 may enable the care provider 108 to update plans for a surgical procedure and/or dental reconstruction during the surgical procedure and/or dental reconstruction (e.g., while the patient 104 is on the table or chair 112). As an example, CAD tools and/or imaging tools provided by the computational devices 116, 120 may enable the care provider 108 to plan surgical maneuvers (e.g., plan a cut/incision, plan an implant placement, check an implant placement, visualize an implant placement, adjust an implant placement, plan a bone graft, etc.), build surgical tools (e.g., build a surgical guide, build a collection of surgical guides, customize implants, customize implant-placement tools, etc.), and perform other tasks during a surgical procedure and/or design prosthetic devices, such as healing abutments, scan bodies, permanent abutments, crowns, overdentures, bridges, veneers, etc., support structures, such as implants, fixed or removable bars (e.g., used in bar-supported overdentures and fixed hybrids (onto which the prosthetic is screwed), and other dental restoration components.

As will be appreciated, the bar is designed to distribute occlusal loads and is generally attached to one or more underlying implants. Bar or bar structure types include removable prosthesis bar types, such as round, Dolder, Hader, free-form milled and Paris bar types, and fixed prosthesis bar types, such as Montreal, Montreal with metallic lingual, wrap-around, and hybrid bar types.

A bar structure for a removable overdenture typically comprises a female or outer portion and a male or inner portion. The male portion is attached to at least two anchor elements, tooth, and/or an implant. The female portion is typically polymerized or integral with the removal overdenture.

A bar structure may be split into one or more resultant portions.

The bar structure described below can be any suitable type of removable or fixed prosthesis bar.

Although the surgical tool(s) 136 and manufacturing system 140 are only depicted as being connected to the computational device 120 for ease of illustration, it should be appreciated that the surgical computational device 116 may also be connected to the surgical tool(s) 136 and/or manufacturing system 140. While two separate computational devices 116, 120 are illustrated, it should be appreciated that the system 100 may include a single computational device that is useable before a surgical procedure and during the surgical procedure. In other words, two or more computational devices are not a requirement of the system 100, but rather are illustrated to show that different computational devices may be used by the care provider 108 during different phases of planning a surgical procedure.

The imaging system 124 may include one or more image capture device 128 that are configured to capture images of the patient 104 or patient anatomy. In some embodiments, the image capture devices 128 are configured to capture image(s) of patient anatomy within a field of view 132. As an example, the image capture device(s) 128 may be operable to image anatomical feature(s) (e.g., a bone, veins, soft tissue, etc.) and/or other aspects of patient anatomy to yield image data (e.g., image data depicting or corresponding to a bone, veins, soft tissue, etc.). “Image data” as used herein refers to the data generated or captured by an image capture device 128, including in a machine-readable form, a graphical/visual form, and in any other form. In various examples, the image data may comprise data corresponding to an anatomical feature of a patient, or to a portion thereof. The image data may be or comprise a preoperative image, an intraoperative image, a postoperative image, or an image taken independently of any surgical procedure.

In some embodiments, an image capture device 132 may be capable of taking a 2D image or a 3D image to yield the image data. The image capture device 132 may be or comprise, for example, any device utilizing X-ray-based imaging (e.g., a fluoroscope, a CT scanner, or other X-ray machine), a Magnetic Resonance Imaging (MRI) scanner, an ultrasound imaging device, an optical coherence tomography (OCT) scanner, an endoscope, a microscope, an optical camera, a thermographic camera (e.g., an infrared camera), a radar or LIDAR system (which may comprise, for example, a transmitter, a receiver, a processor, and one or more antennae), or the like. The image capture device 132 may be contained entirely within a single housing, or may comprise a transmitter/emitter and a receiver/detector that are in separate housings or are otherwise physically separated.

In some embodiments, the imaging system 124 may include more than one image capture device 132. The imaging system 124 is capable of obtaining image(s) of patient anatomy in the form of image data, then providing the image(s) to the computational device(s) 116, 120, where one or more objects or models of patient anatomy may be uploaded into a CAD environment. For instance, images captured with the imaging system 124 may be used to generate one or more models of patient anatomy that can then be visualized and manipulated within a CAD tool executed on the computational device 116, 120. As a more specific, but non-limiting example, the CAD tools executed on the computational device 116, 120 may be configured to generate and manipulate a model of patient anatomy (e.g., hard tissue, soft tissue, combinations of hard/soft tissue, etc.) as will be described in further detail herein.

The surgical tool(s) 136 may include any number of known or yet-to-be developed surgical instruments. In some embodiments, the surgical tool(s) 136 may include handheld tools that are useable by the care provider 108 during the surgical procedure. Examples of such tools include, without limitation, drills, scissors, blades, knives, scalpels, retractors, implants, portions of implants, implant kits, surgical guides, screws, sutures, etc. The surgical tool(s) 136 may alternatively or additionally include robotic surgical tools or robotic surgical systems. For instance, the surgical tool(s) 136 may include a surgical robot that helps the care provider 108 perform a surgical procedure either semi-autonomously or fully-autonomously.

The manufacturing system 140 may be configured to create, in real-time (e.g., during a surgical procedure), surgical tool(s) 136. For example, the manufacturing system 140 may interact with CAD tools provided by the computational device 116, 120 to create surgical implants, prosthetics and associated support structures, surgical guides, stacked surgical guides, or the like. The manufacturing system 140 may be co-located with the table or chair 112 or may be located remotely from the table or chair 112. As a non-limiting example, the manufacturing system 140 may include a three-dimensional (3D) printer, a Computer Numerical Control (NCN) machine, a turning machine, a shaper/planer, a drilling machine, a milling machine, a grinding machine, a power saw, a press, a lamination machine, or a combination thereof.

The manufacturing system 140 may be configured to receive one or more electronic files from a computational device 116, 120 and manufacture an object in accordance with dimensions of the object defined within the electronic file. As a non-limiting example, the manufacturing system 140 may include a 3D printer that is configured to produce a surgical guide or collection of surgical guides during a surgical procedure in accordance with object data received from a computational device 116, 120. The surgical guide or collection of surgical guides may be produced during a surgical procedure based on images captured of the patient 104 while on the table or chair 112 (e.g., while sedated for the surgical procedure). The manufacturing system can also produce dental restoration systems and components thereof.

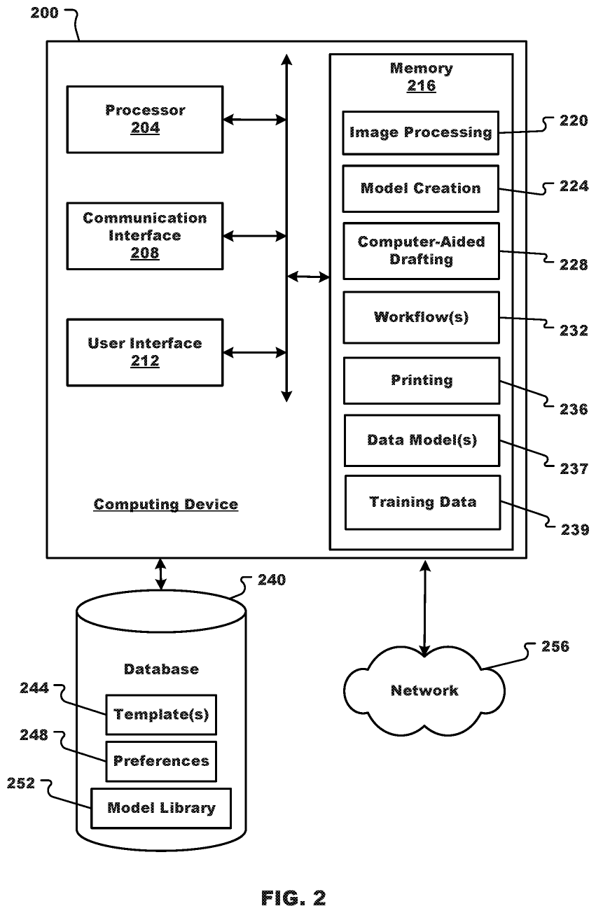

With reference now to FIG. 2, additional details of a computing device 200 will be described in accordance with at least some embodiments of the present disclosure. The computing device 200 may correspond to an example of the computational device 116 and/or computational device 120. The computing device 200 is shown to include a processor 204, a communication interface 208, a user interface 212, and memory 216. The computing device 200, in some embodiments, is interconnected with a database 240 and a broader communication network 256.

The processor 204 of the computing device 200 may be any processor described herein or any similar processor. The processor 204 may be configured to execute instructions or machine learning models (e.g., neural networks, decision trees, etc.) stored in the memory 216 (e.g., data), which may cause the processor 204 to carry out one or more computing steps. Illustratively and without limitation, the processor 204 may be configured to provide CAD tools to a user of the computing device 200 when executing contents of the memory 216.

The memory 216 may be or comprise RAM, DRAM, SDRAM, other solid-state memory, any memory described herein, or any other tangible, non-transitory memory for storing computer-readable data and/or instructions. The memory 216 may store information or data useful for completing, for example, any step of the methods or workflows described herein. The memory 216 may store, for example, one or more image processing algorithms 220, model creation functions 224, CAD tools 228, CAD workflows 232, data model(s) 237, training data 239, and/or printing functions 236. Such instructions, data, or algorithms may, in some embodiments, be organized into one or more applications, modules, packages, layers, or engines. The algorithms, data, and/or instructions may cause the processor 204 to manipulate data stored in the memory 216 and/or received from or via the imaging system 124, the database 240, and/or the communication network 256.

The image processing 220, when executed by the processor 204, may enable the computing device 200 to cooperate with the imaging system 124 to obtain and use images of the patient 104 or patient anatomy. In some embodiments, the image processing 220 may be configured to receive patient images (e.g., preoperative patient images, intraoperative patient images, and/or postoperative patient images), receive object images, etc., and prepare the images for processing by other components of the computing device 200. Illustratively, the image processing 220 may be configured to receive image data and format the image data for consumption by the model creation 224 and/or CAD tools 228. In some embodiments, the image processing 220 may be configured to transform an image or image data into a different consumable format by converting the image from one digital format to another digital format, by performing pixel analysis to determine locations or boundaries of objects, by identifying locations of fiducials in an image, by compressing an image, by decompressing an image, by overlaying object models on an image, and/or any other task associated with preparing an image for consumption by the model creation 224 for use by the CAD tools 228.

The model creation 224 is shown as being separate from the CAD tools 228, but may be incorporated into the CAD tools 228. In some embodiments, the model creation 224 is configured to convert image data from the image processing 220 into one or more models of an anatomical element. For instance, the model creation 224 may be configured to generate an object within the CAD tools that represents the physical dimensions of a patient's 104 anatomical part. As a more specific but non-limiting example, the model creation 224 may be configured to generate an electronic file representing a patient's anatomy (e.g., gingiva, teeth, mandibular jawbone, elements of the mandible, maxillary bone, elements of the maxilla, nerves, soft tissue, etc.). The objects or models created by the model creation 224 may be viewable and capable of manipulation with the CAD tools 228.

To create a prosthesis, the dental region of the patient 104 may be placed within the field of view 132 and scanned, as described above. Alternatively or additionally, the model creation 224 may use other inputs to generate an electronic file representing the patient's 104 anatomy. For instance, the model creation 224 may be configured to generate models using one or more of a stone model made from impression material, laser scanning techniques, a photographic scanning technique, or a mechanical sensing technique. Alternatively or additionally, the care provider 108 can photograph implants and other components that have been placed into or adjacent the patient's 104 mouth. The model creation 224 may also be configured to accurately relate the gingival margin for all mold, model, implant and abutment dimensions.

The CAD tools 228 may be configured to allow visualization and manipulation of objects within a CAD environment. For instance, the CAD tools 228 may enable a visualization of patient 104 anatomy as well as possible implants to be placed within the patient 104 anatomy. Additional capabilities and features of the CAD tools 228 will be described in further detail herein.

The workflow(s) 232 may represent various guides for steps to be taken with the CAD tools 228. Although depicted as separate from the CAD tools 228, it should be appreciated that the workflow(s) 232 may be provided as part of the CAD tools 228. In some embodiments, the workflow(s) 232 represent an ordered series of steps to take within the CAD environment as the care provider 108 manipulates the objects with the CAD tools 228. Workflow(s) 232 may include prosthesis design/creation/placement/planning, surgical guide creation, bone graft planning, incision planning, drill planning, etc.

The printing 236 may correspond to an Application Programming Interface (API) that facilitates communication between the CAD tools 228 and the manufacturing system 140. In some embodiments, the printing 236 functionality enables one or more objects in the CAD environment to be produced via the manufacturing system 140. As a more specific example, the printing 235 functionality may generate one or more electronic files that describe physical dimensions of an object (or multiple objects) in the CAD environment along with instructions for the manufacturing system 140 to accurately produce/replicate the object using an appropriate manufacturing technique (e.g., 3D printing).

In an embodiment, the data models 237 are capable of predicting the volume, contour and/or location of objects corresponding to one or more anatomical features in the images of the patient 104 or patient anatomy, such as teeth and roots thereof, bone structures in the jaw, mandibular nerves or root canal, and soft tissue features such as gingiva, muscles, blood vessels, and the like. Compared to conventional CAD software for dental applications, the care provider would be required to use CAD tools to manually segment and categorize or identify the imaged information surface-by-surface and object-by-object. This process is laborious, time-consuming, and potentially inaccurate. In contrast, the data models 237 can automatically segment the surfaces without user involvement, such as automatically identifying the gingiva, nerves, root canals, bone or bony structure, blood vessels and the like. When the various anatomical features and objects are identified, the data models can create protection areas, such as root canals/nerves and blood vessels, that are avoided by the implant, surgical guide, and other dental restoration components during CAD designing.

In an embodiment, the data models 237 are capable of predicting or recommending, without user involvement or guidance, an optimal crown object configuration or model for a given tooth like object and assign a corresponding identifier (e.g., a unique number under the Universal Numbering System, Palmer Notation Method, or FDI World Dental Federation Notation) of the tooth-like object (e.g., tooth) to the autogenerated crown object. The data model is able to autogenerate the crown objects in the areas of the jaw that are missing teeth taking into account both the dimension and the occlusion, automatically select the implant objects from an implant library or use an implant object selected from the library by a care provider (discussed below) and position the implant objects substantially optimally in view of the available bone structure. The CAD workflows that are performed by a data model to autogenerate the crown object and abutment object are described below.

In an embodiment, the data models 237 are capable of predicting or recommending, without user involvement or guidance, an abutment object configuration or model (e.g., healing or permanent abutment) configuration for an autogenerated crown object for a given tooth like object. The data model is able to auto select the abutment object from an abutment library or use an abutment object selected by a care provider from the library (discussed below), optionally design the emergence profile, and design the abutment and crown objects to engage each other. The CAD workflows that are performed by a data model to autogenerate the abutment object and interface between the abutment object and crown object are described below.

In an embodiment, the data models 237 are capable of predicting or recommending, without user involvement or guidance, a bone graft object configuration or model (e.g., corresponding to a bone graft) for the areas of the jaw that are missing teeth and require additional bone growth to support an implant with sufficient strength to resist masticatory forces. The CAD workflows that are performed by a data model to autogenerate the bone graft object are described below.

In an embodiment, the data models 237 are capable of predicting or recommending, without user involvement or guidance, the various object configurations or models (e.g., corresponding to a crown, inlay, onlay, bar structure and associated attachment and locator members, artificial teeth, abutment, and bone graft), for a permanent or temporary dental restoration model (e.g., corresponding to an inlay or onlay, a dental bridge, a dental implant, a full, partial, immediate, or other implant-retained or supported overdenture), or other restorative dentistry component or system. The data model could present the care provider or patient with various restoration options such as designing and recommending a series of crowns and implants, designing and recommending a hybrid overdenture, designing and recommending a single overdenture, and designing and recommending a surgical guide. The care provider can further provide constraints, such as budget, patient restoration preferences, the care provider's design preferences, and the like. Based on the selected option, the data model autogenerates and recommends one or more dental restoration models for consideration. The various dental restorations and components thereof and associated workflows that are performed by a data model to autogenerate a dental restoration model are described in the workflow below.

In an embodiment, the data models 237 are capable of receiving a dental restoration model and work backwards to select and configure each dental restoration component to be compatible with the dental restoration model. For example, the care provider can design a CAD model of a full or partial overdenture and the data model is configured to design the bar structure or prosthetic object and associated attachment and connector member objects to engage and secure the full or partial overdenture to the patient's jaw. In another example, the gingiva margin line is determined based on the intersection of the crown object with the gingiva object and a custom abutment object is auto-generated by the data model such that the emergence profile on the custom abutment object matches the intersection and the post and outer lip of the abutment object engage the associated crown object. The CAD workflows that are performed by the data model are discussed in detail below.

The data models 237 can be any self-evolving, artificial intelligence (AI)-based models (also referred to as self-learning, AI-based models), whether using supervised, unsupervised, or reinforcement learning methods, machine learning, deep learning, generative AI, computer vision or hybrid models, functions or capabilities or narrow AI, general AI, or super AI in scope. Common models include linear regression, decision trees, and deep neural networks.

The data models can, for example, use computer vision and deep learning to detect anatomical patterns and features. In an embodiment, the data model first pre-processes the image data or model thereof to improve clarity, resolution, and legibility, such as by normalizing pixel values of the image information (e.g., adjusting the intensity range) based on the acquisition metadata to ensure consistent interpretation. The pre-processed image data or model thereof is processed layer by layer using a non-linear predictive control technique, such as a convolutional neural network (CNN) (e.g., neural network designed to detect patterns in images (such as edges, shapes and textures)). The first layers of the CNN detect simple patterns, like edges and textures, while the later layers delve into more complex anatomical cues that help the model spot anatomical structures. The data model, using the information collected and/or based on training data, classifies each identified anatomical structure in the pre-processed image data or model thereof (e.g., tooth, gingiva, bony structure, root canal, nerve, blood vessel, and the like) such as with bounding boxes. In some cases, a model may generate a probability score to show the confidence in the categorization. Next, the data model may overlay the findings on the image data or model thereof. This can be with bounding boxes, explainability tools or heatmaps, providing transparency into why the AI made the decision. The care provider can then use these visual tools to verify or challenge the results from the data model.

In an embodiment, the 2D or 3D scan data is converted into a 3D CAD model as part of the pre-processing process and the CNN is applied to the CAD model. The conversion can be done using reverse engineering software, such as Geomagic Design X™, FreeCAD™, Scan2CAD™, Dassault Systemes Catia™, Autodesk Fusion 360™, Geomagic for Solidworks™, Siemens NX™, Ansys Spaceclaim™, Tebis™, Meshmixer™, and Mesh 2Surface™, among others. The original 2D or 3D scan (typically in STL format) is loaded into the reverse engineering software. A CAD model (typically in STEP format) is generated by designing it on top of the underlying geometry of the 3D scan. In some embodiments, raster pixels in the image data are converted into lines, shapes, curves and dimensions defining the CAD model.

Training of the data models may train a baseline data model. For example, the training data may comprise pre-restoration image data and models and respective dental restoration models that are used to train the baseline model The training data may or may not be associated with one or more care providers or specialists. In the latter case, the trained baseline model would reflect the preferences and dislikes of the associated one or more care providers or specialists. Training is performed by first performing segmentation manually (e.g., using a virtual brush painting technique) and then doing the segmentation by the data model. The manual segmentation is compared with the data model segmentation to determine a set of differences. For instance, the STL or sterolithography file is compared with a DICOM file, or image file compliant with part 10 of the DICOM standard, to determine the set of differences. This can be done for mandibular nerve detection, automatic bone segmentation, with or without teeth, panoramic curve reconstruction, automatic extraction of toothlike objects from the image data or model, and automatic crown object extraction from the image data or model. If the differences exceed a predetermined threshold, the hyperparameters and other parameters of the data model are adjusted to reduce the magnitude of the differences.

In some embodiments, the CAD tools 228 and data models may operate with assistance of data from the database 240. Examples of data that may be stored in database 240 and may be used by the CAD tools 228 include template(s) 244, preferences 248, and a model library 252. While illustrated as being in a separate database 240, it should be appreciated that some or all of the elements shown in the database 240 could be included in memory 216 without departing from the scope of the present disclosure.

The template(s) 244 and/or model library 252 may include one or more electronic files describing objects for use by the CAD tools 228. In some embodiments, objects may be created or manipulated within the CAD environment, then the objects may be saved as templates 244 for later use in a different surgical procedure. For instance, a care provider 108 may create one or more templates that can be slightly adjusted or customized for use with different patients. Objects can be loaded into the CAD environment by the CAD tools 228 using the templates 224. Similarly, presentation and application preferences for the CAD tools 228 may be maintained and referenced as part of the preferences 248. The preferences 248 may correspond to one or more values or settings used at an application level by the CAD tools 228. The preferences 248 may be changed, saved, or reset by the care provider 108.

The model library 252 may include one or more templates 244. In some embodiments, however, the model library 252 may store electronic files for models or objects to be used during a surgical procedure. As an example, the model library 252 may include files describing physical dimensions of implants or implant kit components. The dimensions of the objects stored in the model library 252 may be defined by the manufacturer of the implants. Objects loaded from the model library 252 may or may not be adjustable or have control points that facilitate an adjustment of relative dimensions by the CAD tools 228 whereas objects loaded from the template(s) 244 may be adjustable or have control points that facilitate an adjustment of relative dimensions by the CAD tools 228.

The communication interface 208 may be used for receiving image data or other information from an external source (such as the imaging system 124, the database 240, the network 256, and/or any other system or component not part of the system 100). The communication interface 208 may provide connectivity between the computing device 200 and the communication network 256, thereby enabling machine-to-machine communication with other devices of the system 100. The communication interface 208 may comprise one or more wired interfaces (e.g., a USB port, an ethernet port, a Firewire port) and/or one or more wireless transceivers or interfaces (configured, for example, to transmit and/or receive information via one or more wireless communication protocols such as 802.11a/b/g/n, Bluetooth, NFC, ZigBee, and so forth). In some embodiments, the communication interface 208 may be useful for enabling the computing device 200 to communicate with one or more other processors or computing devices 200, whether to reduce the time needed to accomplish a computing-intensive task or for any other reason.

The user interface 212 may be or comprise a keyboard, mouse, trackball, monitor, television, screen, touchscreen, and/or any other device for receiving information from a user and/or for providing information to a user. The user interface 212 may be used, for example, to receive a user selection or other user input regarding any step of any method described herein. Although the user interface 212 is shown as part of the computing device 200, in some embodiments, the computing device 200 may utilize a user interface 212 that is housed separately from one or more remaining components of the computing device 200. In some embodiments, the user interface 212 may be located proximate one or more other components of the computing device 200, while in other embodiments, the user interface 212 may be located remotely from one or more other components of the computing device 200. Illustratively, the user interface 212 may include a user input device, a user output device, and a combination user input/user output device (e.g., a touch-sensitive display device).

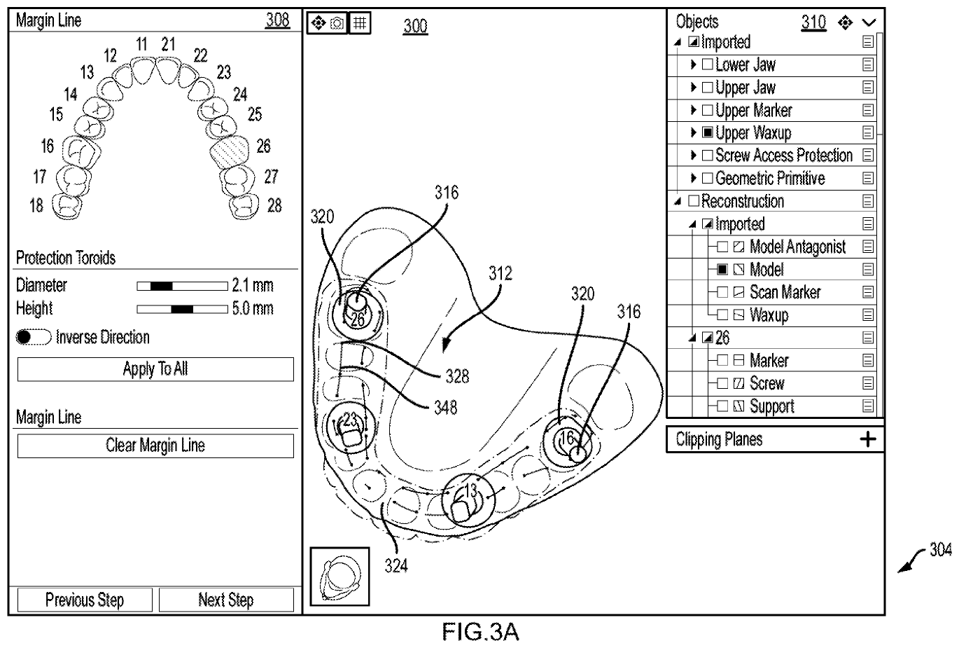

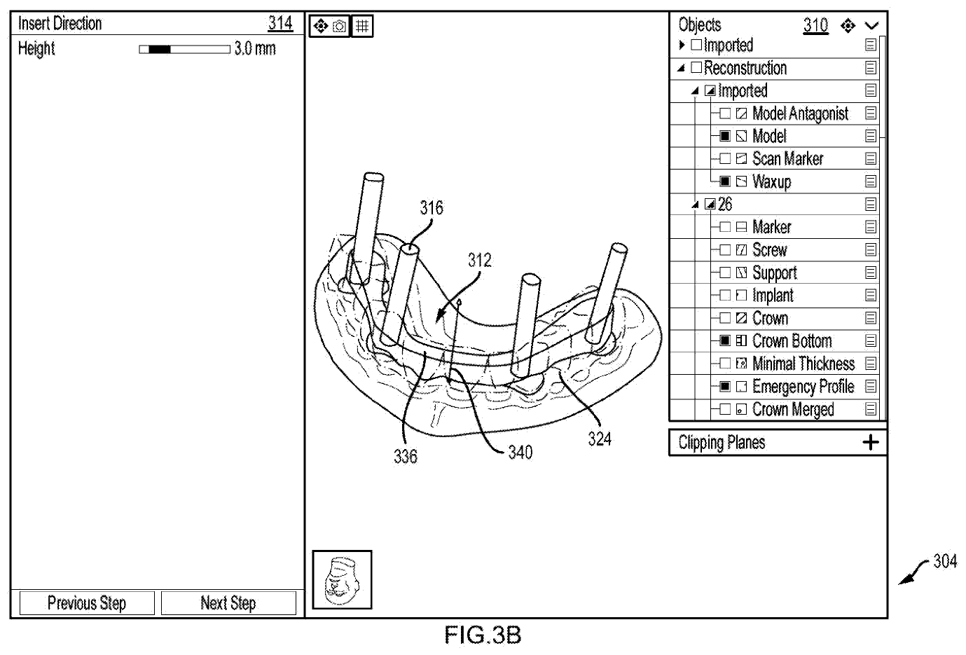

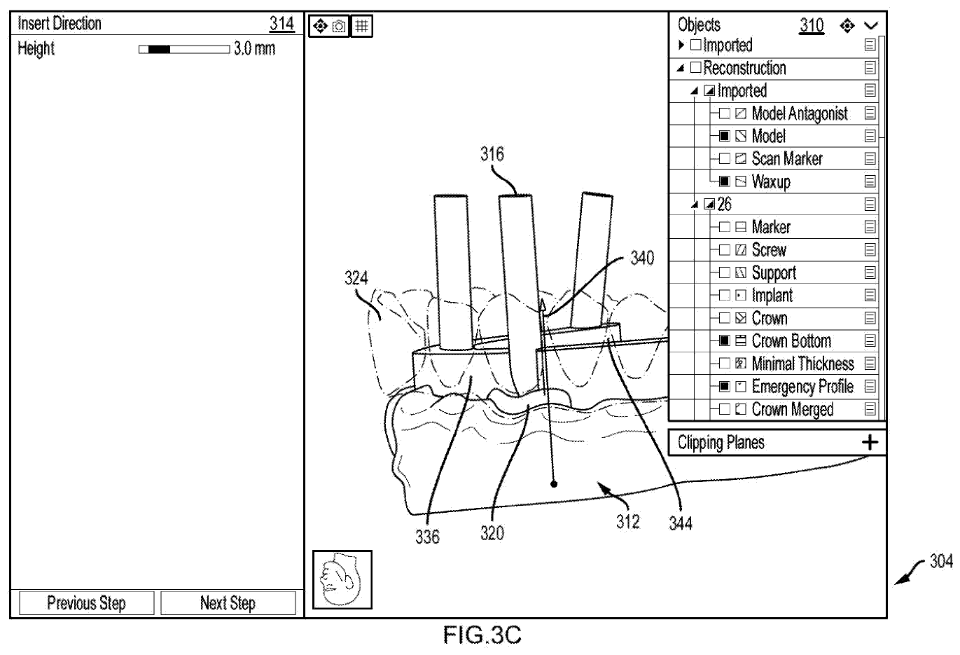

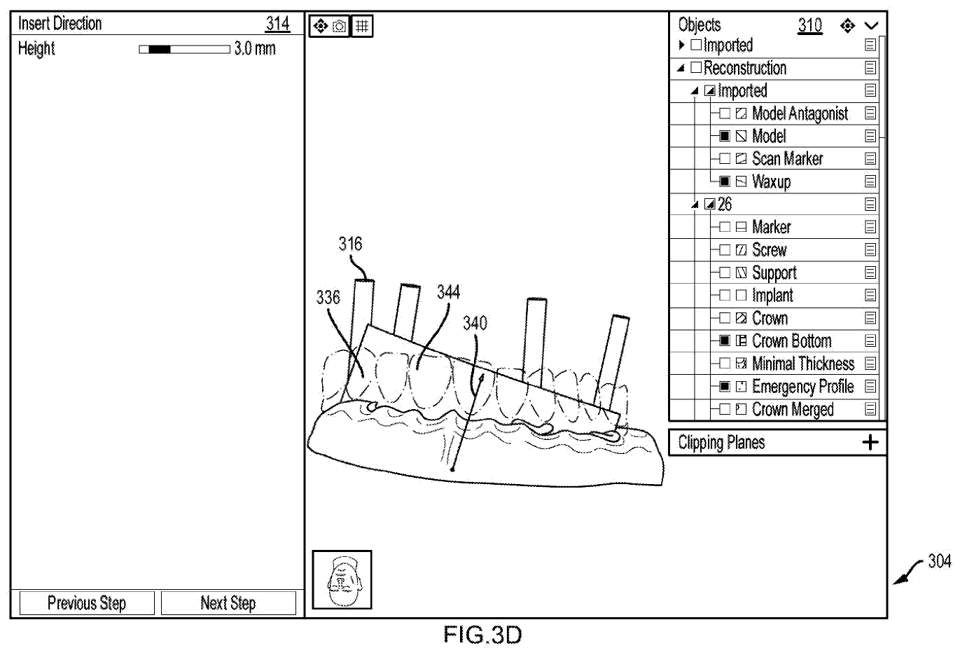

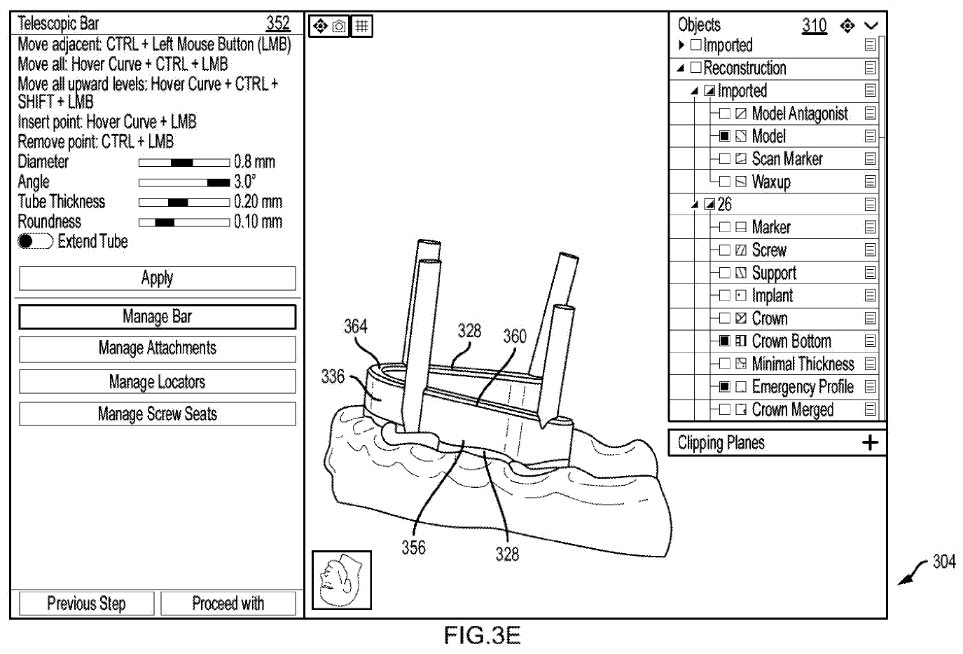

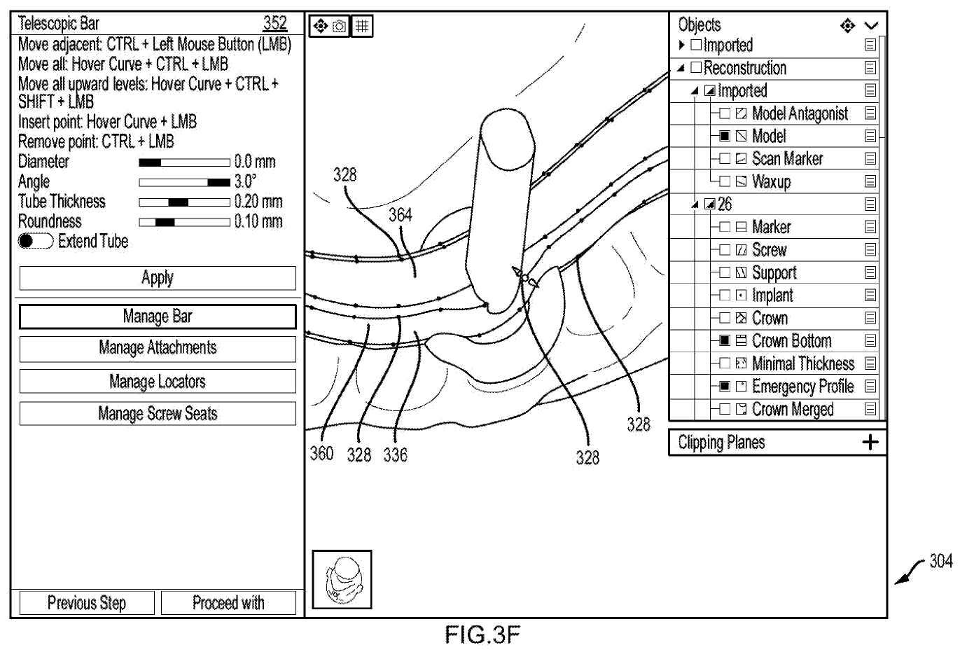

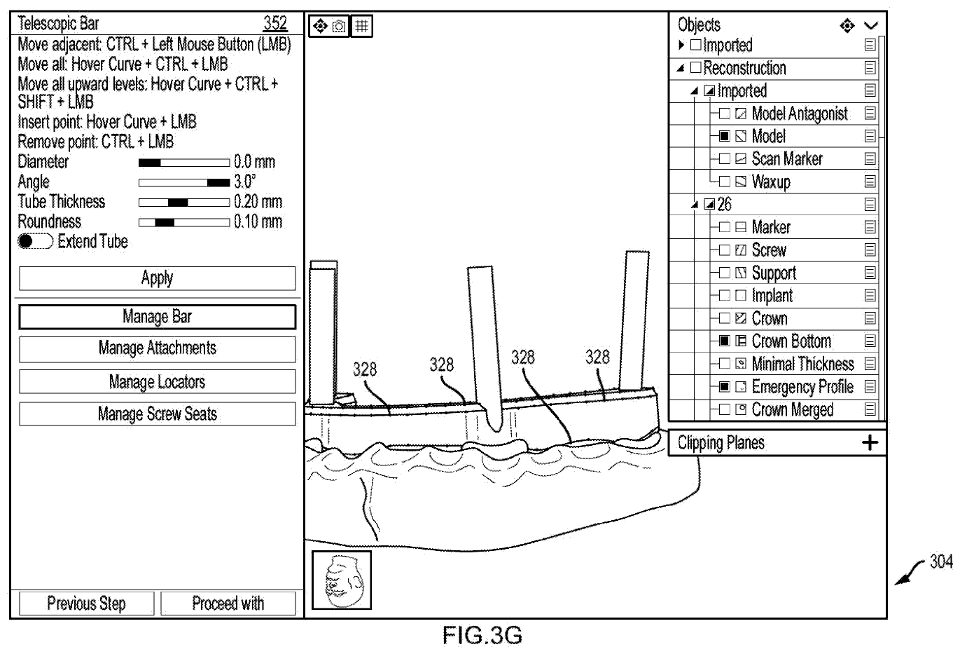

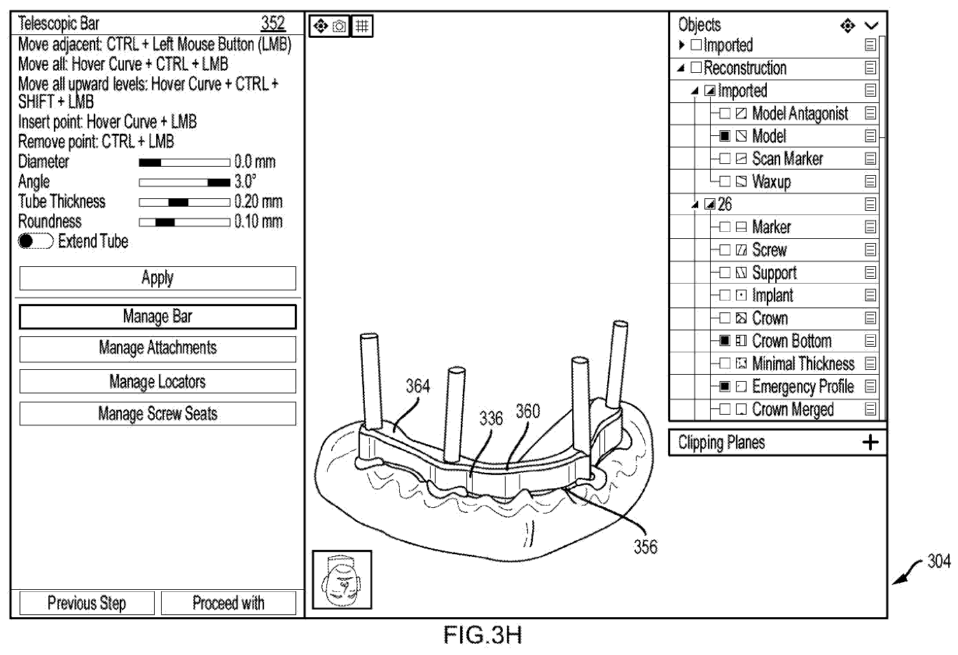

Referring now to FIGS. 3A-16M, various workflows and capabilities of the CAD tools 228 will be described in accordance with at least some embodiments of the present disclosure. The workflows and capabilities are shown and described in a particular order, but it should be appreciated that the CAD tools 228 can be configured to enable the order of operations in any particular workflow to be changed, skipped, modified, or the like. More specifically, the CAD tools 228 are flexibly configured to allow the care provider 108 to take any step or combination of steps in any order desired. The illustrated steps are shown for purposes of illustration and should not be construed as limiting embodiments of the present disclosure.

The various workflows and capabilities of the CAD tools 228 can enable any created or edited object to be saved as a selected object or combination of objects as a template 244 or into the model library 252. The workflows allow the user is allowed to name the object(s) currently selected within the CAD environment 304 as a new template 244 or object in the model library 252.

In addition to providing the ability to create new object, the various workflows may also facilitate the importation of an object into the CAD environment 304 from a template 244 or the model library 252. As discussed below, libraries of objects may be provided to enable users to view or browse some or all of the objects that have been saved as a template 244 or object in the model library. An object selected from the slot library may be imported into the CAD environment 304 for manipulation relative to other objects already imported into the CAD environment 304. The object, when initially imported, may have all of the dimensions and control points that existed when the object was created or saved; however, it may be possible to customize the dimensions of the object once imported into the CAD environment. For example, a selected object imported from the object library may have multiple control points that can be adjusted to realize a new freeform object.

In addition to facilitating the creation of customized object via use of cut-type objects, embodiments of the present disclosure also contemplate that freeform objects can be added or merged with other objects in the CAD environment. For instance, a workflow is provided in which one or more objects can be merged with other objects to arrive at a resultant object. The object(s) may have one or more control points that are movable in three dimensions. A presentation of the objects in an overlapping arrangement can be shown even while the user manipulates and adjusts a position of control points, thereby changing a size of one or more objects. Eventually, a merge function may be performed using one or more Boolean operations, thereby combining the two separate objects into a resultant object that occupies the volumes and has the shapes of the previously separated objects.

An object may be duplicated or imported into the CAD environment 304 multiple times. Each portion (e.g., volume) of overlap between an object and another object may be determined. The overlapping volume(s) may then be subject to a Boolean operation in which the overlapping volume(s) are subtracted, removed, or otherwise adjusted into a split volume. Alternatively, the objects may be merged or combined in the CAD environment 304. In some embodiments, objects may only be merged with another object of a particular type. For example, but without limitation, objects may only be eligible for merging with other non-anatomical objects. Thus, when a merge function is selected, only the objects eligible for merger with the object may remain displayed while other objects not eligible for merger with the object are removed from view.

Referring initially to FIGS. 3A-3H, a first workflow or set of workflows will be described in accordance with at least some embodiments of the present disclosure. FIG. 3A illustrates a first view of a GUI 300 provided by the CAD tools 228. The GUI 300 may be presented via a user interface 212. The GUI 300 is shown to include a presentation frame or application window that provides one or more icons, visualization tools, and the like. The GUI 300 illustrated in FIG. 3A is shown to include a CAD environment 304 in which one or more objects are viewable, manipulatable, and/or rotatable. It should be appreciated that a greater or lesser number of objects can be presented simultaneously such that relative dimensions of various objects can be visualized for purposes of planning a surgical procedure or dental restoration. The objects can correspond to a patient feature or man-made object. The objects representing patient 104 anatomical features may include hard tissue objects (e.g., bones, teeth, etc.) or soft tissue objects (e.g., nerves, arteries, gingiva, tongue, etc.). The objects representing man-made objects may include prosthetics, implants, abutments, bar structures, screws, surgical guides, stacked surgical guides, alignment mechanisms, fasteners, or the like. The GUI 300 also includes a margin line toolbar 308 that includes user selectable tools to change an orientation, position, or presentation of the occlusal margin, or the interface or edge where a dental restoration (such as a bar, abutment or crown) meets the tooth structure on the biting or occlusal surface and an object control toolbar 310 may be presented alongside the CAD environment 304 to enable further manipulation or adjustment of objects presented in the CAD environment 304. In an embodiment, the object control toolbar 310 includes tools to load and save import objects (such as lower jaw, upper jaw, upper marker, upper waxup, screw access protection, and geometric primitive) and reconstruction objects (such as model antagonist, model, scan marker, screw, support, and waxup).

Referring to FIGS. 3A and 3B, the CAD environment 304 comprises an insert direction toolbar 314 that includes tools to manipulate one or more geometric parameters of an inserted object and a first object 312, which is a virtual representation of the patient's arch and inter-arch areas (e.g., the gingiva tissue of the patient), screw access object 316, which is a virtual representation of a tool access object showing its dimensions and longitudinal axis or tool access direction of a corresponding prosthetic object (such as a dental implant object, attachment member object or locator member object), third object 320, which is a virtual representation of an outer peripheral surface of the corresponding implant, and fourth object 324, which is a virtual representation of a selected dental restoration (e.g., prosthetic teeth in a overdenture, bridge, or crown).

FIG. 3A also illustrates the independently adjustable control points 328 and intervening boundaries 348 that may be established between adjacent control points to define a prosthetic object 336 created within the CAD environment 304 (which prosthetic object 336 is shown for purposes of illustration and not by way of limitation as a bar structure). The prosthetic object 336 may correspond to a freeform object that includes one or more control points that are independently capable of manipulation. The control points, as will be described in further detail herein, can be adjusted in one, two, or three dimensions within the CAD environment 304 and the adjustment of control points relative to other control points will result in a different spatial configuration of the prosthetic object 336 (e.g., the spatial confirmation may be a different shape, surface position, degree of angularity or curvature of a surface, an orientation of a surface, a position of a surface, or other presentation parameter). Control points enable the creation and manipulation of a selected object as a freeform object and allow the user a unique level of control and customization over the selected object. In some embodiments, the adjustment of a control point 328 will result in a change of the volume occupied by the selected object. This may also impact the amount of overlap between the selected object and other objects in the CAD environment 304. The control points 328 may be added or deleted to the selected object as well. Each control point 328 may provide a mechanism to adjust the size and/or shape of the selected object in one, two, or three dimensions. Furthermore, prosthetic objects 336 may be created from scratch or may be created from a template 224.

As can be seen in FIG. 3B, the prosthetic object 336 is created within the spatial volume of the selected dental restoration or the fourth object 324. In some embodiments, the prosthetic object is created by redefining a portion of the fourth object's inner volume as a newly created object. In some embodiments, the prosthetic object is created by using a cut-type object to remove a portion of the inner volume and replacing the cut or removed portion with a new object having the same volume as the cut-type object. As will be appreciated, the creation or generation of the prosthetic object will not affect the remaining volume, surface configuration or other presentation parameter of the fourth object. While the prosthetic object is shown as a telescopic or extruded bar structure, it is to be understood that other prosthetic objects may be created using the teachings of the present disclosure, such as an abutment as the prosthetic object configured to receive a prosthetic tooth or crown as the fourth object or a bridge as the prosthetic object configured to receive one or more prosthetic teeth as the fourth object. The ability to use control points to define a prosthetic object within a restoration object can enable the user to use fewer steps to create a prosthetic object than conventional techniques.

With reference to FIGS. 3B-3D, the CAD environment comprises an insert direction adjustment handle 340, which, as discussed below, is a tool in the insert direction toolbar 314, that can be manipulated to control an orientation and position of the opposing side surfaces 344 of the prosthetic object 336. The illustrated bar structure as the prosthetic object 336 provides load distribution on extended parts of the prosthetic reconstruction making the overall reconstruction 336 robust. Adjustment of the opposing side surfaces 344 of the prosthetic object in one, two or three dimensions is desired to ensure sufficient thickness of the prosthetic manufactured from the fourth object 324 to respond to masticatory forces without failure.

With reference to FIGS. 3E-H, the CAD environment comprises a prosthetic wizard side panel 352 (shown in an embodiment as the telescopic bar side panel) that comprises tools to adjust a geometric or spatial parameter of the prosthetic object 336, such as bar position, thickness, angularity or roundness, surface position or orientation, and diameter, along with tools to manage the bar and bar attachments, locators, and screw seats. The prosthetic object 336 comprises multiple sets of control points 328 corresponding to different surfaces of the prosthetic object 336, namely a first set enabling manipulation of the lower seating surface 356 of the prosthetic object 336 to enable contouring to match the anatomical contours of the patient's gums or gingiva, a second set enabling manipulation of an intermediate surface 360 of the prosthetic object 336, and a third set enabling manipulation of an upper surface 364 of the prosthetic object 336. As will be appreciated, more or fewer sets of control points may be employed and control points may be used to manipulate other surfaces of the prosthetic object 336. Control point manipulation enables the user to move the spatial position, shape, angularity, curvature, or orientation of the corresponding surface.

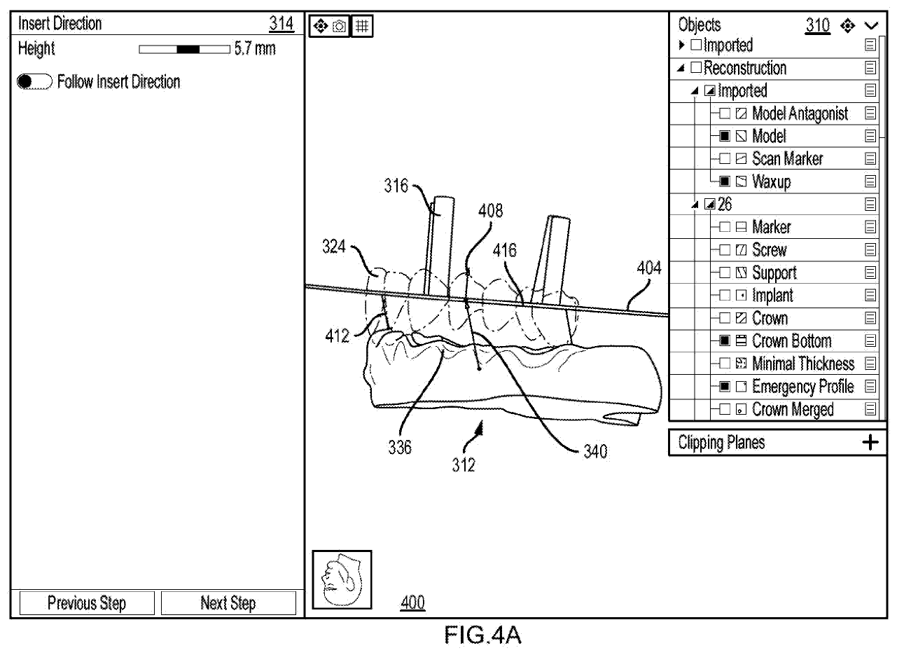

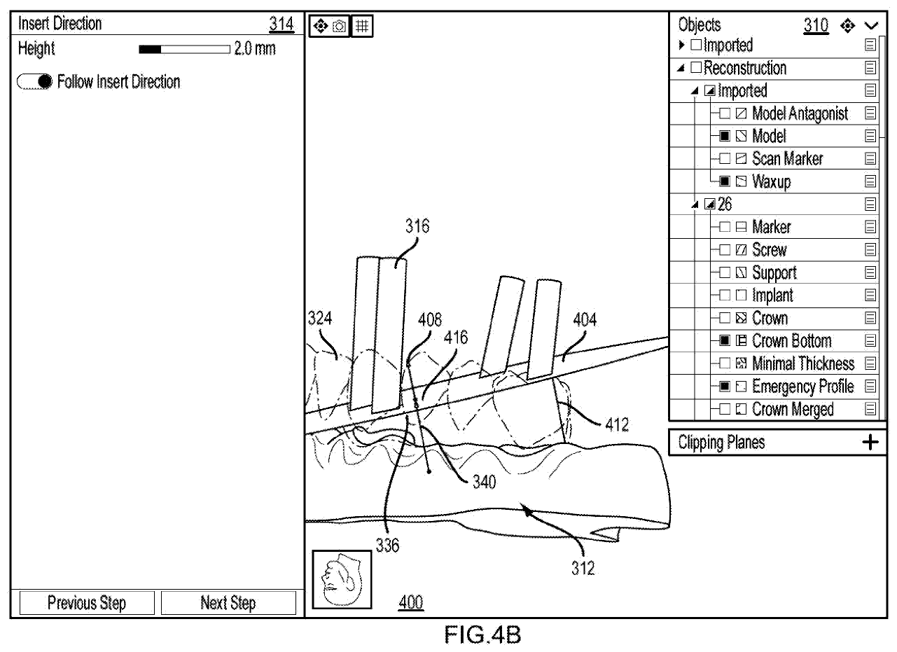

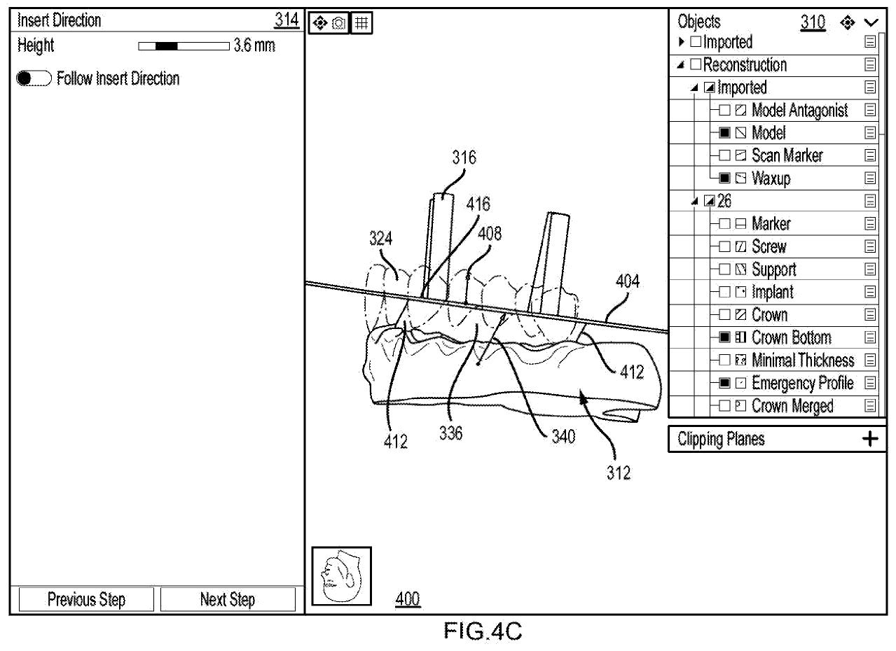

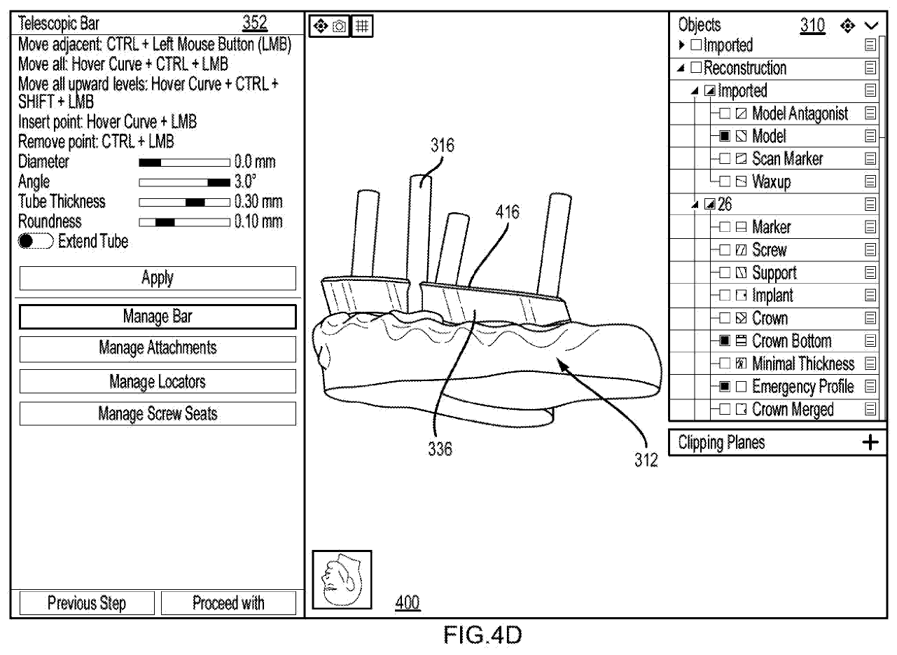

With reference to FIGS. 4A-4D, the use of the insert direction adjustment handle 340, which is a tool in the insert direction toolbar 314, will be further described. In the CAD environment 400, an occlusal plane object 404 (which is a virtual representation of the occlusal plane of the corresponding patient) and occlusal force vector object 408 (which is a vector normal to the occlusal plane object 404 and is also representative of the abstraction axis of the overstructure of the selected dental restoration) are depicted. As noted, the insert direction adjustment handle 340 manipulates the position and orientation of the opposing inner and outer side surfaces 412 of the prosthetic object 336 relative to the CAD environment coordinate system in one-two or three dimensions and the occlusal force vector object 408 manipulates the position and orientation of the occlusal plane object 404 relative to the CAD environment coordinate system in one, two, or three dimensions and thereby collectively enable the position and extraction (or orientation of the opposing inner and outer side surfaces 412 of the prosthetic object 336 relative to the CAD environment coordinate system) to be substantially optimized relative to the outer surfaces of the overstructure of the selected dental restoration object 324. In other words, the position and orientation of the prosthetic object 336 relative to the overstructure of the dental restoration object 324 is substantially optimized to accommodate and distribute occlusal forces while maintaining longevity of the overstructure in response to episodic application of masticatory forces. As will be appreciated, the position and orientation of the occlusal force vector object 408 relative to the position and orientation of a selected portion of the overstructure of the dental restoration object 324 (e.g., one or more teeth of the overstructure) and the arch object indicates the occlusal plane position and orientation associated with the substantially optimal stress distribution. A desired stress distribution typically requires the occlusal force vector object 408 to be positioned in a central portion of the arch and generally parallel to an average longitudinal axis of one or more of the teeth and centrally located in the overstructure. The position and extraction of the opposing side surfaces 412 are selected by manipulation of the insert direction adjustment handle 340 to withstand the stress distribution represented by the occlusal plane while maintaining sufficient material in the overstructure on either side of the opposing side surfaces 412 and above the upper surface 416 of the prosthetic object 336 to avoid failure. As shown in FIGS. 4A-D, the occlusal plane object 404 is positioned on the upper surface 416 of the prosthetic object 336.

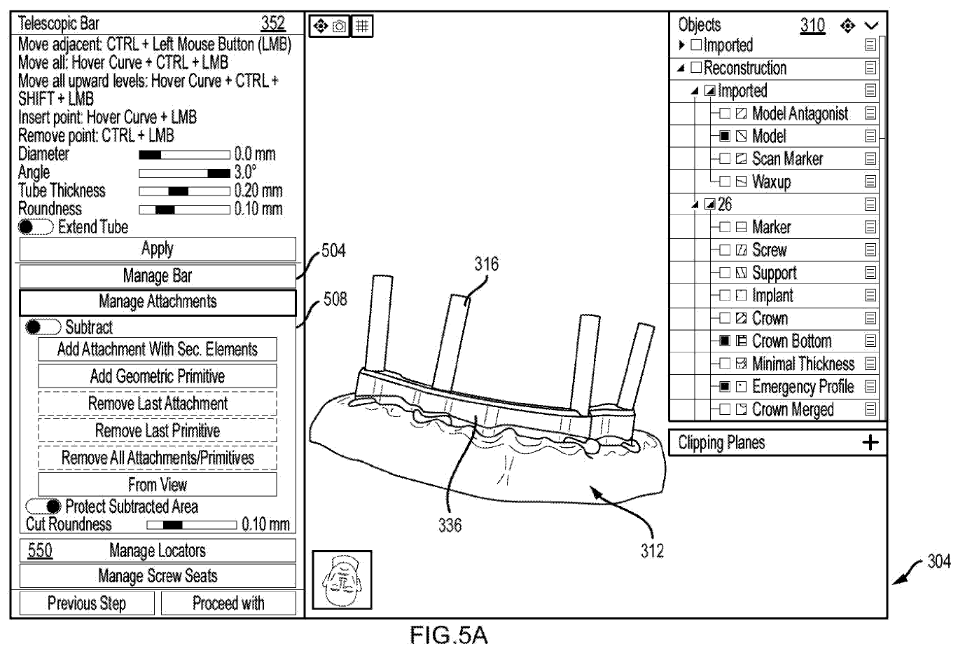

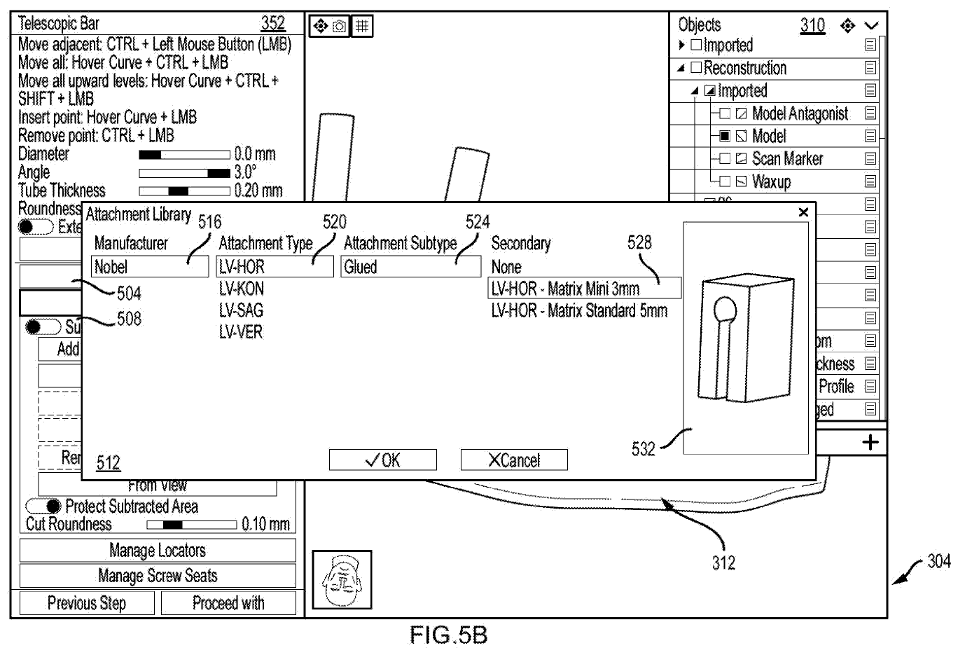

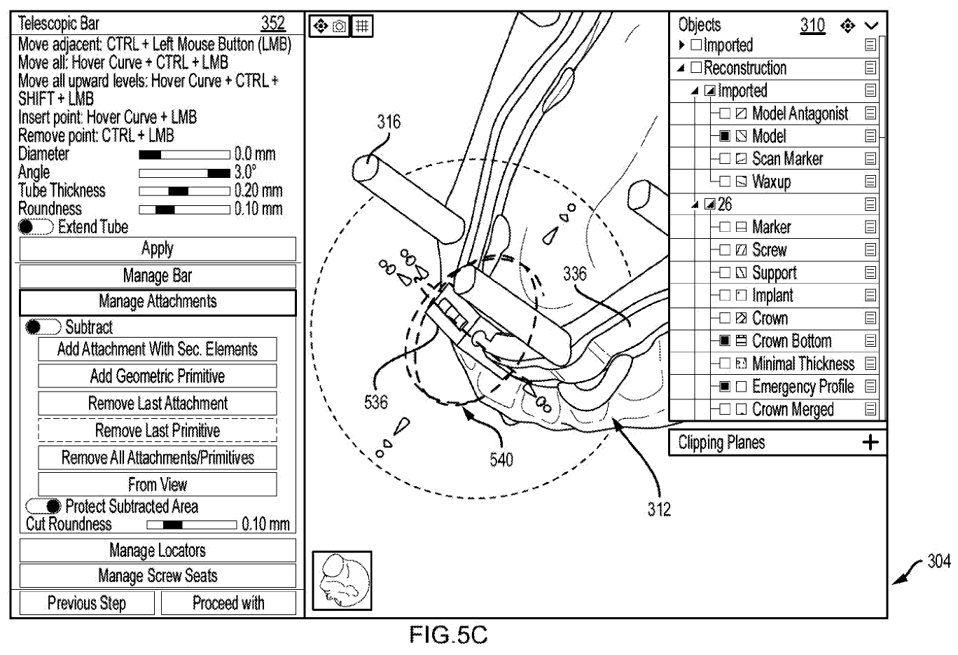

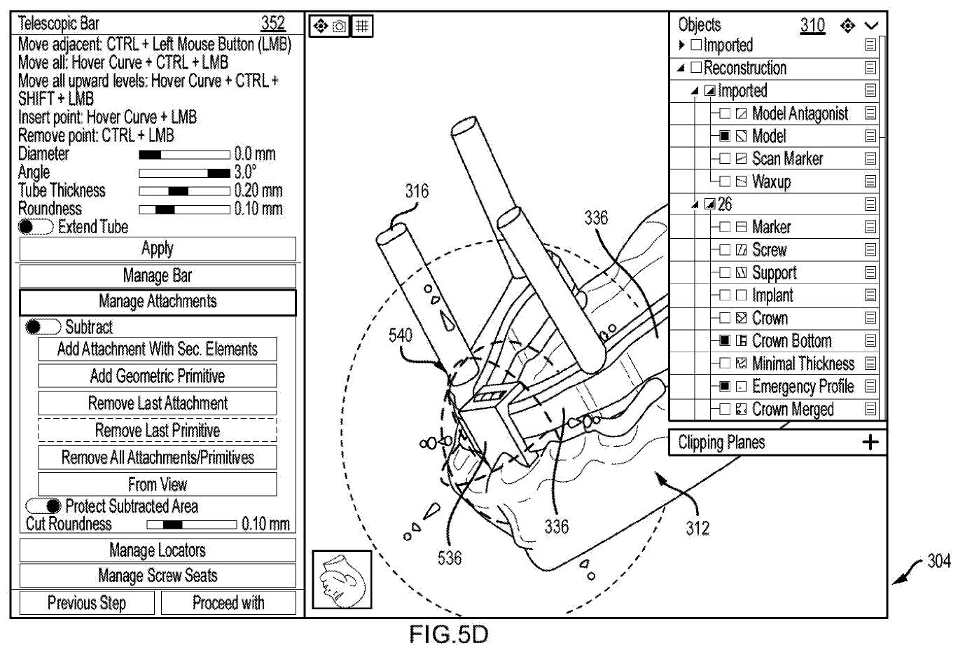

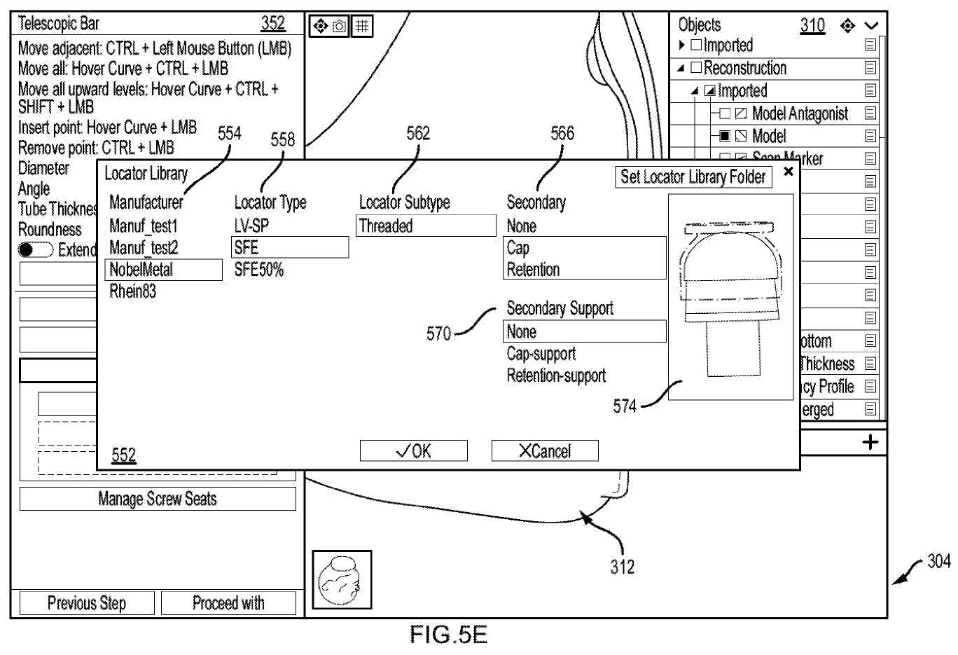

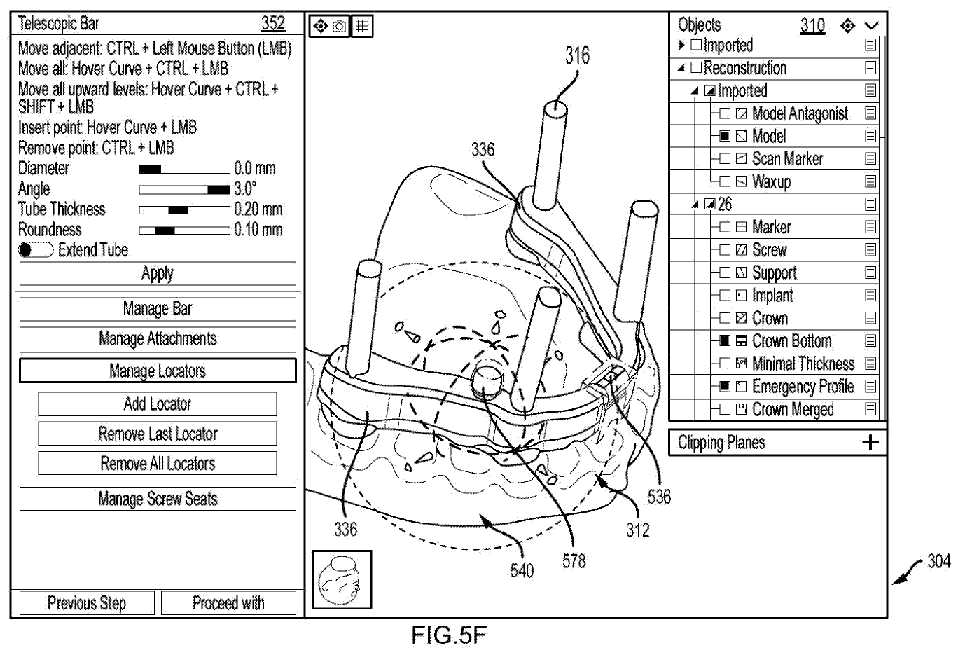

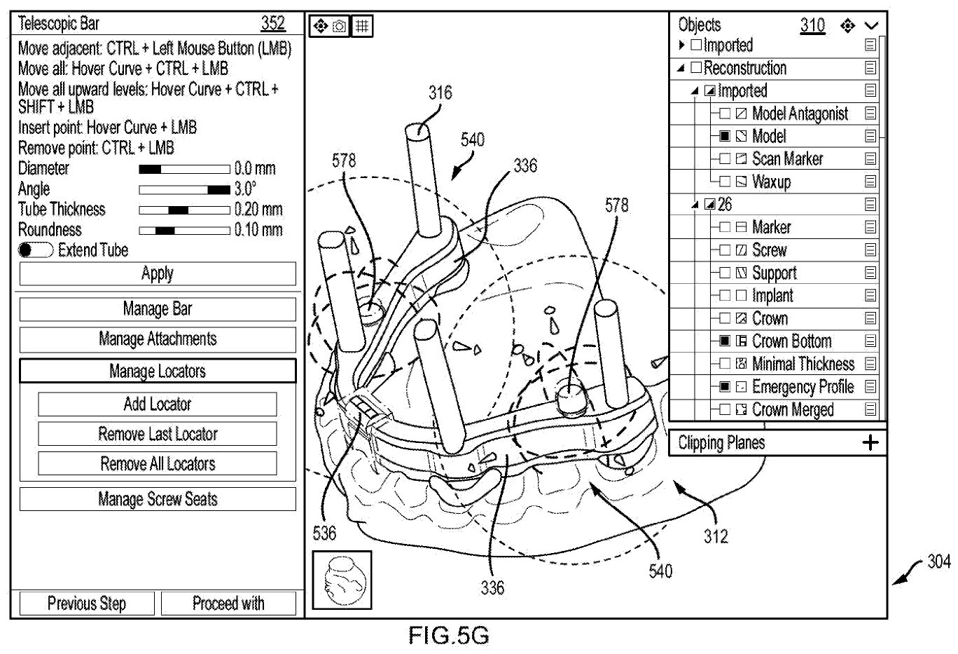

With reference to FIGS. 5A-5H, a CAD workflow that enables attachments and locators to be modeled and applied to the prosthetic object 336 substantially simultaneously will be discussed. The ability to model the attachments within a CAD model of the patient's oral cavity can eliminate trial and error by a care provider, such as a dentist, oral surgeon or dental care provider. The illustrated prosthetic object 336, despite the customization of its shape, can have dimensions that could interfere with their anatomical coupled prosthetic overstructure of the selected dental restoration, thereby making it desirable or necessary to design both the prosthetic object 336 and overstructure in a CAD environment.

With reference to FIGS. 5A-5D, the prosthetic wizard side panel 352 comprises a tool 508 to manage attachments. As will be appreciated, attachments refer to structures or mechanisms, such as clips, studs, or housings, used to maintain the overstructure of the removable prosthetic restoration in position by withstanding vertical forces applied to the overstructure during use. User selection of the tool presents a further display panel 508 including selectable options to add to the CAD environment an attachment with secondary elements, add to the CAD environment a geometric primitive (e.g., a predefined basic, atomic or other pre-defined one-, two-or three-dimensional shape), remove from the CAD environment a last attachment, remove from the CAD environment a last primitive, and remove from the CAD environment all attachments and primitives.

With reference to FIG. 5B, user selection of the add attachment with secondary elements option in the further display panel an attachment library panel 512 provides a library of objects that are either templates or models from the model library 252 associated with different selectable attachments. By way of illustration, the library includes, for each attachment member object, a manufacturer field 516, attachment type field 520 (e.g., the attachment mechanism to the over structure such as clip type or configuration such as Hader bars, Acriman clips, RTX attachments, and the like), attachment subtype field 524 (e.g., attachment mechanism to the prosthetic object 336 such as glued or threaded (e.g., screwed)), and secondary field 528 (including descriptors such as dimensions) along with an image 532 of the associated attachment member corresponding to the attachment member object.

With reference to FIGS. 5C-5D, a model or template of the selected attachment member object 536 (as defined by the selected library fields) is imported into the CAD environment 304 and positioned on the prosthetic object 336 in a desired position and orientation. Once imported into the CAD environment 304, the object 536 may have rotation handles 540 that enable manipulation or customization of the object within the CAD environment 304. The rotation handles 540 may be centered about the center of mass of an object and may facilitate a rotation of the object in all three dimensions. The rotation handles 540 may allow the object to be rotated relative to other objects in the CAD environment 304. The rotation handles 540 may also allow a translational movement of the object within the CAD environment 304. For instance, the rotation handles 540 may be used to rotate the object in three dimensions and may also be used to translate the object in three dimensions relative to other objects in the CAD environment 304. The object can be rotated and translated such that portions of the object overlap portions of other objects. The object 536 thus may be moved and/or manipulated while still presented as a separate object from the other objects in the CAD environment 304. In some embodiments, the object 536 may be manipulated to overlap at least a portion of another object in the CAD environment 304, such as the prosthetic object 336. As the object 536 is moved within the CAD environment 304 (e.g., rotated, translated, flipped, etc.), the volume occupied by each object in the CAD environment 304 is determined. Furthermore, any volume that is occupied by two or more objects is identified as an overlapping volume in the CAD environment 304.

With reference to FIGS. 5E-5G, the prosthetic wizard side panel 352 comprises a tool 550 to manage locators (shown in FIG. 5A). As will be appreciated, locators refer to structures or mechanisms, such as clips, studs, or housings, used to maintain the overstructure of the removable prosthetic restoration in position by withstanding horizontal forces applied to the overstructure during use. User selection of the tool presents a further display panel including selectable options to add to the CAD environment a locator with secondary elements, add to the CAD environment a geometric primitive (e.g., a predefined basic, atomic or other pre-defined one-, two-or three-dimensional shape), remove from the CAD environment a last locator, remove from the CAD environment a last primitive, and remove from the CAD environment all locators and primitives.

With reference to FIG. 5E, user selection of the add locator with secondary elements option in the further display panel a locator library panel 552 provides a library of objects that are either templates or models from the model library 252 associated with different selectable locators. By way of illustration, the library includes, for each locator member object, a manufacturer field 554, locator type field 558 (e.g., type or configuration of locator that engages the over structure), locator subtype field 562 (e.g., locator attachment mechanism to the prosthetic object 336 such as glued or threaded), secondary field 566 (e.g., locator configuration such as cap type, retention type, or none) and secondary support field 570 (e.g., secondary support configuration such as cap-support, retention-support, and none) long with an image 574 of the associated locator member associated with the locator member object.

With reference to FIGS. 5F-5G, a model or template of the selected locator member object 578 (as defined by the selected library fields) is imported into the CAD environment 304 and positioned on the prosthetic object 336 in a desired position and orientation. Once imported into the CAD environment 304, the object 578 may have rotation handles 540 that enable manipulation or customization of the object within the CAD environment 304. The object 578 may be moved and/or manipulated while still presented as a separate object from the other objects in the CAD environment 304. In some embodiments, the object 578 may be manipulated to overlap at least a portion of another object in the CAD environment 304, such as the prosthetic object 336. As the object 578 is moved within the CAD environment 304 (e.g., rotated, translated, flipped, etc.), the volume occupied by each object in the CAD environment 304 is determined. Furthermore, any volume that is occupied by two or more objects is identified as an overlapping volume in the CAD environment 304.

As shown in FIG. 5G either or both of the attachment or locator member objects may be duplicated or imported into the CAD environment 304 multiple times. Each portion (e.g., volume) of overlap between an object and another object may be determined. The overlapping volume(s) may then be subject to a Boolean operation (e.g., AND, SUBTRACT, OR, NOT, XOR, etc.) in which the overlapping volume(s) are subtracted, removed, or otherwise adjusted. In some embodiments, the overlapping volume will become a split volume or new object. The portion of an object that was not overlapping any other object may be removed from the CAD environment whereas the portion of the object that was overlapping one or more other objects may become a new split volume. In some embodiments, the split volume is created using one or more Boolean operations. The Boolean operations may be used to first identify the overlapping volume shared between two or more objects in the CAD environment 304. Alternatively or additionally, the Boolean operations may be used to identify the volume(s) of the object that do not overlap another object.

Alternatively, a merge connector toolbar may be provided that facilitates the merging or combining of objects with other objects in the CAD environment 304. In some embodiments, objects may only be merged with another object of a particular type. For example, but without limitation, objects may only be eligible for merging with other non-anatomical objects. Thus, when a merge function is selected, only the objects eligible for merger with the object may remain displayed while other objects not eligible for merger with the object are removed from view. When the user selects a final merge option, a simple Boolean operation (e.g., AND) in a single command may be used to join or merge the objects with other objects based on their overlapping volumes. When merged, each of the objects and associated primary and secondary library objects (e.g., the selected features and attributes in the library panels 512 and 552) are joined or merged into the merged object. In this manner, the merged object is not defined by separate, disconnected and disjoined data structures but by a data structure that merges the selected or associated primary and secondary library objects into a connected, linked, or joined data structure, thereby simplifying dental restoration design into a single workflow. FIG. 5G illustrates the resultant objects 336, 536, and 578 after the merger with other objects in the CAD environment 304 to form the merged object (e.g., the bar structure and merged attachment and locator objects). When the object corresponds to a bar structure, the bar structure may be split by a CAD workflow into one or more resultant portions. The resultant portions may collectively have the same shape as the bar structure minus the volume of any cut-type object. Physical objects manufactured according to the dimensions of objects in the CAD environment 304 will mate perfectly (e.g., within machining tolerances) to one another.

As part of the merge operation, the processor 204 can verify compatibility of the objects to be merged along with verifying the dimensional compatibility of any dimension of the merged object with the overstructure or the dental restoration formed by merger of the merged object and the overstructure with the patient oral cavity before the physical bar and associated attachment and locator members are manufactured. This can be done by comparing dimensions of the overstructure with the merged object and/or of the overstructure as modified by merger with the merged object against the dimensions of the oral cavity. When an incompatibility is identified, an error message can be provided to the user identifying the existence and basis of the incompatibility and optionally provide one or more object changes (such as dimensional changes or substitute or replacement objects) to remove the incompatibility.

The prosthetic object 336 may be saved as a selected object or combination of objects as a template 244 or into the model library 252. In some embodiments, selection of a save icon causes the CAD tools 228 to present a save window. Within the save window, the user is allowed to name the object(s) currently selected within the CAD environment 304 as a new template 244 or object in the model library 252.

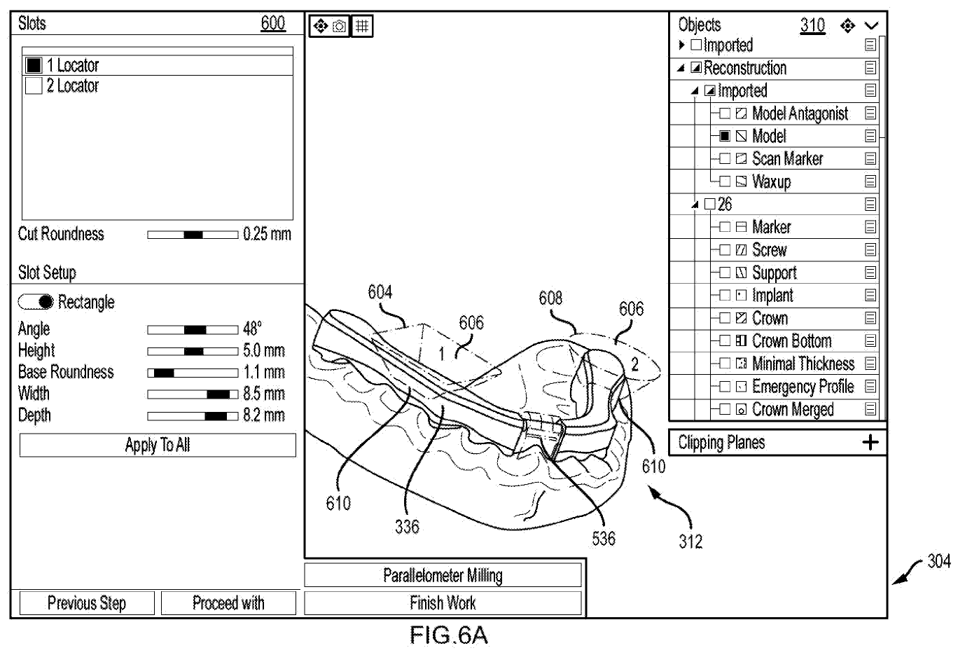

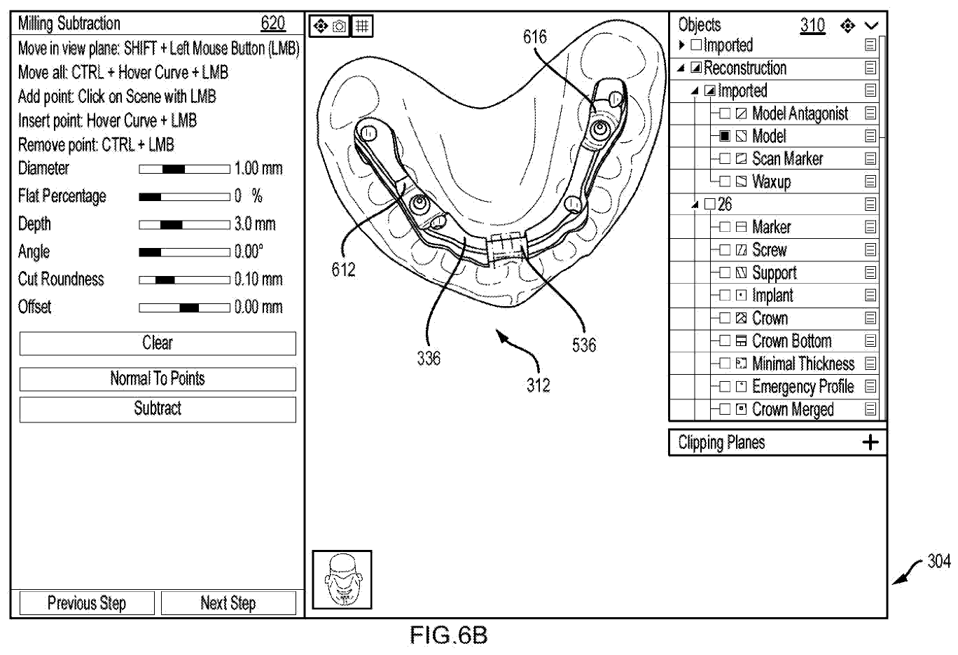

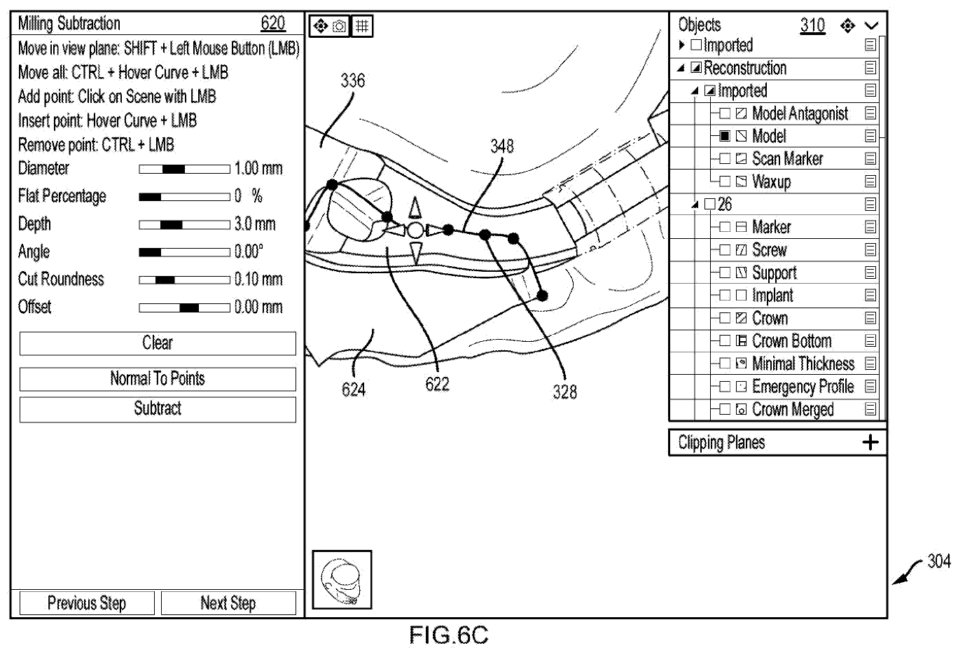

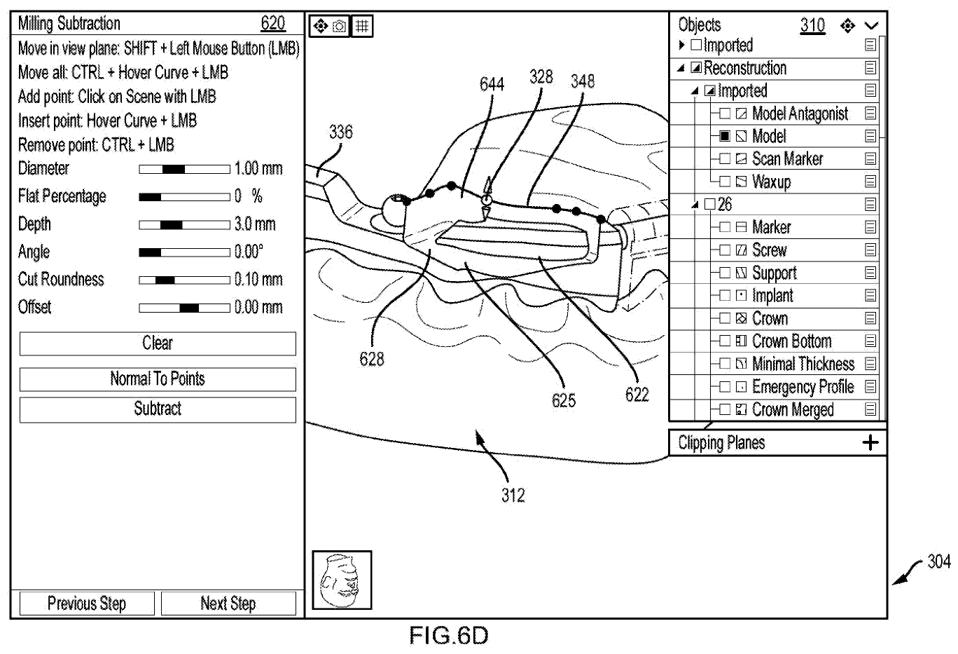

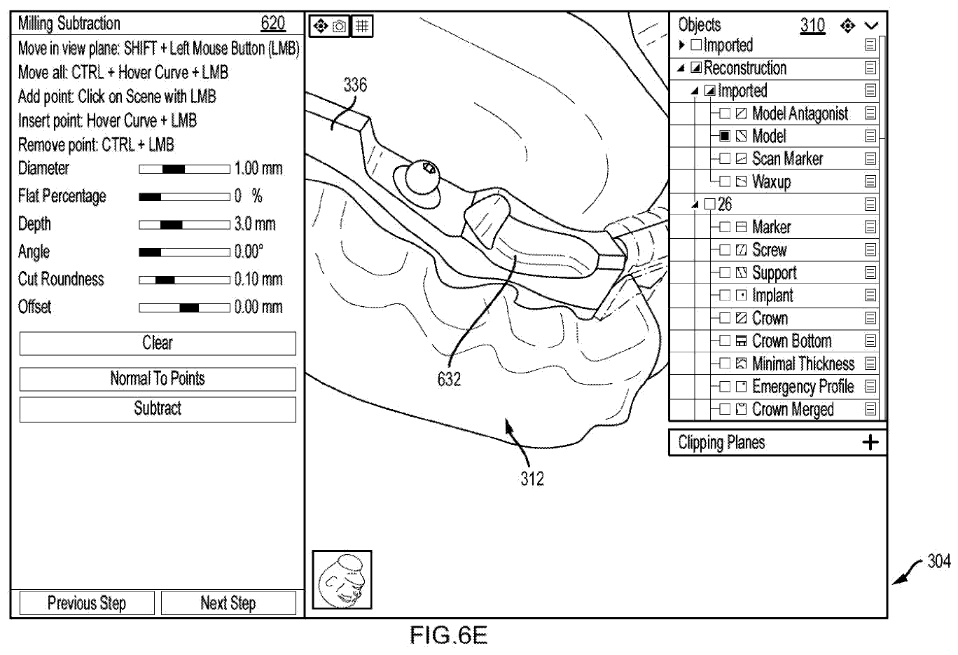

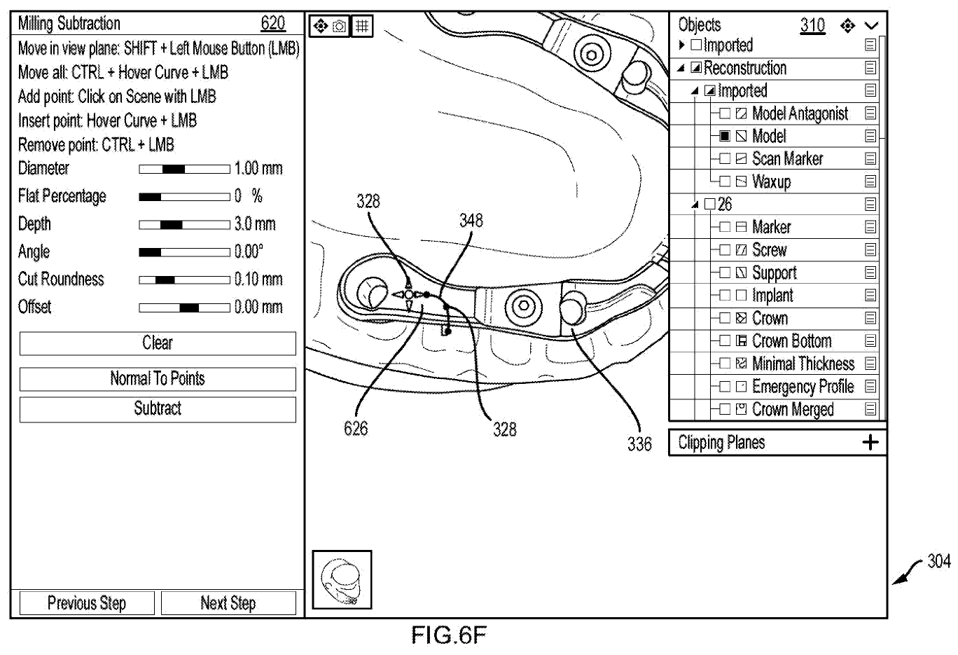

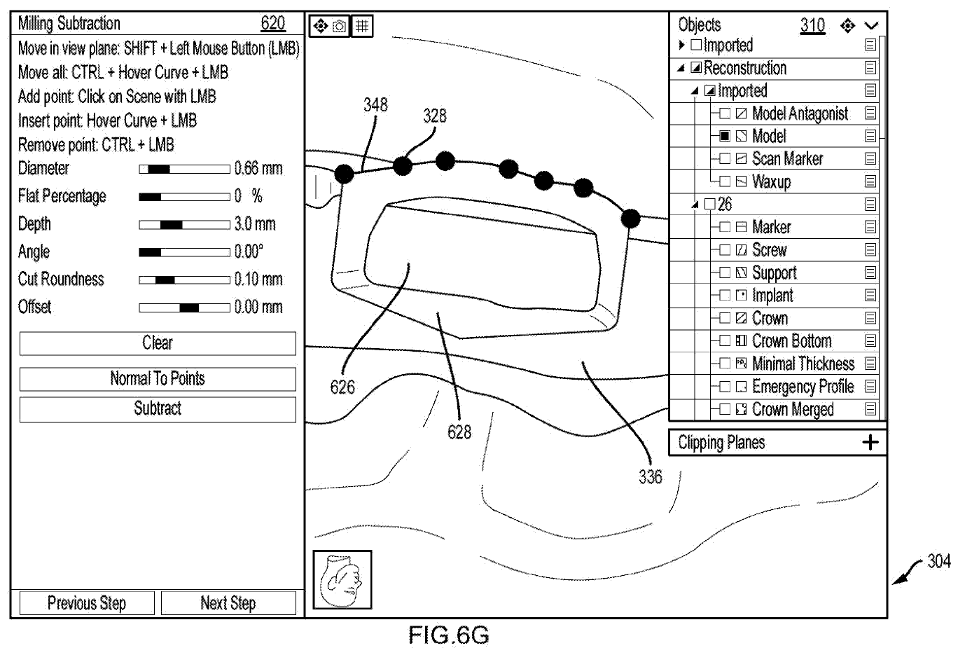

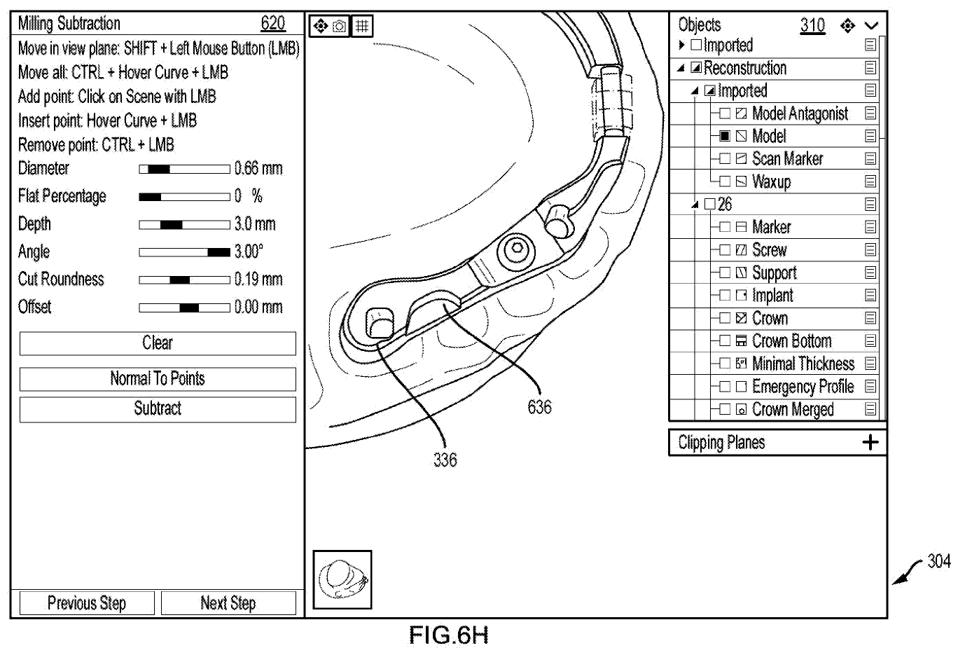

With reference to FIGS. 6A-6H, a CAD workflow that enables cut-type objects to be used to create volumes of any size, shape, depth or configuration and at any location for removal from another object will be discussed. The cut-type object may be freeform or predefined using a template or object from the model library. The cut-type object can be initially created as a two-dimensional object within a single plane, two planes or three planes. The cut-type object may correspond to a freeform object that includes one or more control points that are independently capable of manipulation. Furthermore, cut-type objects may be created from scratch using one or more control points or may be created from a template 224. For example, a cut-type object may be created from scratch with control points being added in a first plane in a sequential fashion. As control points are added, the cut-type object may be expanded within the first plane.

The cut-type object may be expanded to a volume (e.g., occupying space within three dimensions) using the control points initially defined within the first plane (e.g., the horizontal plane). The cut-type object may alternatively be initially created in three dimensions as a volume, where pairs of control points are automatically created when a user creates a single control point in a single dimension. Said another way, when a control point is created for a new cut-type object in one dimension, the CAD tools 228 may automatically create a second corresponding control point in a second plane such that the corresponding control point exists in the same location of the first control point in two planes, but has a different position in a third plane. In an example, control points created in the x-plane and y-plane may result in an automated creation of a corresponding control point in the z-plane to establish the cut-type volume.

The resulting object after removal of the cut-type objects can be physically manufactured by milling or additive or subtractive 3D printing techniques using instructions describing the resulting object.

With reference to FIG. 6A, the CAD environment comprises a slot creation toolbar 600. As will be described in further detail herein a slot may correspond to a particular type of object within the CAD environment 304. In some embodiments, a slot may refer to a cut-type of object 604 or 608 that can be created and manipulated within the CAD environment 304. The slot creation toolbar 600 may present features and functions that facilitate a care provider's creation and manipulation of a cut-type object 604 or 608. The cut-type object 604 or 608 may correspond to a particular type of object that can be used to remove a volume from another object within the CAD environment 304. For example, when a cut-type object 604 or 608 overlaps or shares a volume with some other object in the CAD environment 304, the overlapping volume may be subtracted or removed from the other object as shown by the removed volume 612 on the prosthetic object 336 corresponding to cut-type object 604 and removed volume 616 on the prosthetic object 336 corresponding to cut-type object 608. The overlapping volume may be completely removed or may be separated into a separate volume (e.g., thereby creating a third separate volume or object within the CAD environment 304). While the cut-type object 604 is shown as a three-dimensional prism and object 308 as a frustoconical structure, it is to be understood that the cut-type object can have any one, two, or three-dimensional shape. As shown in FIG. 6A, the slot creation toolbar 600 can set the cut-type object 604 shape to “rectangle” to provide selectable options to set a desired degree of angle (of the side panels), “height” to set the height of the upper panel 608 relative to the lower panel 610, “base roundedness” to set a degree of curvature of the transition between the side panels and the upper or lower panel 608 and 610, respectively, “width” to set the width of the upper or lower panel, and “depth” to set the depth oof the upper or lower panel. For the cut-type object 608, the slot creation toolbar provides selectable options include to set a desired degree of angle (of the conical side panel), “height” to set the height of the upper panel 608 relative to the lower panel 610, “base roundedness” to set a degree of curvature of the transition between the conical side panel and the upper or lower panel 608 and 610, respectively, and “diameter” to set the diameter of the upper or lower panel.

The slot creation toolbar 600 may include a save slot icon which allows the user to save a selected object (e.g., cut-type object) or combination of objects as a template 244 or into the model library 252. In some embodiments, selection of the save slot icon causes the CAD tools 228 to present a save window. Within the save window, the user is allowed to name the object(s) currently selected within the CAD environment 304 as a new template 244 or object in the model library 252.

In addition to providing the ability to create new object, the slot creation toolbar 600 may also facilitate the importation of an object into the CAD environment 304 from a template 244 or the model library 252. A slot library may be used to view or browse some or all of the objects (e.g., cut-type objects or other objects) that have been saved as a template 244 or object in the model library. An object selected from the slot library may be imported into the CAD environment 304 for manipulation relative to other objects already imported into the CAD environment 304. The object, when initially imported, may have all of the dimensions and control points that existed when the object was created or saved; however, it may be possible to customize the dimensions of the object once imported into the CAD environment. For example, a cut-type object imported from the slot library may have multiple control points 328 that can be adjusted to realize a new freeform object.

With reference to FIGS. 6B-H, the CAD environment comprises a milling subtraction toolbar 620. After specifying the milling direction (or the direction of milling the physical counterpart of the bar structure) via milling direction vector object 622, the milling subtraction toolbar enables the user to delineate, using control points 328 and intervening boundaries 348 that may be established between adjacent control points, a free-form one, two or three-dimensional cut-type object 622 or 626 defined by one or more cutting planes 624 for removal from the prosthetic object (shown for illustration purposes as the bar structure) to define corresponding removed volumes 632 and 636. As shown in FIGS. 6C-H, the control points 328 may be independently adjustable in one, two or three dimensions relative to other control points 328 to result in a different cut-type object configuration. This enables the creation and manipulation of the cut-type object 622 or 626 as a freeform object and allows the user a unique level of control and customization over the cut-type object 622 or 626. In some embodiments, the adjustment of a control point 328 will result in a change of the volume occupied by the cut-type object 622 or 626. This may also impact the amount of overlap between the cut-type object 622 or 626 and other objects in the CAD environment 304. The control points 328 may be added or deleted to the cut-type object as well. Each control point 328 may provide a mechanism to adjust the size and/or shape of the cut-type object in one, two, or three dimensions.

As can be seen in FIG. 3B, a cut-type object 622 or 626 can be initially created as a two-dimensional object within a single plane, two planes, or three planes. As noted, the cut-type object 622 or 626 may correspond to a freeform object that includes one or more control points that are independently capable of manipulation. The control points can be adjusted within the CAD environment 304 and the adjustment of control points relative to other control points will result in a different configuration of the cut-type object 622 or 626. Furthermore, cut-type objects 622 or 626 may be created from scratch or may be created from a template 224. FIGS. 6C-H illustrate a process where a cut-type object 622 or 626 is created from scratch and control points are added in a first plane in a sequential fashion. As control points are added, the cut-type object 622 or 626 may be expanded within the first plane.

FIGS. 6D and F illustrate that the cut-type object may then be expanded to a volume (e.g., occupying space within three dimensions) using the control points initially defined within the first plane (e.g., the horizontal plane). The cut-type object may alternatively be initially created in three dimensions as a volume, where pairs of control points are automatically created when a user creates a single control point in a single dimension. Said another way, when a control point is created for a new cut-type object in one dimension, the CAD tools 228 may automatically create a second corresponding control point in a second plane such that the corresponding control point exists in the same location of the first control point in two planes, but has a different position in a third plane. In the example of FIG. 6D, control points created in the x-plane and y-plane may result in an automated creation of a corresponding control point in the z-plane to establish the cut-type volume. Stated differently, adjustment of the control point 328 upwardly or downwardly or horizontally in a first cut plane 644 causes a similar or identical upward or downward or horizontal adjustment, respectively, of a different transverse cut plane 628 (which cut planes define the boundaries of the cut-type object) to define a curvilinear shape in the cut plane 628. In some embodiments shown in FIG. 6D, only one of the cut planes 644 (which is substantially parallel to the milling direction) contains control points and intervening boundaries while the transverse cut plane 628 (which is transverse to the milling direction) has fewer or no control points and intervening boundaries.

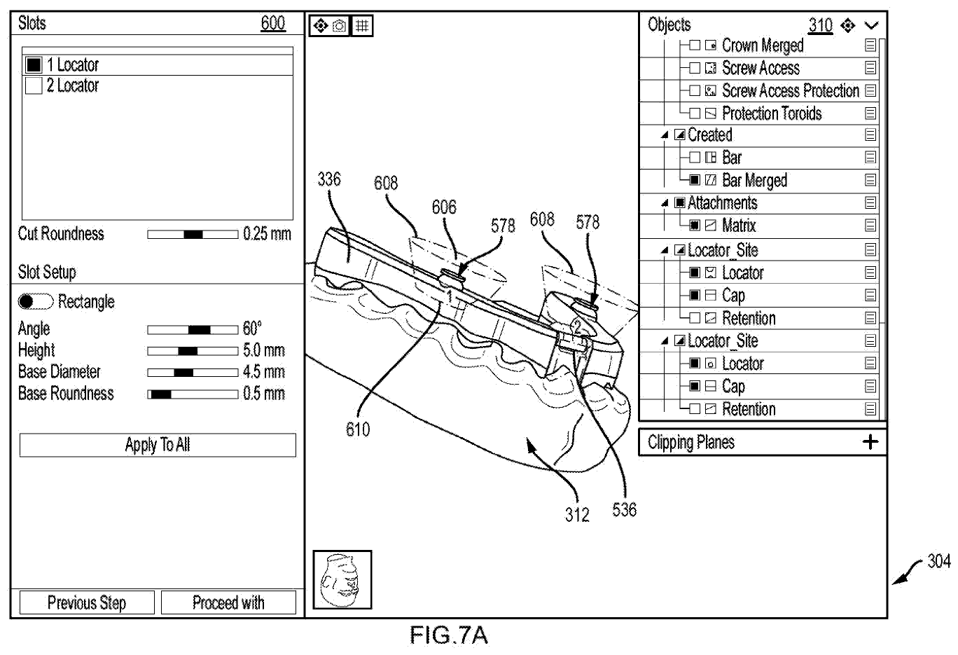

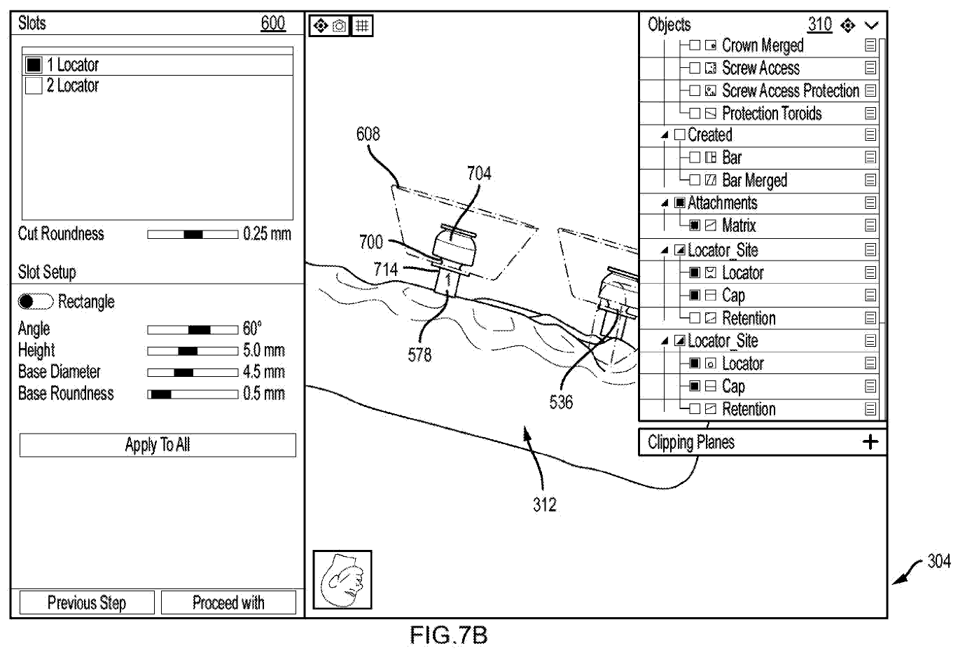

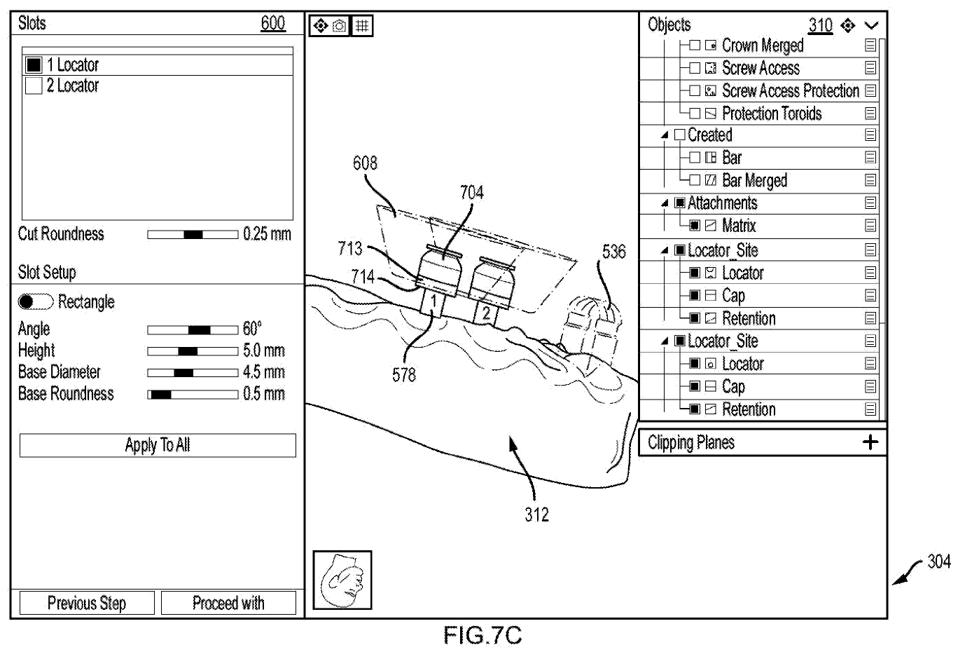

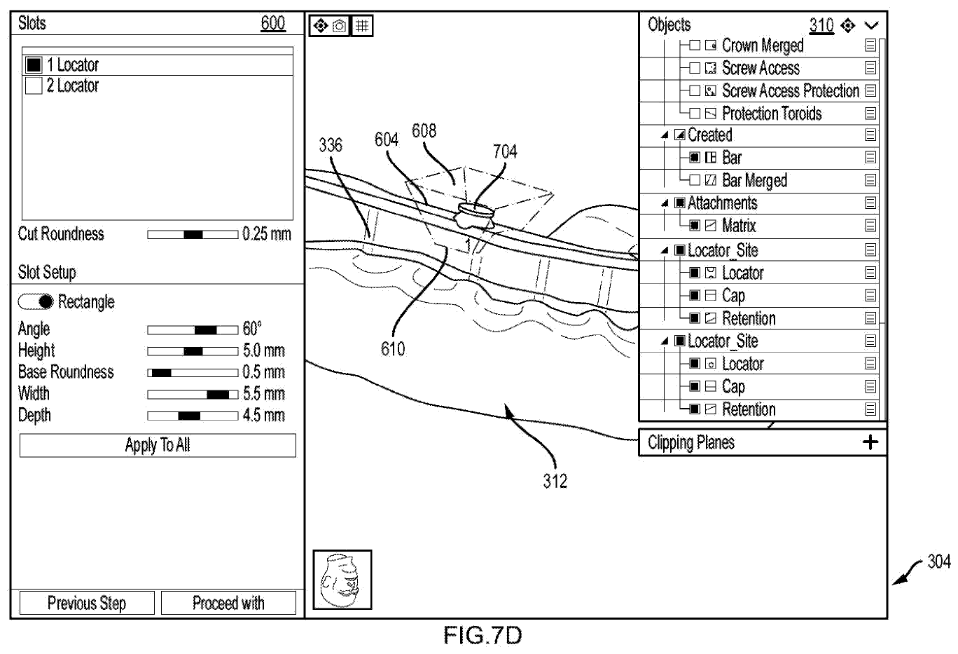

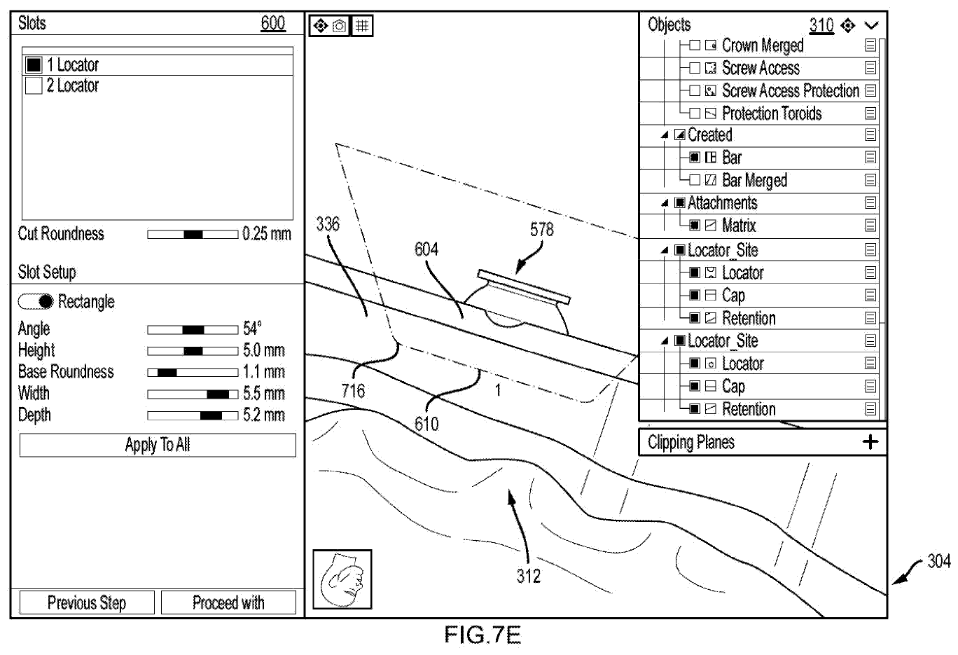

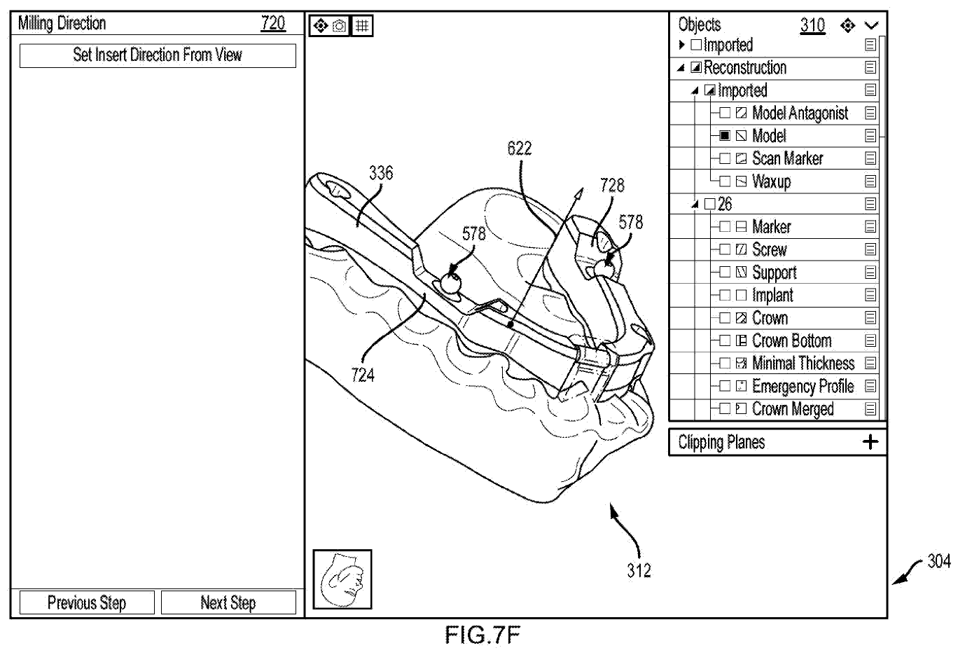

With reference to FIGS. 7A-7F, a CAD workflow that enables cut-type objects to be used to create coherent prosthetic structures, such as full or partial bar structures and bridges, at the same as the overstructures such as overdentures, crowns, abutments, and prosthetic teeth, will be discussed. In particular, aperture structure objects, such as slots, in a bar structure object created using cut-type objects can be automatically and simultaneously transferred to mating structures in the overstructure object. For example, an attachment member, location member or cap object created using a cut-type object in a lower portion of the bar structure can be automatically and simultaneously created using cut-type objects in an upper part of the bar structure object in the overstructure object. The resulting object after removal of the cut-type objects can be physically manufactured by milling or additive or subtractive 3D printing techniques using instructions describing the resulting object. The workflow may be applied not only to telescopic bar structures but also to standard and split bar structures.

With reference to FIG. 7A, the CAD environment 304 comprises the slot creation toolbar 600 and object control toolbar 310. As noted above, a slot may correspond to a particular type of object within the CAD environment 304. First and second cut-type objects 608 are depicted positioned to surround a respective locator member object 578 on the prosthetic structure 336. The corresponding slot setup settings in the slot creation toolbar 600 define the shape and dimensions of each cut-type object.

Referring to FIGS. 7B-7C, the prosthetic object has been hidden from view to reveal the otherwise hidden locator 578 structure. The description of the cap object 704 (corresponding to a physical cap) for selected locator member object 1 has been selected from a secondary and/or secondary support field 566 or 570 of the locator library panel 552. Referring to FIG. 7C, the disc-shaped void volume 700 below the cap 704 and shoulder 714 of the locator member object 578 has been replaced with a retention object 713 (corresponding to a physical retention member) described in a selected secondary and/or secondary support field 566 or 570 of the locator library panel 552.

Referring to FIGS. 7D-7E, the cut-type object 608 for locator 1 has been replaced by cut-type object 610. The corresponding slot setup settings in the slot creation toolbar 600 define the shape and dimensions of the cut-type object. As can be seen from FIG. 7E, the slot setup setting include not only the angle (of the side panels), height of the upper panel 608 relative to the lower panel 610, width of the upper or lower panel, and depth oof the upper or lower panel but also the degree of curvature of the transition 715 between the side panels and the lower panel.

With reference to FIG. 7F, the CAD environment 304 comprises a milling direction toolbar 720 and object control toolbar 310. The milling direction toolbar 720 includes tools to define manufacturing settings, such as by milling or subtractive or additive 3D printing. The resulting prosthetic object 336 is shown in FIG. 7F relative to a milling director vector object 622. A first slot 724 created by cut-type object 604 and second slot 728 created by cut-type object 608 are depicted. The stored CAD description of the prosthetic object 336, including the descriptions of the first and second slots 724 and 728 can be used as machine commands to manufacture a physical prosthetic structure corresponding to the prosthetic object 336.

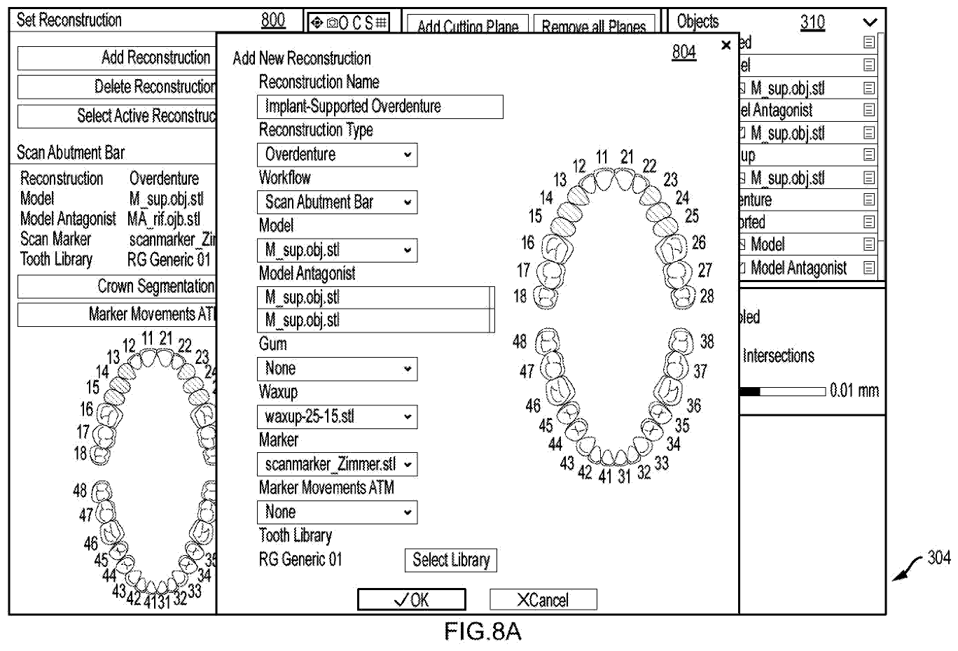

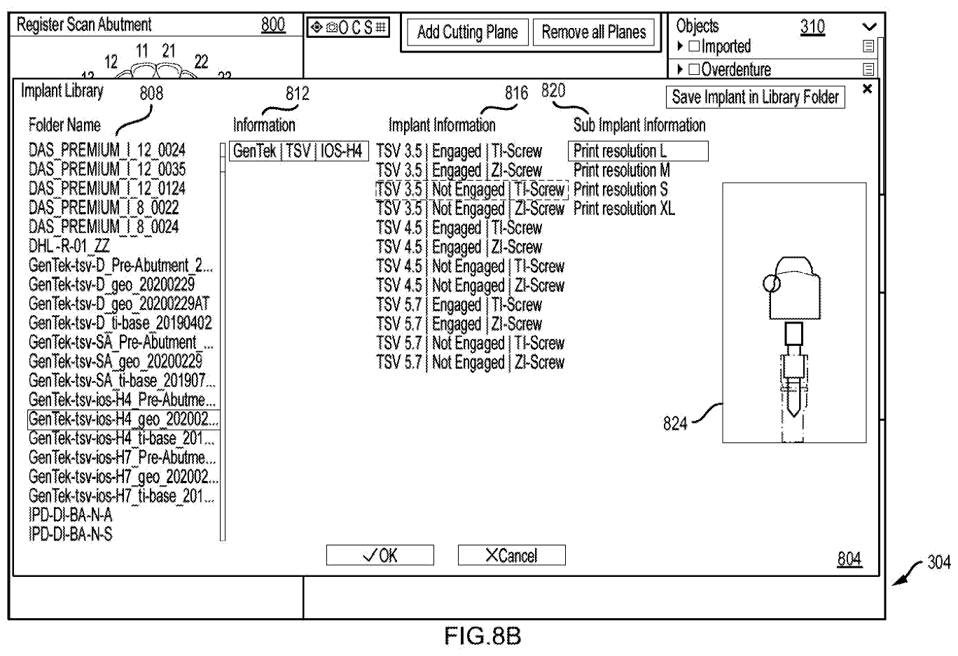

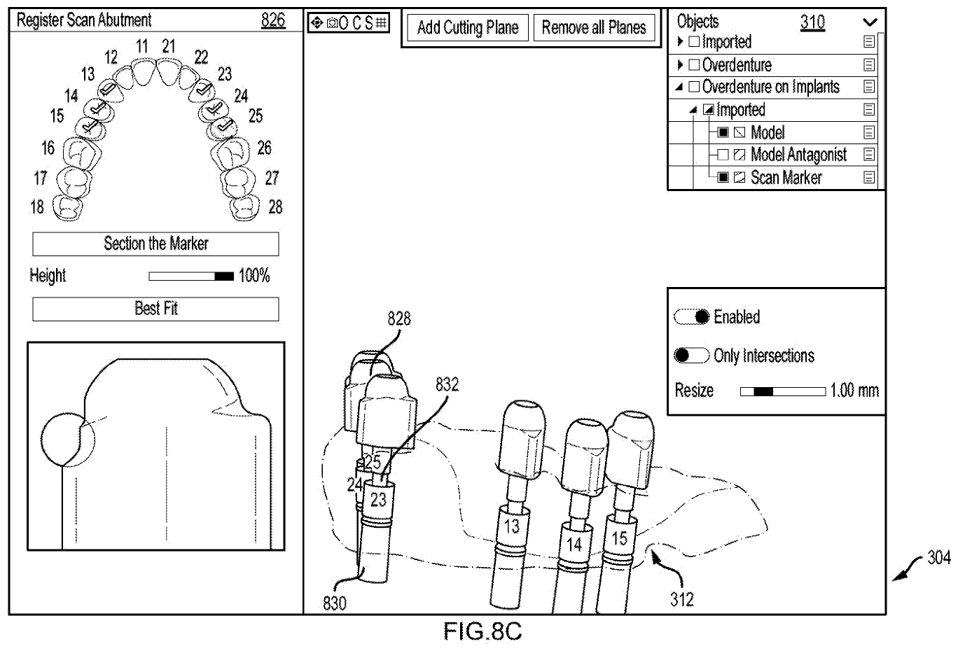

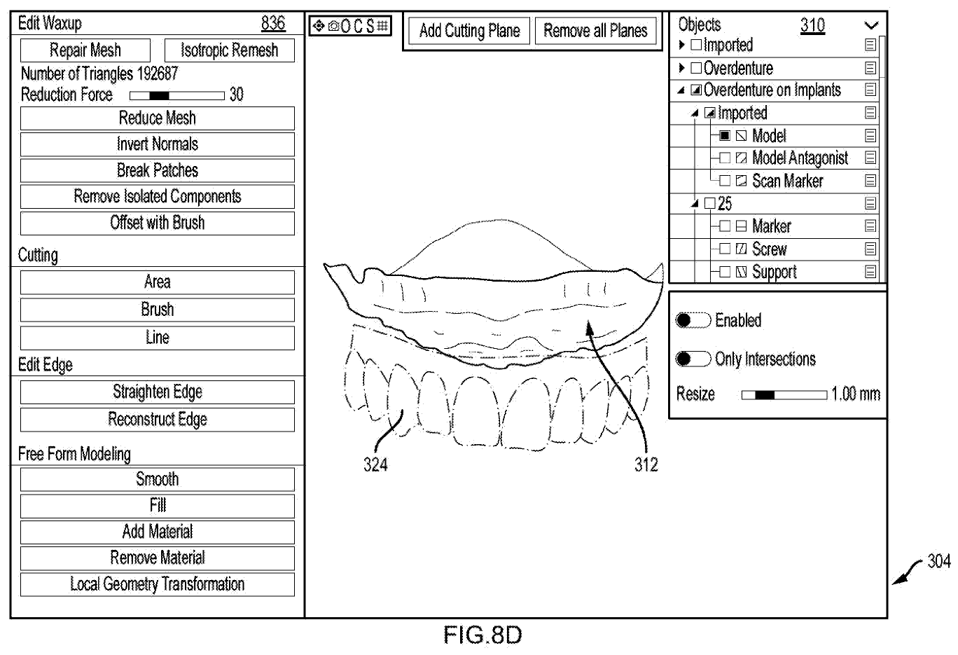

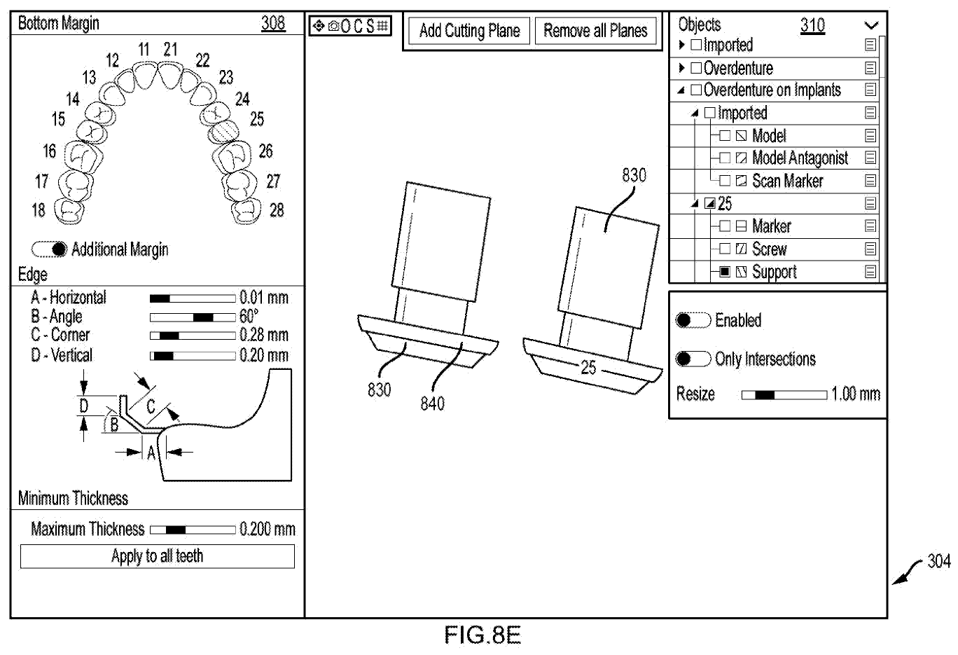

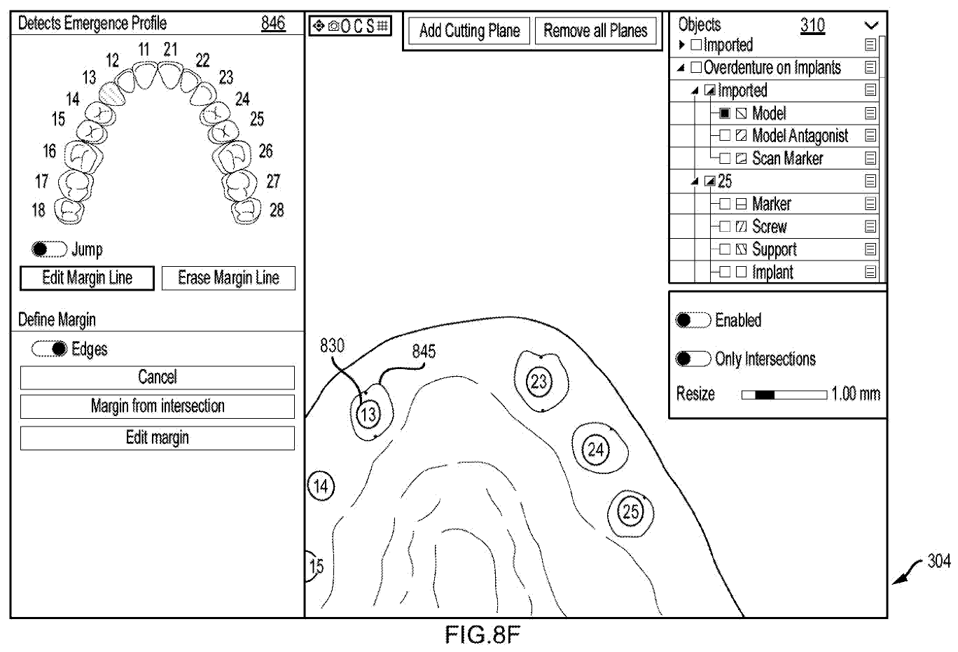

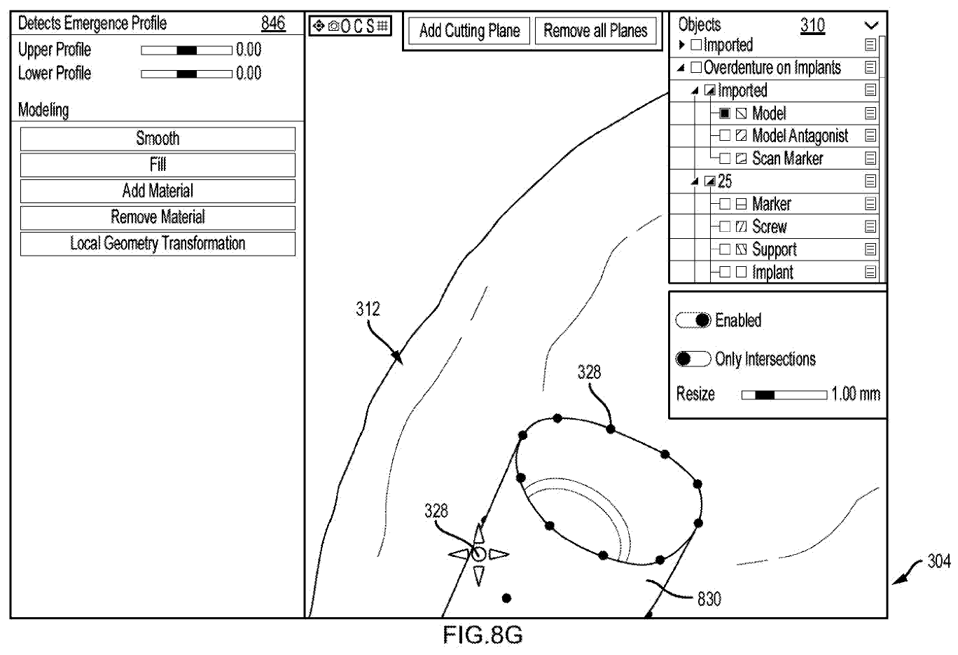

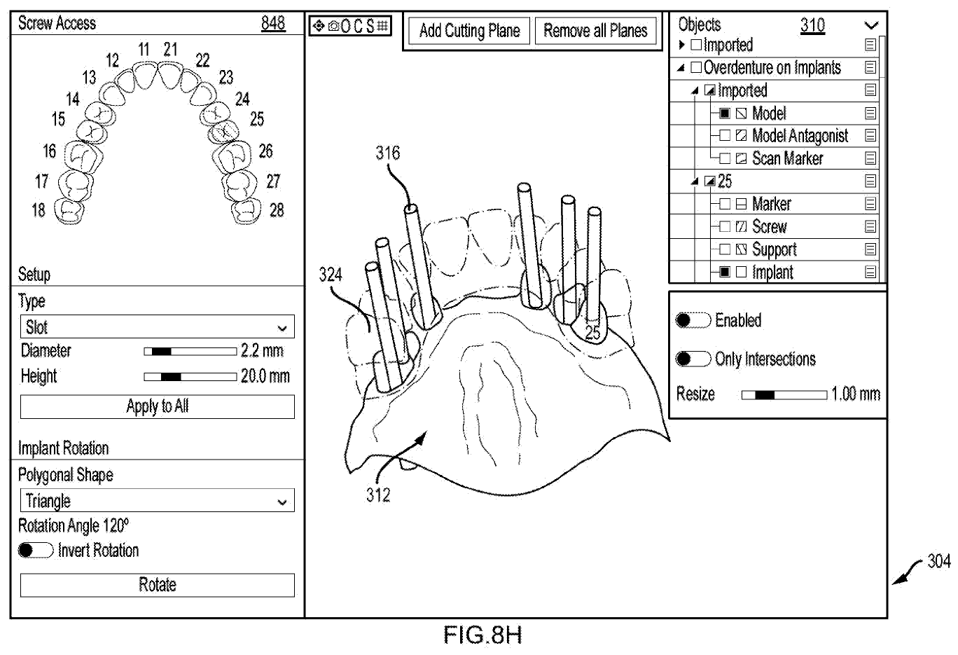

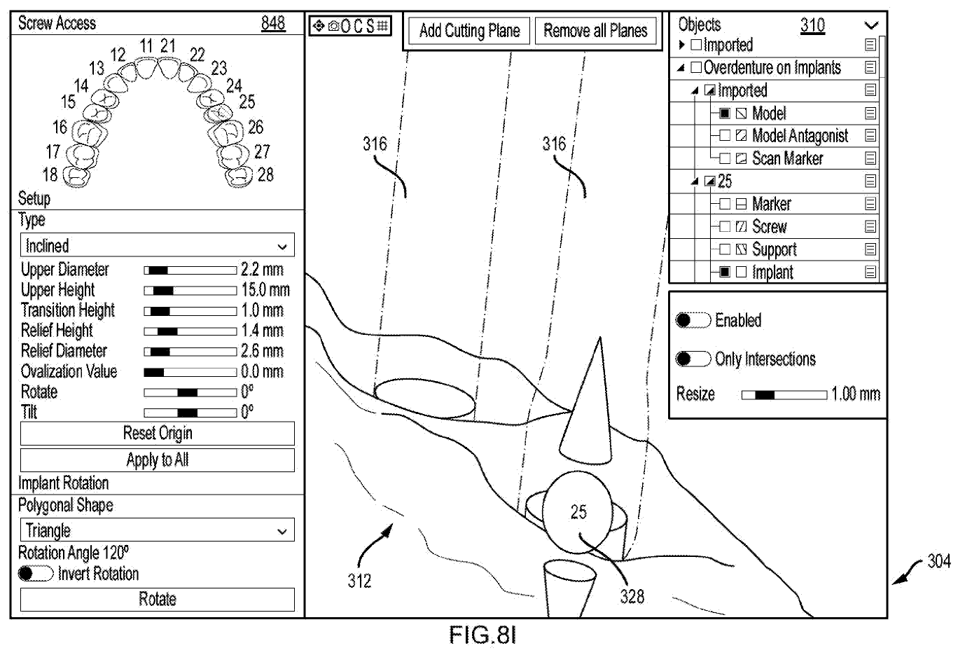

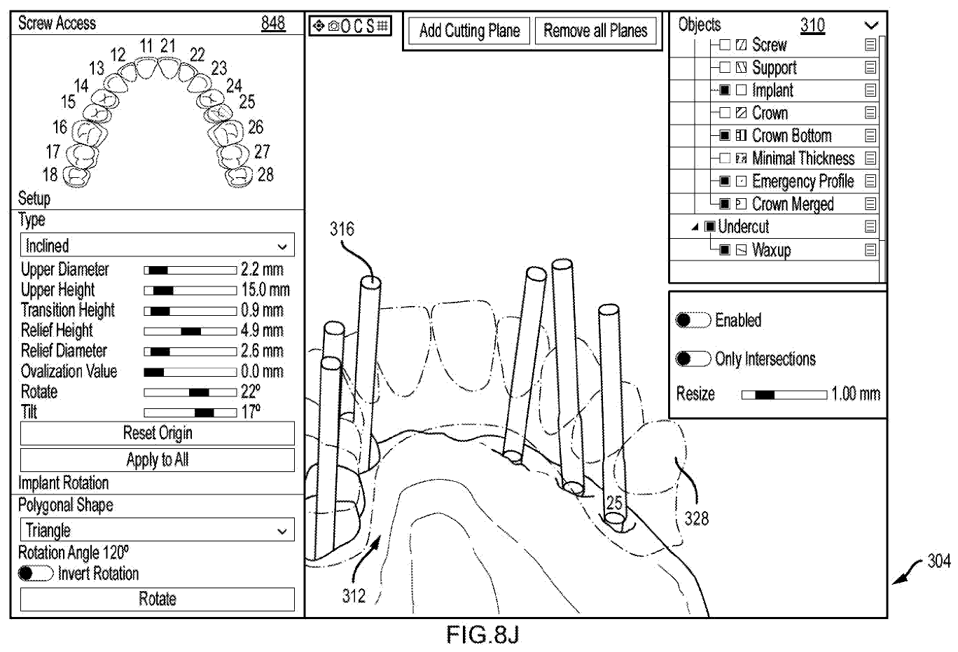

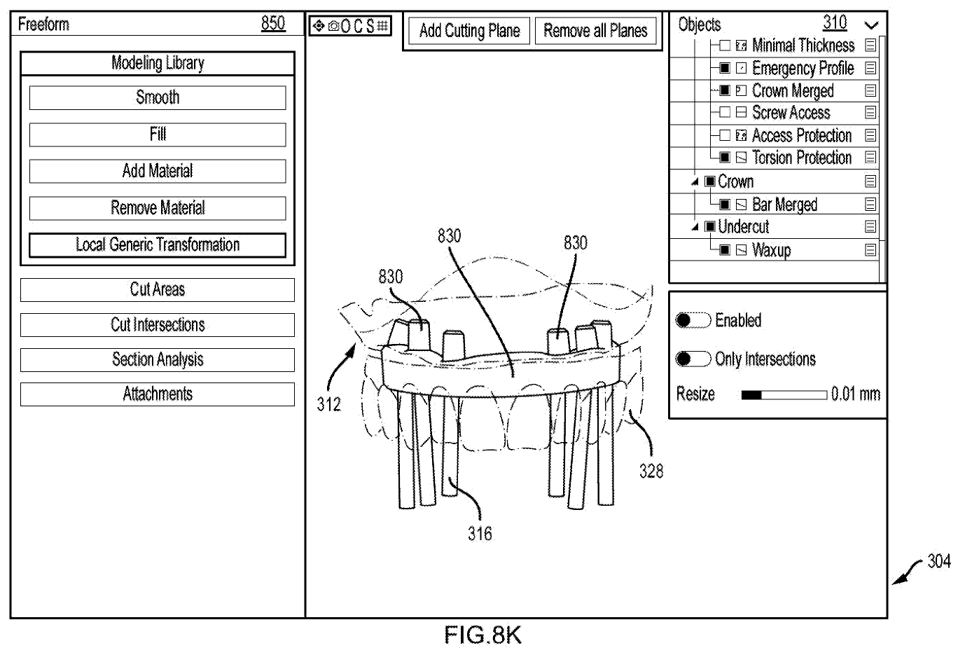

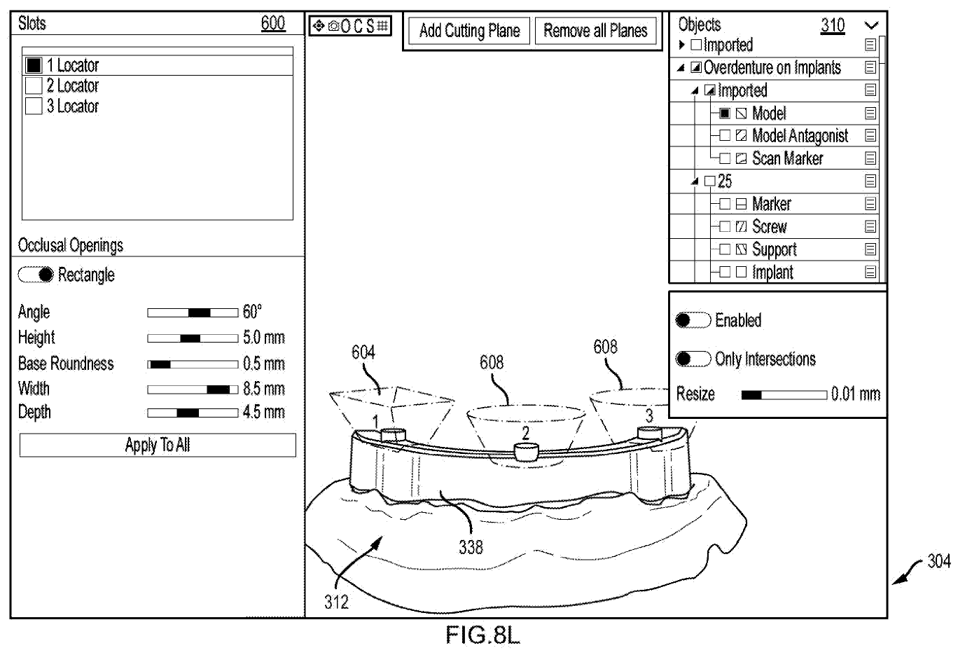

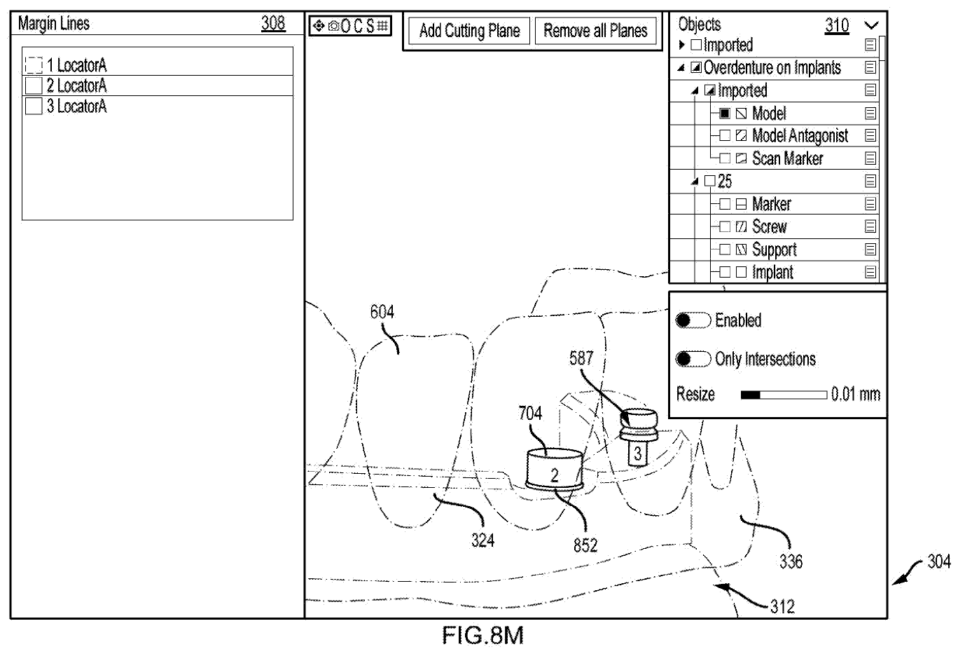

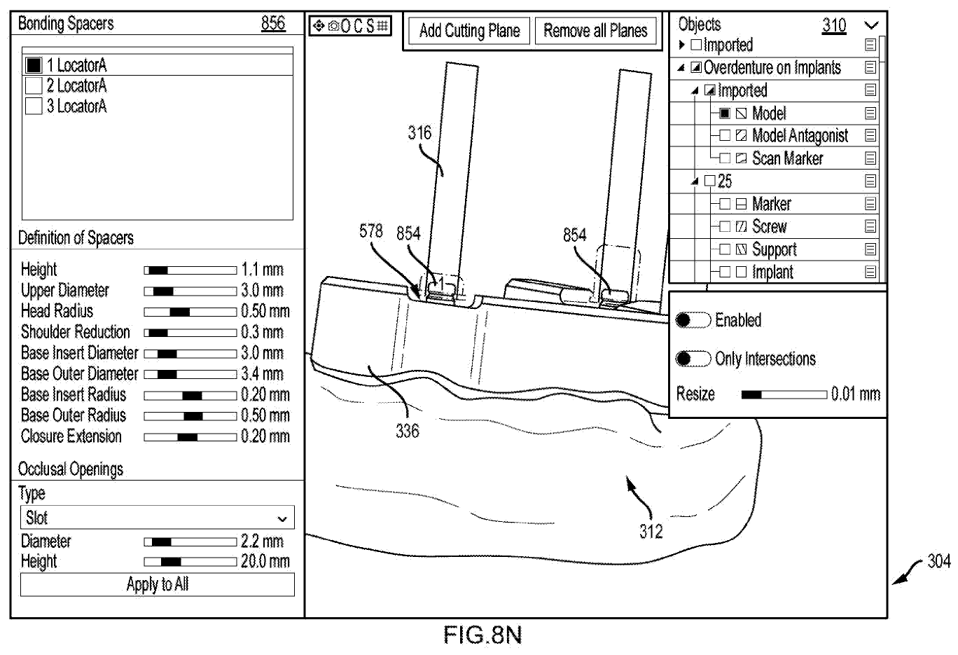

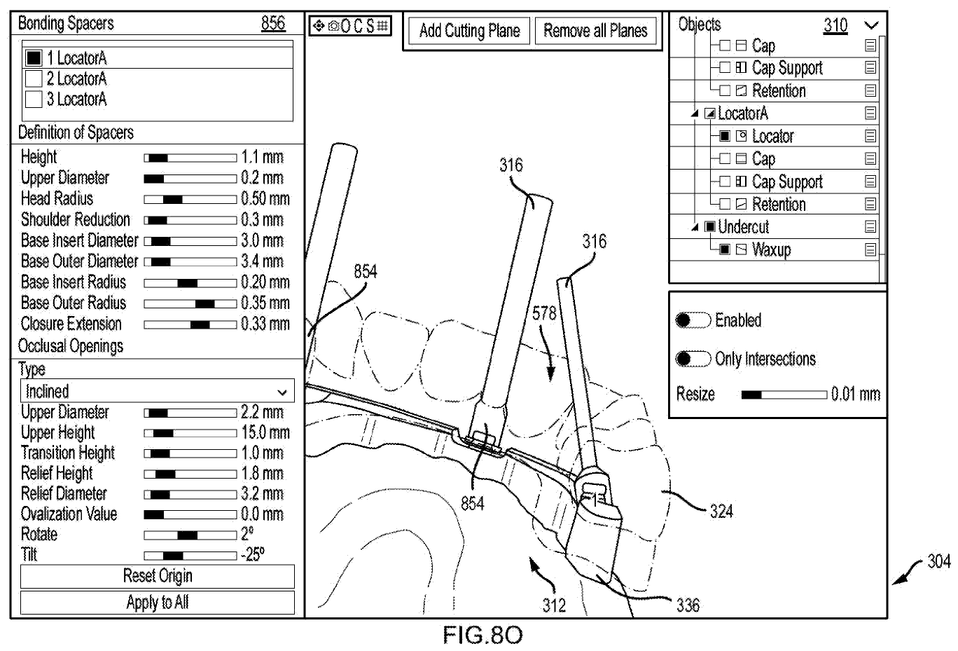

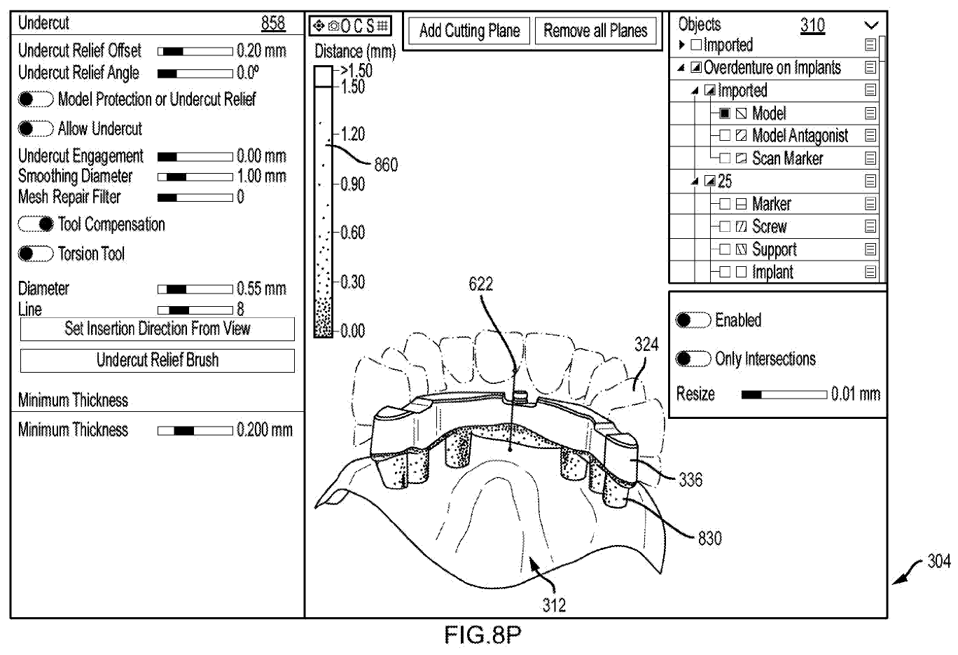

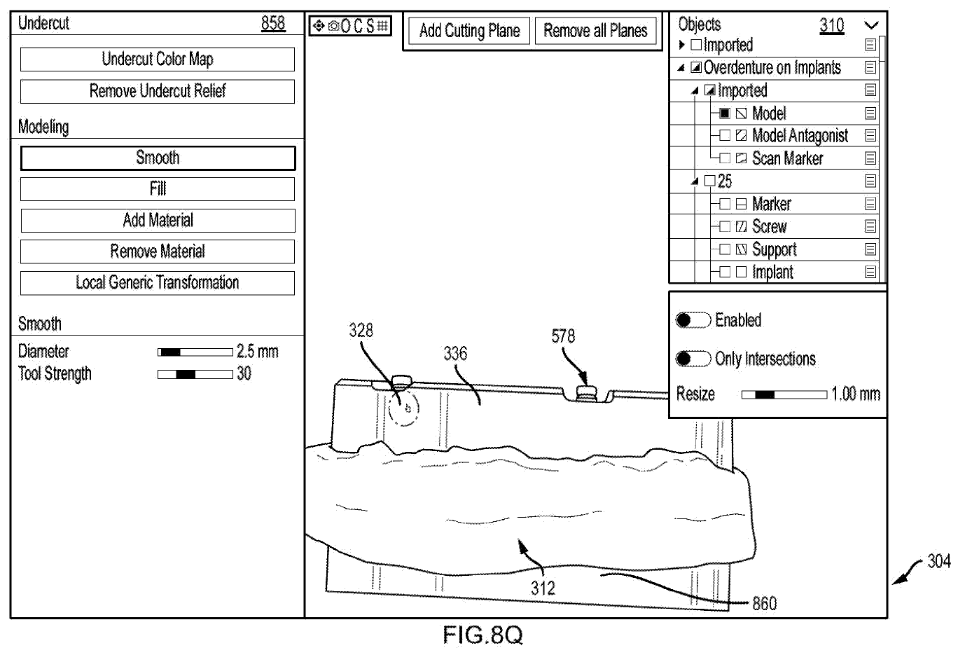

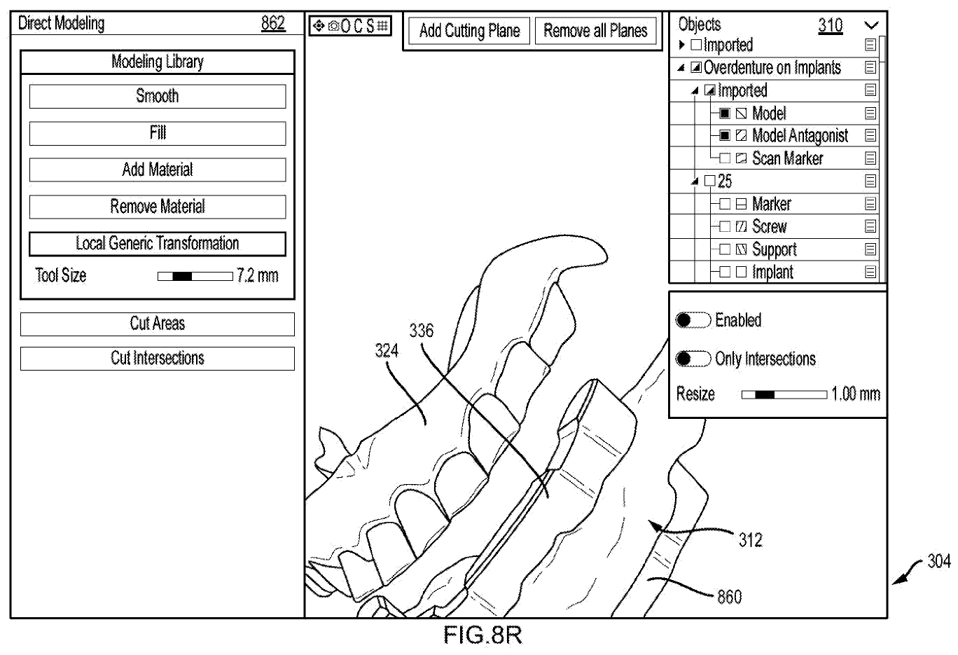

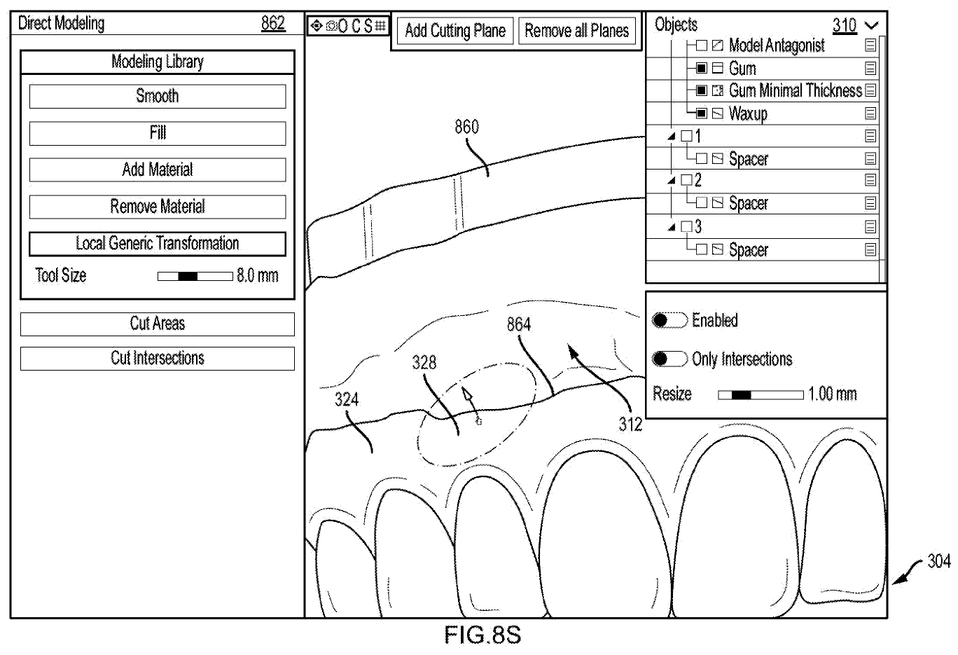

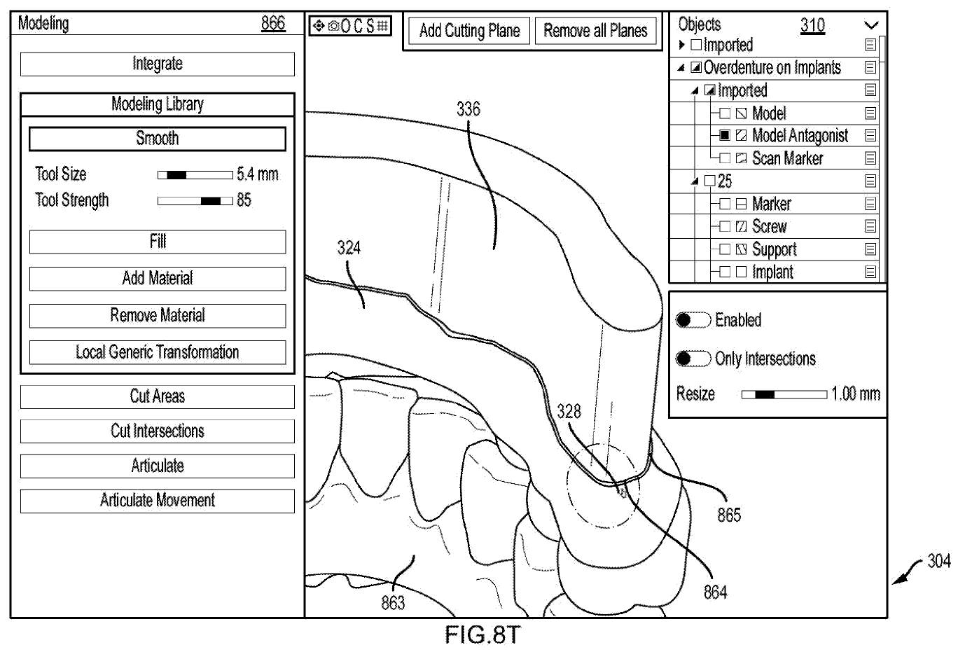

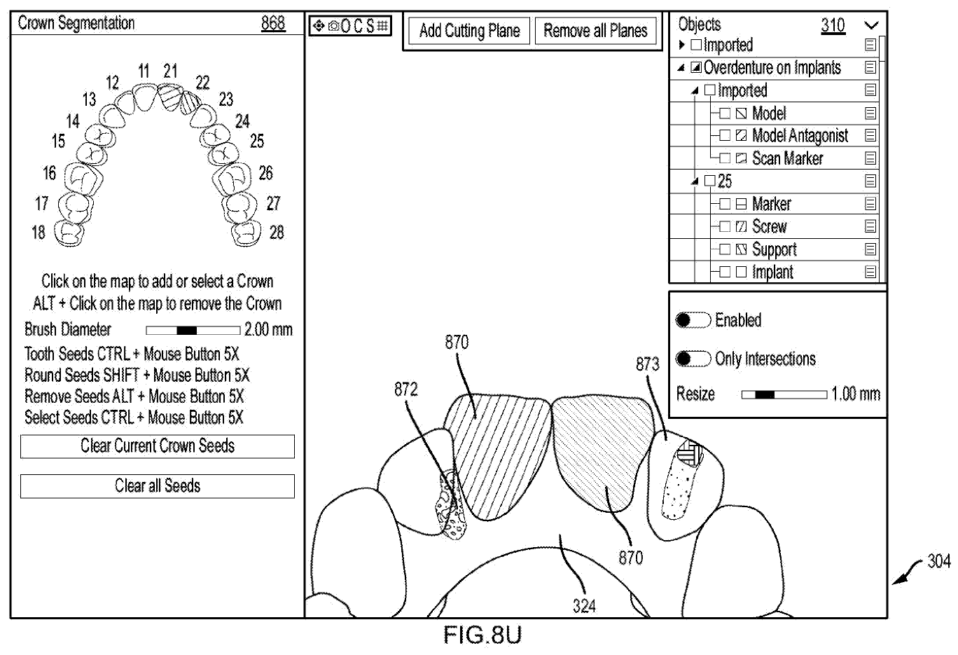

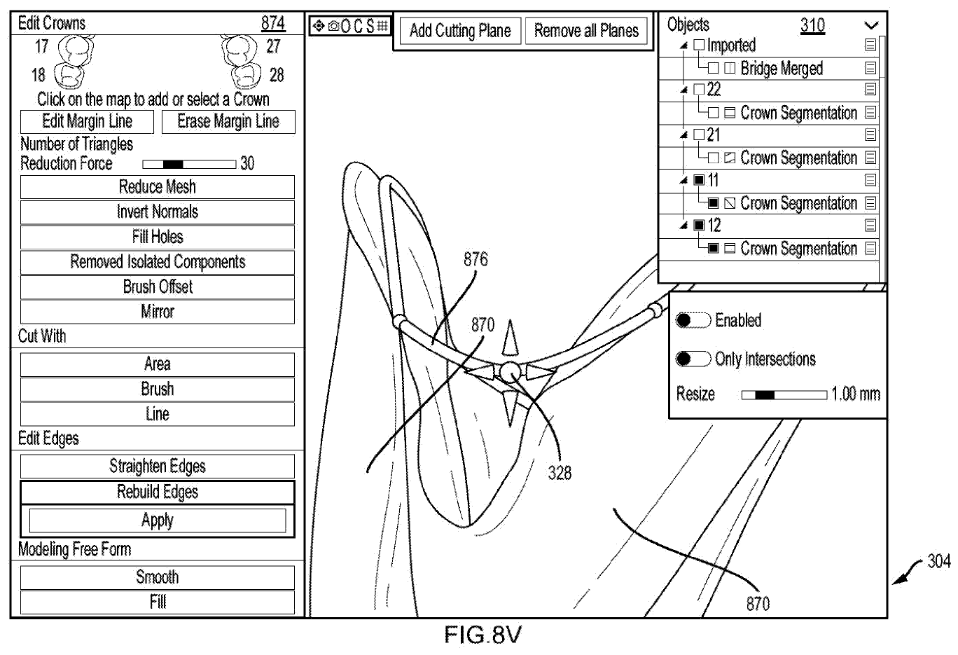

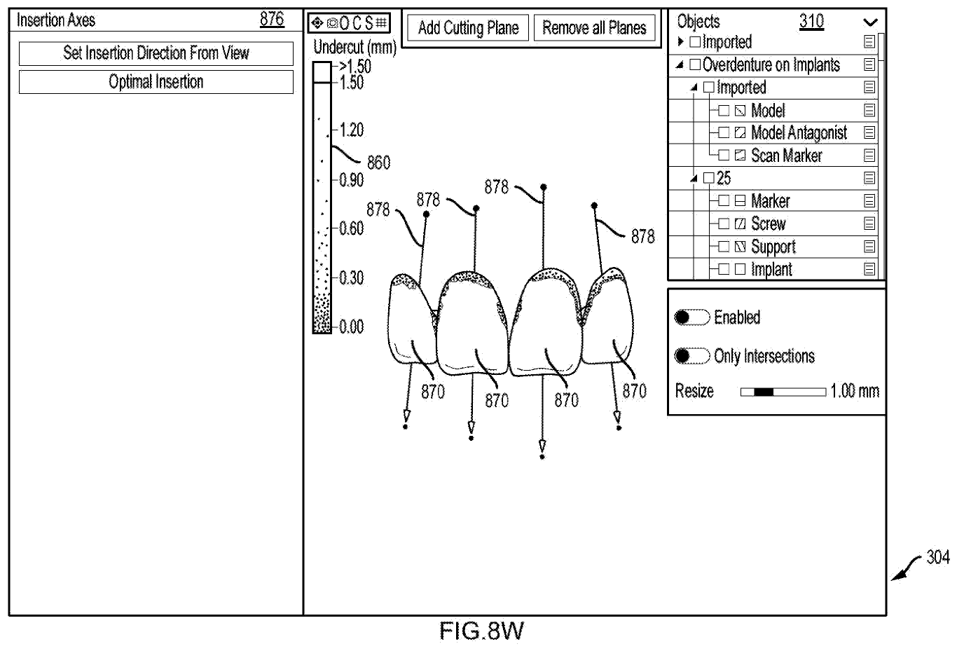

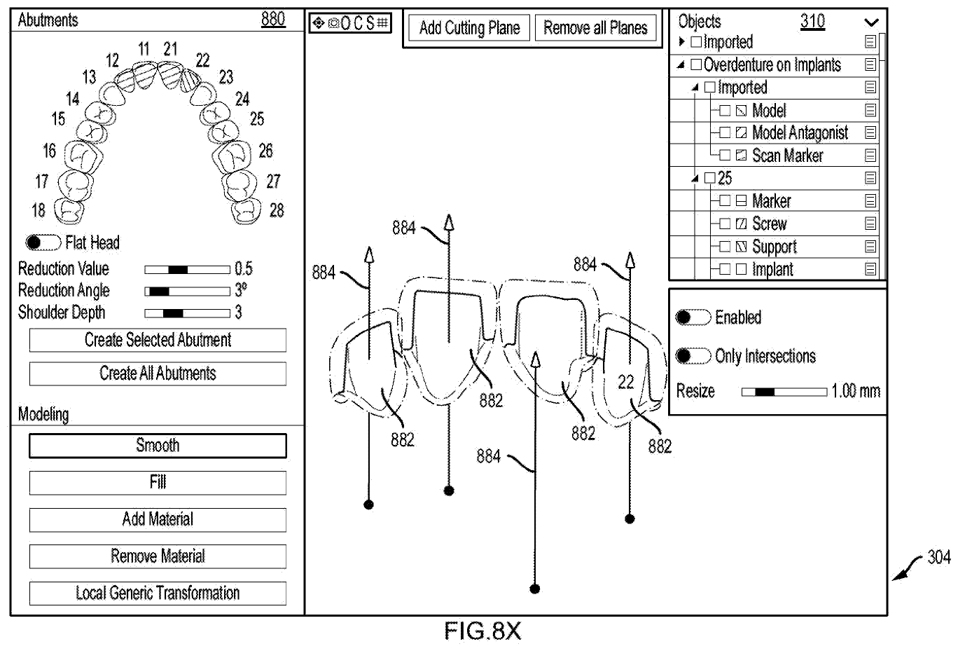

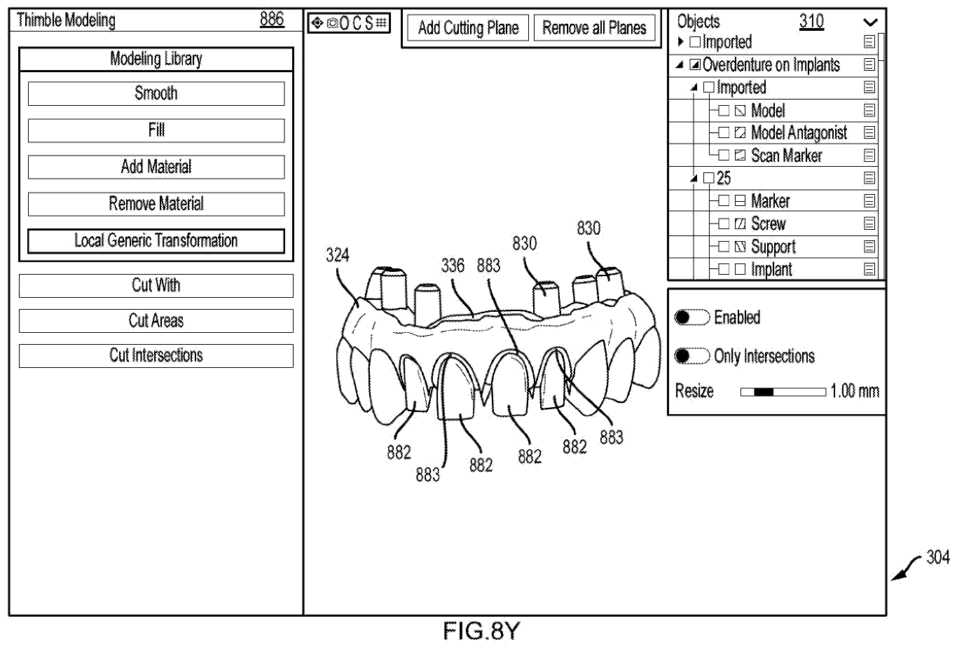

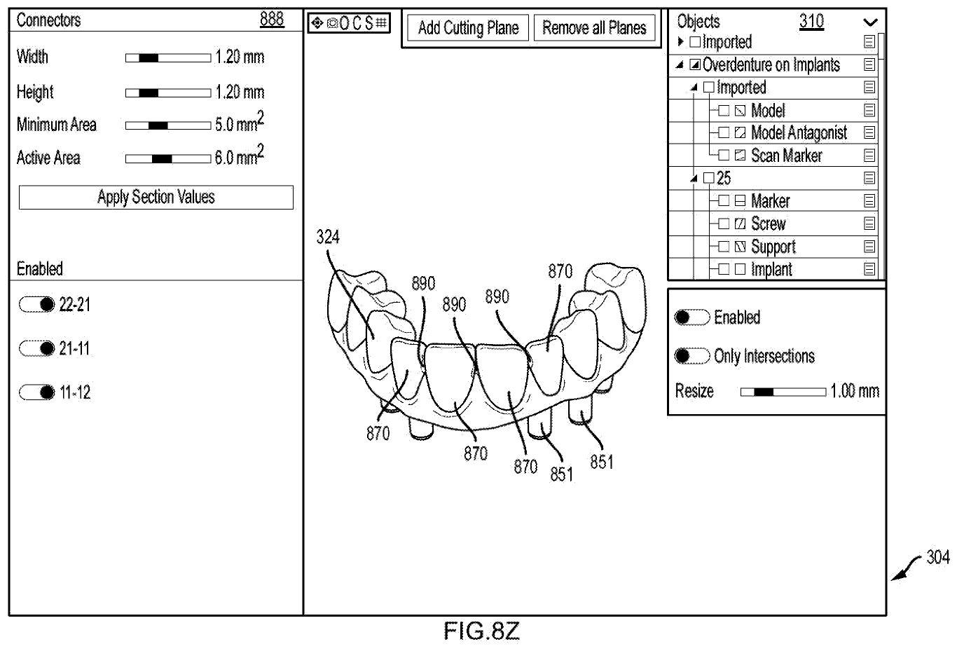

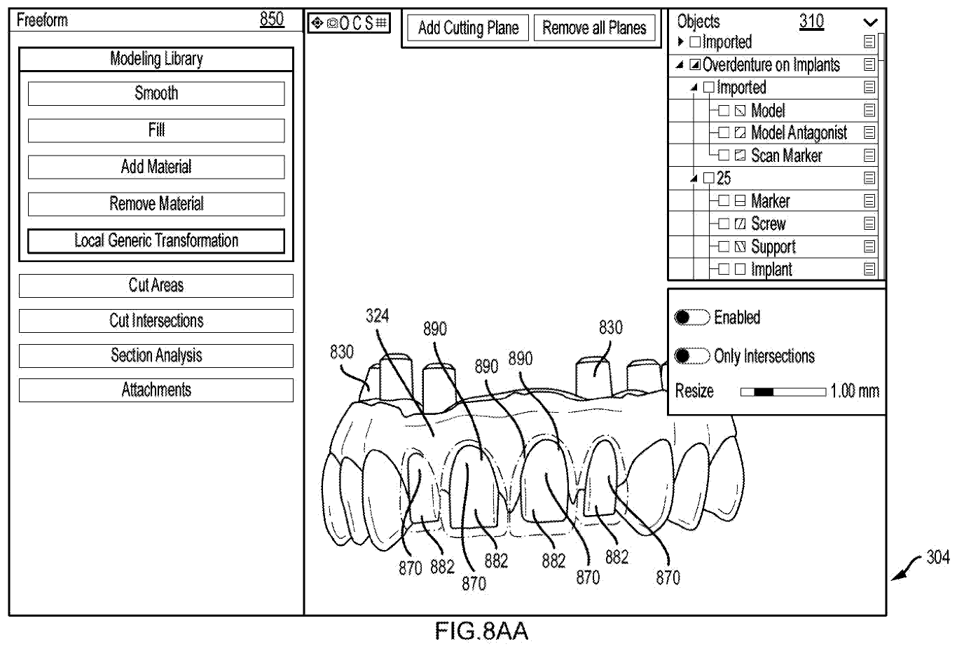

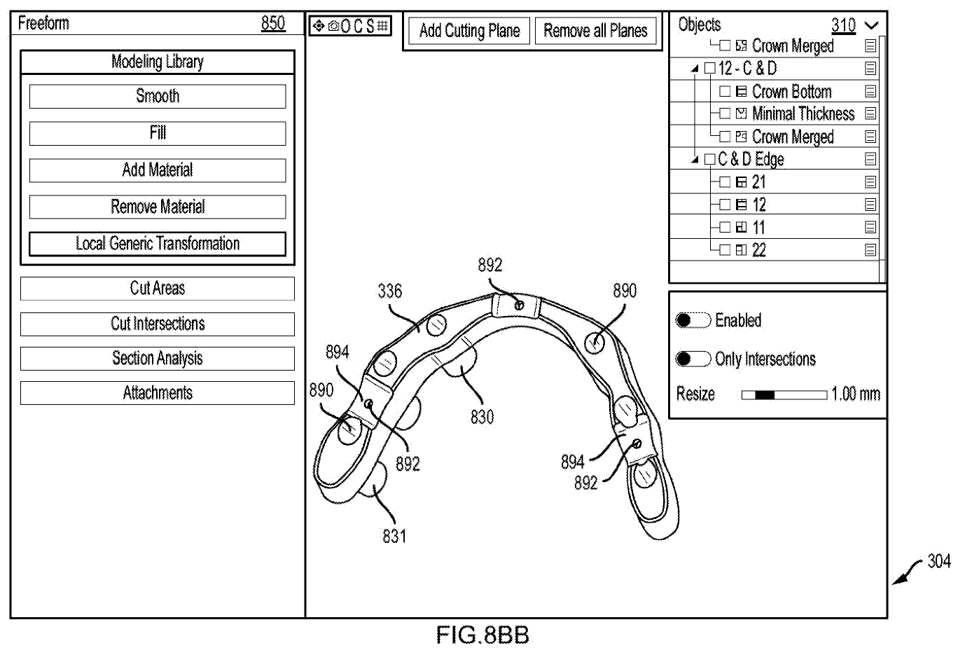

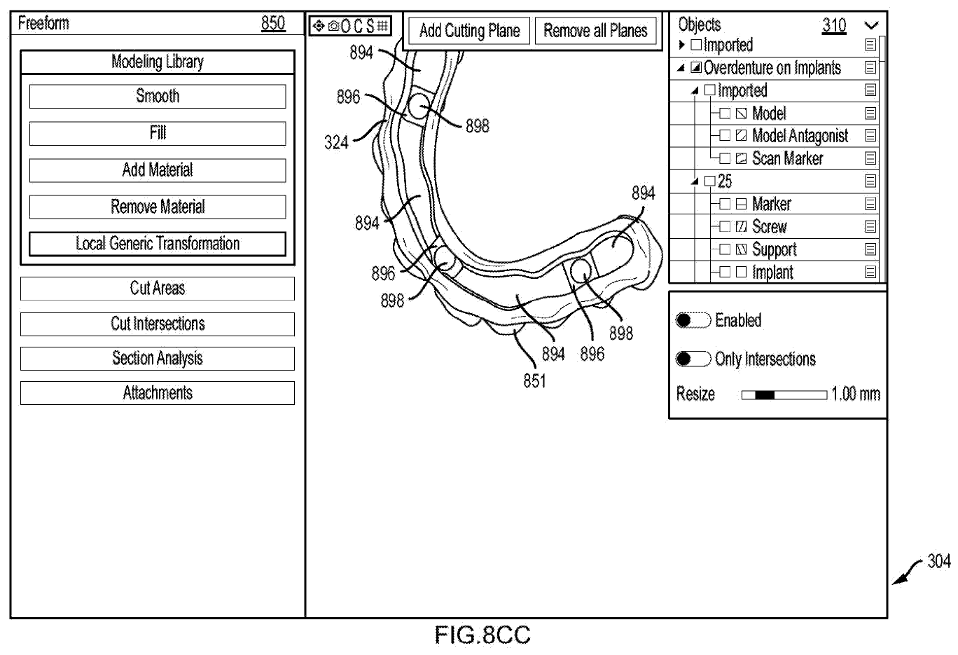

With reference to FIGS. 8A-8CC, a CAD workflow that enables design of prosthetic objects, such as a bar structure, in view of the spatial and other limitations of a selected predetermined dental restoration, such as an overdenture or other over structure will be discussed. The prosthetic object includes attachment and locator member objects and dental implant anchorage structures, such as abutments and sleeves, to fasten the prosthetic object to one or more underlying dental implants. The CAD workflow further enables the creation of bonding structures between selected portions of the predetermined dental restoration and design of tooth-like dental restoration structures, such as crowns, using segmentation techniques. The prosthetic objects may be freeform or predefined using a template or object from the model library.

Referring to FIG. 8A, the CAD environment 304 comprises a set reconstruction toolbar 800 comprising tools to define a dental reconstruction, such as creating a bar structure object from a dental imaging information including one or more dental abutments and designing tooth-like dental restoration structures, such as crowns. In the CAD environment 304, the user has selected teeth positions 11-15 and 21-25 in the patient's arch for reconstruction of objects in a dental restoration.

Referring to FIGS. 8B-8C, user selection of an add implant in the reconstruction setup toolbar 800 provides an implant library panel 804 provides a library of implant objects that are either templates or models from the model library 252 associated with different selectable implants. By way of illustration, the library panel 804 includes, for each implant object, a manufacturer field 808, implant model identification field 812, implant descriptive information field 816, and secondary implant descriptive information field 820 along with an image 824 of the associated implant. The selected implant objects 832 including implant driver objects 828 for each of the selected teeth positions 13-15 and 23-25 along with an implant receiving structure object 830 (e.g., a surgically drilled blind hole in a jaw of the patient) for each implant object are shown in FIG. 8C.

Referring to FIG. 8D, the CAD environment 304 includes an edit waxup toolbar 836 comprising tools to edit cut width and border and enable freeform modeling. Upon selection of the tool to edit border or margin, the CAD environment 304 provides a margin line toolbar 308 shown in FIG. 8E to edit the edge or border 840 of the implant receiving structure object 830, such as a sleeve or abutment, of an associated implant object 832.

Referring to FIGS. 8F-8G, the CAD environment 304 comprises a detect emergence profile toolbar 846 comprising tools to edit a gingival margin 845 for each implant engagement site as shown in FIG. 8F and edit a profile of an implant receiving structure 830 via control points 328 as shown in FIG. 8G.

Referring to FIGS. 8H-8J, the CAD environment 304 comprises a screw access toolbar 848 comprising tools, which are described in more detail below, to create and/or edit (via control points 328) the configuration of tool access objects 316 including a width or diameter and longitudinal, access orientation or slope of the tool access or screw access object 316, and other dimension, for each dental implant object As will be appreciated, the bar structure is typically secured to the corresponding implants by means of threaded objects, such as screws.

The prosthetic object 336 (e.g., male and female portions of the bar structure) is then created using the CAD workflows and tools discussed above in connection with FIGS. 3A-3H, 4A-D, 5A-5G, and 6A-6H to provide the CAD environments shown in FIGS. 8K-8L. The CAD environment 304 further includes a freeform toolbar 850, which as discussed in more detail below, includes tools to model selected objects, such as define a level of roughness or smoothness of a surface, fill a volume, adding or subtracting material, local generic transformation, cutting area, cut intersection and section analysis.

Referring to FIG. 8M, the margin line toolbar 308 comprises a tool to edit a margin or interface between each locator cap 704 or other attachment or locator member object (which removably engages the female portion of the bar structure) and the prosthetic object 336.

Referring to FIGS. 8N-8O, the CAD environment includes a bonding spacer toolbar 856 comprising tools for defining spacers and screw access objects 316 in various prosthetic objects, including occlusal or prosthetic object openings for attachment and locator member objects via one or more control points 328. The spacer 854 corresponds to an attachment structure or mechanism, such as an adhesive interface, to engage a locator or attachment member object to the prosthetic object 336. Spacer definition can include, for example, upper spacer, spacer head, and spacer base dimensions such as diameter, radius, and shoulder reduction and annular spacing between the attachment and locator member object and the surrounding prosthetic object surfaces, such as the internal padding to allow for adhesive placement.

Referring to FIGS. 8P-8Q, the CAD environment 304 of FIG. 8P includes an undercut toolbar 858 comprising tools to create or edit the dimensions and/or orientations of implant receiving structures 830 via one or more control points and a distance bar 860 showing the distance of each surface portion of an object relative to a selected reference point or surface, such as an interior surface of the prosthetic object 336 while the undercut toolbar 858 in the CAD environment 304 of FIG. 8Q includes tools to model or edit a surface of a prosthetic object via one or more control points 328, such as by defining a level of roughness or smoothness of a surface, filling a volume, and adding or subtracting material. The CAD environment 304 illustrates a prosthetic object corresponding to a rapid prototype, that includes the prosthetic object 336 and base member 860. In some embodiments, the undercut toolbar tools enable the CAD workflow to automatically adjust for spatial tolerances in the prosthetic object features and components required for various attachment structures, such as glue, as well as automatically adjust the prosthetic object features and components to reflect spatial limitations imposed by the first object 312 and fourth object 324 to obtain a substantially optimal fit of the prosthetic object relative to the first and fourth objects.

Referring to FIGS. 8R-8S, the CAD environment 304 includes a direct modeling toolbar 862 that includes tools to model or edit a surface or interface of the selected dental restoration via one or more control points 328, such as by defining a level of roughness or smoothness of a surface, filling a volume, and adding or subtracting material or adjusting an edge 864 of the restoration to substantially conform to an underlying surface of the first object 312.

Referring to FIG. 8T, the CAD environment 304 includes a modeling toolbar 866 that includes tools to model or edit a surface or interface of the selected dental restoration via one or more control points 328, such as by defining a level of roughness or smoothness of a surface, filling a volume, and adding or subtracting material or adjusting an edge 864 of the restoration to provide a selected offset or gap relative to the adjacent exterior surface 865 of the prosthetic object 336.

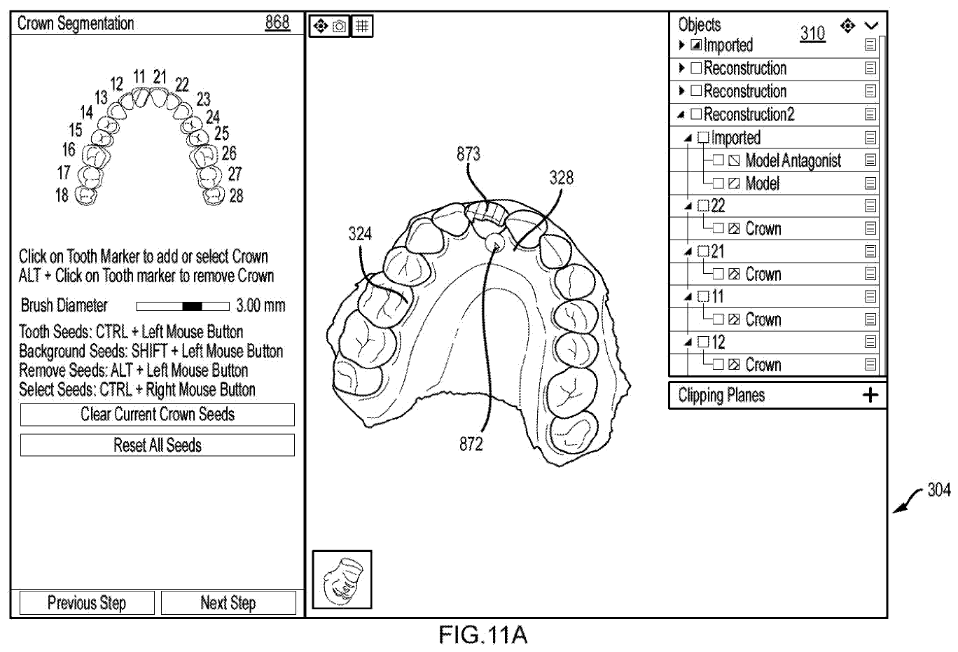

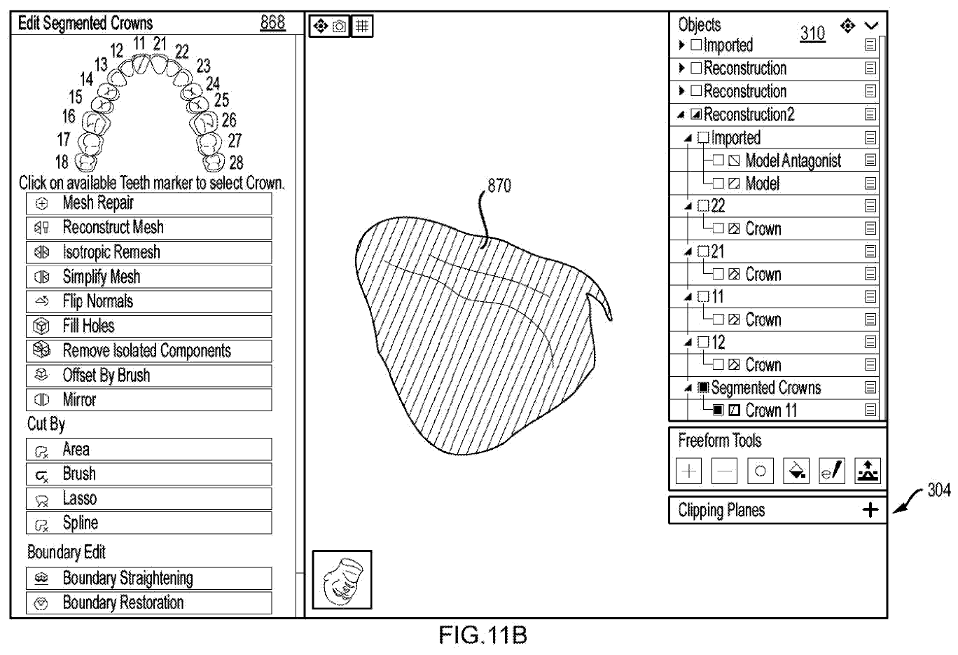

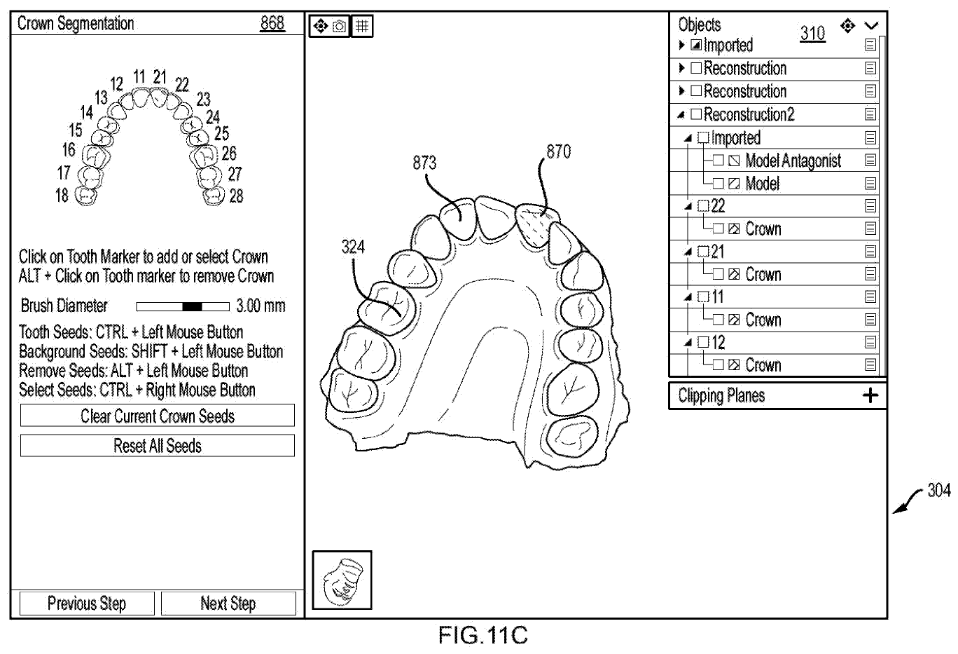

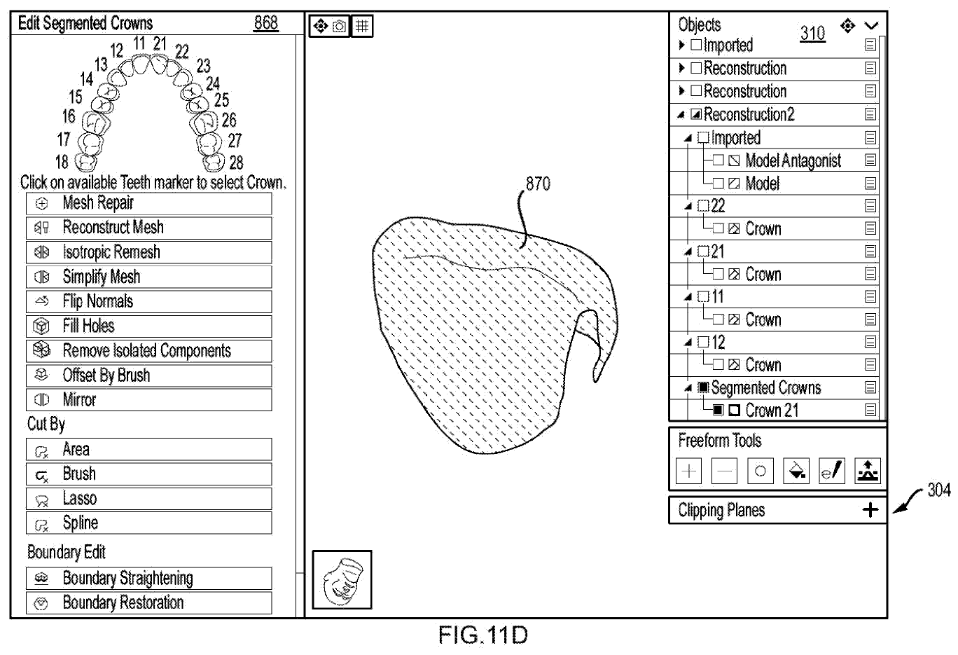

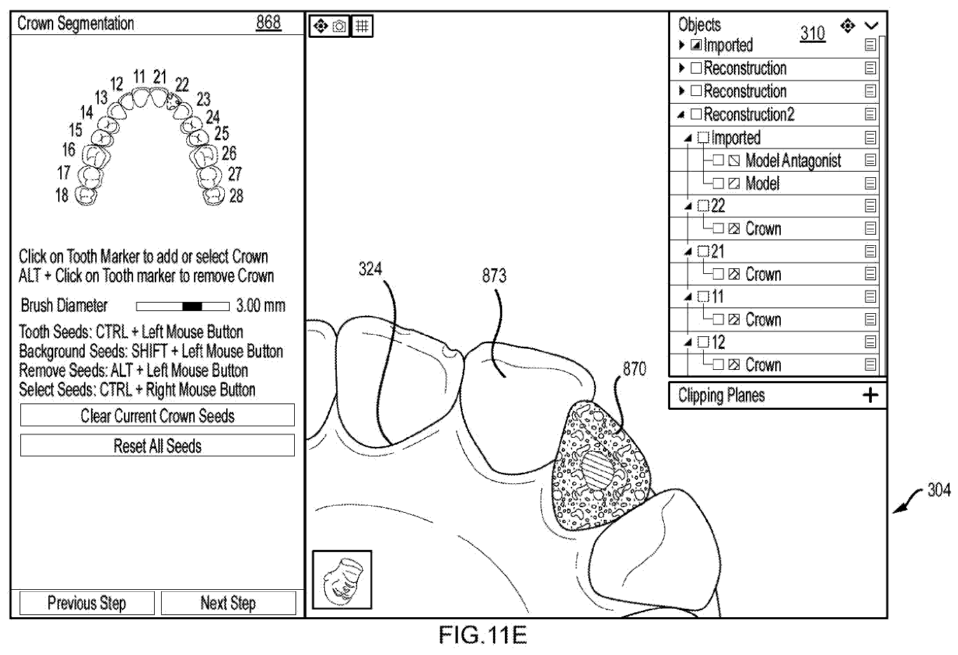

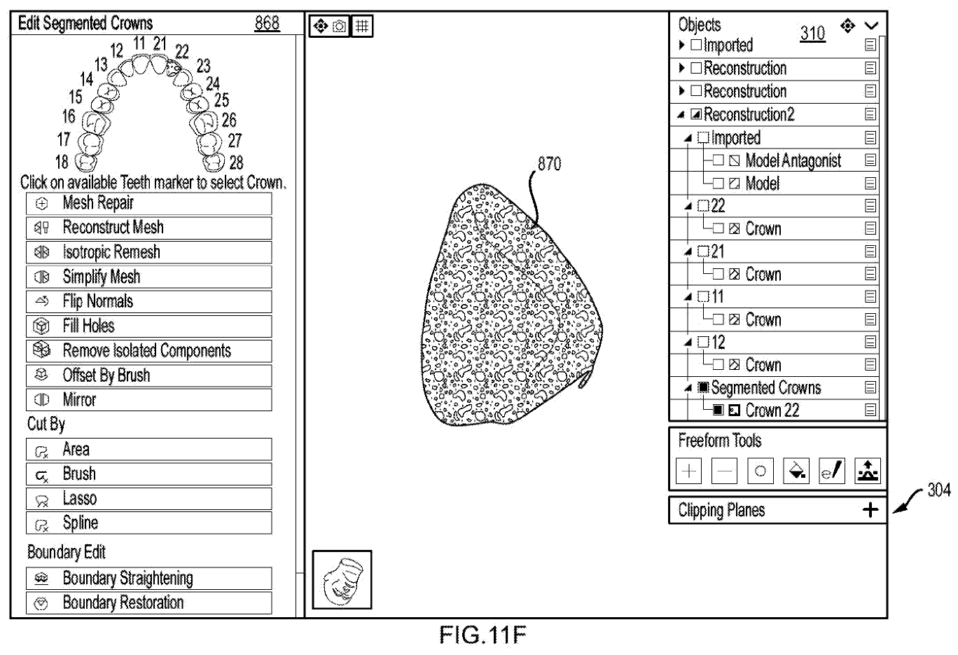

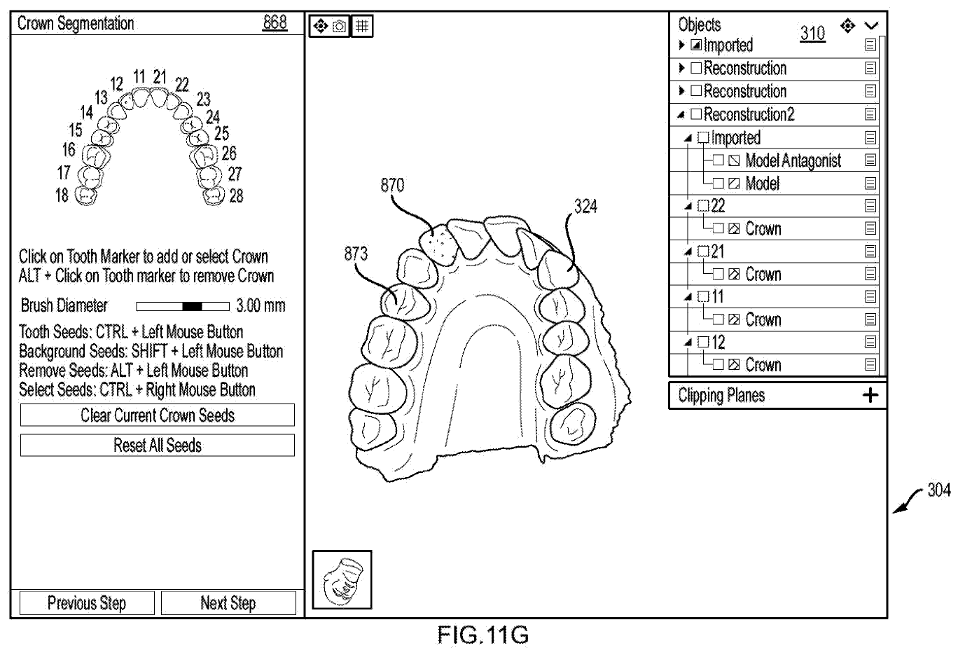

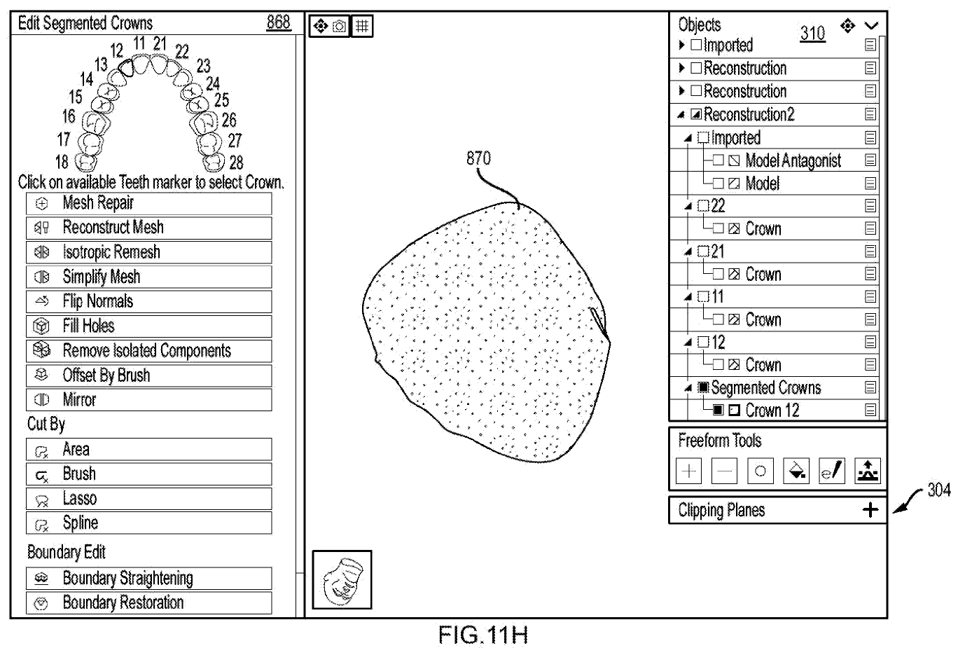

Referring to FIG. 8U and FIGS. 11A-H, the CAD environment 304 includes a crown segmentation toolbar 868, discussed in more detail below, that includes tools to select a tooth-like object 873 on the fourth object 324 to serve as the basis to create and edit a crown object. The selection is done by a selector icon 872 that is used to select and/or define the areal extent and contours of the tooth-like object (which is typically above the patient's gingival margin) for automatic generation of a surface matching crown object. Once a tooth-like object 873 is selected and defined, a differently colored surface is used to define the crown as shown by the crown objects 870. In effect, the selector icon 872 is a copy or cut and paste operation in which the exterior surface topology of the tooth-like object is copied to create a crown object having the identical surface topology. The tooth-like object can be on the restoration itself or a tooth in the original oral imaging information (e.g., intra-oral scanning information) taken of the patient's oral cavity. In this manner, the original shape and appearance of the patient's teeth can be used in the dental restoration. While the above discussion relies on a manually operated copy operation, it is to be understood that a data model may automatically identify each tooth and its corresponding position on the arch (e.g., tooth number) and automatically copy the above-margin tooth shape for auto-generation of the crown object.

While any technique may be employed, the crown segmentation toolbar 868 in an embodiment of the disclosure can employ mesh segmentation to copy the surface topology of the tooth-like object. Mesh segmentation is the process of decomposing a 3D surface mesh into smaller, meaningful, and functional parts or sub-meshes. Mesh segmentation can utilize geometric features—such as curvature, dihedral angles, and shape diameter—to partition complex 3D models into distinct, manageable regions for texture mapping. Part-type segmentation splits objects, such as the tooth-like object, into functional components while surface-type segmentation partitions the surface of the tooth-like object into patches based on geometric criteria. These techniques can be done using methods such as clustering (in which faces and vertices are assigned to groups based on proximity and similarity), region growing (which starts from seed faces and expands based on curvature or angle properties), graph-cut (which minimizes an energy function to create optimal, smooth boundaries between segments), shape diameter function (SDF) (which measures local object thickness to guide segmentation), and deep learning (which uses multi-view convolutional neural networks (CNNs) or data-driven methods to automatically identify components). As will be appreciated, other object detection and segmentation techniques may be employed.

In particular, CNNs are deep learning models that process data with grid-like or mesh topology as images. CNNs comprise convolutional layers (which apply convolutional operations to input image information using filters or kernels to detect features such as edges, textures, and more complex patterns while preserving the spatial relationships between pixels), pooling layers (which down sample the spatial dimensions of input to reduce the computational complexity and the number of parameters in the network as exemplified by max pooling that selects a maximum value from a group of neighboring pixels), activation functions), and fully connected layers (which connect every neuron in one layer to every neuron in the next layer and make predictions based on the high-level features learned by the previous layers).

In operation, the CNN receives and preprocesses the input image information to ensure uniformity of size and format, convolution layer filters extract features, like edges, textures, and shapes from the preprocessed image information, pooling layers down sample feature maps output by the convolutional layers to reduce dimensionality, the down sampled feature maps are passed through the fully connected layers to produce final output in the form of a prediction, such as a classification label, a class of the image, or a localization of a selected object in the image information.

Referring to FIG. 8V, the CAD environment 304 includes an edit crown toolbar 874 that includes tools to edit the crown objects 870 via one or more control points 328 including shrink mesh, invert normals, fill holes, remove isolated components, offset with panel, mirror, delineate cut width, edit border, coloration, and free form modeling. The CAD environment 304 shows the user editing an edge 876 of the crown object 870. As shown by FIG. 8V, the outer and/or inner surfaces of the crown object can mirror the outer surface of the selected tooth-like object, with each selected portion of the inner surface typically being substantially uniformly spaced from an opposing portion of the outer surface and the outer edge of each of the outer and inner surfaces being identical and conforming to the edges of the corresponding selected tooth-like object highlighted by the crown segmentation toolbar 863. In other embodiments, the outer surface of the conformal crown object can mirror the outer surface of the selected tooth-like object while the inner surface of the crown object mirrors an outer surface of an abutment object in the fourth object corresponding to an abutment to which the crown corresponding to the crown object is to be bonded or otherwise attached.

Referring to FIGS. 8W and 8X, the CAD environment 304 of FIG. 8W includes an insertion axes toolbar 877 that includes tools to display and edit the longitudinal or insertion axes 878 of each of the crown object 870 and the CAD environment 304 of FIG. 8X includes an abutments toolbar 880 that includes tools to edit the shape and dimensions of each abutment object and display and edit the longitudinal axes of each abutment object 882 corresponding to a crown object 870. The longitudinal axis 884 of each abutment object is typically parallel to and co-located with the insertion axis of the corresponding crown object 870. The outer surface of each abutment object can have the same shape and configuration as the inner surface of the corresponding crown object. To enable bonding of the crown corresponding to each crown object to the respective abutment corresponding to each crown object, the interior surface of the crown object is typically substantially uniformly spaced from the exterior surface of the respective abutment object.

Referring to FIG. 8Y, the CAD environment 304 includes a thimble modeling toolbar 874 that includes tools to edit the abutment objects 882 via one or more control points 328, such as by free modeling, adjusting a level of smoothness or roughness of a selected surface, filling a volume, adding or removing material, local generic transformation, adjusting a cut width, selecting a cutting axis, and the like. As will be appreciated, the thimble refers to the U-shaped interface 883 between the abutment object and the fourth object 324 or selected dental restoration. The thimble may be identified by a data model using segmentation techniques to identify the interface 883, which segmentation technique is discussed in more detail below. As will be appreciated, an abutment is secured to an overdenture using a retentive housing (e.g., a retentive device such as a metal cap with nylon insert and the like) embedded into the overdenture base using self-curing acrylic. These housings snap onto the abutments (e.g., by a ball, locator, bar, and the like) attached to the implants, providing stability while allowing the patient to remove the prosthesis. The tools enable a user to edit the shape and/or dimensions of the interface 883 but also the retentive housing type and configuration. As the shape and/or dimensions of the thimble object are edited, the engaging internal surface of the corresponding crown object is automatically adjusted to mirror the edited shape and/or dimensions to ensure a substantially optimal fit.

In an embodiment, the tooth-like object is split into a first volume associated with the crown object and a second volume associated with the abutment object. The workflow can provide the ability of an object to create split volumes and/or subtract volumes from existing objects within the CAD environment 304. Specifically, a user (e.g., care provider 108) may be presented with a tool that helps the user work through the process of creating a split volume and/or subtracting a portion of a volume from another object. In some embodiments, the split volume results when a selected object is at least partially overlapping one or more other objects in the CAD environment 304. When the selected object is overlapping at least some volumetric portion of another object, then the overlapping volume may be subtracted from the original volume. This may result in a total removal of the overlapping volume or may result in a split volume that treats the overlapping volume as a new object within the CAD environment 304.

In case of a tooth-like object and crown object, the non-overlapping volume between the crown object and the tooth-like object will become a split volume or new abutment object. The portion of the crown object 336 that was overlapping the tooth-like object may be removed from or hidden in the CAD environment to render the abutment object and thimble. In some embodiments, the split volume is created using one or more Boolean operations (e.g., AND, SUBTRACT, OR, NOT, XOR, etc.).

Referring to FIG. 8Z, the CAD environment 304 includes a connector toolbar 888 that includes tools to add, remove, and edit connector objects 890 via one or more control points. The connector objects refer to connecting mechanisms, such as adhesive bonding, soldering, and other connectors, between opposing crowns objects and/or underlying abutment objects in the selected dental restoration 324. The tool enables the dimensions and other descriptive parameters of each connector objects to be selected, modified or edited, such as connector object height, length, and minimum and/or active area.

Referring to FIG. 8AA, the CAD environment 304 includes the freeform toolbar 850 discussed above. The CAD environment 304 displays the fourth object 324, abutment objects 882, crown objects 870, and implant receiving structure object 830. The prosthetic object 336 is in a layer hidden from view.

Referring to FIG. 8BB, the designed prosthetic object 336 and implant receiving structure object 830 are depicted. The prosthetic object 336 comprises a locator member receiving structures 894 to receive a respective locator member object to removably engage the fourth object 324, and stepped implant connector holes 890 aligned with the implant receiving structure object 830 to receive threaded connectors to connect the prosthetic object 336 to the implant objects.

Referring to FIG. 8CC, the designed fourth object 324 is depicted. The channel 894 is the female portion of the bar structure and is a reverse image of the contacting surface of the prosthetic object 336. As will be appreciated, the shapes of the opposing walls of the channel 894 and prosthetic object 336 are mirror images of each other and the depth of the channel 894 is substantially the same as the height of the prosthetic object 336 at spatially opposing locations.

As can be seen from the workflows of FIGS. 8A-8CC, the workflow creates the prosthetic object 336 based upon the spatial limitations imposed by the pre-existing selected dental restoration or fourth object 324 and the first object 312, thereby enabling design of the prosthetic object 336 not only with fewer mouse clicks but also with a more accurate model of the prosthetic object 336. The workflows further enable the direct linkage of attachment and locator member objects and associated data structures to the prosthetic object, alignment by the screw or tool access object 316 of the implant object axis with the matching implant connector receiving structures in the prosthetic object, configuration of the thimble of the abutment objects with the corresponding crown objects, and the creation of connector objects 890 between opposing tooth-like structures in the fourth object 324. In other words, at each step of the workflow, the proposed edits and additions of various objects associated with the prosthetic object can be double checked against the dimensions of the first and fourth objects to avoid any inconsistencies that may cause issues subsequently for example when the bar structure and dental restoration manufactured from the CAD models are installed on a patient. Due to the direct linkage of the data structures defining the first and fourth objects and the prosthetic object as modified in the above workflow, machine instructions defining the final designs of the rapid prototype and/or bar structure comprising the features and attached components described above (e.g., the stepped holes and recessed steps and locators and attachment members) and/or dental restoration including the channel and associated features (e.g., the raised steps and locator and attachment member engagement features) for manufacture by milling or additive or subtractive 3Dd printing can be generated by the CAD workflow described above using a single mouse command (e.g., mouse click).

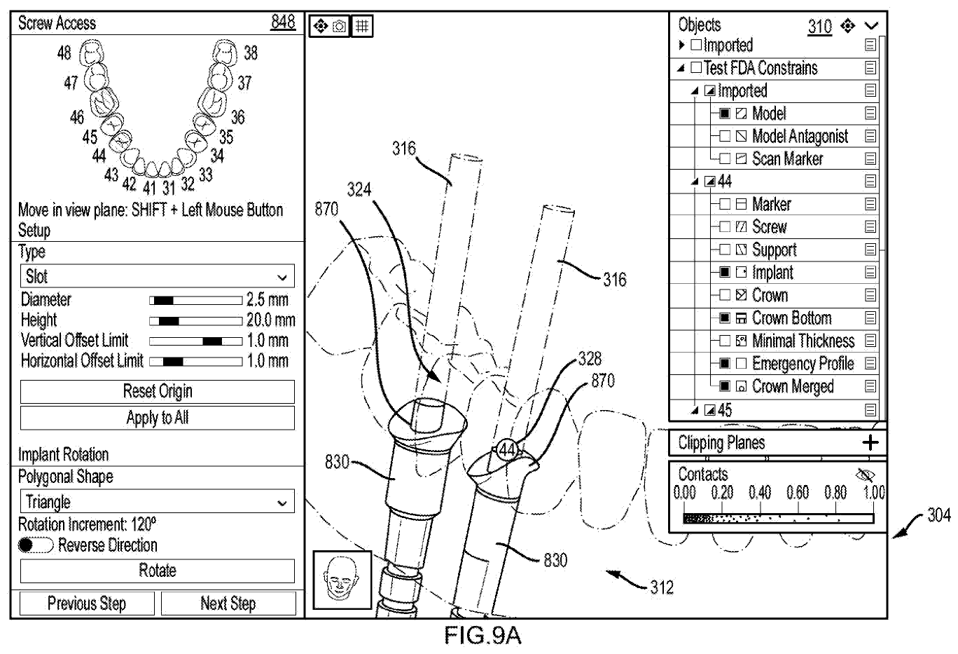

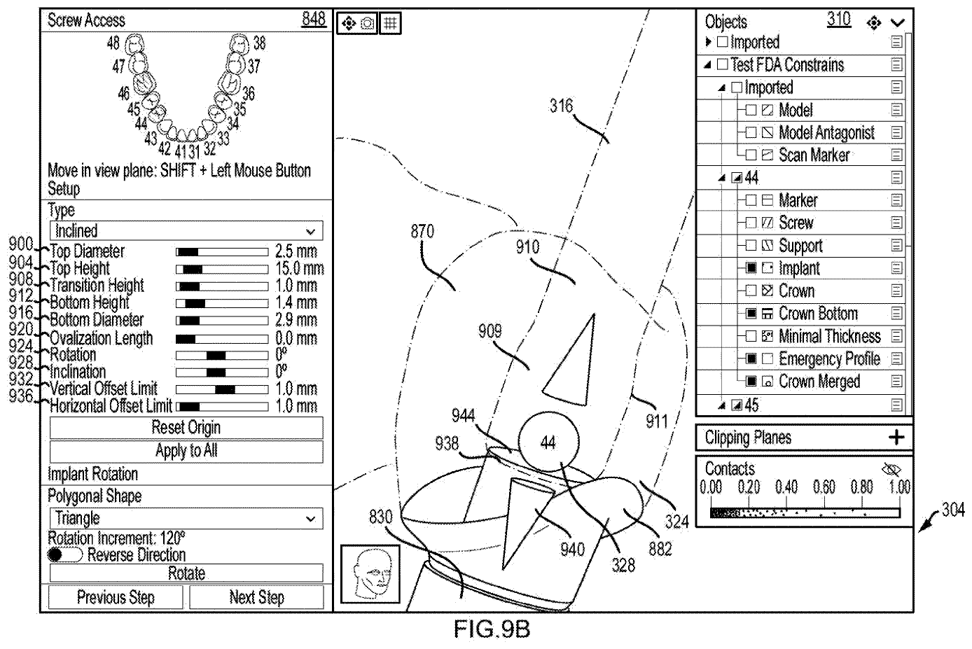

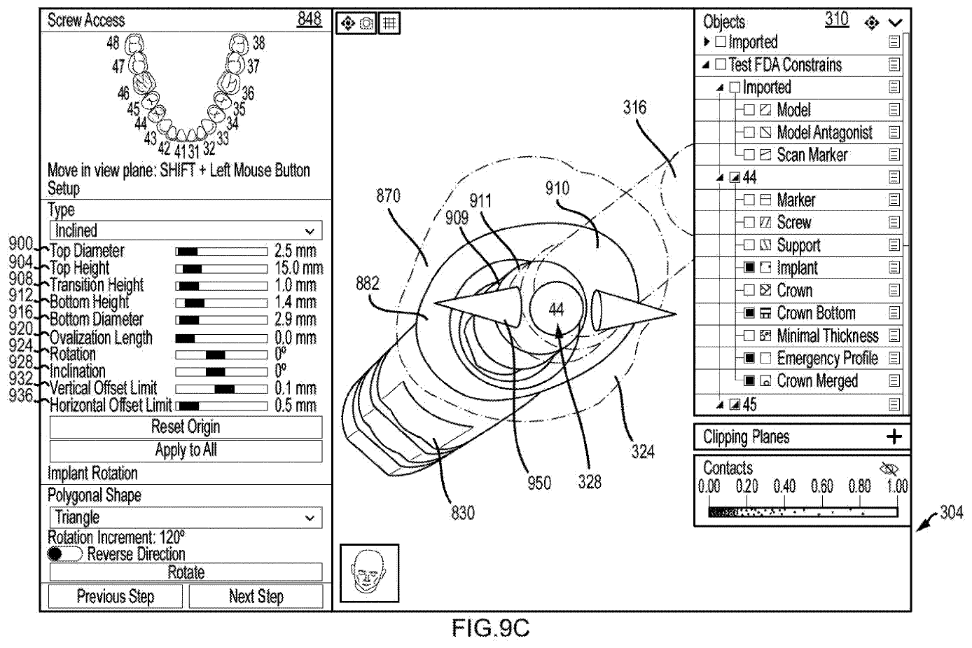

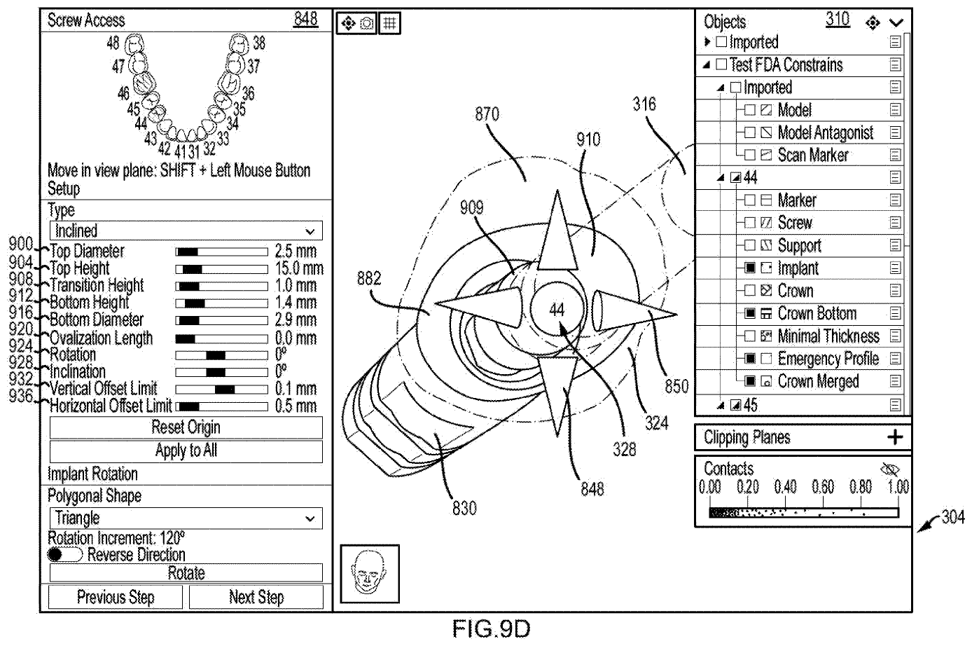

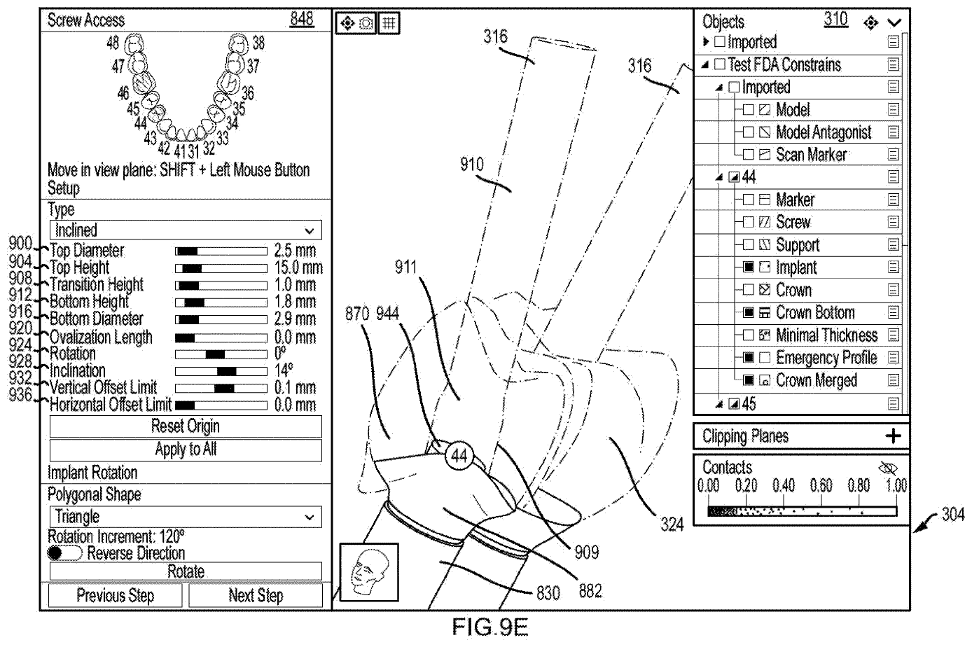

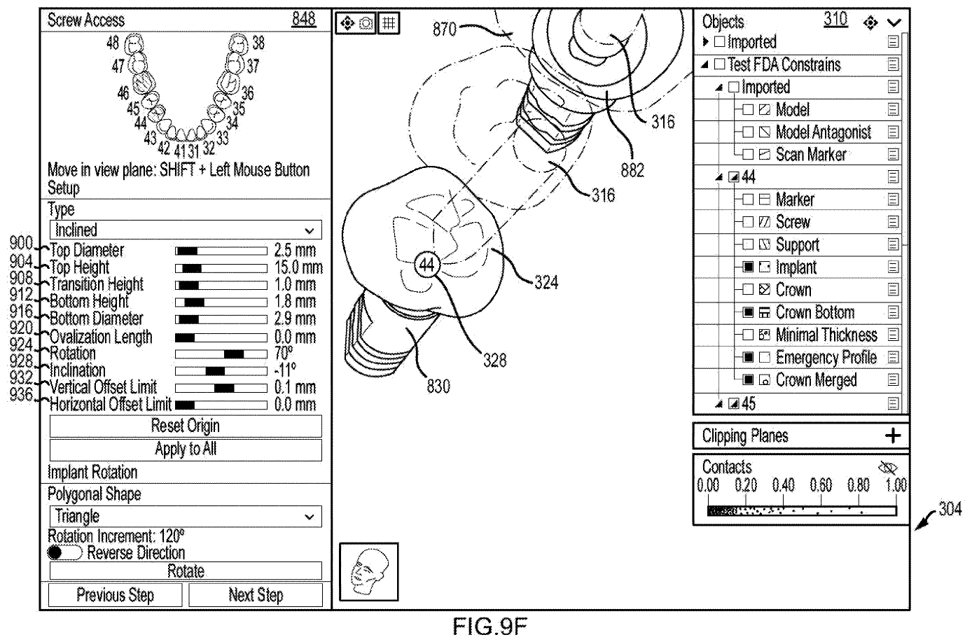

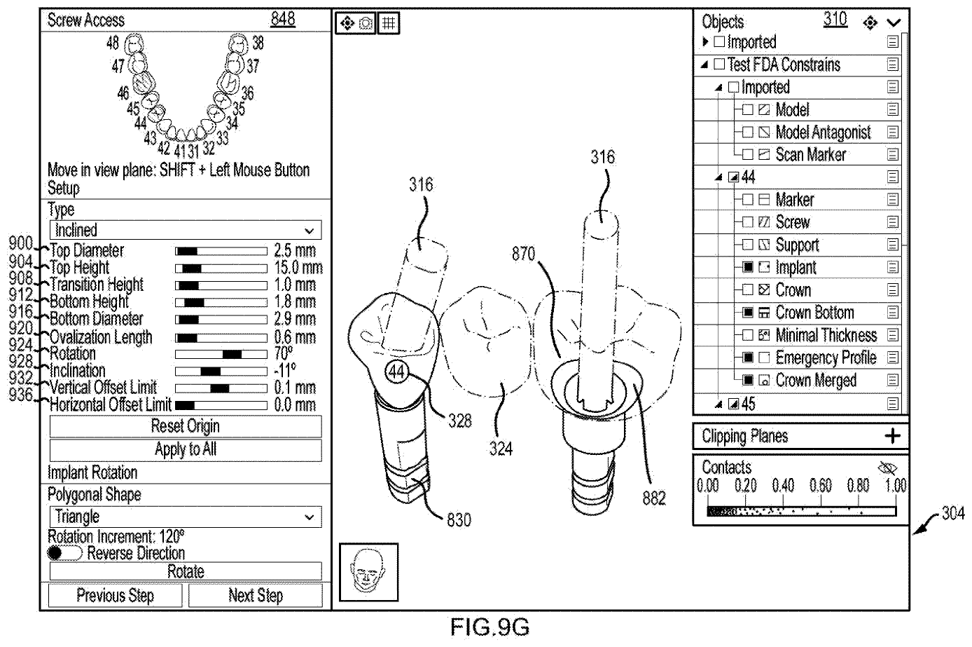

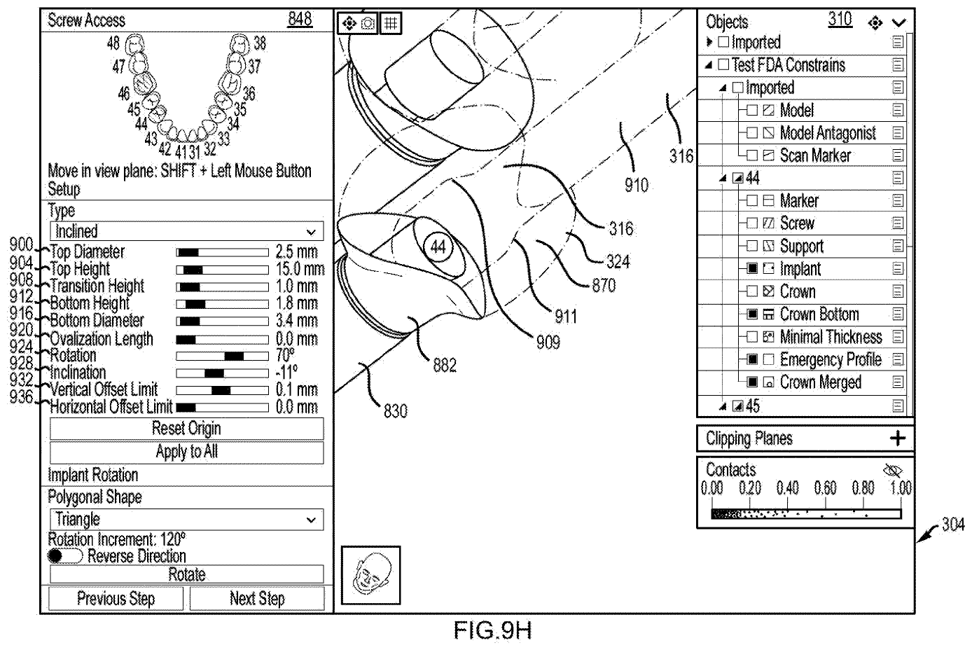

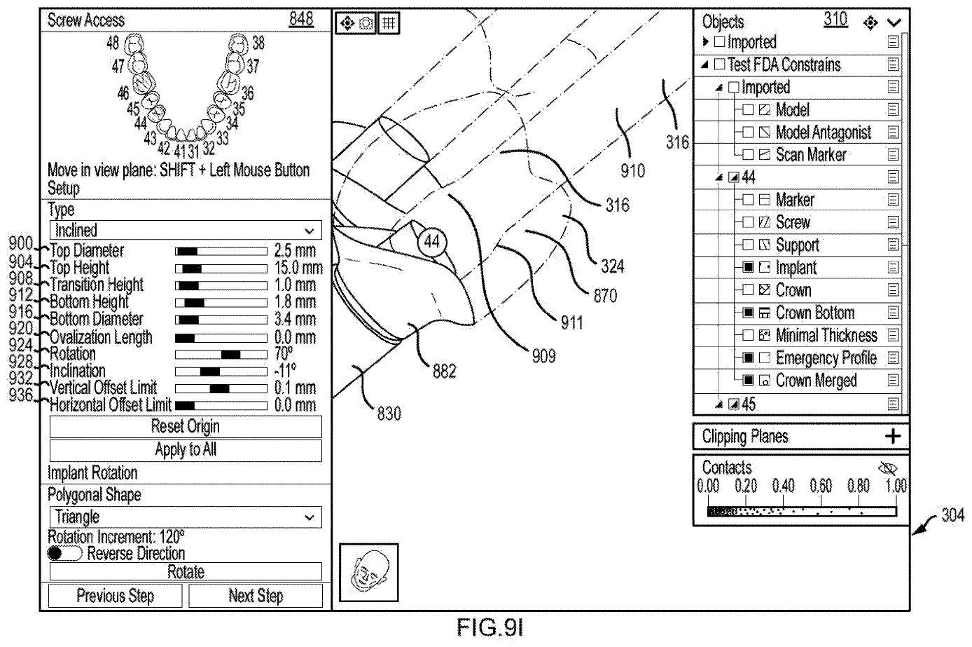

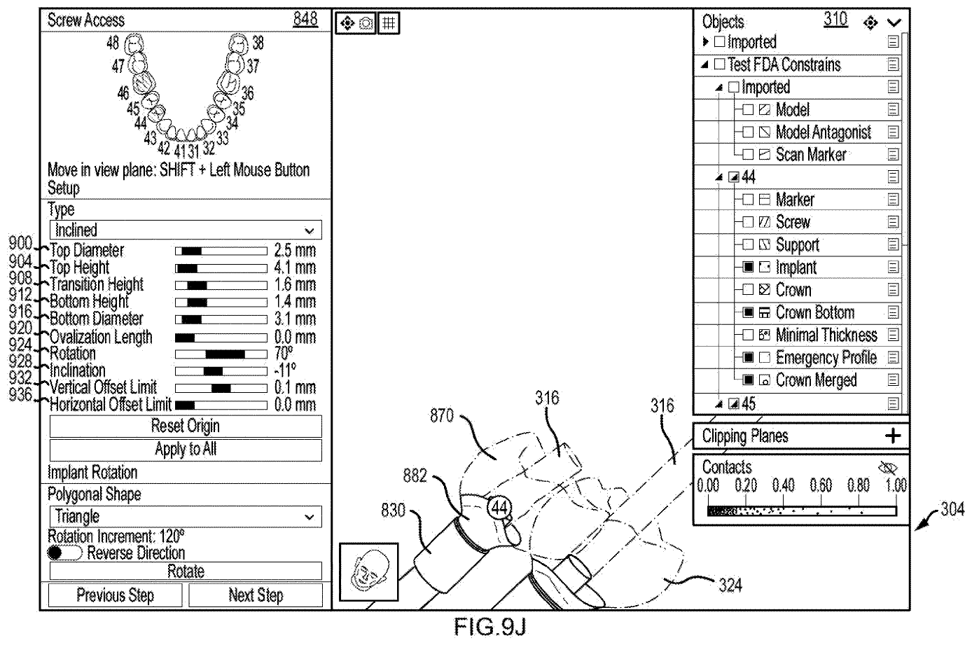

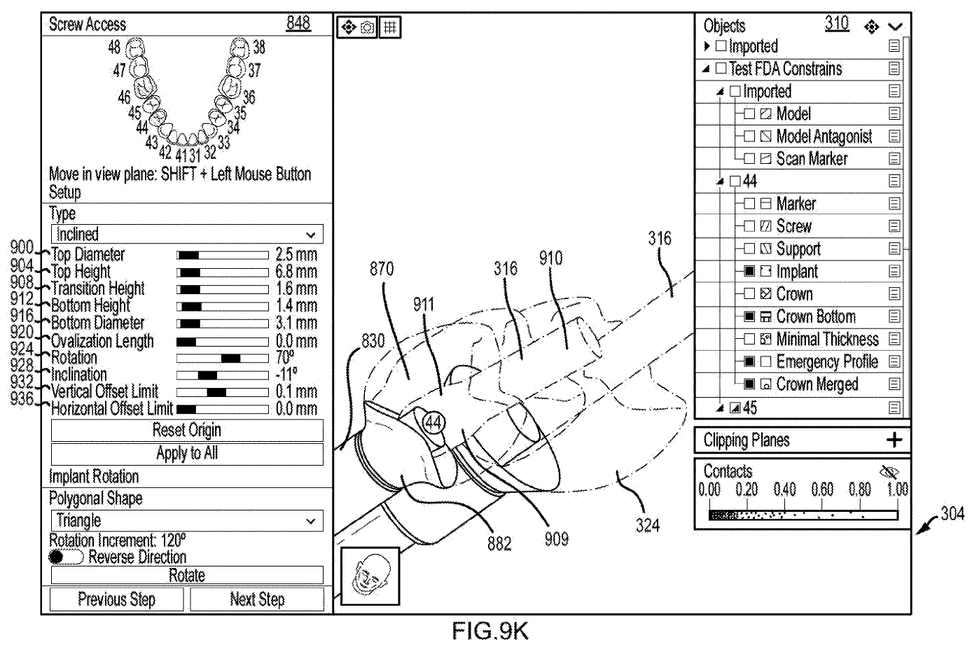

With reference to FIGS. 9A-9K, a CAD workflow that enables configuration of parametric connector (e.g., threaded connector between the prosthetic object and the implant object) access. The workflow can enable the definition of connector access through parameters, such as length, width, slope, and radius, as opposed to fixed dimensions such that changing one parameter updates the object model or template automatically to reflect the parameter change.

Referring to FIG. 9A, the CAD environment 304 comprises the screw access toolbar 848 comprising tools to create and/or edit (via control points 328) the configuration of tool access objects 316 and slots including a diameter, height, vertical offset limit, and horizontal offset limit of the slot (or hole) in the fourth object 324 occupied by the tool access object 316. As will be appreciated, tool access is required to enable care providers to thread screws into threaded slots or holes in an underlying implant to secure the dental restoration (e.g., the bar structure or abutment) to the arch or inter-arch of the patient. Due to implant placement and obstacles such as other teeth or oral features and to substantially optimize screw engagement by the driver, the access axis (or longitudinal axis of the tool access object 316) may need to be angulated, or transverse, to a longitudinal axis of the implant. Unlike CAD software of other vendors which configure tool access at the bottom of the screw, the CAD workflow of the present disclosure can configure tool access beginning at the top of the screw, thereby substantially optimizing screw access without compromising aesthetics. As will be appreciated, the tool access object 316 corresponds to a physical slot or hole in the dental restoration to enable a driver to access the screw. The workflow described below enables not only the direction of access to be defined but also the cross-sectional area and other dimensions of the tool access object 316 to be adjusted to accommodate the driver to be employed.

Referring to FIG. 9B, the screw access toolbar 848 comprises, for an inclined tool access object 316 configurable options for the top diameter of the tool access object (option 900), top height of the tool access object (or the height of the upper portion 910 of the tool access object-which typically has a smaller diameter than the lower portion 909 of the tool access object) (option 904), transition height of the tool access object (or the length of the transition 911 between the bottom portion 909 and upper portion 910 of the tool access object 316) (option 908), bottom height of the tool access object (or the height of the bottom portion 909 of the tool access object-which typically has a larger diameter than the upper portion 910 of the tool access object) (option 912), bottom diameter of the bottom portion 909 tool access object (option 916), ovalization length of the tool access object (e.g., the relationship of the major access length and the minor access length of the arcuate cross-section of the object 316) (option 920), rotation of the tool access object (which refers to the rotation of the longitudinal axis of the tool access object 316 relative to a fixed point on the upper surface 944 or longitudinal axis of the abutment object or on the seating surface or longitudinal axis of the implant object) (option 924), inclination or slope of the tool access object (option 928), vertical offset limit of the tool access object (which defines the maximum degree of offset along the longitudinal axis of the tool access object 316 between the bottom or base 938 of the tool access object 316 and the relative to the upper surface 944 of the abutment object 882) (option 932), and horizontal offset limit of the tool access object (which defines the maximum degree of offset normal to the longitudinal axis of the tool access object 316 of the bottom or base 938 of the tool access object 316 relative to the upper surface 944 of the abutment object 882) (option 936). The CAD environment 304 displays a control point 328 that moves the bottom or base 938 of the tool access object 316 up and down along the longitudinal axis of the object 316 as shown by the opposing directional cones 940 to displace the base 938 relative to the upper surface 944 of the abutment object 882 within the fourth object 324.

Referring to FIGS. 9C-9D, the tools in the screw access toolbar 848 enable the control point 328 to horizontally displace the base of tool access object 316 of the bottom or base 938 of the tool access object 316 in the direction of the opposing directional cones 948 and 950 relative to the upper surface 944 of the abutment object 882 (or the degree of offset of the longitudinal axis of the tool access object 316 relative to a longitudinal axis of the abutment object 882). A point on the top or the upper section of the tool access object is typically fixed while the control point is moved as described.

Referring to FIGS. 9D-9E, the tools in the screw access toolbar 848 enable the selection of the inclination option 928 to select the value of the positive or negative inclination of the longitudinal axis of the tool access object 316 relative to the upper surface 944 of the abutment object 882 and seating surface or longitudinal axis of the implant object 830. The change in inclination is evident by comparing the object 316 inclination in FIG. 9D against that in FIG. 9E.

Referring to FIG. 9F, the tools in the screw access toolbar 848 enable the selection of the rotation option 924 that rotates the tool access object 316. More specifically, the option enables selection of the degree of rotation of the longitudinal axis of the tool access object 316 relative to a fixed point on the upper surface 944 or longitudinal axis of the abutment object or on the seating surface or longitudinal axis of the implant object.

Referring to FIG. 9G, the tools in the screw access toolbar 848 enable the selection of the option 920 enables the difference between (or alternatively the ratio of) the major access length and the minor access to be selected. When the difference is specified, a value of 0 means that the arcuate cross-section is a circle and not an oval. When the ratio is specified, a value of 1 means that the arcuate cross section is a circle and not an oval.

Referring to FIG. 9H, the tools in the screw access toolbar 848 enable the selection of the option 916 enables the bottom diameter of the bottom portion 909 of the tool access object to be changed.

Referring to FIG. 9I, the tools in the screw access toolbar 848 enable the selection of the option 908 enables the transition height of the tool access object (or the length of the transition 911 between the bottom portion 909 and upper portion 910 of the tool access object 316) to be specified.

Referring to FIG. 9J, the tools in the screw access toolbar 848 enable the selection of option 904, which enables the top height of the tool access object (or the height of the upper portion 910 of the tool access object above the lower portion 909 of the tool access object to be specified.

Referring to FIG. 9K, the tools in the screw access toolbar 848 enable the selection of option 900, which enables the top diameter of the tool access object (or the diameter of the upper portion 910 of the tool access object to be specified.

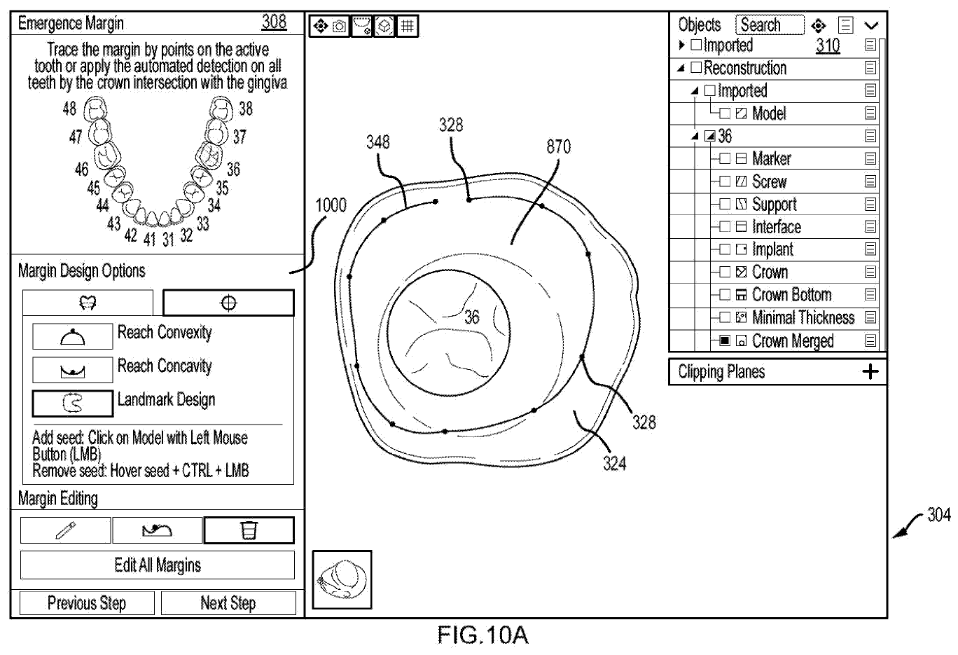

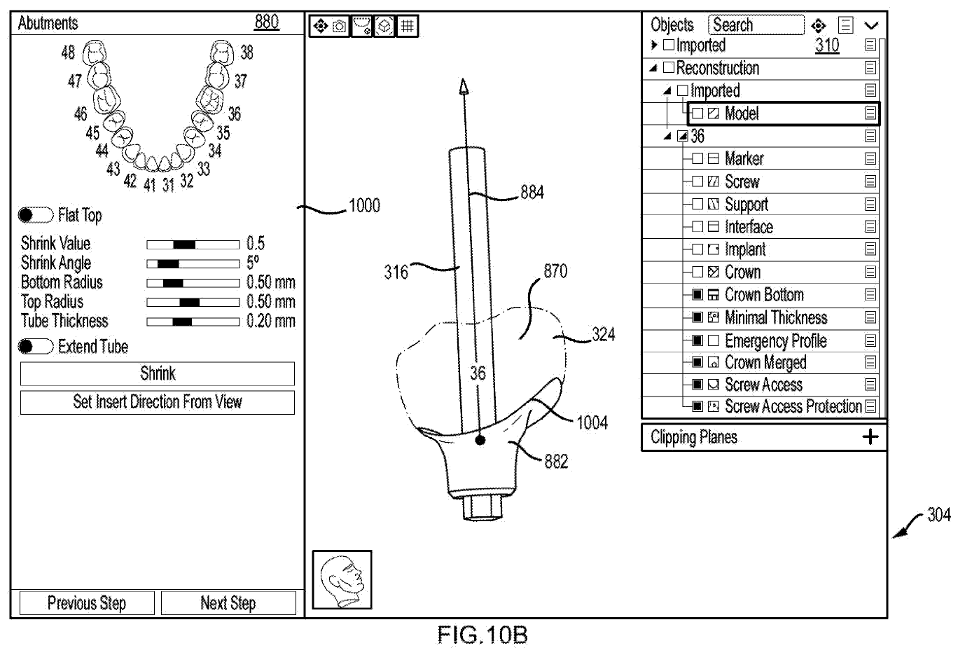

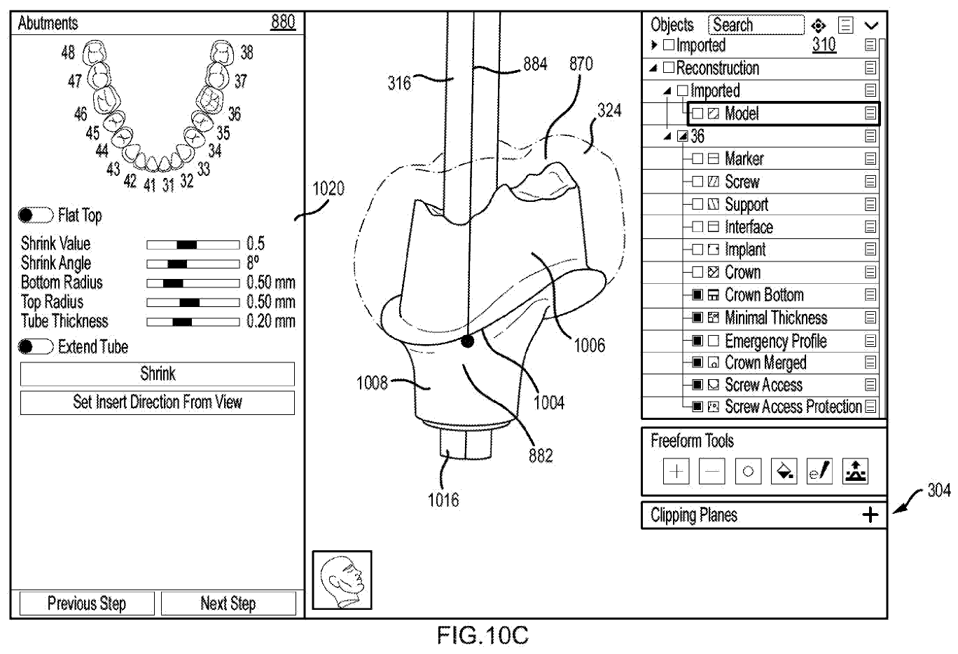

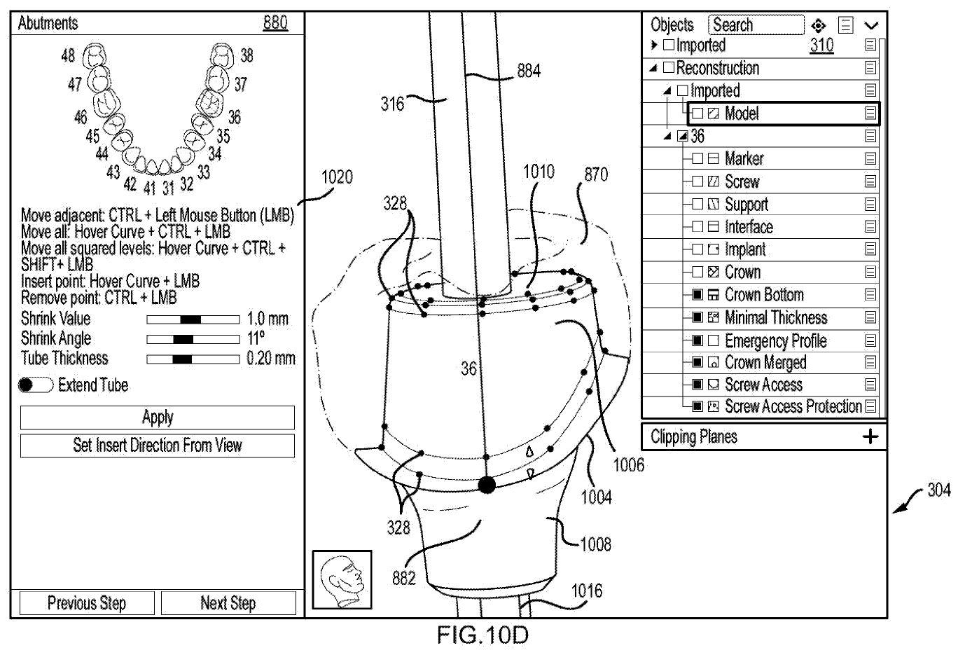

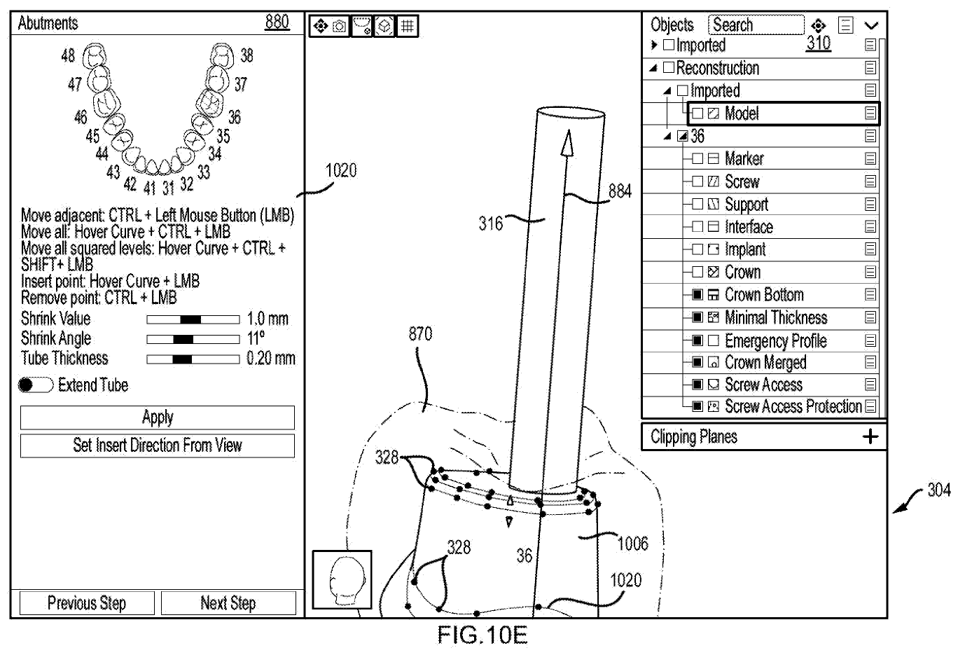

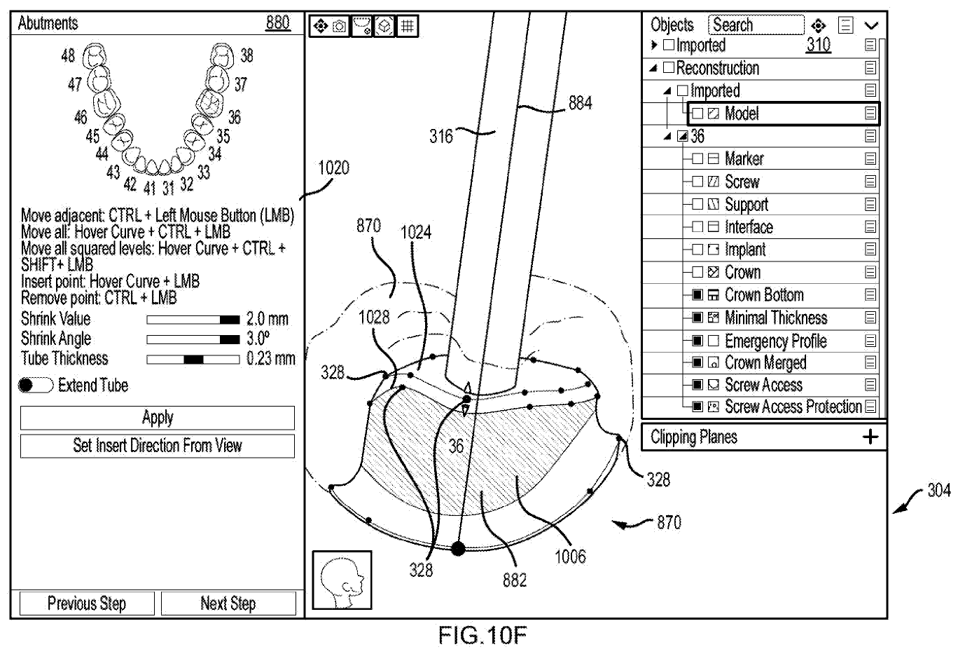

With reference to FIGS. 10A-10F, a CAD workflow that enables configuration of a margin design on a tooth-like object corresponding to a prosthetic or natural tooth or crown in a dental restoration (rather than on a model of the abutment itself) and configuration of an abutment object using a split volume methodology. In other words, the abutment object is generated from and after the design of the tooth-like object. The tooth-like object is not designed after the abutment object.

Referring to FIG. 10A, the CAD environment 304 comprises an emergence margin toolbar 308 that includes tools to configure an emergence margin or interface between the abutment and prosthetic tooth, such as a crown. The emergence margin typically corresponds closely to the gingival interface with the prosthetic tooth. The control points 328 and intervening boundaries 348 enable the user to configure the emergence margin around the periphery of the tooth-like object.

Referring to FIG. 10B, the CAD environment 304 comprises an abutment toolbar 880 that comprises selectable options 1000 to select a flat top to the abutment, set a shrink value (which depends on the material being milled as the amount of shrinkage that will occur during abutment manufacture depends on the material), shrink angle (or the angle of the tube walls), bottom radius of the tube, top radius of the tube, tube thickness and tube length (or height). As shown in the figures below, the tube refers to the upper tubular portion (or post) 1006 of the abutment object. As can be seen from FIGS. 10B and 10C, the emergence margin set in FIG. 10A has been automatically converted into the interface 1004 between the tooth-like object 324 and abutment object 882. The abutment object 882 comprises the tubular upper portion (e.g., post) 1006, lower portion 1008 and nonrotational feature 1016.

As can be seen from FIGS. 10A and 10B-C, the abutment object is generated when the emergence margin is configured using split volume techniques. In other words, the volume of the tooth-like object is subdivided into first and second volumes, with the first volume being the tubular upper portion of the abutment object 882 and the second volume being the remaining non-overlapping volume of the tooth-like object. As will be appreciated, split volume in CAD is a split command, which divides a single 3D solid body or part into two or more distinct. The first volume is generated automatically based on predetermined design criteria for the abutment and crown to ensure that the abutment and crown each will have sufficient strength to withstand mandibular chewing forces. Alternately, the user selects a design for the tubular portion of the abutment object and the selected abutment object is automatically modified to match the emergence margin and reflect the spatial dimensions and orientation of the prosthetic tooth object followed by creation of the second volume using the modified abutment object. The selected abutment object can correspond to an abutment blank. It is to be understood that a data model may automatically create the crown object and corresponding abutment object by identifying each tooth and its corresponding position on the arch (e.g., tooth number), receiving a selected abutment object from an abutment library of abutment objects (each of which corresponds to a physical abutment) that are either templates or models from the model library 252, and automatically modify the selected abutment object based on the tooth-like object (which may be a model of the actual tooth of the patient as noted above), and the crown object interior to engage the exterior surface of the abutment object.

In the CAD environments of FIGS. 10D-10F, the abutment object has been modified to have a flat upper surface or top 1010 and various sets of control points 328 provided to enable a corresponding plane defined by each set of control points to be modified in one, two or three dimensions. By way of illustration, in the CAD environment 304 of FIG. 10E the plane 1020 defined by the respective set of control points has been modified to provide arcuate-shaped segments. In the CAD environment 304 of FIG. 10F the planes 1024 and 1028 defined by the respective set of control points have been modified to provide sloping surfaces.

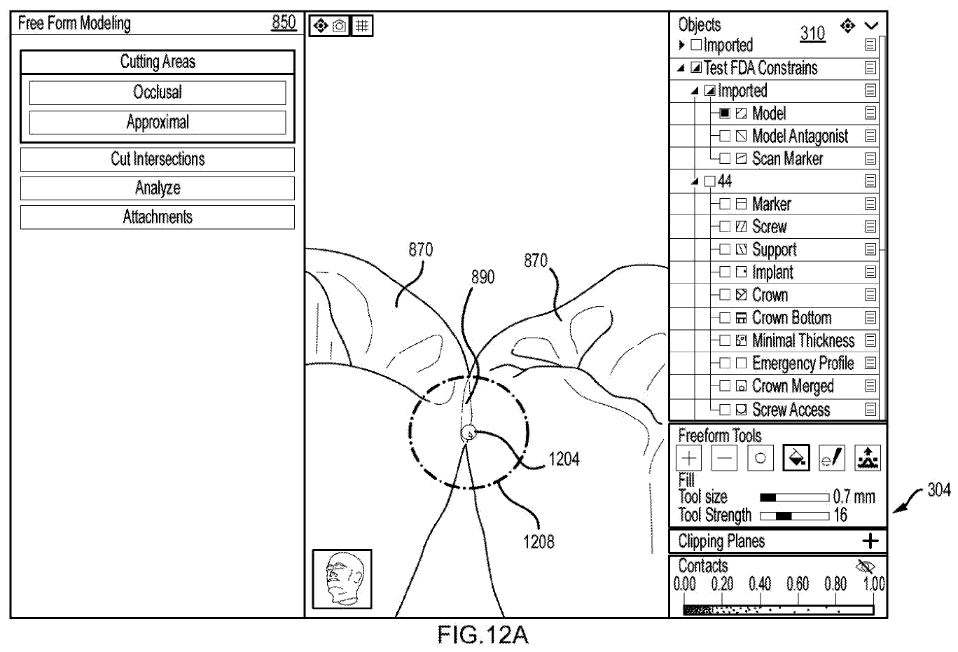

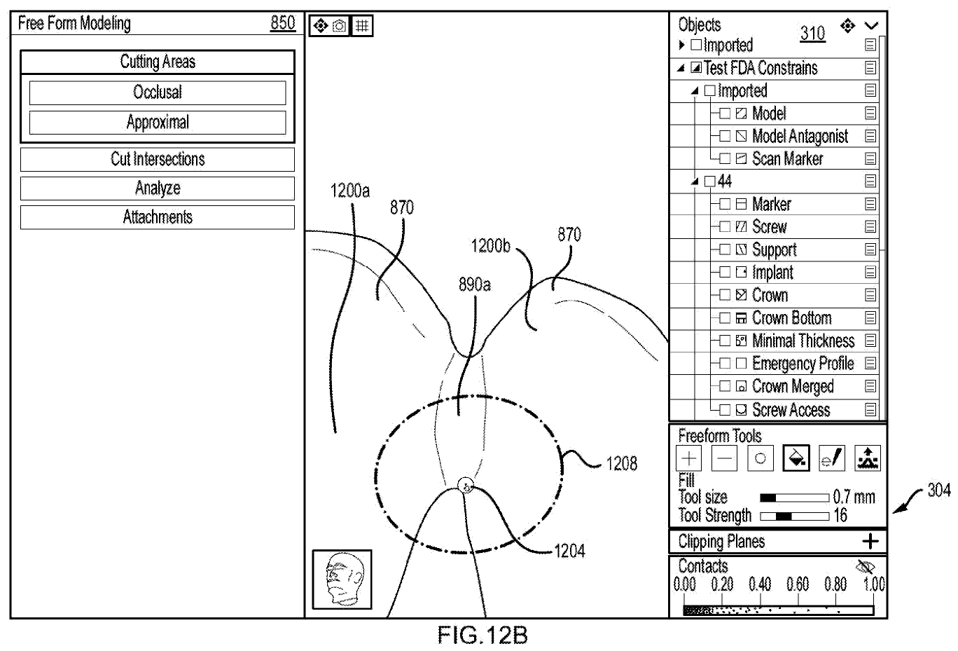

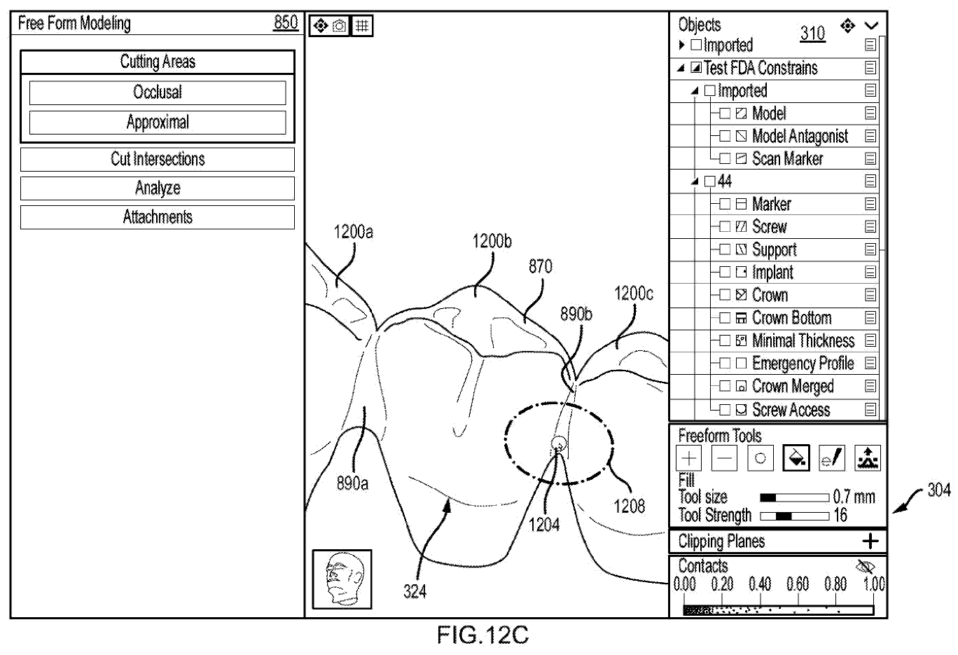

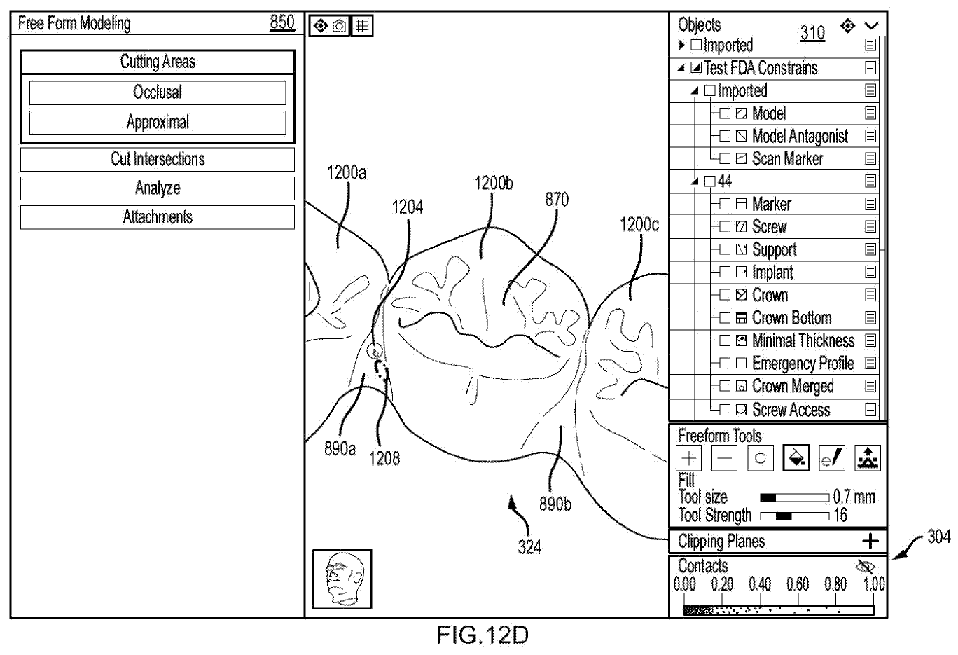

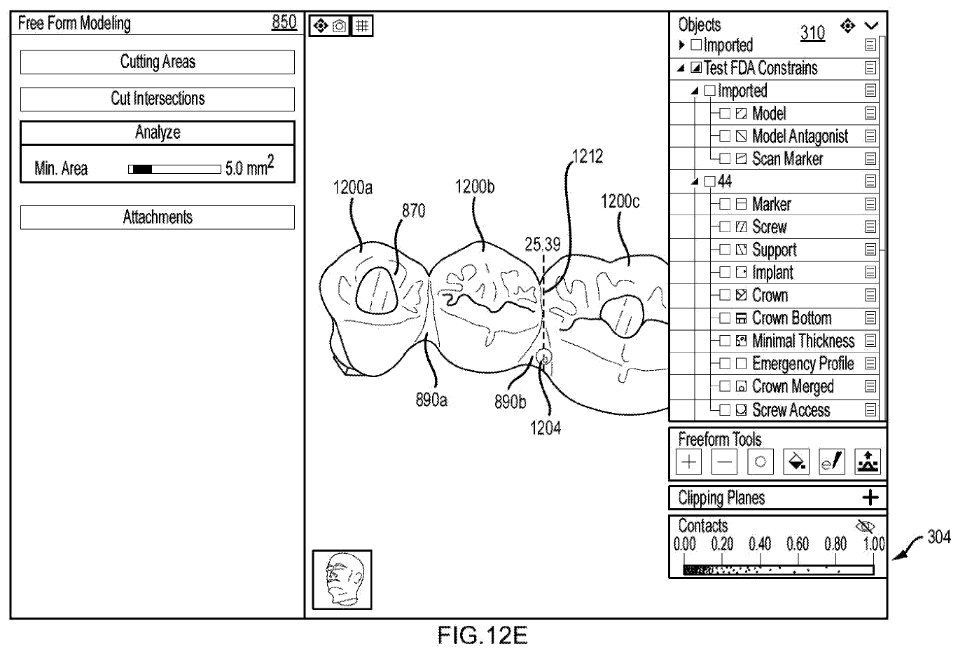

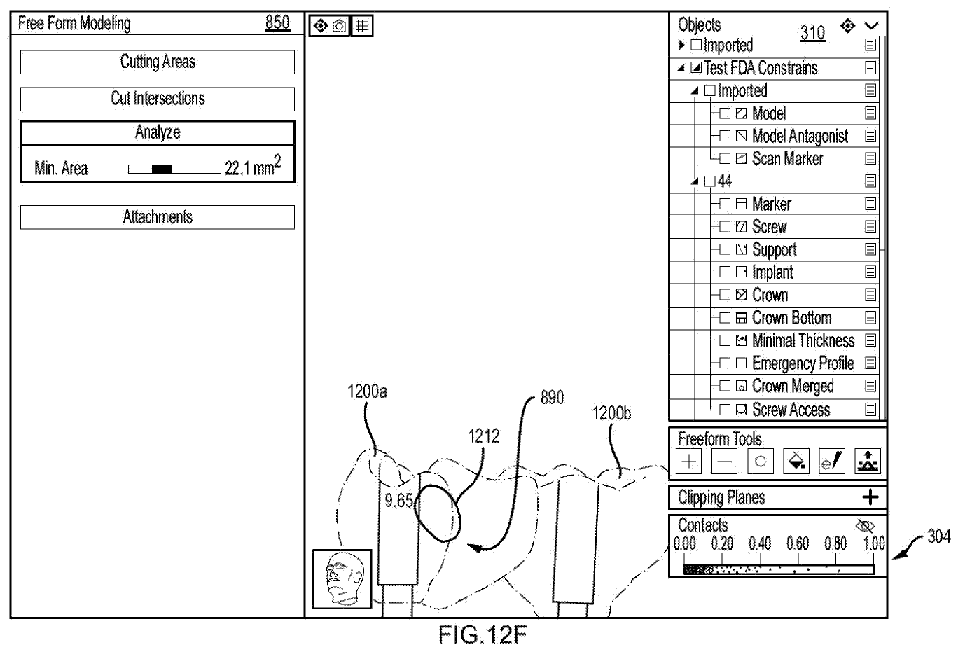

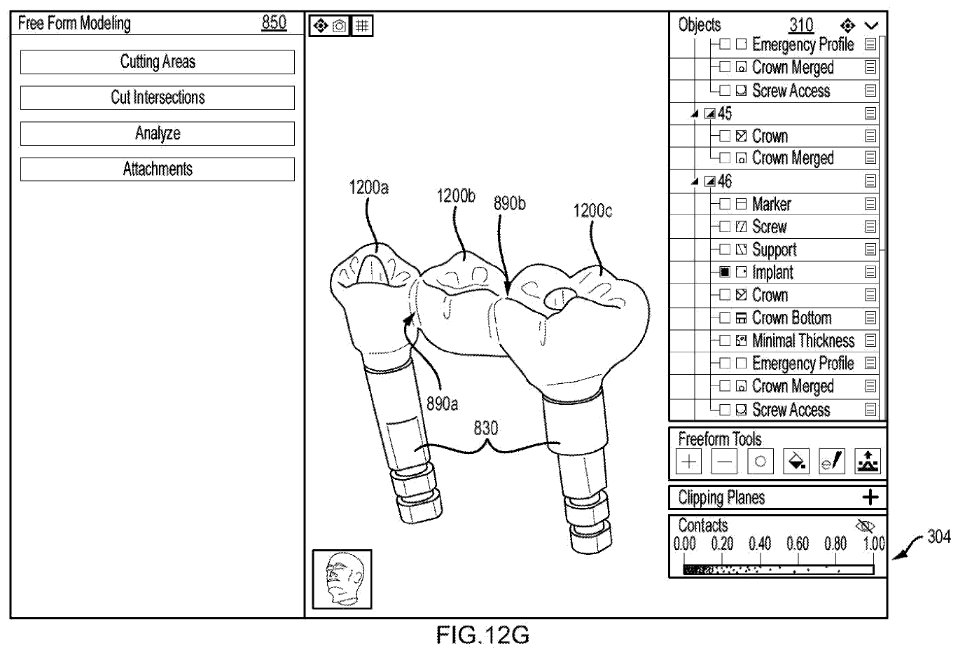

With reference to FIGS. 12A-12G, a CAD workflow that enables configuration of a connector object between opposing tooth-like objects of a dental restoration will be discussed. As will be appreciated, connectors in adjacent teeth are typically manually soldered together to form the bridge. By contrast, the workflow enables a user to create, position, and configure by free-hand techniques connector objects between opposing tooth-like objects that are included in code defining the dental restoration. The code is sent to a mill or 3D printer that manufactures without manual labor the dental restoration, including the connectors between adjacent teeth. In other words, the physical dental restoration can be free of soldering joints between adjacent teeth.

With reference to FIGS. 12A-12B, the CAD environment 304 includes a free form modeling toolbar 850 comprising tools that enable free form modeling of connector objects 890a between adjacent tooth-like objects 1200a and b in the restoration 324. The user can position and fill the connector object 890a to a desired volume (by activating and deactivating a user interface control such as a mouse scroll wheel, left, middle or right mouse button or side button) to form a continuous structure bridging the gap or space between the adjacent tooth-like objects in a manner similar to soldering. For example, the CAD environment 304 comprises a connector creator 1204 positioned between adjacent tooth-like objects in the restoration 324 that is in the process of filling the connector object 890 with virtual solder to realize the desired connector object 890a volume shown in FIG. 12B. For aesthetic purposes, the user positions the connector object 890a on an interior facing surface of the restoration 324 at a location where adjacent tooth-like objects 1200a and b either touch each other or where the adjacent tooth-like objects, though not touching, are closest to each other. This can provide the user with great flexibility on the positioning and volume of the connector object to realize a better aesthetic and structural outcome. By contrast, existing CAD workflows simply merged tooth-like objects at points of contact between adjacent tooth-like objects. An area of influence circular boundary 1208 directs the user's attention to the area being joined by the connector object 890a.

With reference to FIGS. 12C-12D, the CAD environment 304 shows the first connector object 890a of FIGS. 12A-B after being filled with virtual solder to the desired volume and a second connector object 890b being formed between the opposing surface of the center tooth-like object 1200b and third tooth-like object 1200c.

With reference to FIGS. 12E-12F, the CAD environment 304 comprises a lasso tool 1204 that measures the circumference in a desired plane of a selected object, such as a connector object 890 or tooth-like object 1212.

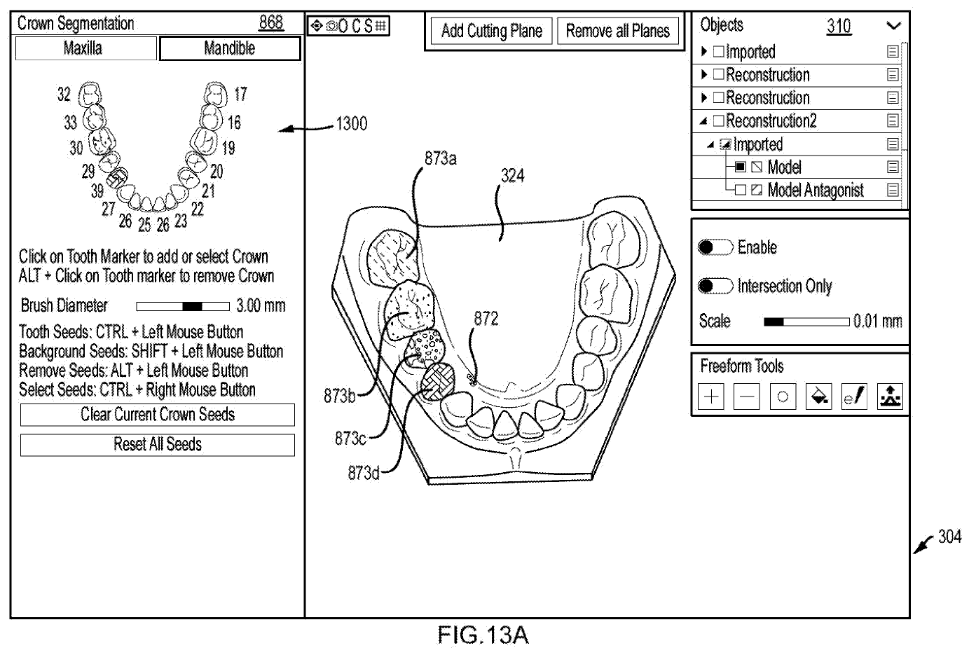

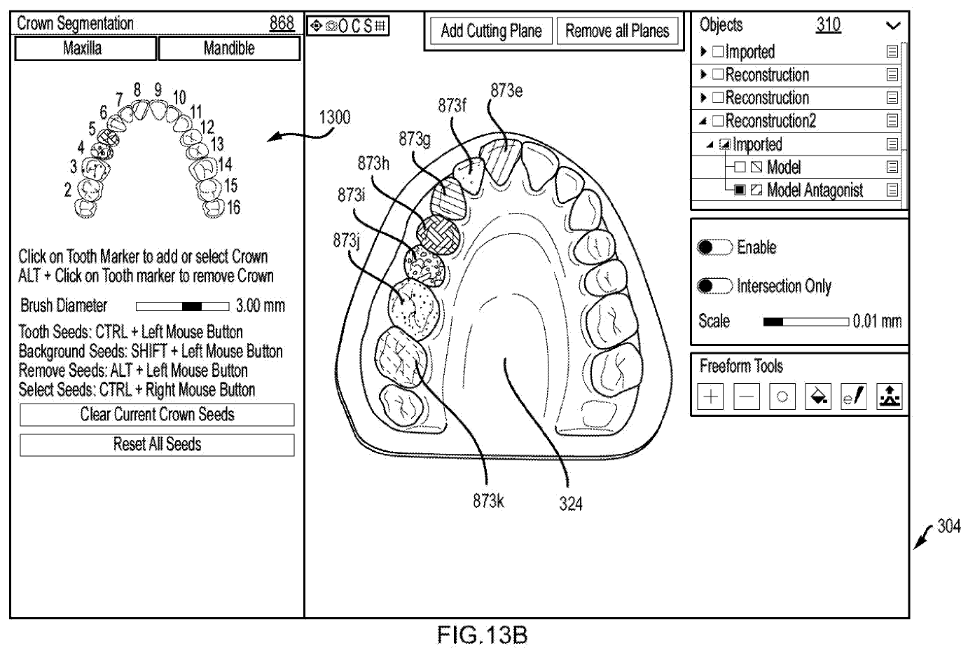

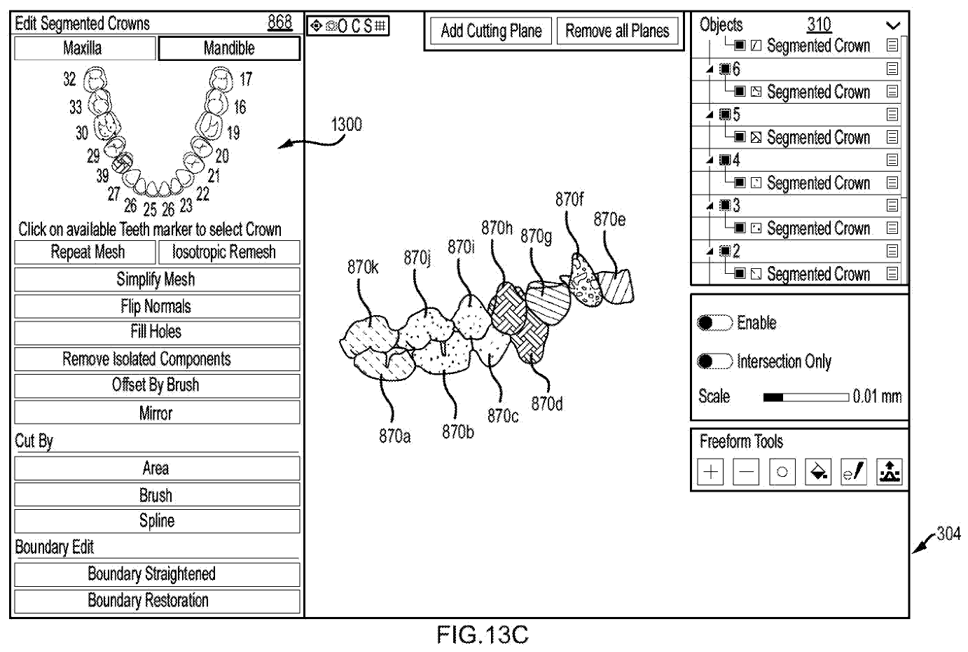

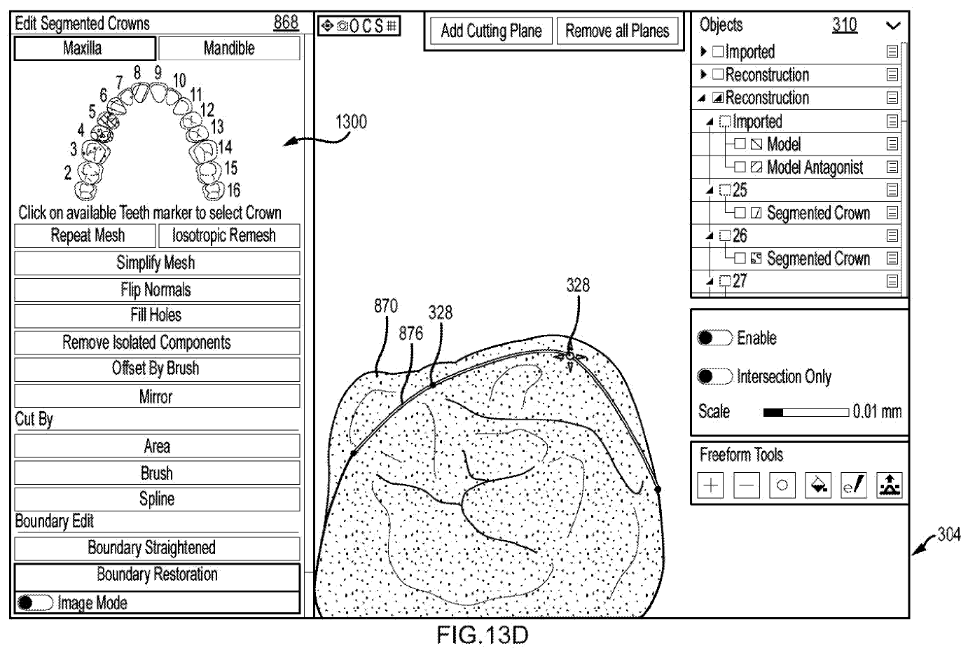

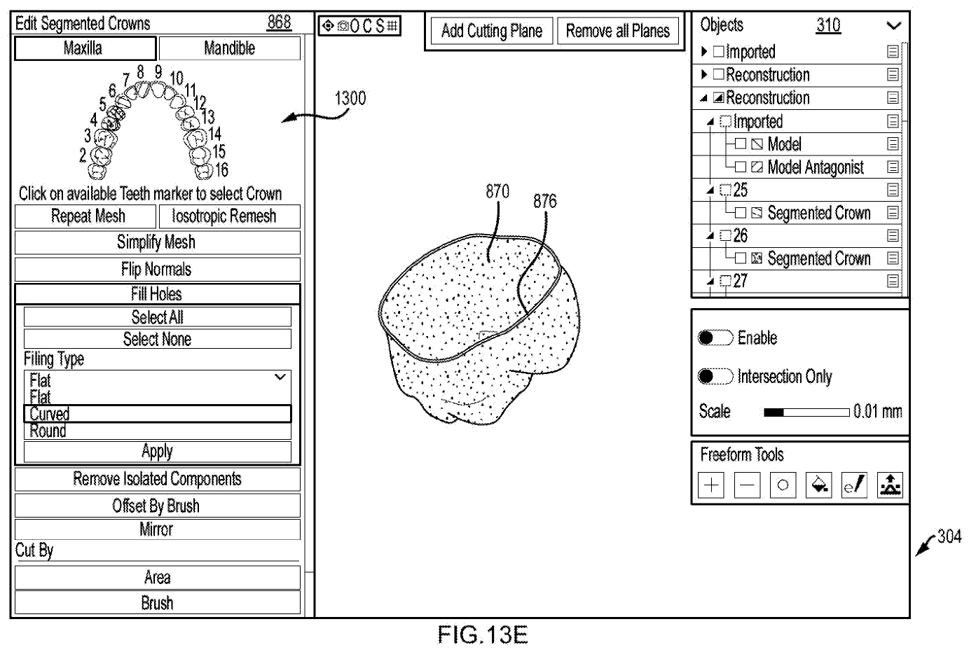

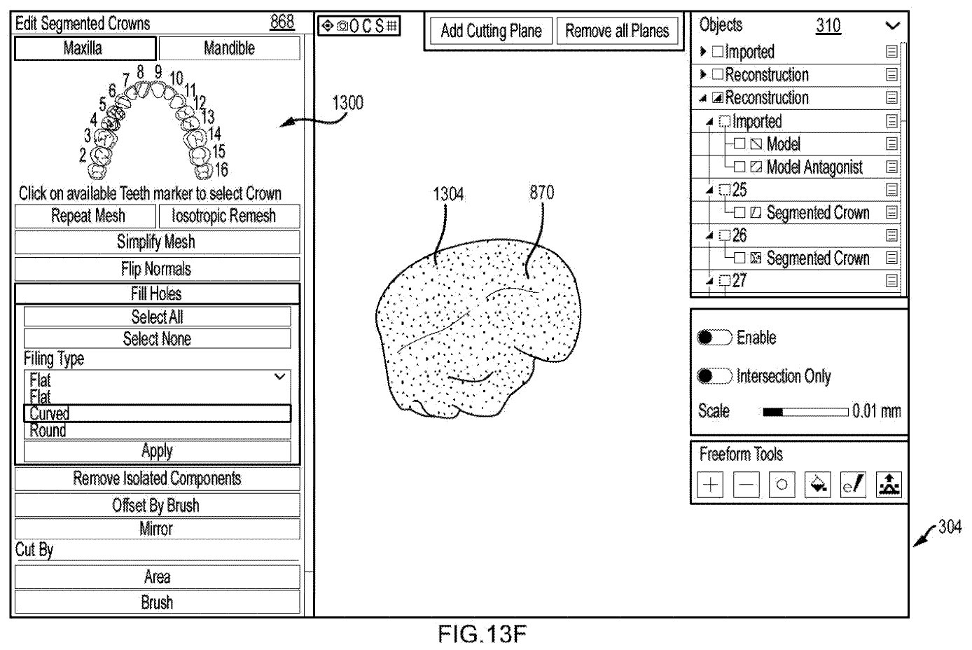

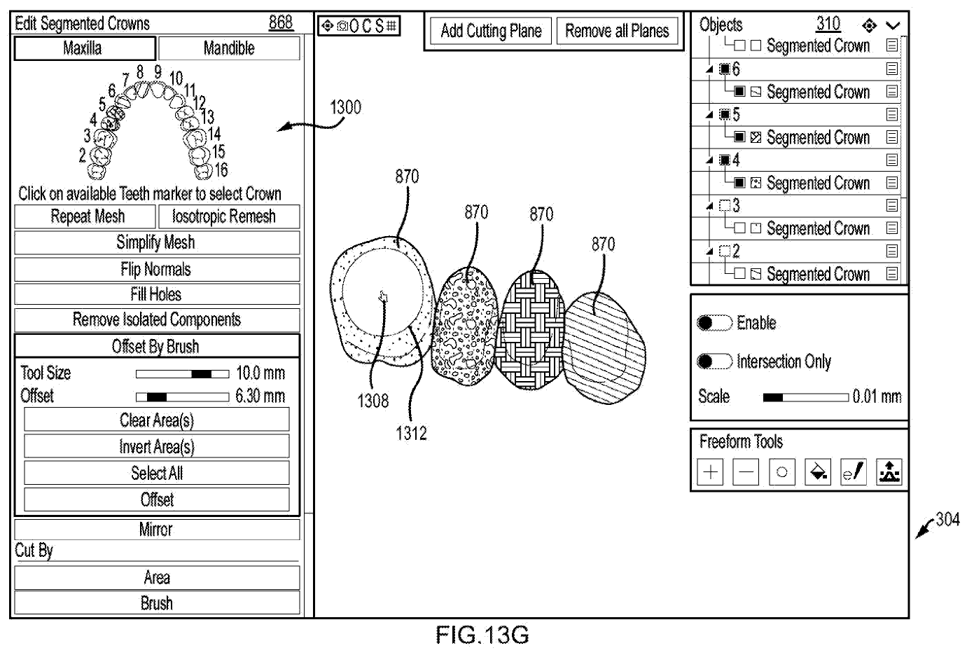

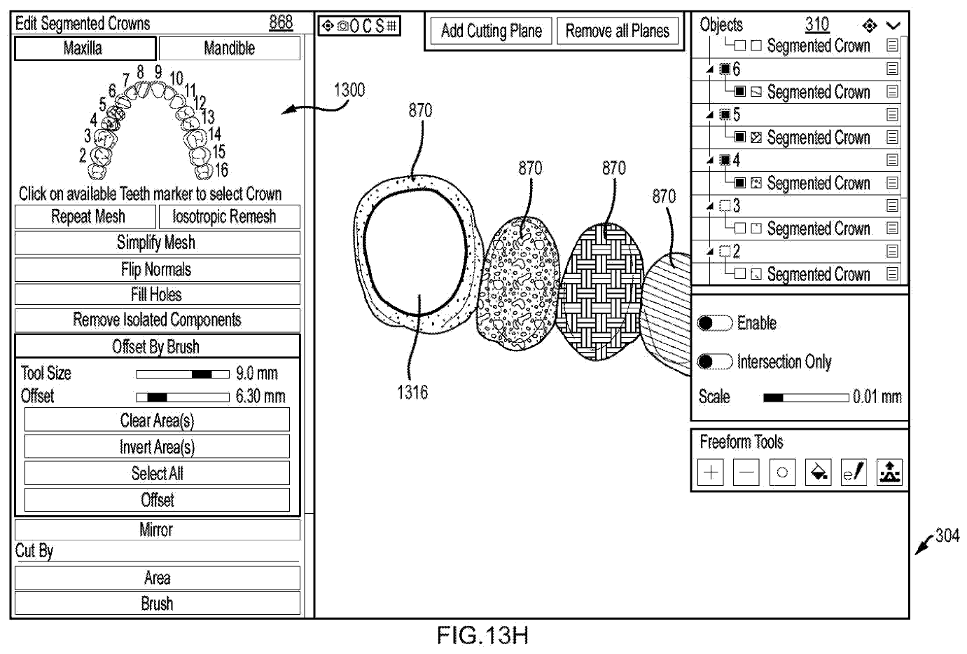

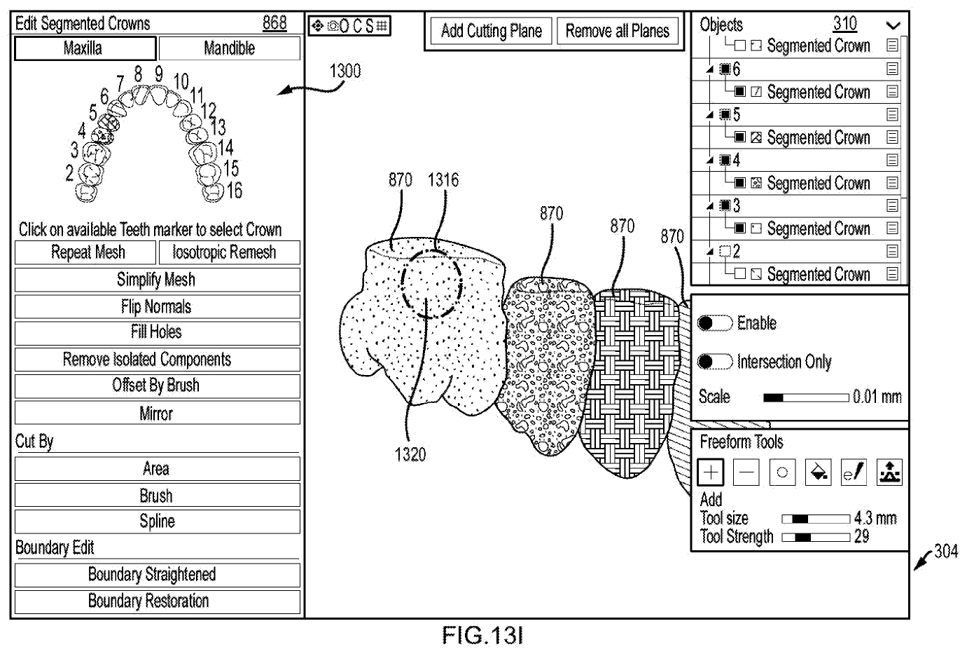

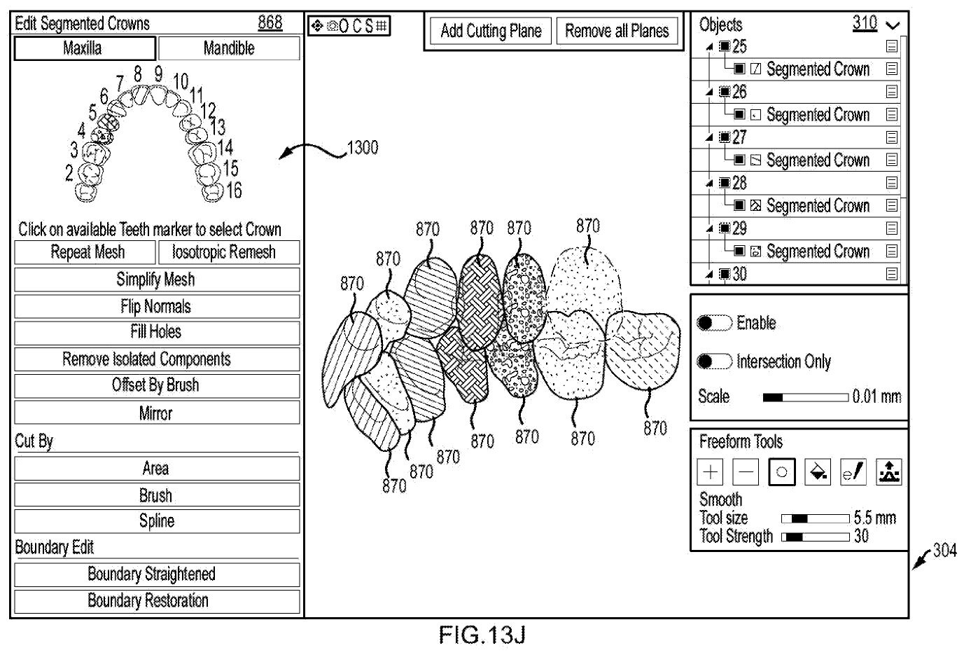

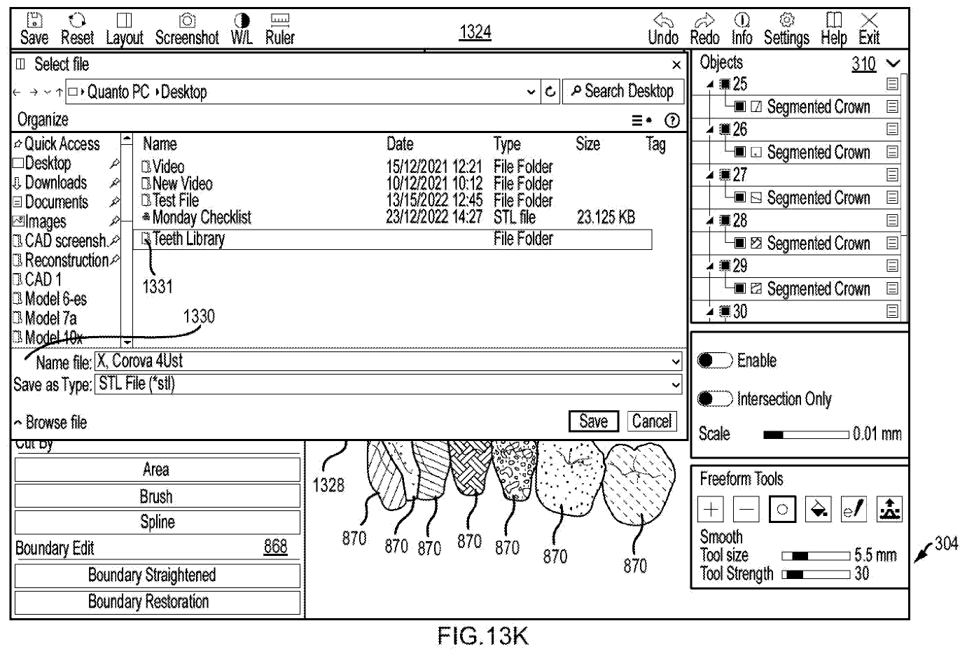

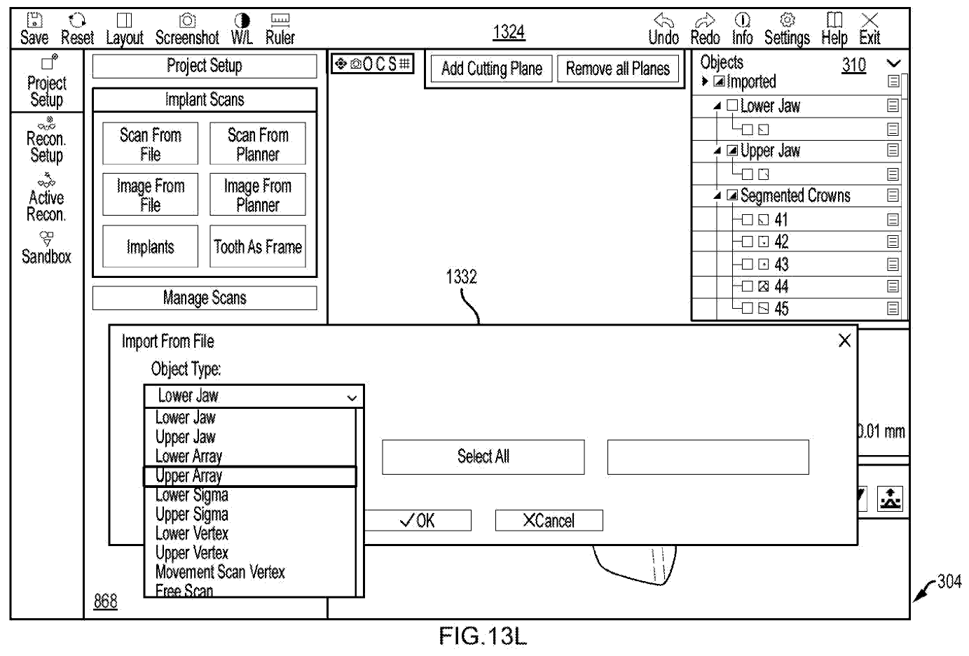

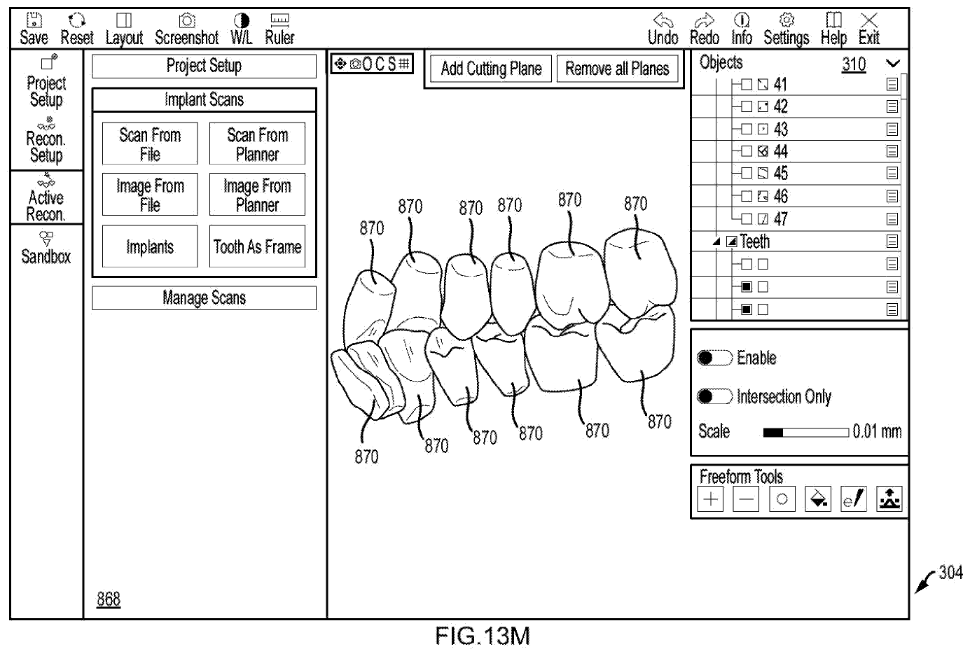

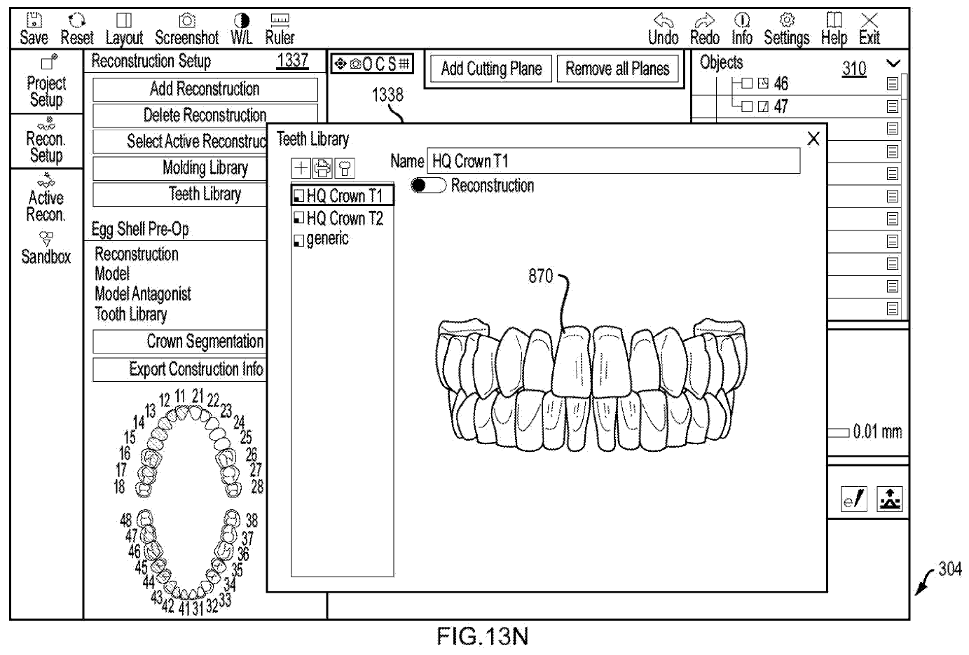

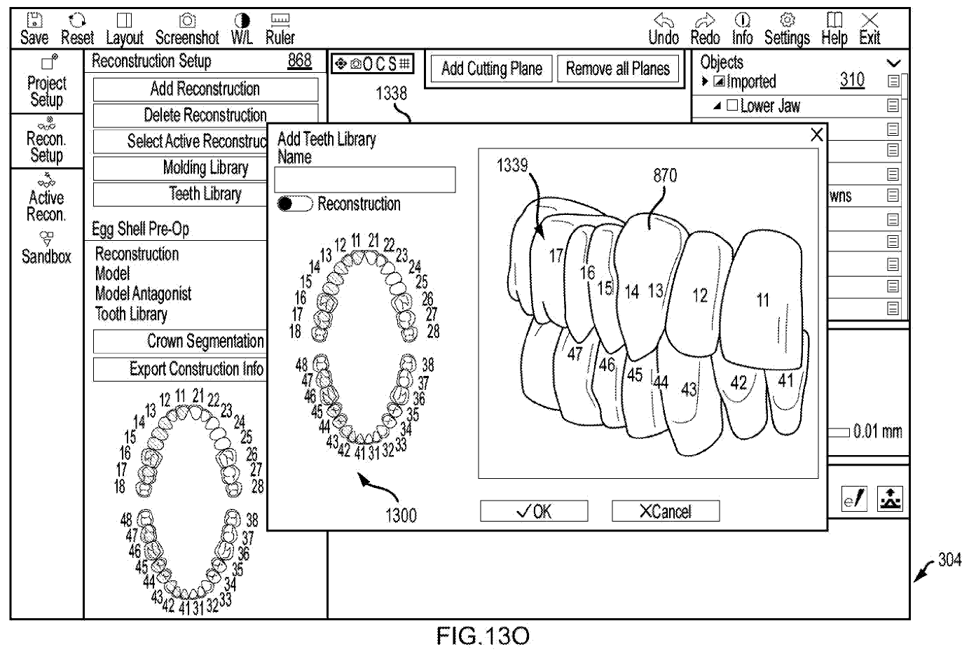

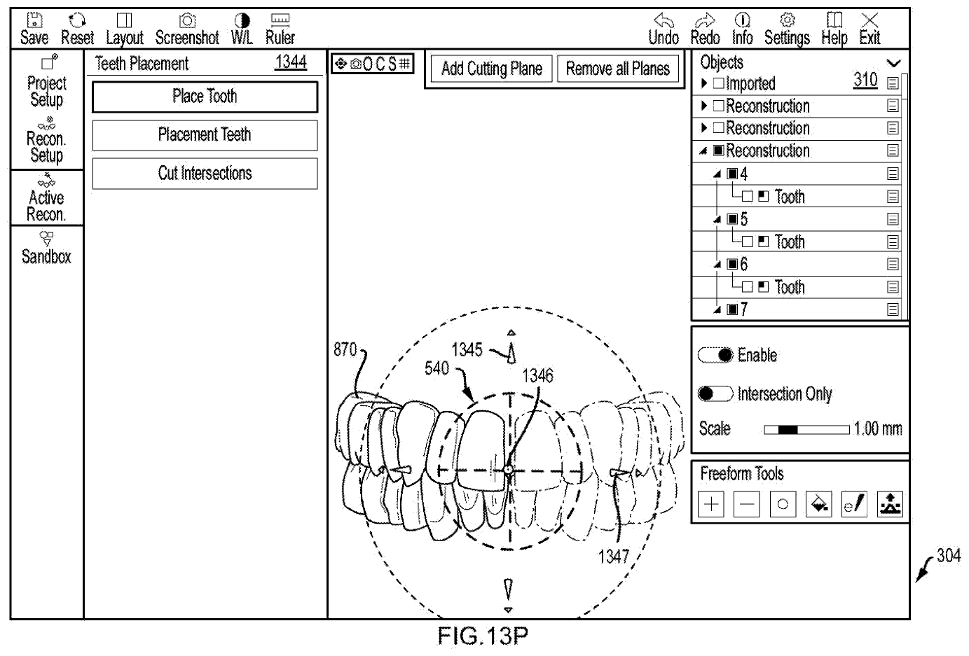

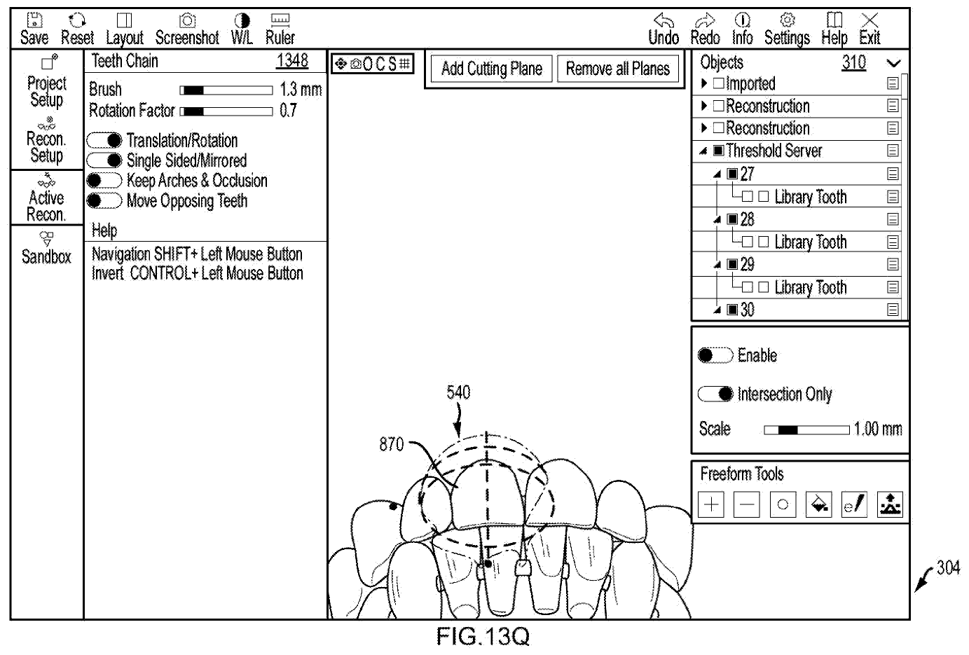

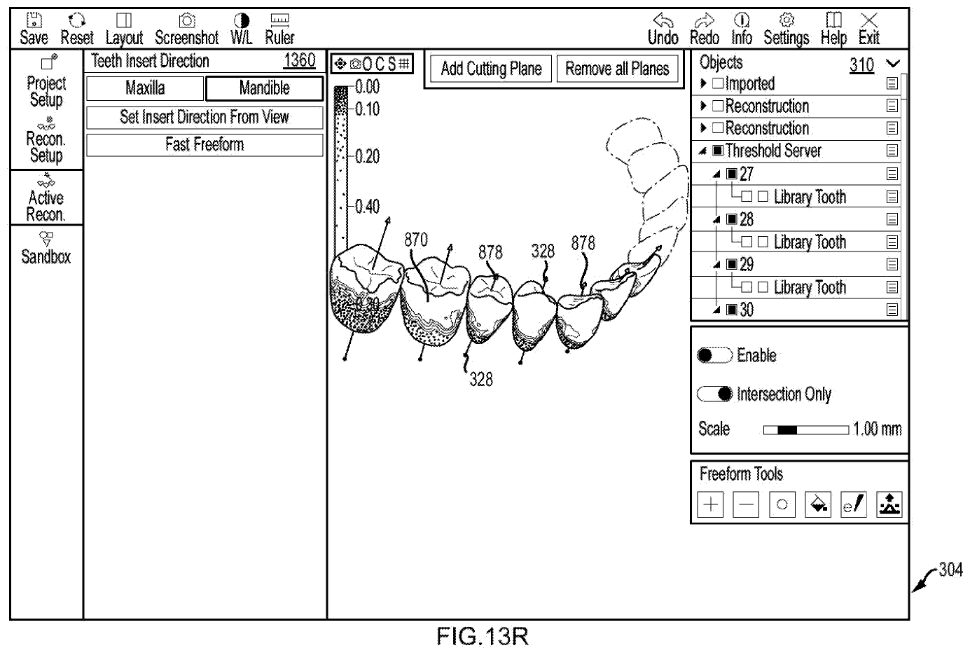

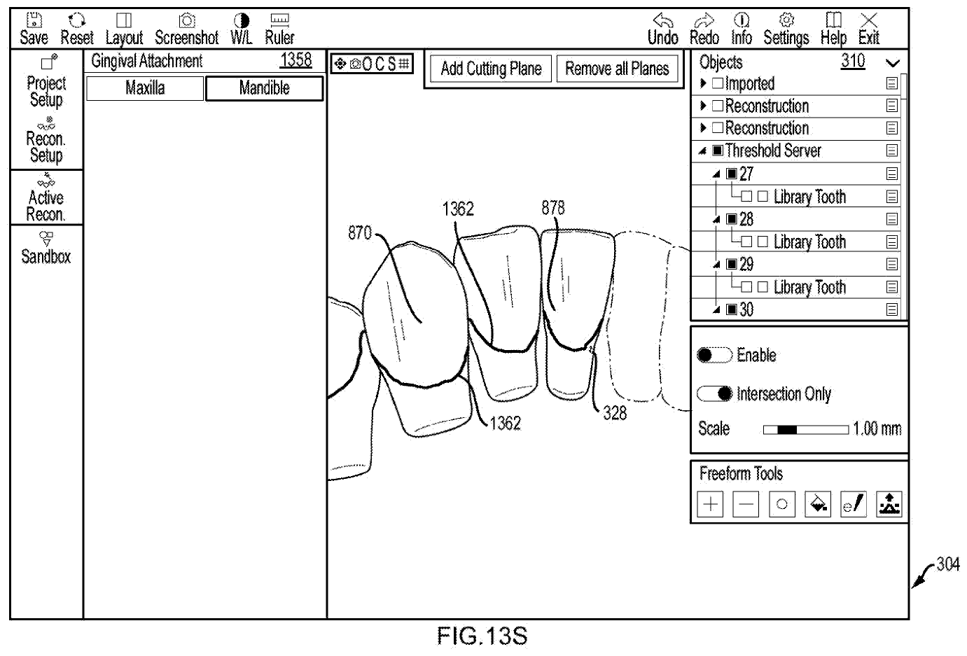

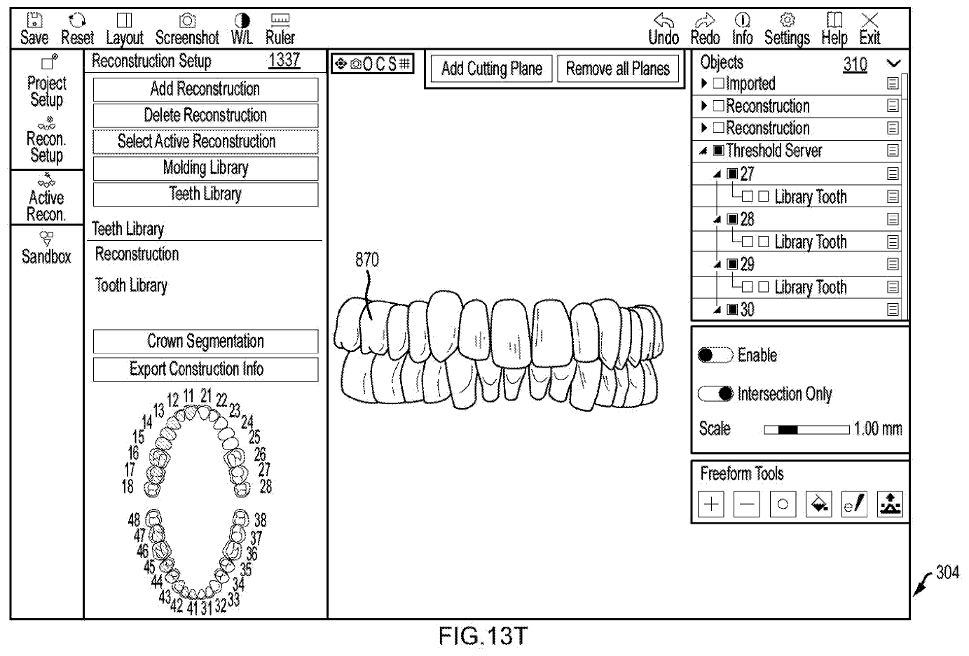

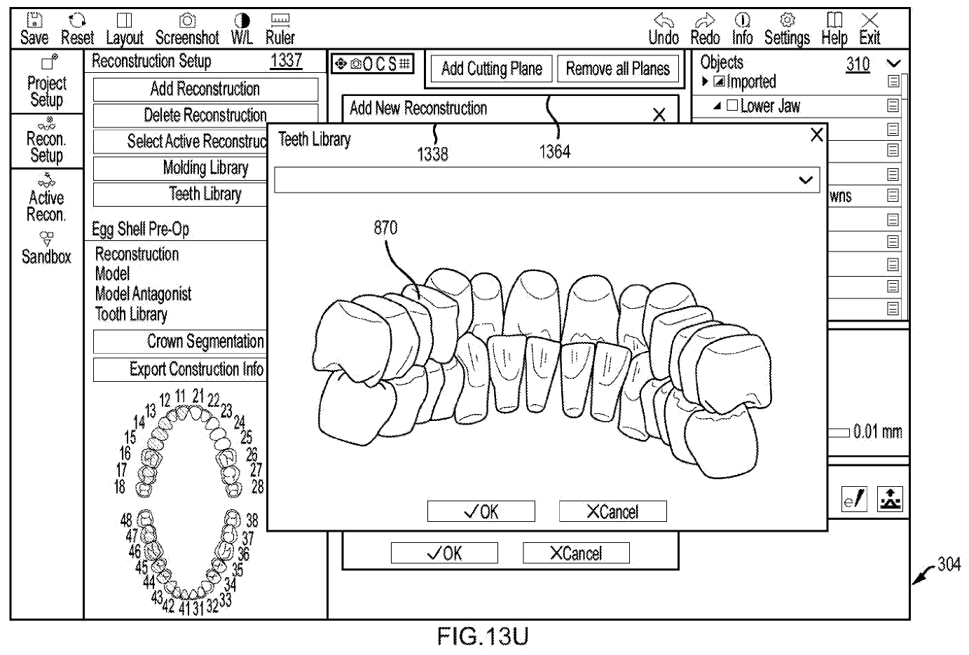

With reference to FIGS. 13A-13T, a CAD workflow that enables crown segmentation and crown occlusion. The crowns may be created by a data model through segmentation from oral scans or imaging information or imported into the workflow. The workflow can create a personalized customized library tool for a patient, care provider or other entity.

Referring to FIGS. 13A-B, the CAD environment 304 comprises the crown segmentation toolbar 848 that, as discussed above, includes tools to select a tooth-like object 873a-k on the fourth object 324 to serve as the basis to create and edit a crown object. The selection is done by the selector icon 872 that is used to select and/or define the areal extent and contours of the tooth-like object (which is typically above the patient's gingival margin) for automatic generation of a surface matching crown object. Once a tooth-like object 873 is selected and defined, a differently colored surface is used to define the crown as shown by the crown objects 870. The color on each tooth-like object 873 has a matching tooth of the same color on the arch representation 1300. FIG. 13A shows the CAD environment 304 for the mandible arch while FIG. 13B shows the CAD environment 304 for the maxilla arch.

With reference to FIG. 13C-J, the CAD environment 304 comprises the crown segmentation toolbar 868 that, as discussed above, includes tools to edit each crown object 870a-k corresponding to each selected tooth-like object 873a-k. The edit segmented crown toolbar includes tools to edit the crown objects 870 via one or more control points 328 including repair mesh, isotropic remesh, simplify mesh, flip normals, fill holes, remove isolated components, offset by brush, mirror, cut by area, cut by brush, cut by spline, boundary edit by boundary straightening, and boundary edit by boundary. The CAD environment 304 shows the user editing an edge 876 of the crown object 870.

The CAD environment 304 of FIG. 13D illustrates use of the boundary edit to adjust or modify the boundary or edge 876 of the crown object. As noted above, the boundary or edge typically corresponds to the gingival margin of the overdenture or patient oral cavity depending on the type of dental restoration.

The CAD environments 304 of FIGS. 13E-F illustrate use of the fill-type object controlled by a fill hole tool to fill the open lower end of the crown object to add a base surface 1304 adjust or modify the boundary or edge 876 of the crown object. As noted above, the boundary or edge typically corresponds to the gingival margin of the overdenture or patient oral cavity depending on the type of dental restoration. As will be appreciated, the added base surface 1304 can be done by merging the fill-type object with the crown object at the open lower portion of the crown object.

The CAD environments 304 of FIGS. 13G-I illustrate use of a surface offset-type object controlled by the offset by brush tool to delineate, by movement of a brush tool 1308, a bounded portion 1312 of a surface of the crown object 870 to convert into an elevated or raised surface 1316. This can be done by merging a surface offset-type object with the crown object at the bounded portion 1312. The CAD environment 304 of FIG. 13G illustrates use of a surface modification tool 1320 that modifies a degree of roughness or smoothness of a surface of the crown object 870.

The CAD environment 304 of FIG. 13J illustrates the resulting edited crown objects 870 corresponding to the mandible and maxilla arches.

Referring to FIGS. 13K-L, the CAD environments illustrate the use of an export and import tool to export the crown objects 870 for the maxilla arch to a library and import the crown objects for the maxilla arch from the library. The crown objects 870 can be a template or model from the model library 252 and in any file format with a stereolithography or STL binary file format being an example. As shown by drop down menu 1328, the selected crown objects are assigned a file name 1330 and saved in a folder 1331 corresponding to a library, and as shown by drop down menu 1332 in FIGS. 13L-M, the selected crown objects are imported from the library when needed. The crown objects can be associated in the library with a patient, care provider, case, or other identifier.

In some embodiments, the library is used for training data for the data models. As will be appreciated, the dental restoration models in the training data can be used to teach the self-learning, artificially intelligent data models how to make predictions regarding a most suitable restoration for a specific patient's oral conditions, recognize patterns such as treatment preferences for a specific care provider, or otherwise generate content. The library models can be labeled or unlabeled depending on the application. The training data can teach the data models not only how to match an existing dental restoration from one patient to another patient having similar oral characteristics but also how to select and combine dental restoration components from dental restorations to target different problems or issues in a given patient's oral characteristics.

Referring to FIG. 13N, a CAD environment includes a reconstruction setup toolbar 1337 comprising tools for adding or deleting a reconstruction, selecting an active reconstruction, accessing a milling library, accessing a teeth library, crown segmentation to access the crown segmentation toolbar, and export construction information. Selecting the teeth library access tool provides a library window 1338 displaying images of the crown objects 870 in the library corresponding to the patient, care provider, case or other identifier. As shown in the CAD environment of FIG. 13O, selection of the export construction information tool opens a window 1338 enabling the user to add the crown objects to the teeth library with each crown object having the corresponding tooth number 1339 of the tooth position in the rendering of the mandible and maxilla arches 1300.

With reference to FIG. 13P, the CAD environment 304 comprises a teeth placement toolbar 1344 that provides mirror teeth, placement, and cut intersection tools. Selection of the mirror teeth tool causes a center or cut plane 1345 of the maxilla and mandible arches to be rendered along with rotation handles 540 to enable the crown objects on either side of the center or cut plane to be rotated about the center 1346 or otherwise displaced in the direction of any of the four arrows 1347 relative to one another in one, two or three dimensions.

With reference to FIG. 13Q, the CAD environment 304 comprises a teeth chain toolbar 1348 to adjust a reach or rotation factor magnitude or tools to translate or rotate, single-sided mirrored, keep arches in occlusion, and move opposing teeth. The CAD environment 304 includes rotation handles 540 to rotate or translate the selected crown object 870 relative to the adjacent crown objects.

With reference to FIG. 13R, the CAD environment 304 comprises a teeth insert direction toolbar 1360 that provides tools, such as one or more control points 328 to adjust the position of the longitudinal or insertion axes 878 of each of the crown object 870 and therefore of the corresponding crown object 870.

With reference to FIG. 13S, the CAD environment 304 includes a gingiva attachment toolbar 1358 comprising one or more control points 328 to adjust the position of the gingiva boundary 1362 on each crown object 870.

Referring to FIGS. 13T-U, the CAD environments 304 include the reconstruction setup toolbar 1337. Selecting the add reconstruction tool provides the library window 1338 displaying images of the crown objects 870 in the library corresponding to the patient, care provider, case or other identifier.

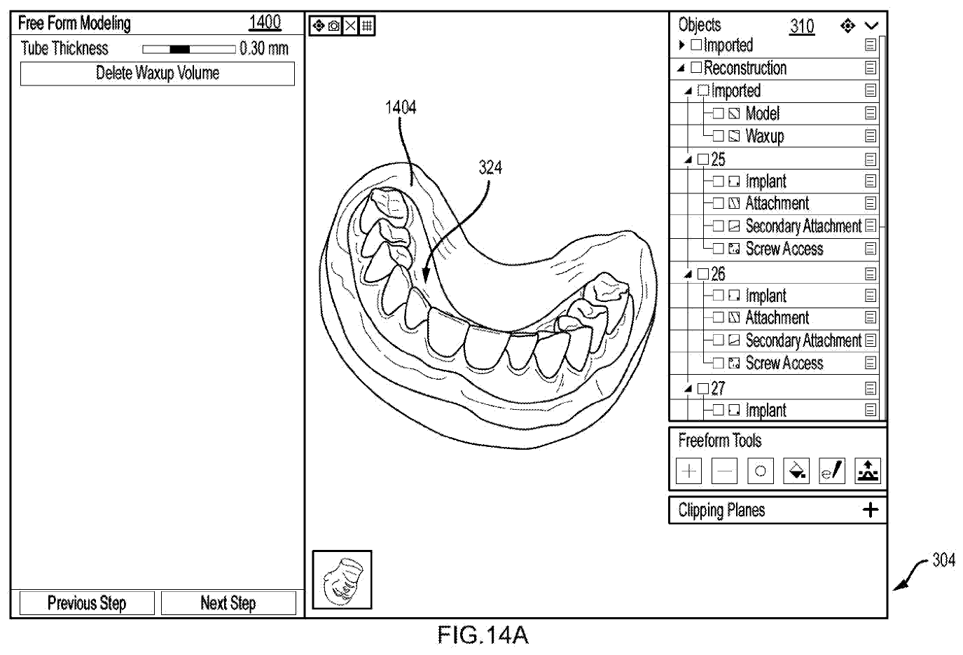

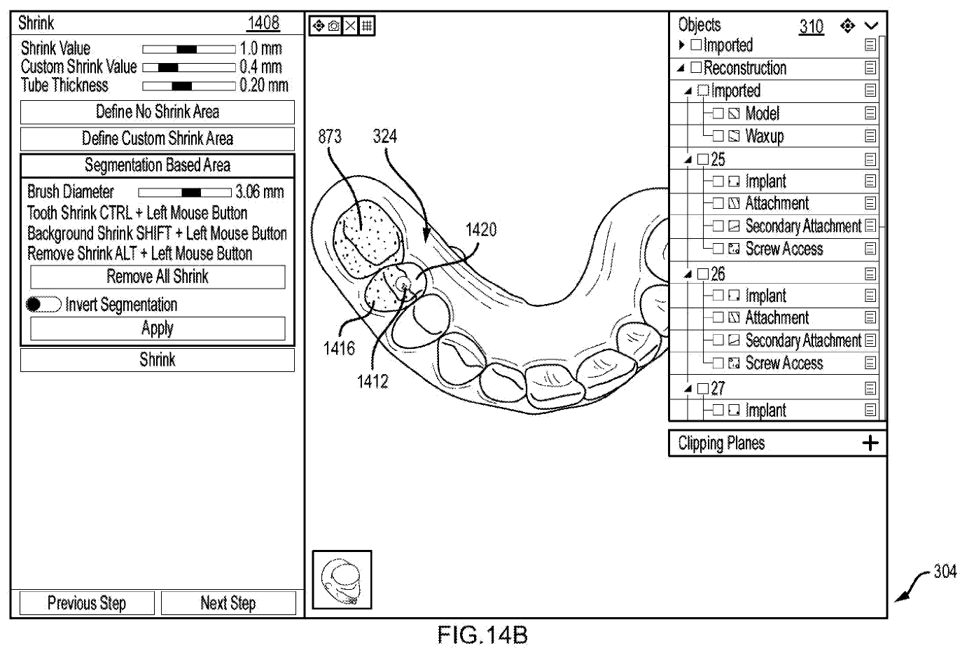

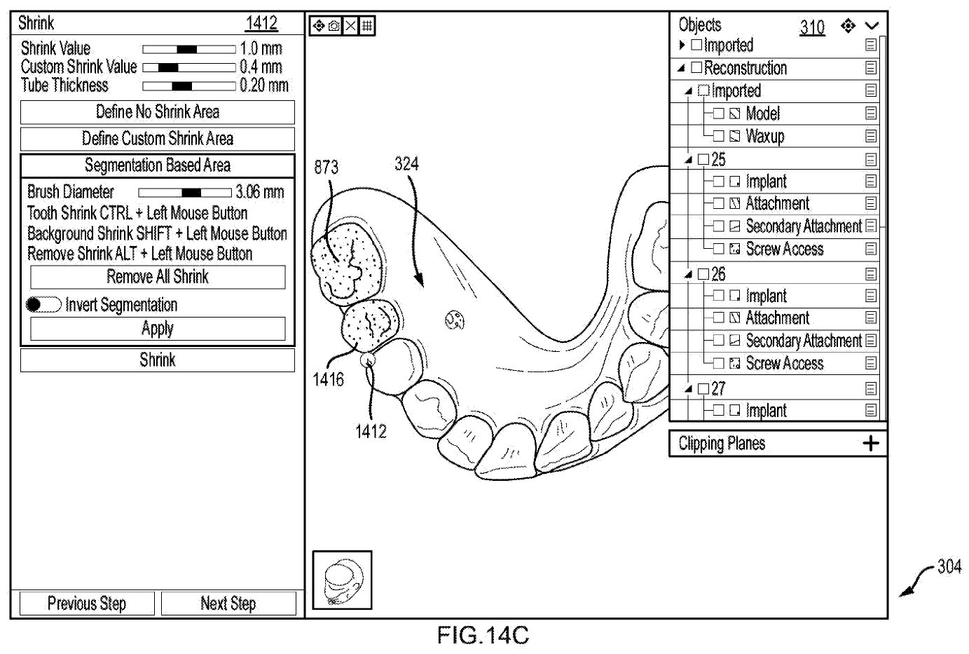

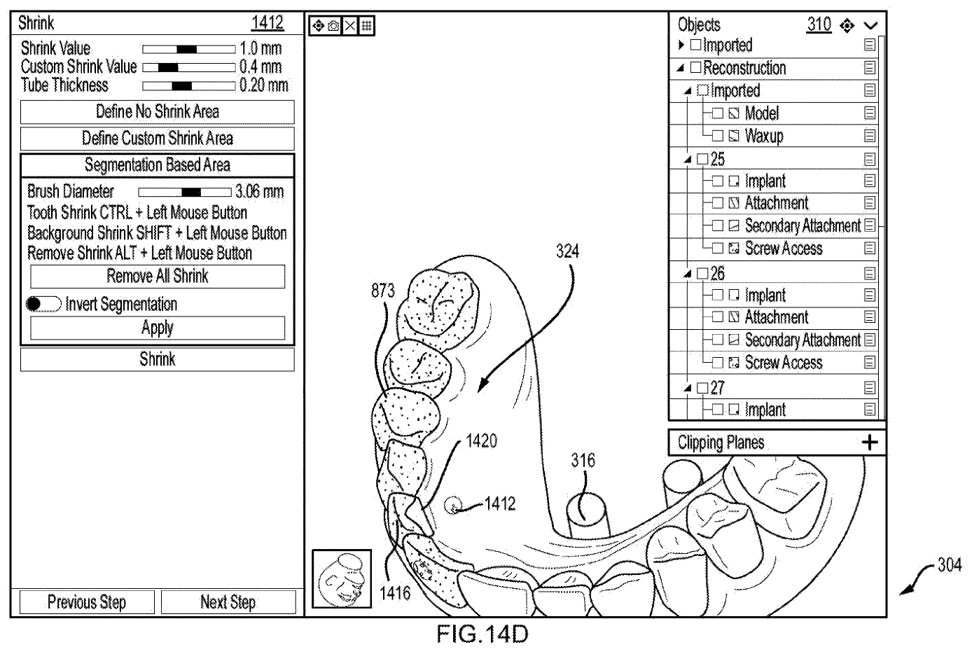

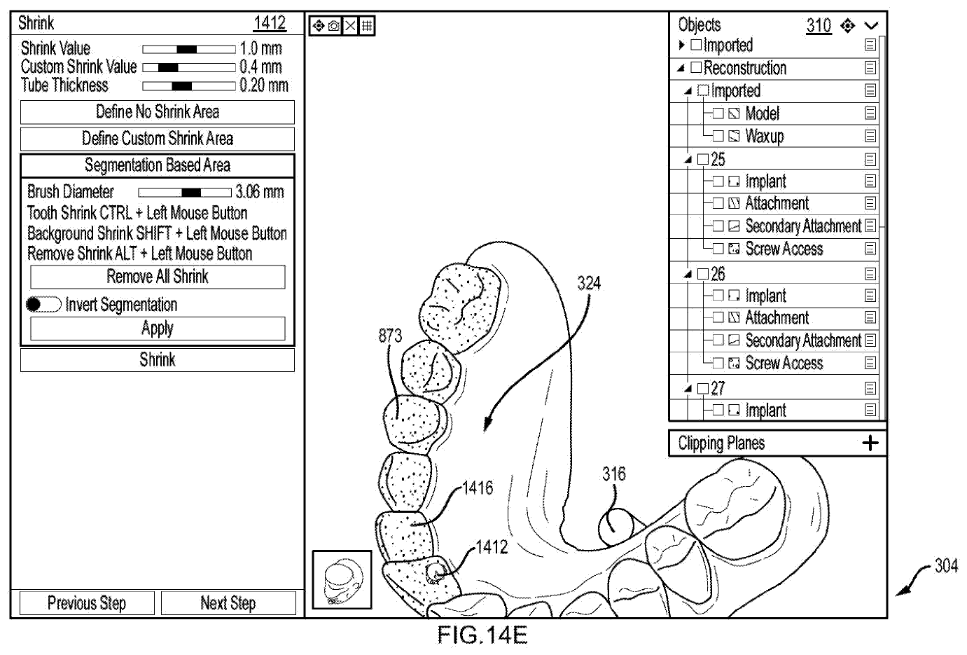

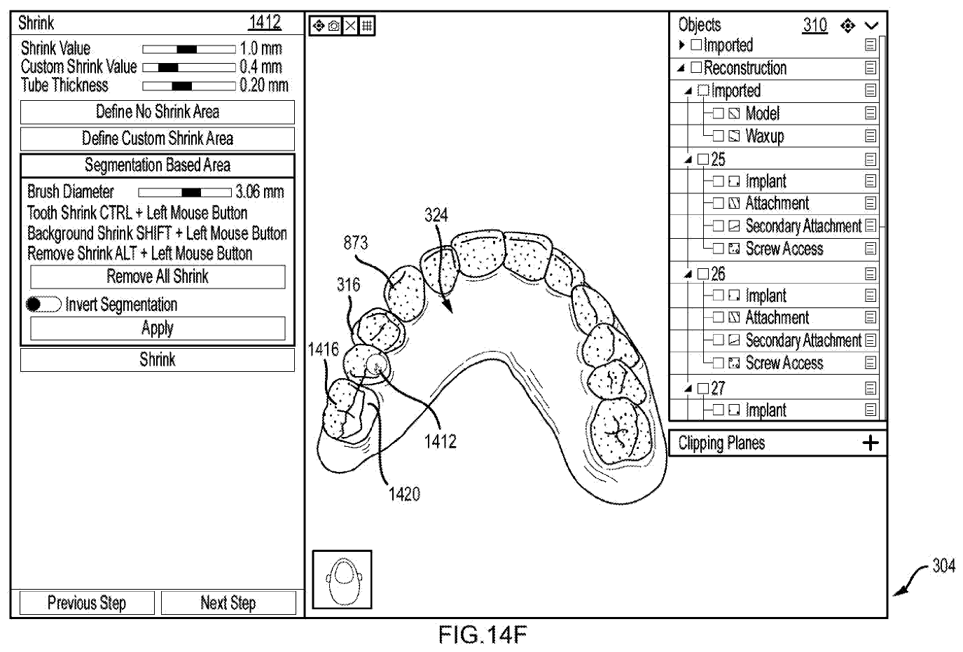

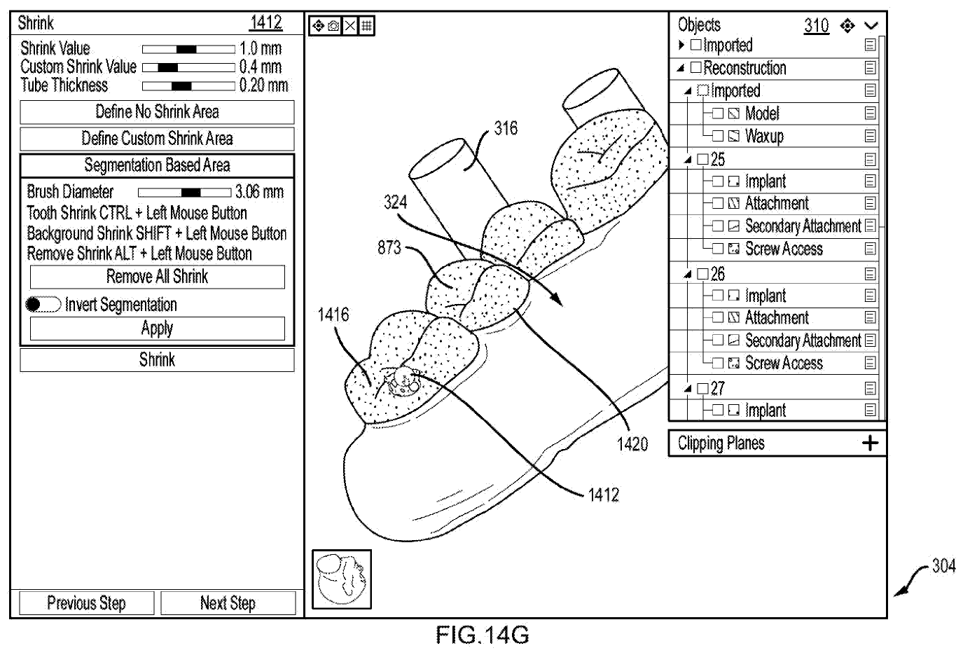

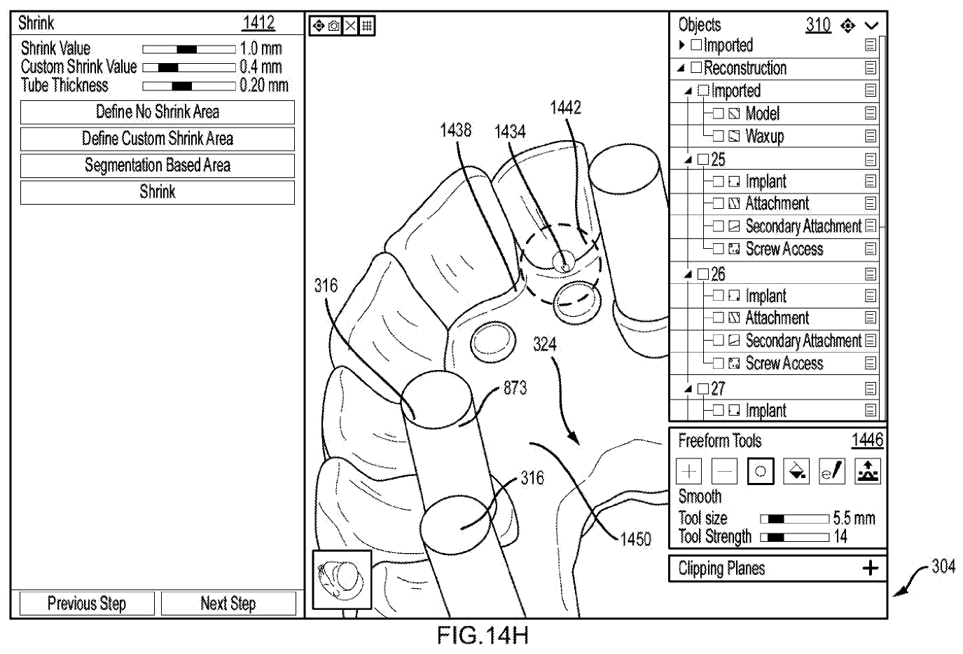

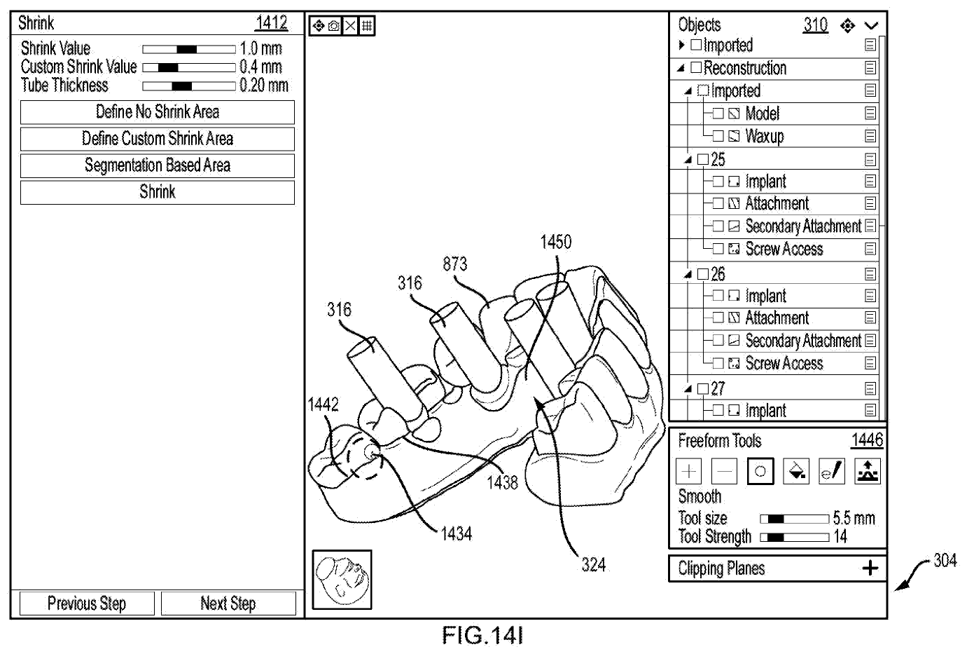

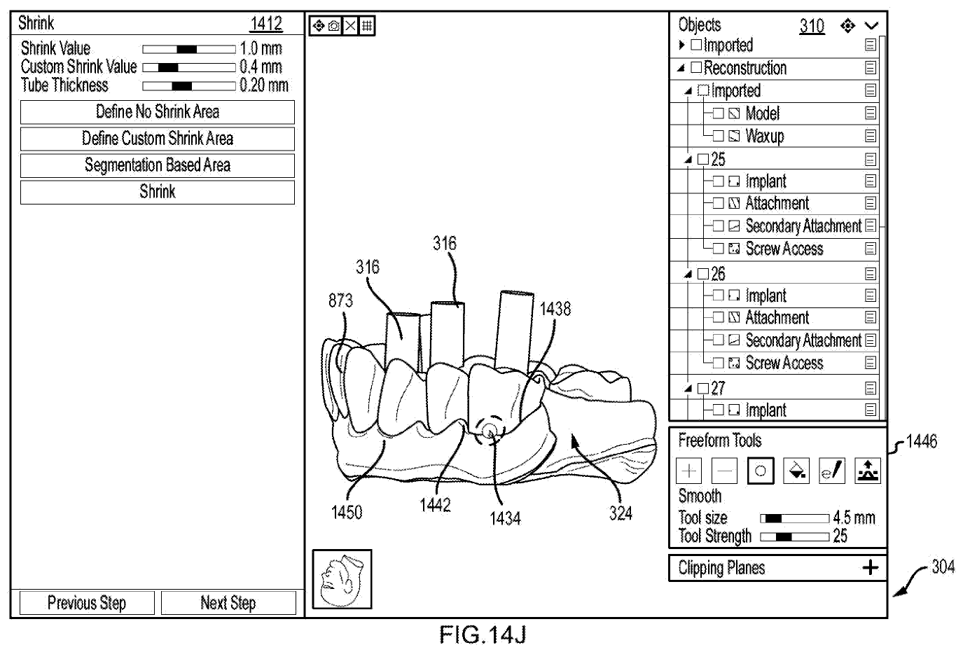

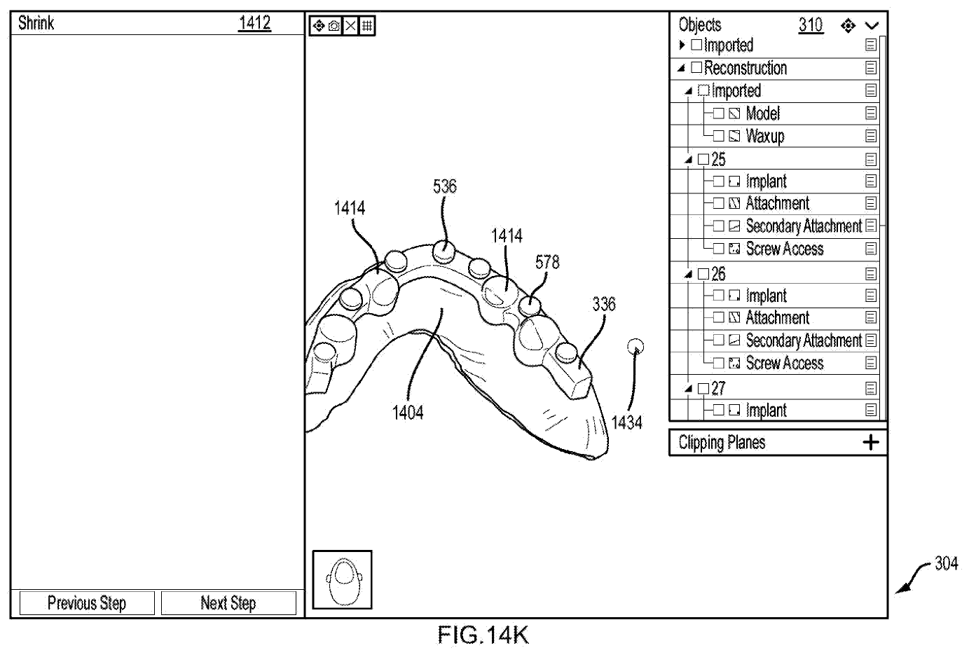

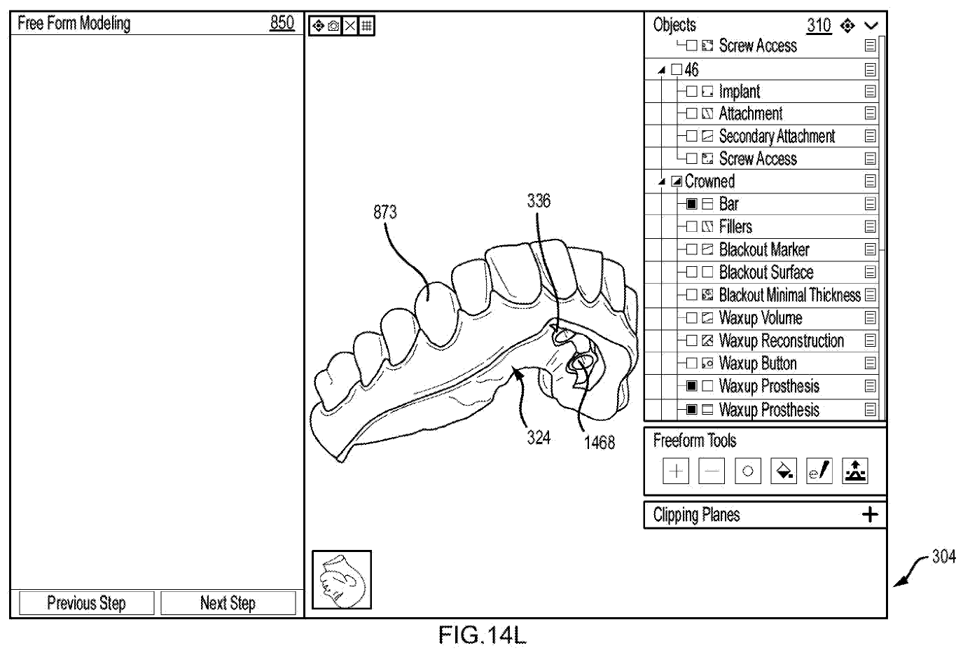

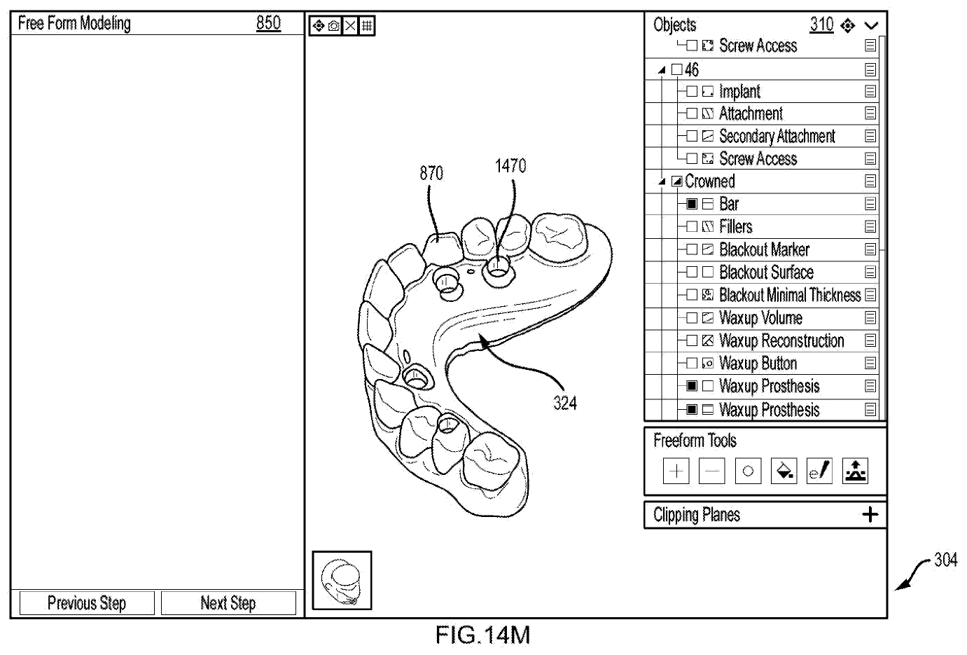

With reference to FIGS. 14A-M, a CAD workflow that enables reduced protection areas by a combination of segmentation and brush painting is provided. The CAD workflow can enable preservation or configuration of the margin or boundary between the gingiva and tooth-like object.

With reference to FIG. 14A, a CAD environment 304 includes a waxup volume toolbar 1400 comprising tools that enable display of the waxup object 1404. As will be appreciated, the waxup object 1404 corresponds to a wax-up that is a three-dimensional model of a patient's oral cavity or mouth taken from impressions, thereby making it an exact replica of the patient's oral cavity (e.g., teeth and gingiva. This allows the care provider to see what procedures may be required and how the dental restoration will look upon completion. In the present case, the waxup object engages a dental restoration or fourth object 324 engaged with the waxup object as discussed in more detail below.

With reference to FIGS. 14B-14G, various CAD environments 304 are depicted. Each CAD environment 304 includes a shrink toolbar 1408 (described above in connection with FIG. 10B) comprising tools for setting shrink values, custom shrink values, and tube thickness, define a shrink area, define a custom shrink area, define a segmentation base area, and cause the shrinkage value to be effected in the displayed dental restoration or fourth object 324. When the define segmentation base area tool is selected, the target surface indicator 1412 can indicate a surface or object to be highlighted by the segmentation algorithm to define a highlighted object portion 1416 for extraction to define a crown object as described above. Any surface portion that is not highlighted, such as unhighlighted object portion 1420, can be identified by the target surface indicator 1412 and converted into a highlighted object portion 1416. Any error in the highlighted object portion 1416, such as failing to highlighted a portion 1420 of the target object or highlighting a portion of a different untargeted object such as the surrounding gingival surface can be corrected by using the target surface indicator 1412 as a brush to paint or highlight the missing unhighlighted portion 1420 or as an eraser to erase or unhighlight any improperly highlighted portion.

With reference to FIGS. 14H-14J, a freeform tool 1446 (with user selectable values for tool size and strength) provides a gingival margin modifier 1434 that modified the transition or gingival margin between a tooth-like object 873 and the gingival surface 1450. The gingival margin modifier 1434 can increase a degree of smoothness or roughness in the gingival margin. This is shown by the gingival margin modifier 1434 converting a roughened gingival margin segment 1442 into a smoother gingival margin segment 1438.

With reference to FIG. 14K, the waxup object 1404 is shown in engagement with the prosthetic object 336 in the form of a bar structure to attach the dental restoration 324 to the waxup object (which represents the patient's guns in a full dental restoration). The prosthetic object comprises attachment member objects 536 and/or locator member objects 578 depending on the application. As noted above, the cylindrical objects 1414 each represent mechanisms to attach to an implant (not shown) in the patient's jaw. The CAD environment 304 of FIG. 14L shows the underside of the dental restoration or fourth object 324 showing the prosthetic object 336 including the implant attachment mechanisms 1468. The CAD environment 304 of FIG. 14M shows the top of the dental restoration or fourth object 324 showing the access holes 1470 to access the implant attachment mechanisms 1468 and underlying implants (not shown).

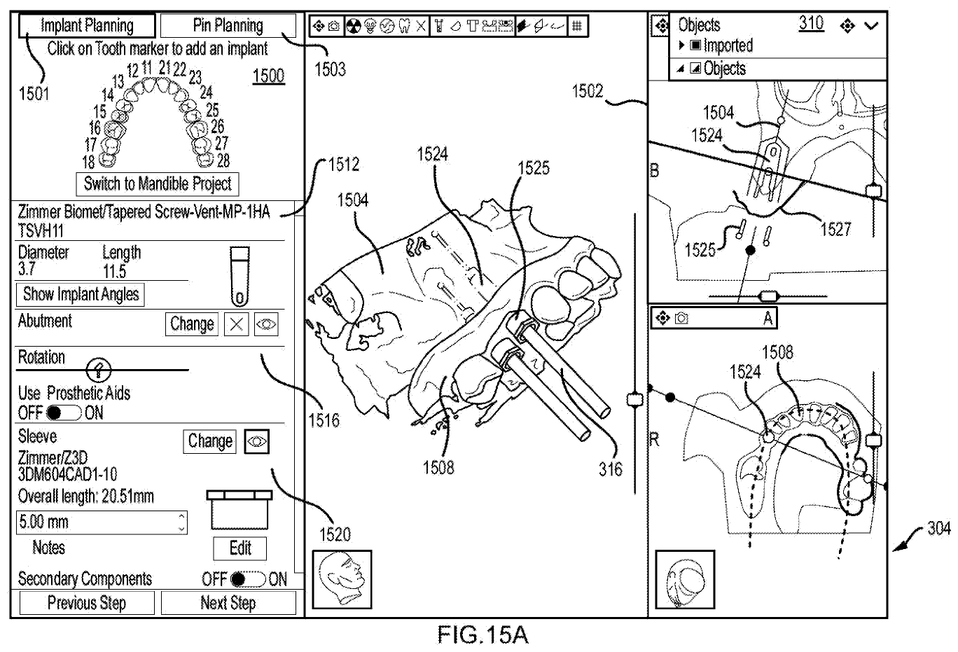

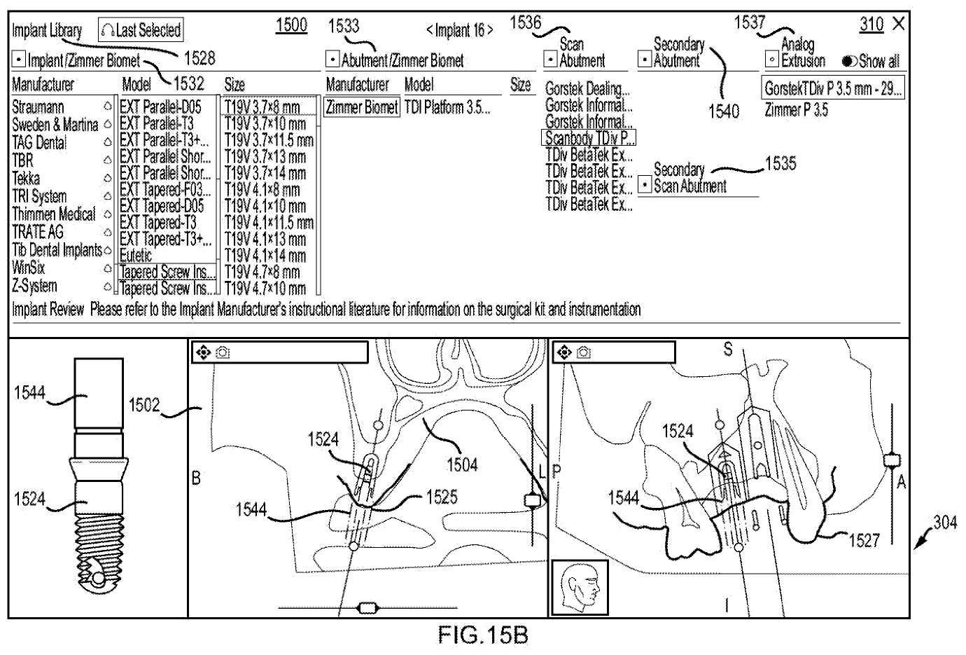

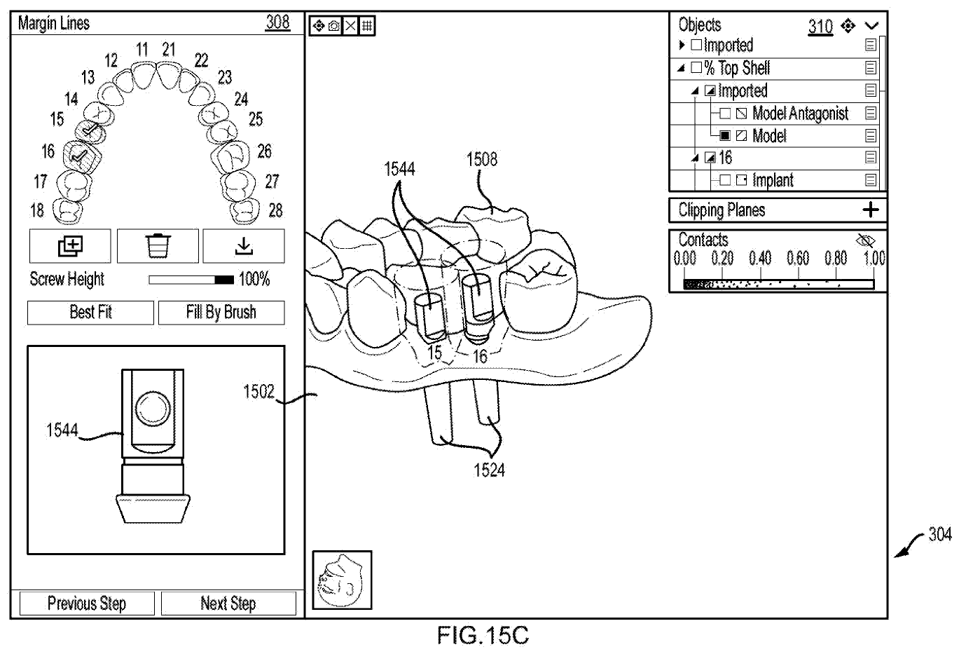

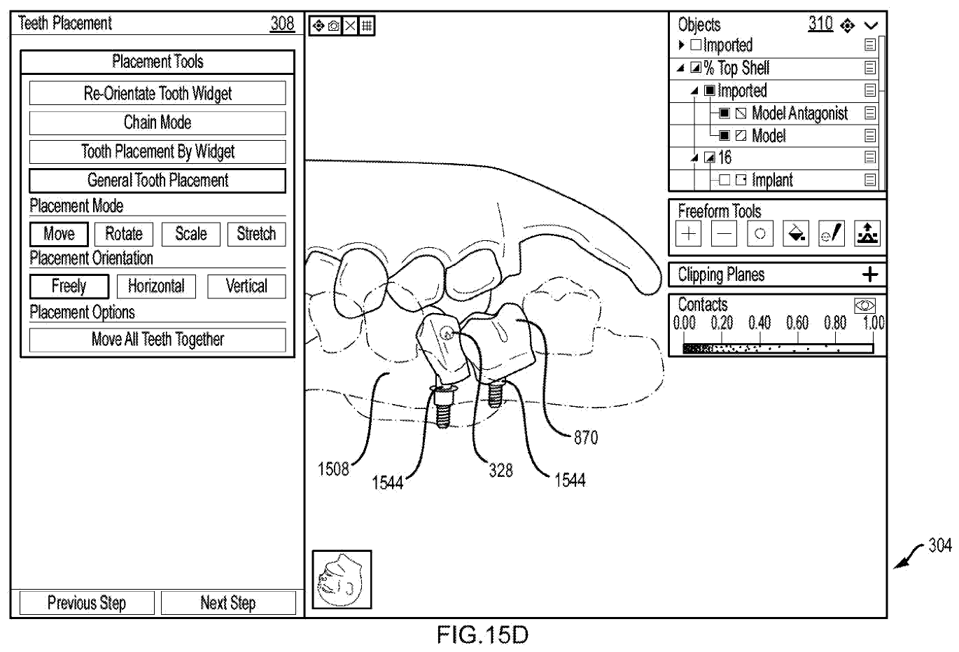

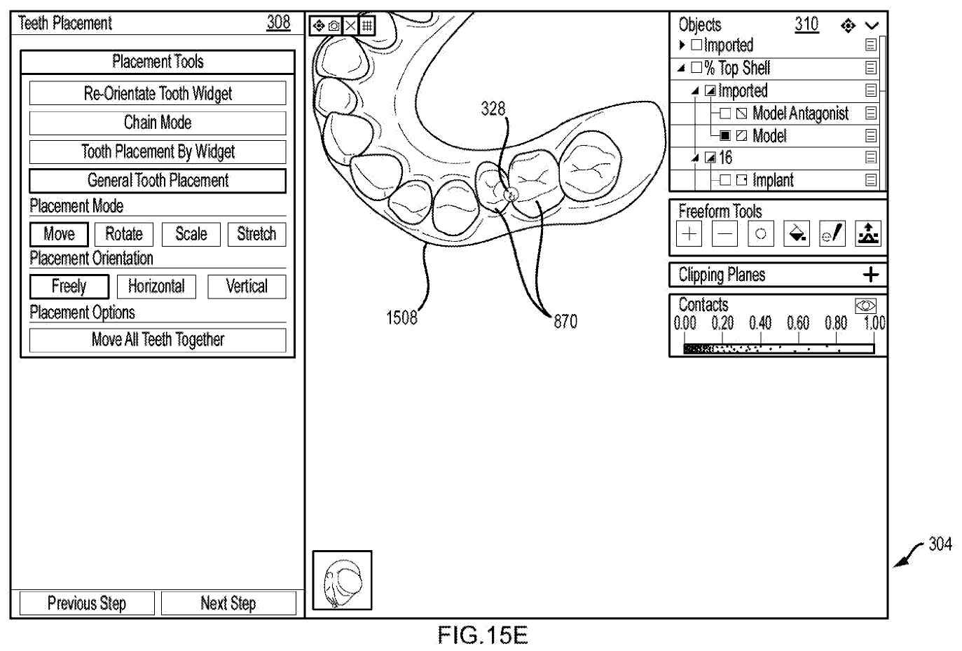

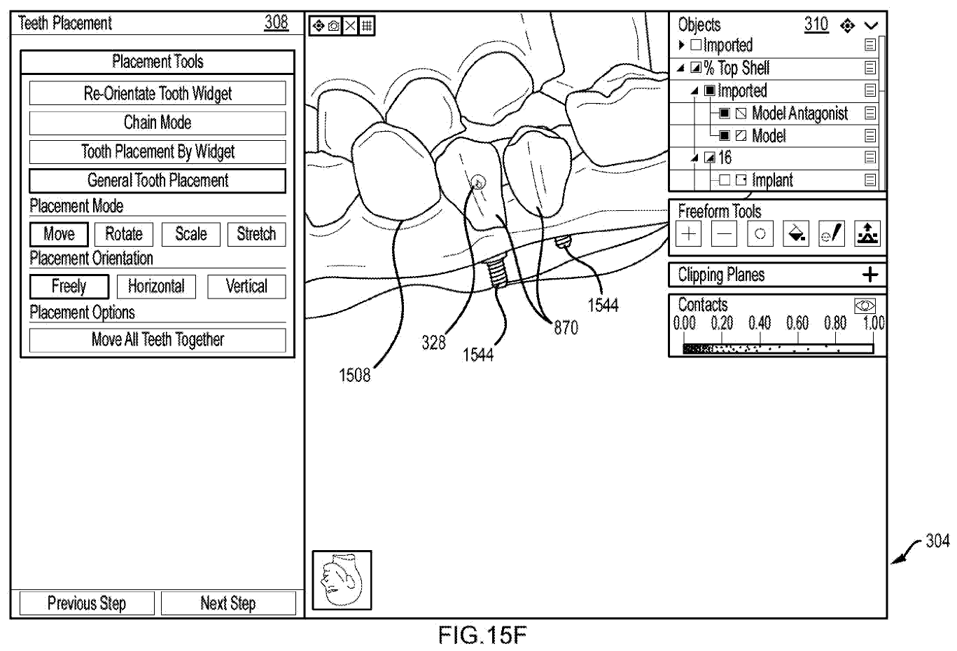

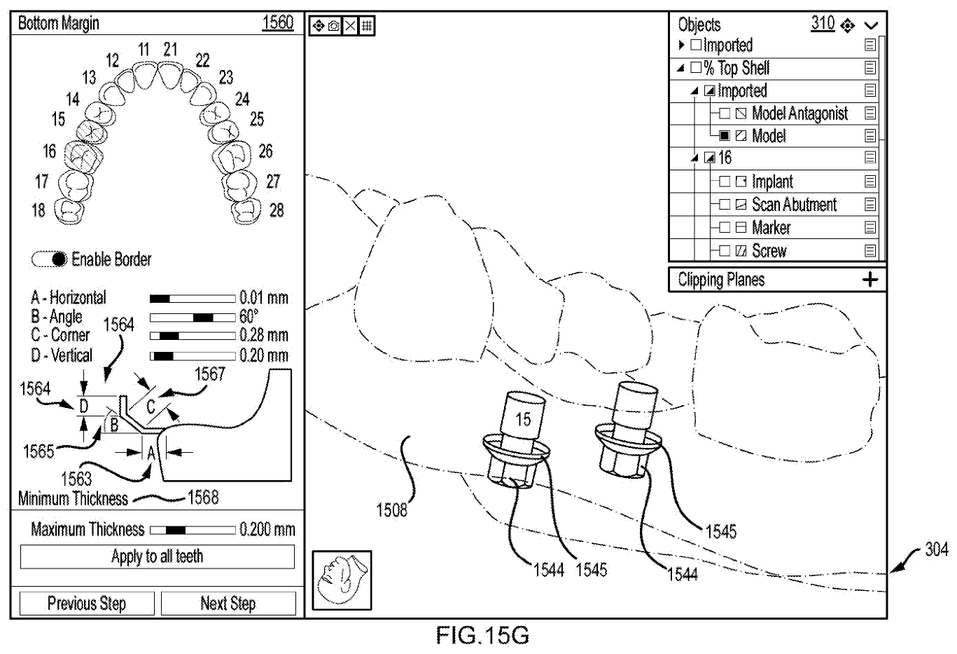

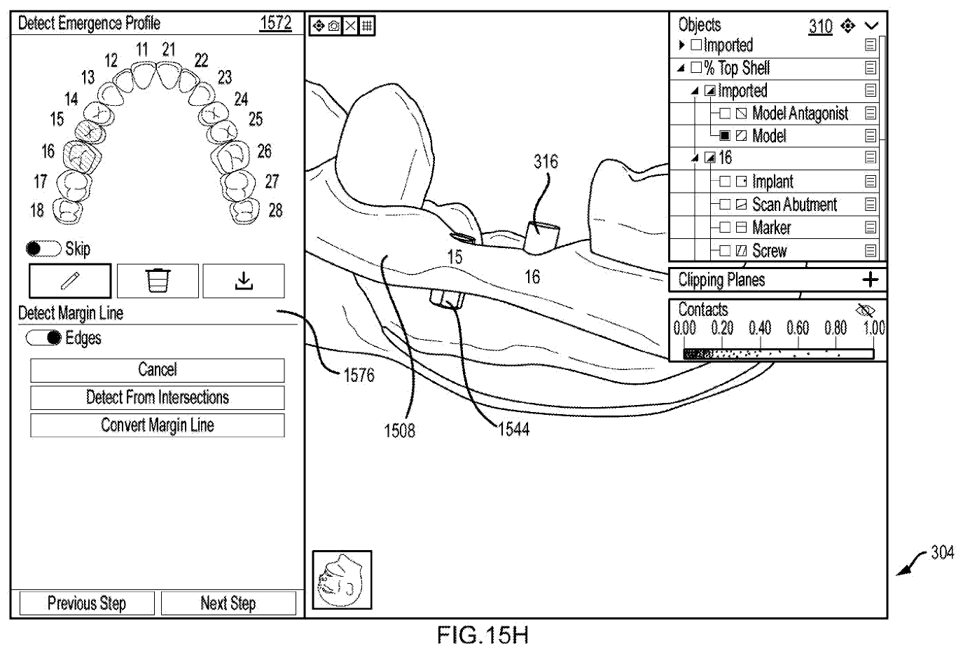

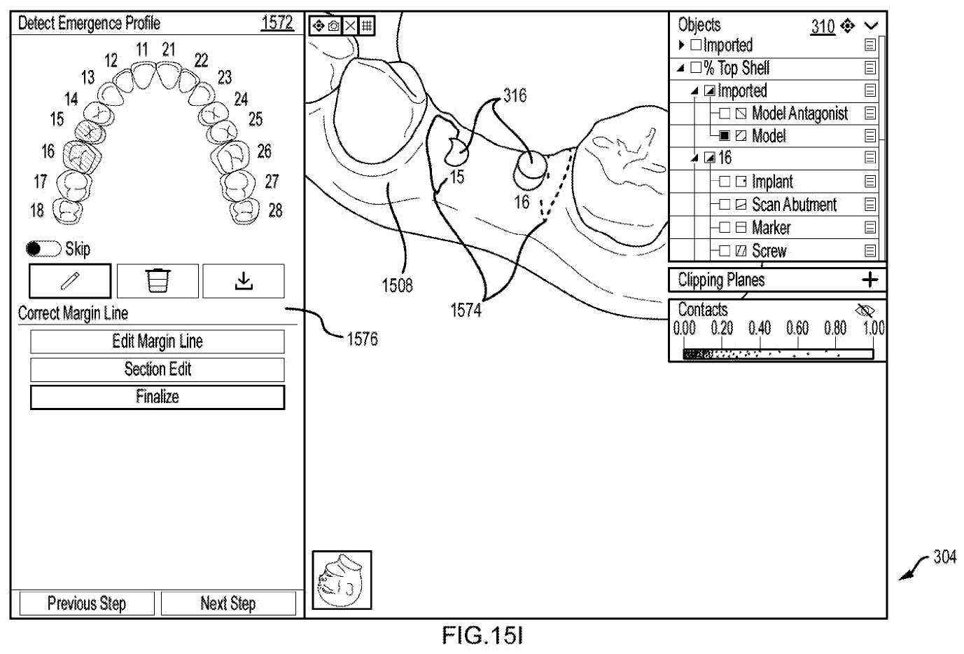

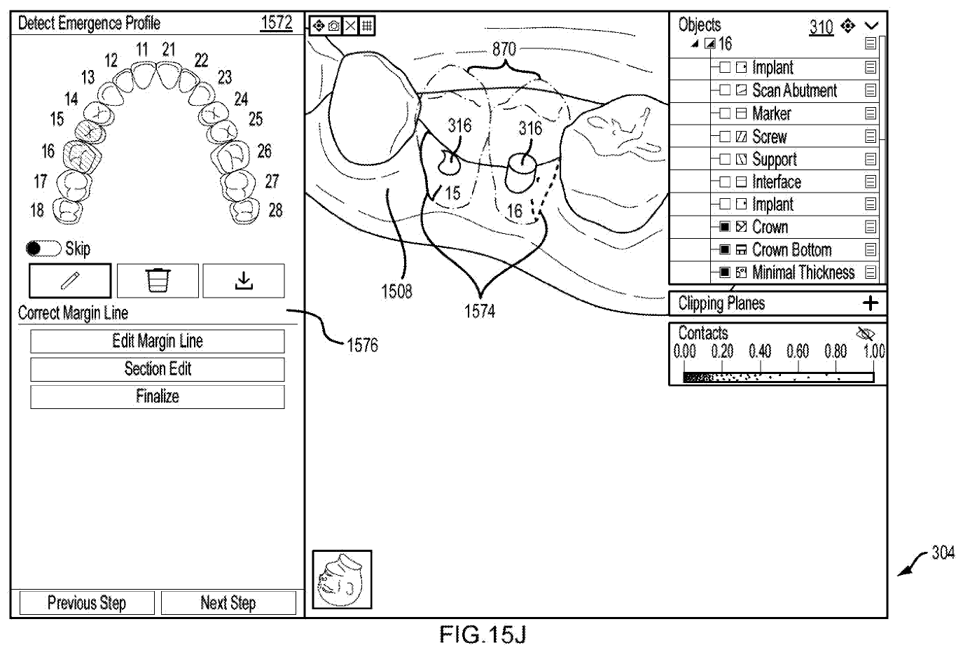

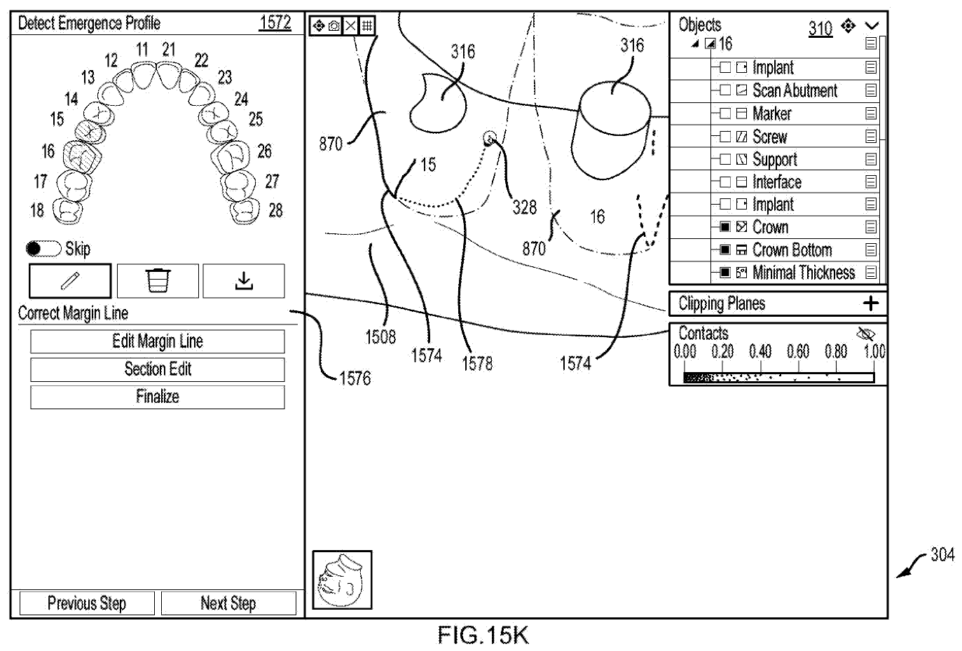

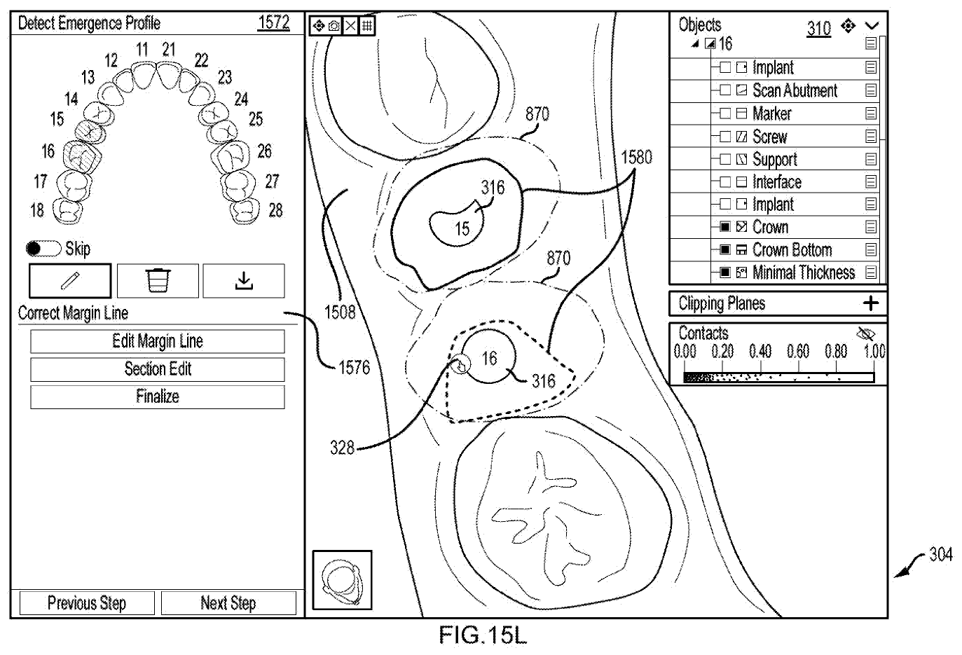

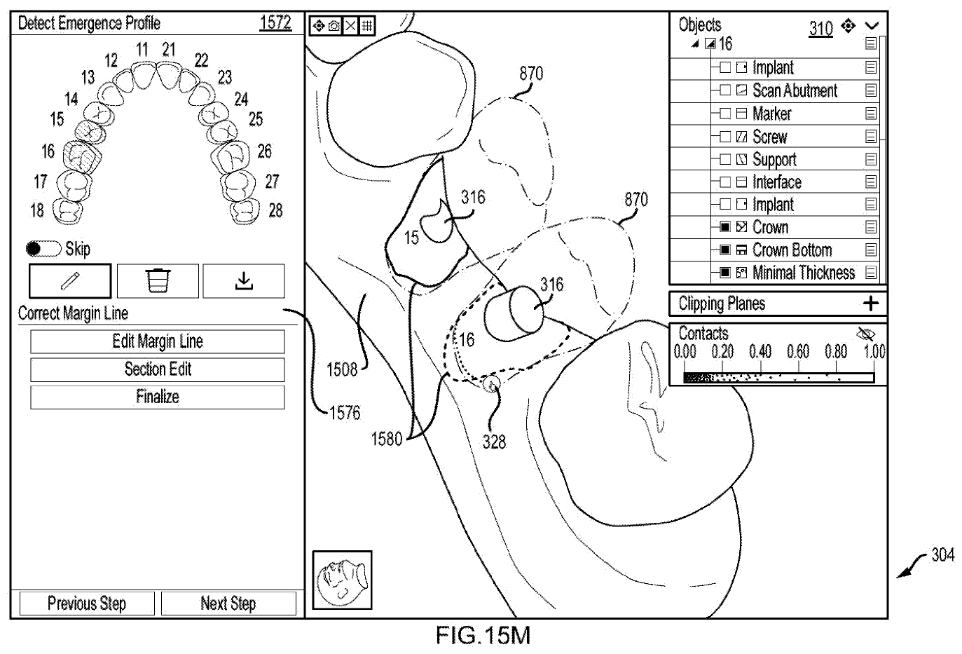

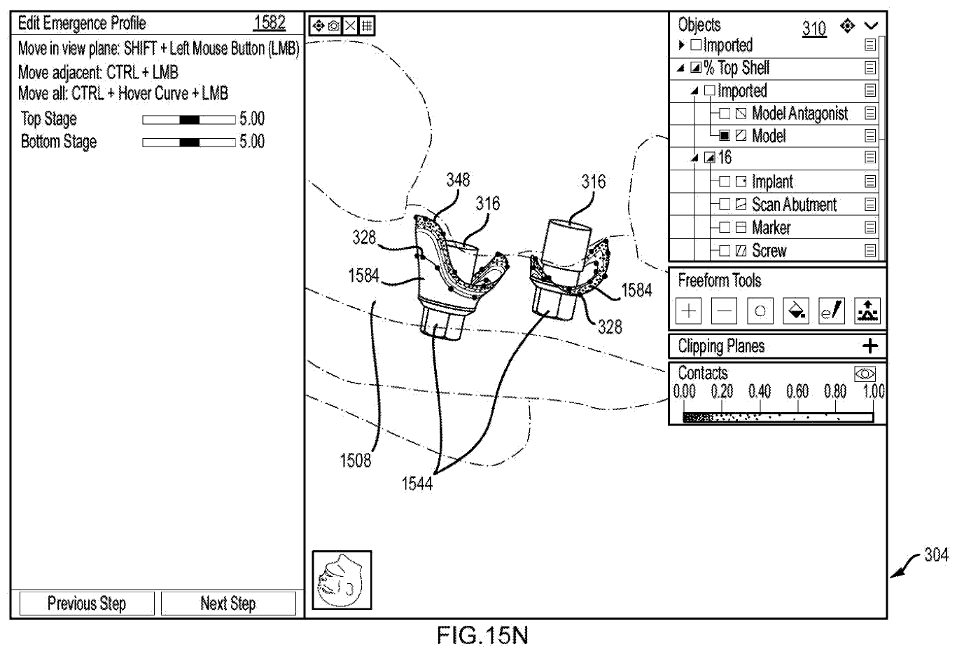

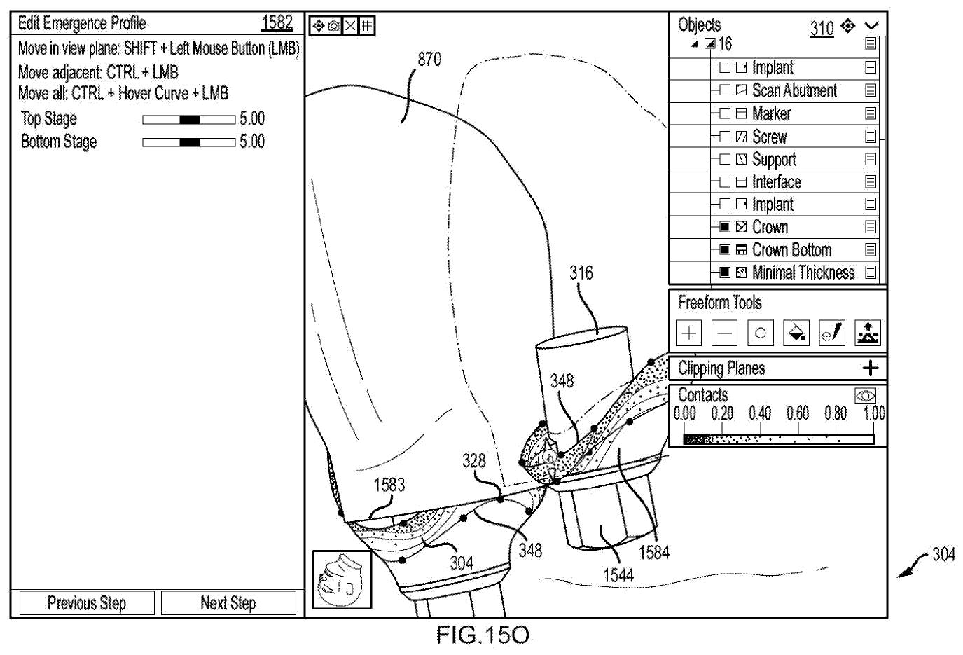

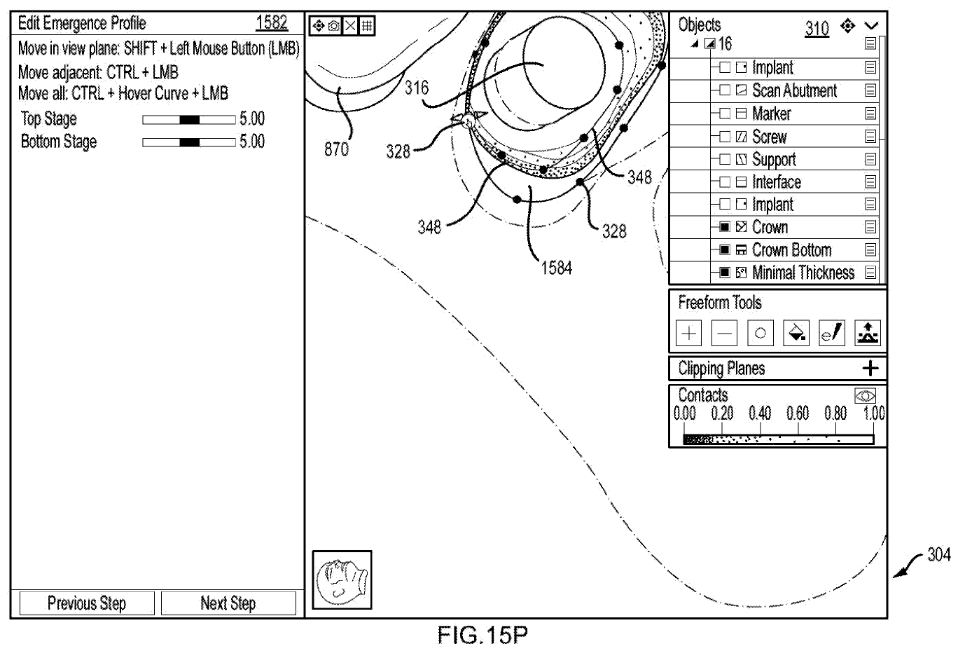

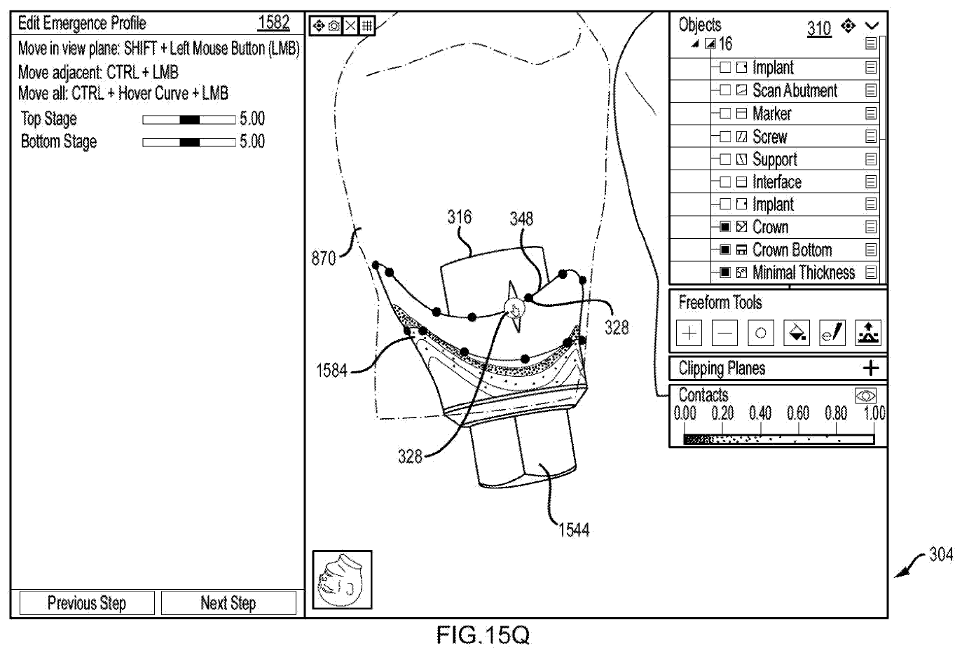

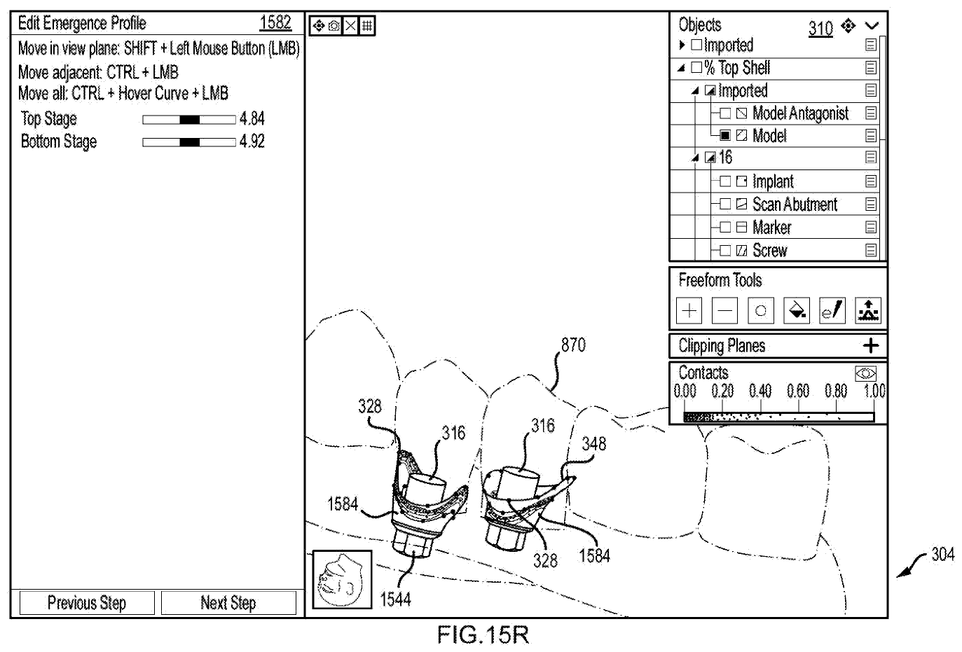

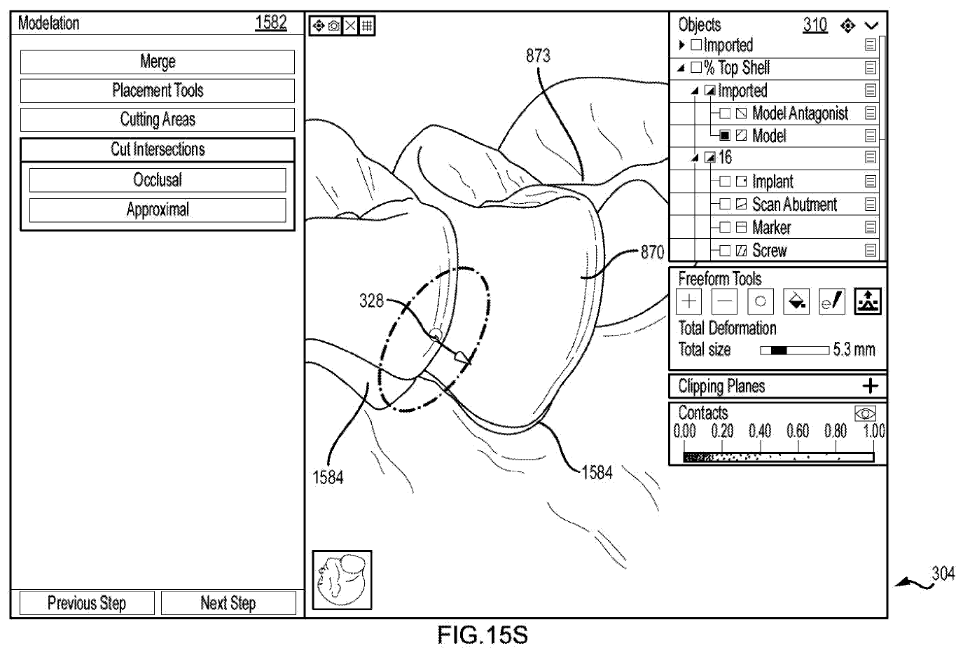

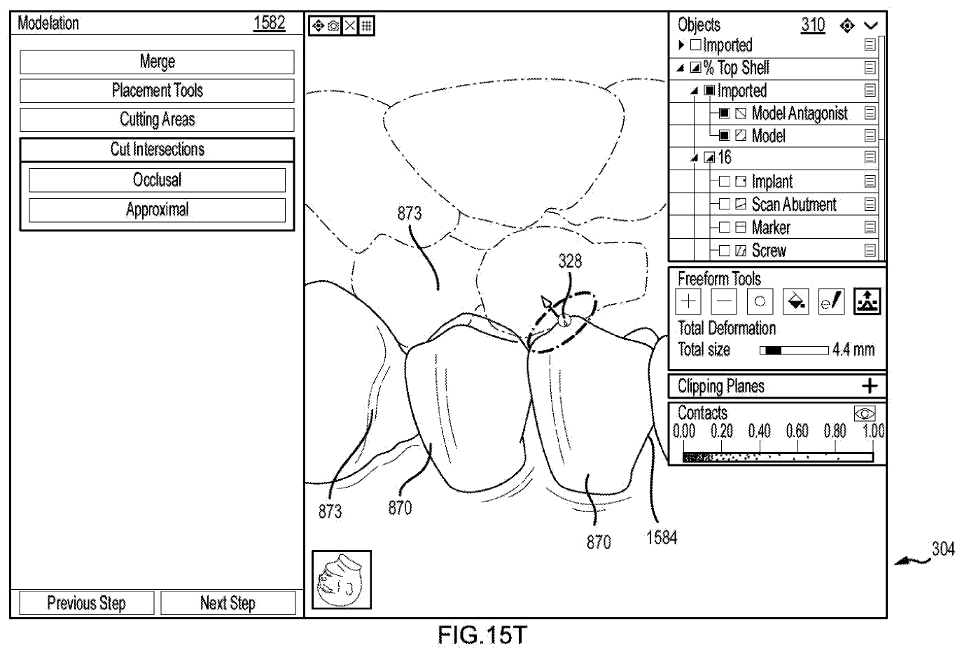

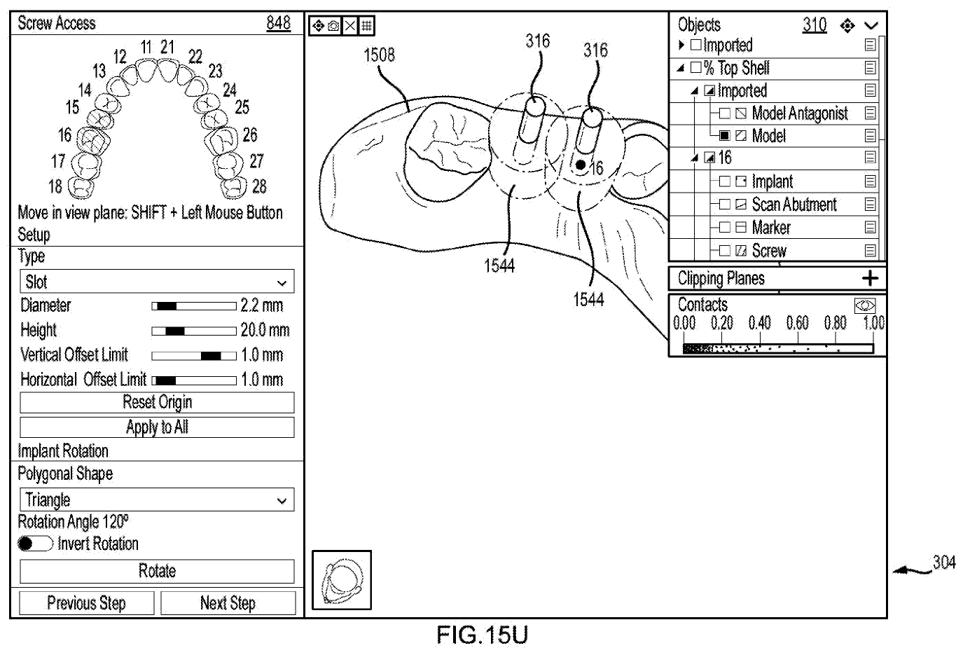

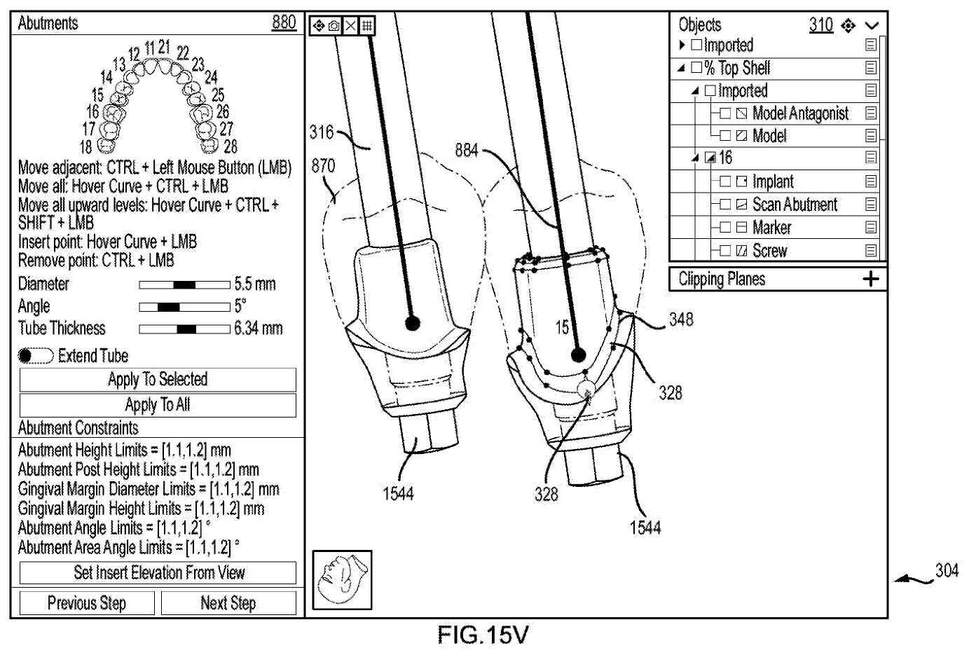

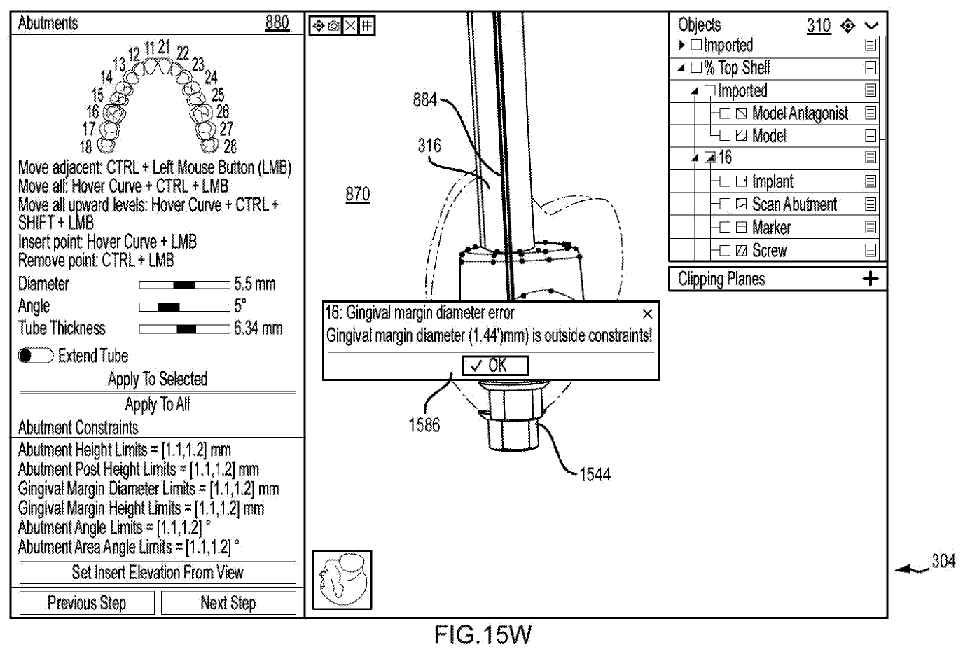

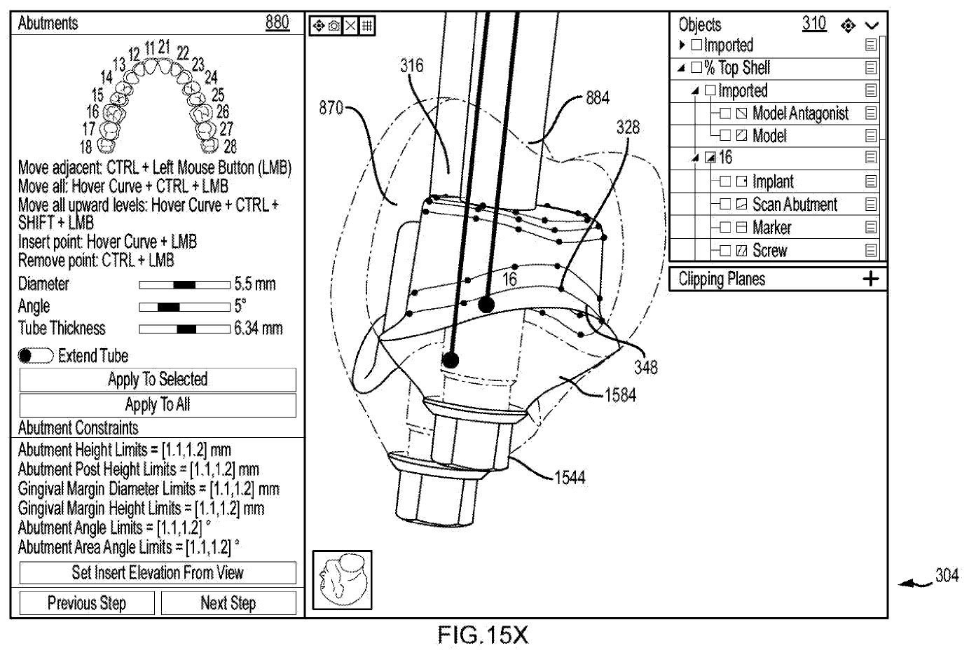

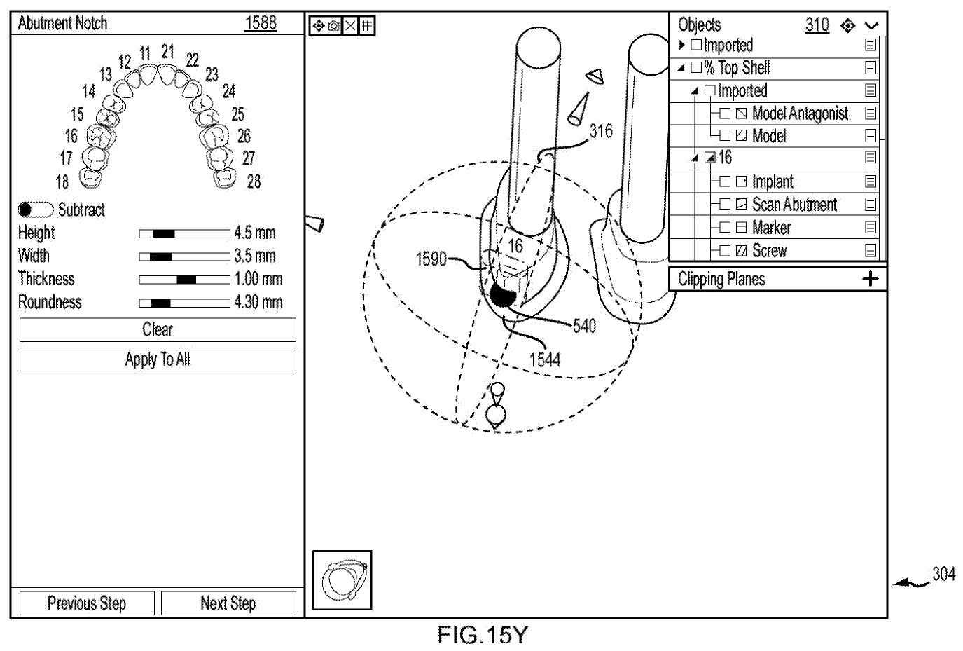

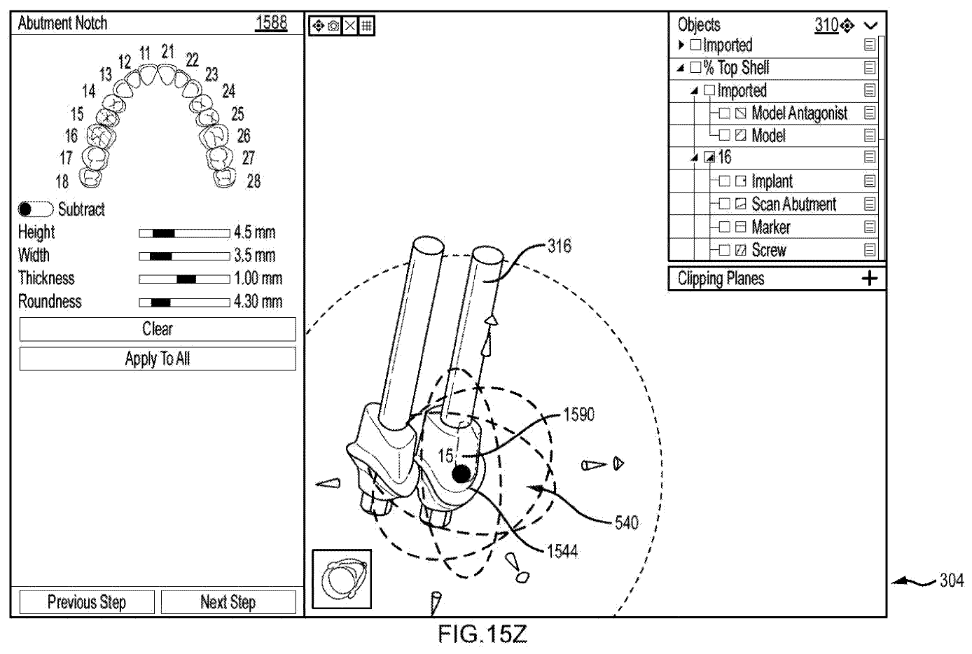

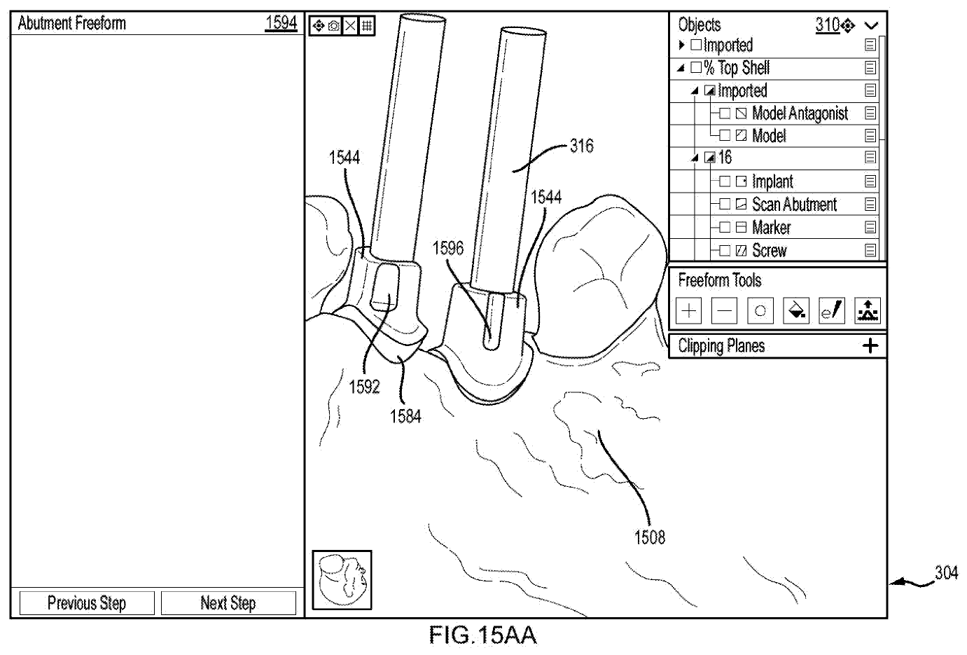

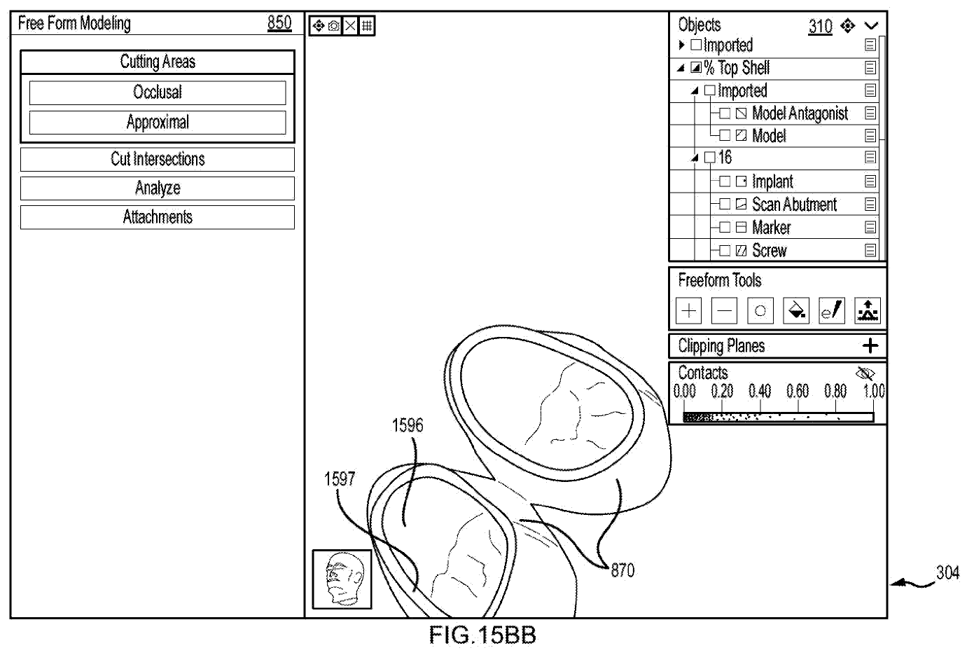

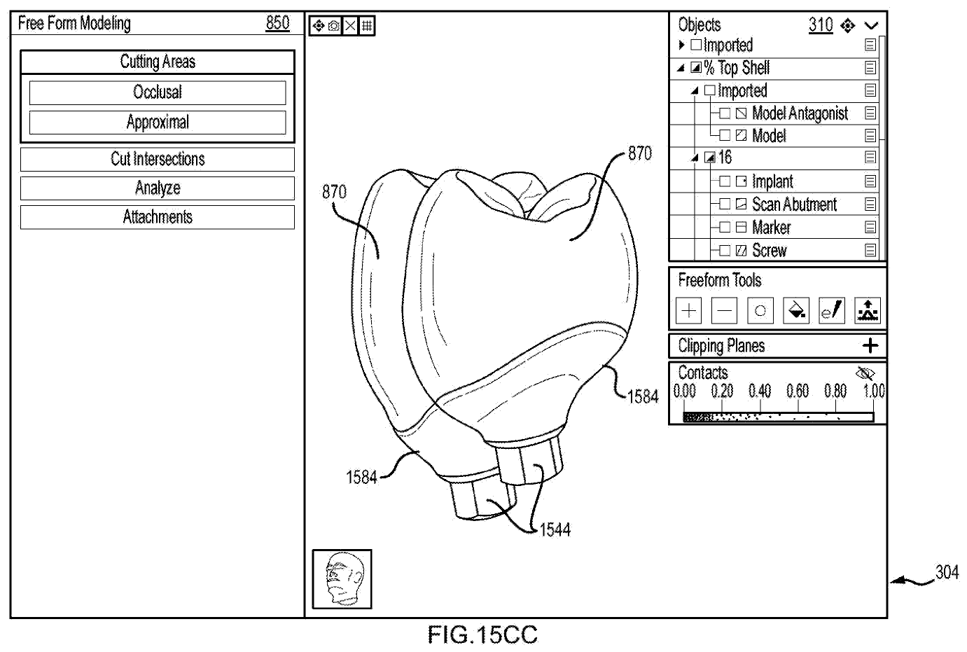

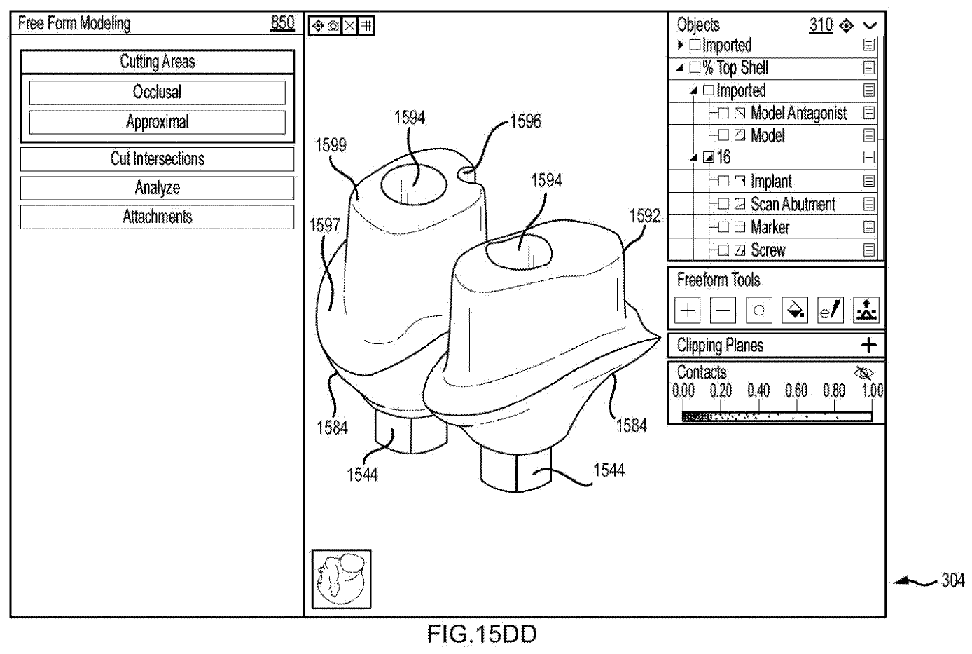

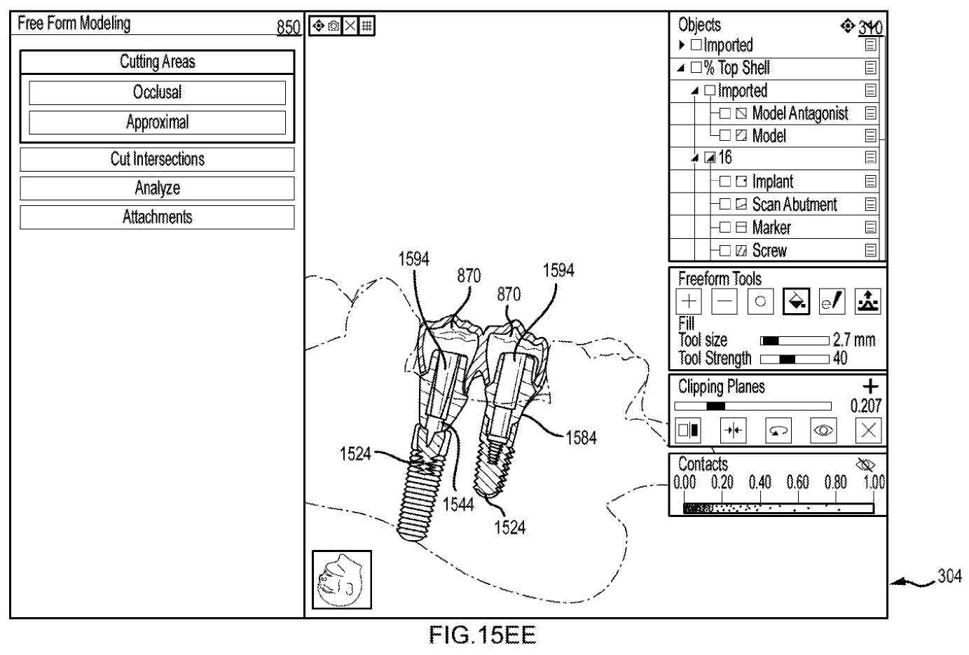

With reference to FIGS. 15A-15EE, CAD workflows will be discussed that use virtual scan bodies for definitive abutment construction with a configurable and correct emergence profile, a one-shot compensation relining crowns and/or waxup, and the design of custom abutments as healing abutments for soft tissue (e.g., gingiva) shaping. In an embodiment, the virtual scan body is used by a data model to identify a gingival margin and/or emergence profile in the 3D CAD model of the patient's oral cavity.

With reference to FIGS. 15A-B, the CAD environment 304 comprises a toolbar 1500 that provides tools, such as tools to select either an implant planning mode (which is shown as selected) 1501 or a pin planning mode 1503, tool 1512 to access an implant library to select and change a displayed implant object corresponding to a selected implant, tool 1516 to access an abutment library to select and change a displayed abutment object corresponding to a selected abutment, and tool 1520 to access a sleeve library to select and change a displayed sleeve object corresponding to a selected sleeve. The implant, abutment and sleeve objects can be a template or model from the model library 252. The CAD environment 3034 displays a model 1504 of the patient's oral cavity and gingival or soft tissue object 1508 with the selected implant and sleeve objects 1524, 1544, and 1525, respectively, in position relative to the screw access object 316. The CAD environment 304 further includes a side panel 1502 comprising cross-sectional and top views of the selected implant 1524, abutment, and sleeve 1525 objects in position on the model 1504 of the patient's imaged oral cavity and the position of the gingival or soft tissue surface contour 1527 of the first or fourth object 1508. The CAD environment of FIG. 15B shows the library panel 1528 containing fields 1532 for implant manufacturer, model, size, fields 1533 for abutment manufacturer, model and size, fields 1536 for scan abutment manufacturer, model, and size, fields 1540 for secondary abutment manufacturer, model, and size, model, fields 1535 for secondary scan abutment manufacturer, model, and size, and fields 1537 for analog extraction manufacturer, model, and size.

With reference to FIG. 15C, the CAD environment 304 comprises a margin line toolbar 308 comprising tools to perform a best fit or fit by brush. The CAD environment 304 displays a selected abutment object 1544 engaging the selected implant object 1524 in position on the gingival or soft tissue object 1508.

Referring to FIGS. 15D-F, the CAD environment comprise a teeth placement toolbar 308 comprising teeth placement tools to place toothlike objects in desired position and various other tools to place teeth, and alter or modify teeth contours in one, two or three dimensions, including a re-orientate teeth widget tool, chain mode tool, tooth placement by widget tool, general teeth placement tools, placement mode tools (e.g., to move, rotate, scale and stretch the toothlike object), placement direction tools (e.g., to move the toothlike object freely, horizontally, and vertically), and placement option tools (e.g., to move selected teeth together or simultaneously). The CAD environments 304 show the crown objects 870 in different positions relative to the abutment objects 1544. The tools comprise one or more control points 328 to move the crown objects in one, two or three dimensions into a desired position and orientation and a desired shape.

Referring to FIG. 15G, the CAD environment 304 comprises a bottom margin toolbar 1560 including tools to enable a parameter for a bottom margin or border 1545 to be configured horizontally 1563, an angle 1565 magnitude, angle 1567, or vertical 1569 as shown in the displayed image along with specifying a parameter value for minimal thickness.

With reference to FIGS. 15H-M, the CAD environments 304 comprise a detect emergence profile toolbar 1572 that includes tools 1576 to detect the gingival margin line from an intersection or to correct the margin line. With reference to FIGS. 15H-I, the CAD environments depict the gingival or soft tissue object 1508, abutment objects 1544 and screw access object 316, with the margin 1574 detected by a data model being shown in the CAD environments of FIGS. 15I-J. The CAD environments of FIGS. 15K-M show the edit margin toolbar editing the margin 1574 to provide an edited margin segment 1578 via one or more control points 328 to provide an edited margin 1580 surrounding the screw access object 316.

With reference to FIGS. 15N-R, once the edited margin 1580 is completed, an edit emergence profile toolbar 1582 comprises tools to edit the emergence profile 1584 of the abutment object 1544 (which may correspond to a healing abutment or permanent abutment). As will be appreciated, the emergence profile refers to the shape of the crown or abutment as it rises from the implant platform through the gum tissue. This contour can determine how the surrounding tissue will adapt and heal. The tools comprise a plurality of sets of control points 328 and intervening boundaries 348 to enable configuration of the emergence profile in one, two or three dimensions. As shown in FIG. 15O, the base 1583 of the crown object 870 does not conform to the edited emergence profile as the emergence profile is on the abutment object, and the crown object engages the upper surface and post of the abutment object as shown in the CAD environment of FIG. 15S.

With reference to FIGS. 15S-T, the CAD environments 304 include a moderation toolbar 1582 that comprises tools to merge selected objects, place selected objects in desired locations, cut by cut-type objects selected objects, and cut intersections (including occlusal offset and cut roundness parameter values) of selected objects. As shown in the CAD environments of FIGS. 15S and T, the crown object 870 position, contours or shape, or dimensions can be modified or configured in a desired fashion by manipulating one or more control points 328.\

With reference to FIG. 15U, the CAD environment 304 comprises a screw access toolbar 848 discussed above in connection with FIGS. 8H-8J.

Once the emergence profile of the abutment objects 844 (which may be a permanent or healing abutment, scan body, or combination thereof) has been configured, a user can use the CAD environments of FIGS. 15V-Z to configure the upper section of the abutment object, including the post, that engages the crown object. The CAD environments 304 of FIGS. 15V-X include an abutment toolbar 880 discussed above with reference to FIG. 10B. As shown in FIG. 15), the tools can provide an error message 1586 when the edited changes violate a constraint or rule, such as a gingival margin error diameter or the edited gingival margin diameter being outside a preset constraint.

With reference to FIG. 15U, the CAD environment 304 comprises an abutment notch toolbar 1588 that includes tools to employ a cut-type object 1590 to remove a selected volume from the post or upper portion of the abutment object as shown and further described above. The rotation handles 540 can be used to position the cut-type object in the desired position and orientation as shown. The CAD environment 304 of FIG. 15AA comprises an abutment freeform toolbar 1594 including tools to further modify or change the abutment object 1544 in one, two or three dimensions. The abutment objects include a notch 1592 and slot 1596 formed using the cut-type objects 1590.

Referring to FIGS. 15BB-15DD, the CAD environments include a free-form modeling toolbar 850 that includes tools for cutting areas of a selected object (including occlusal and approximal), cut intersections of selected objects, analyze a selected object, and an attachment tool to attach selected objects to each other. The CAD environment of FIG. 15BB includes crown objects 870 showing the hollow interior 1596 and open bottom to receive the post 1599 of the abutment object and lower edge 1597 to seat in the surrounding lip 1597 of the corresponding abutment object. With reference to the CAD environment of FIG. 15DD, the post 1599 comprises a tool access bore 1594 that passes completely through the abutment (as shown in the cross-section of the CAD environment of FIG. 15EE) to receive an anchoring screw and tightening tool to anchor the abutment object 1544 to the corresponding implant object 1524.

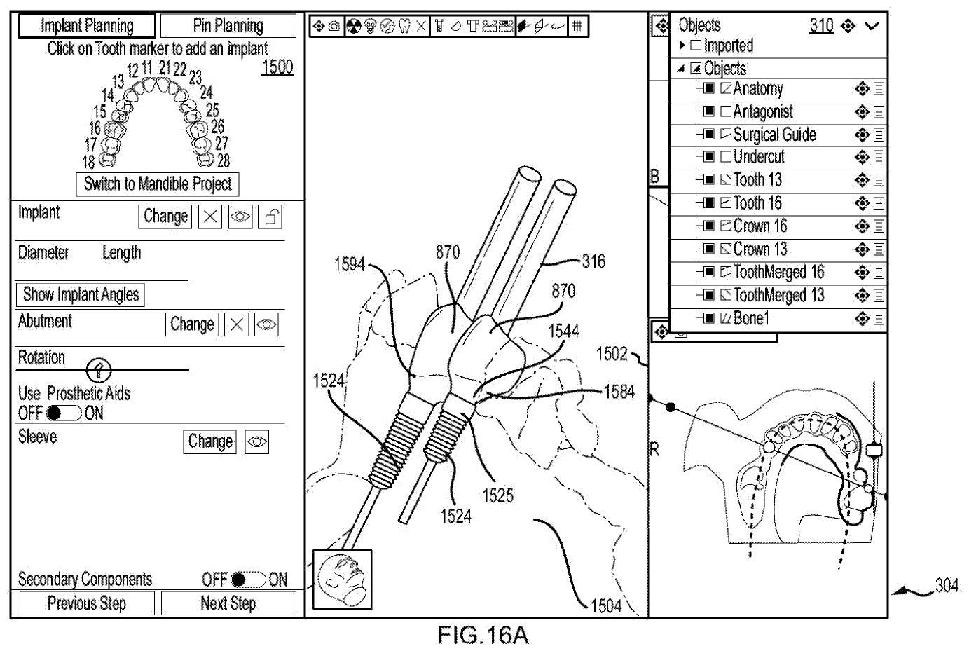

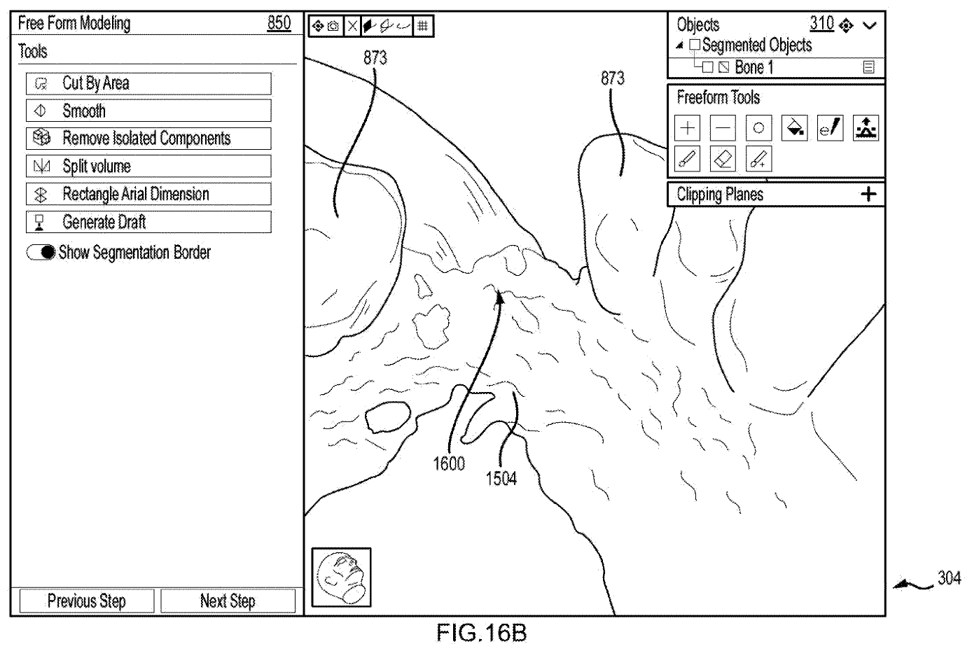

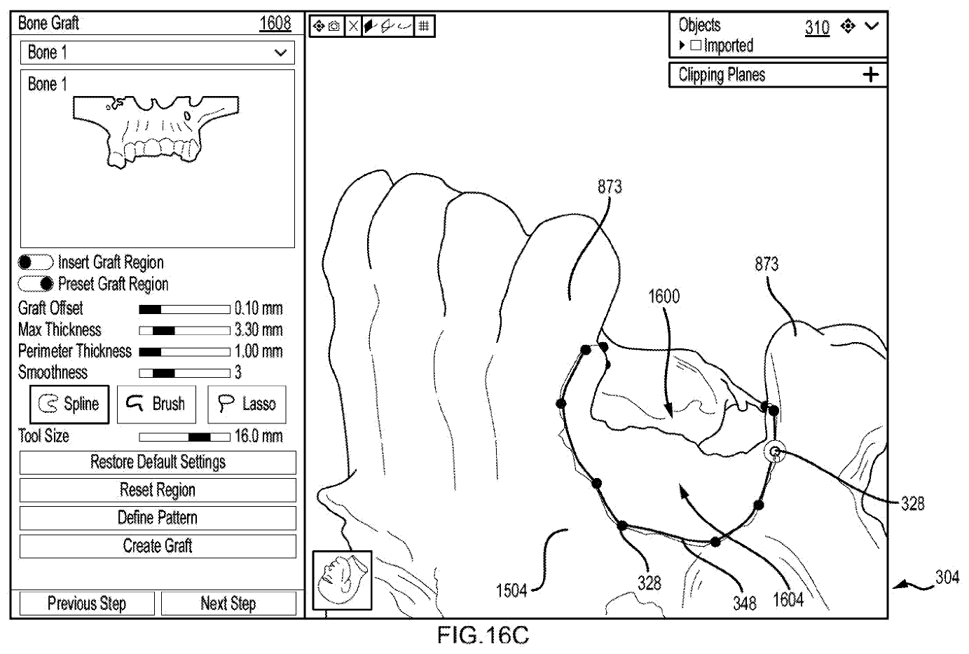

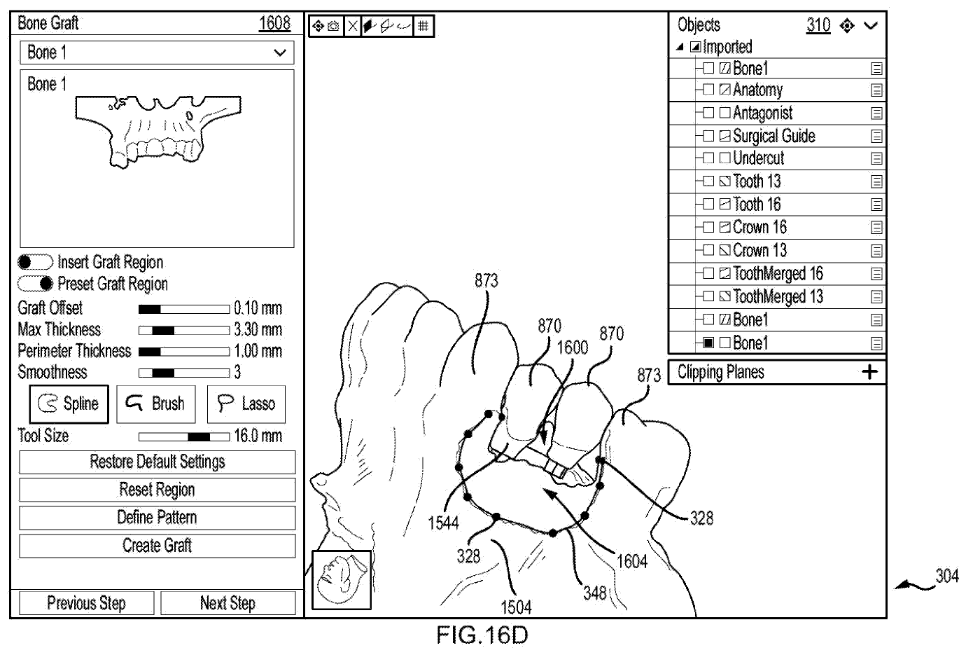

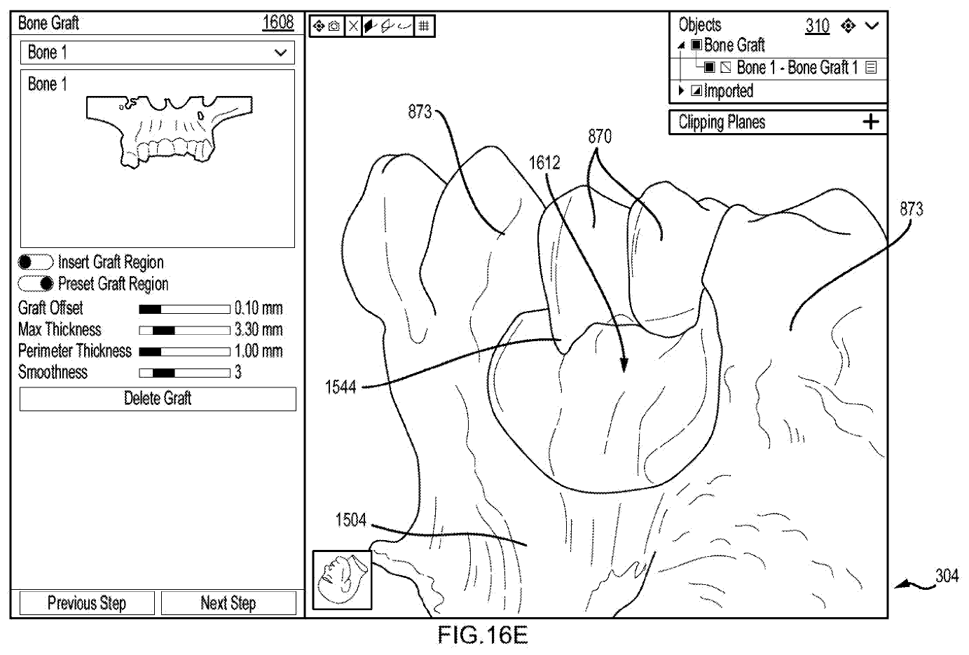

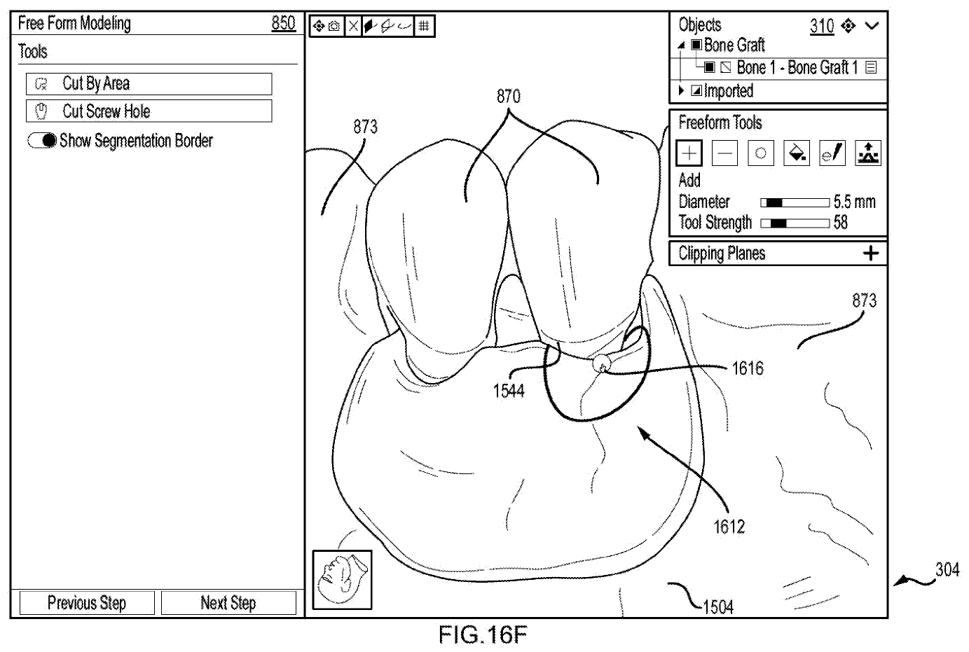

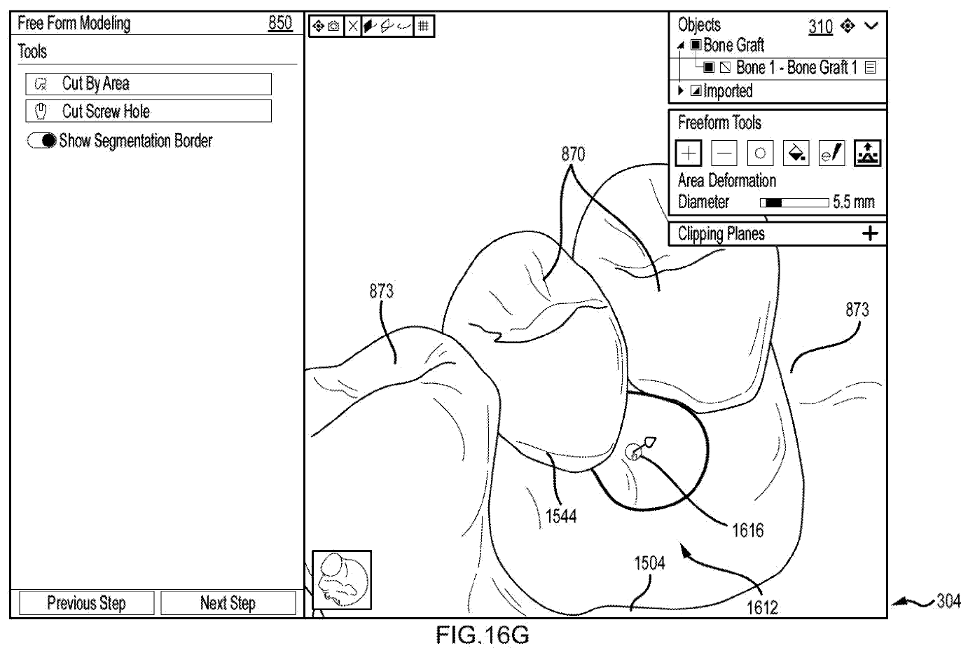

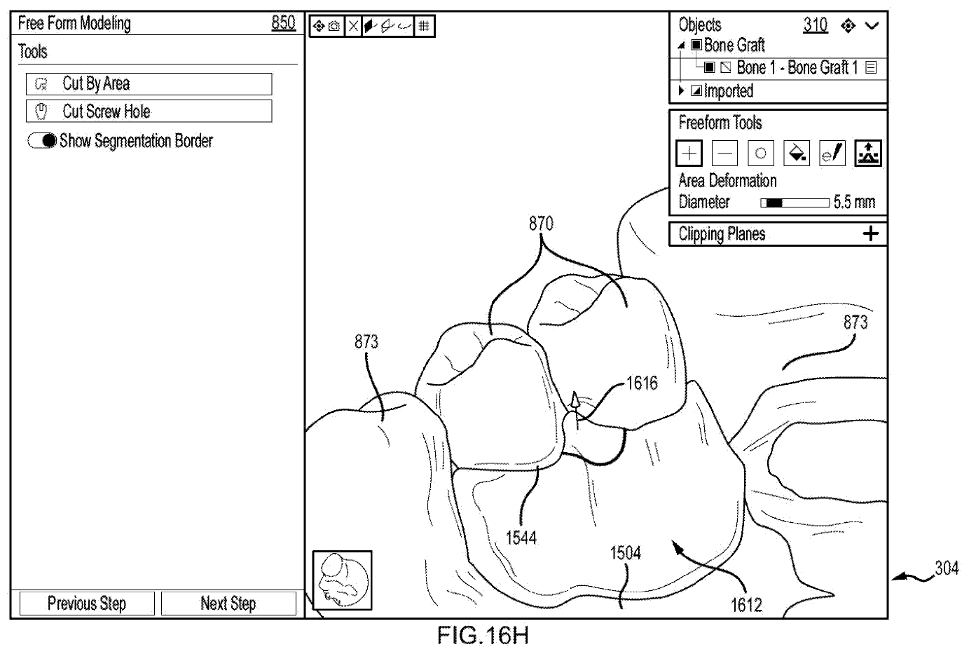

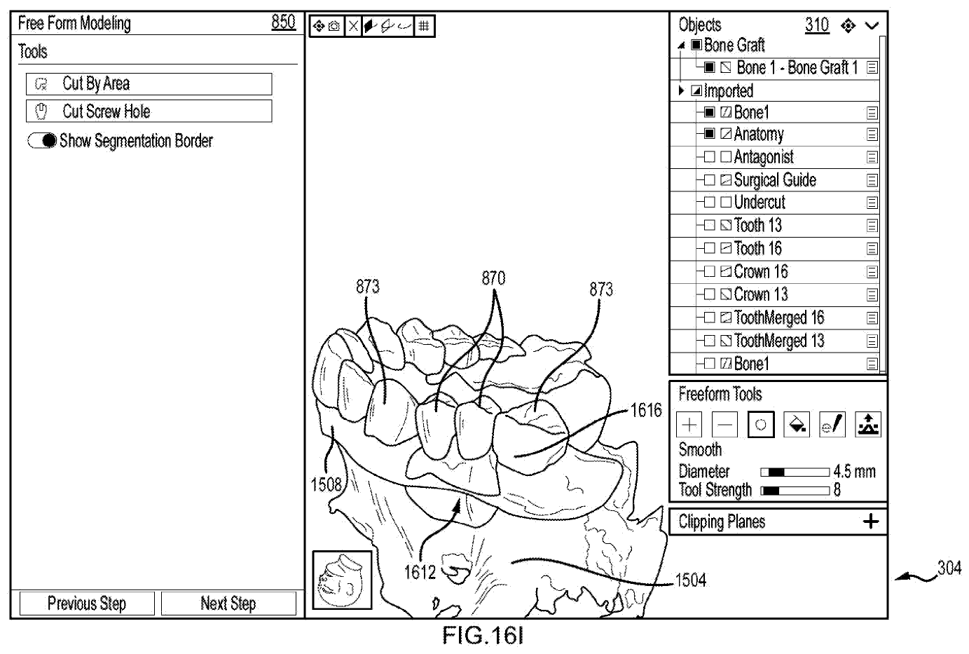

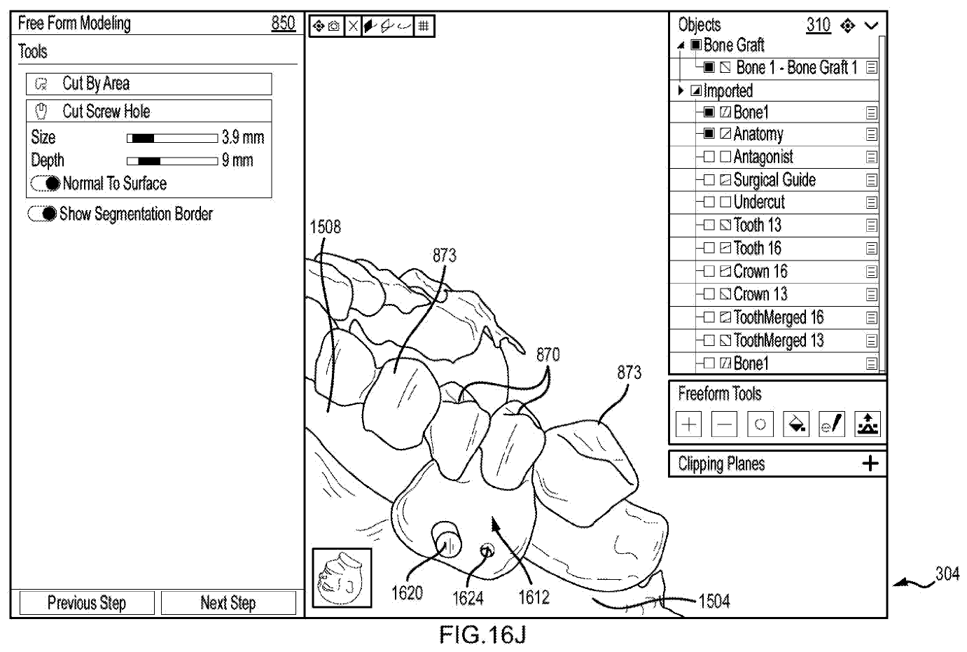

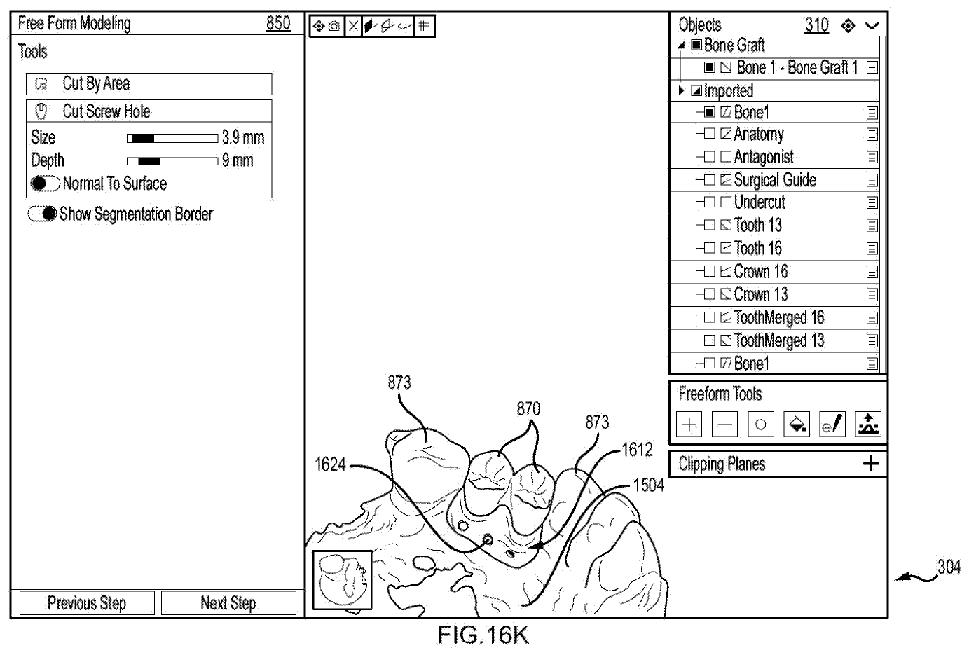

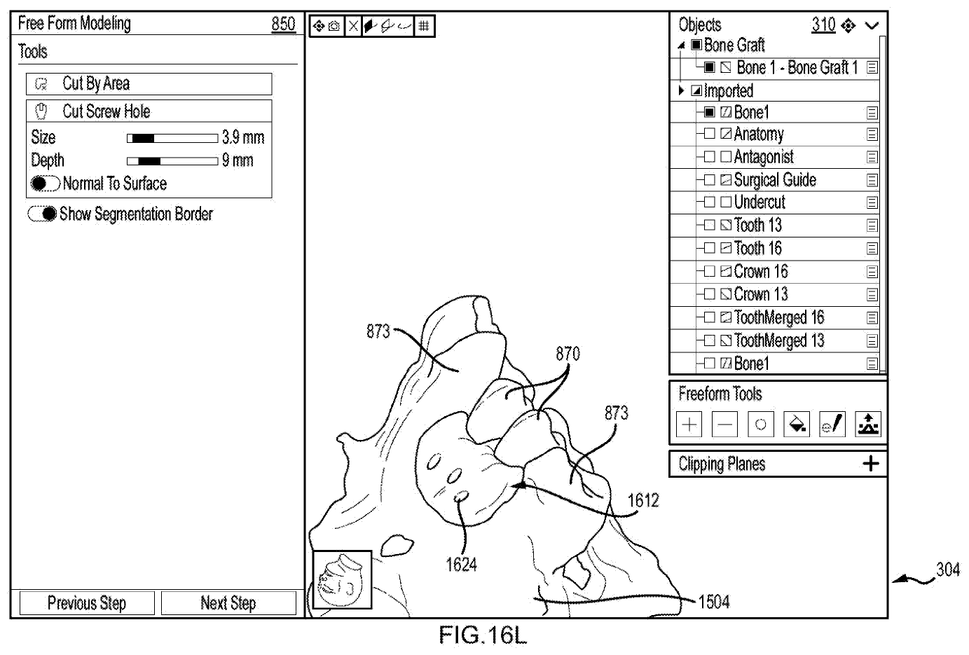

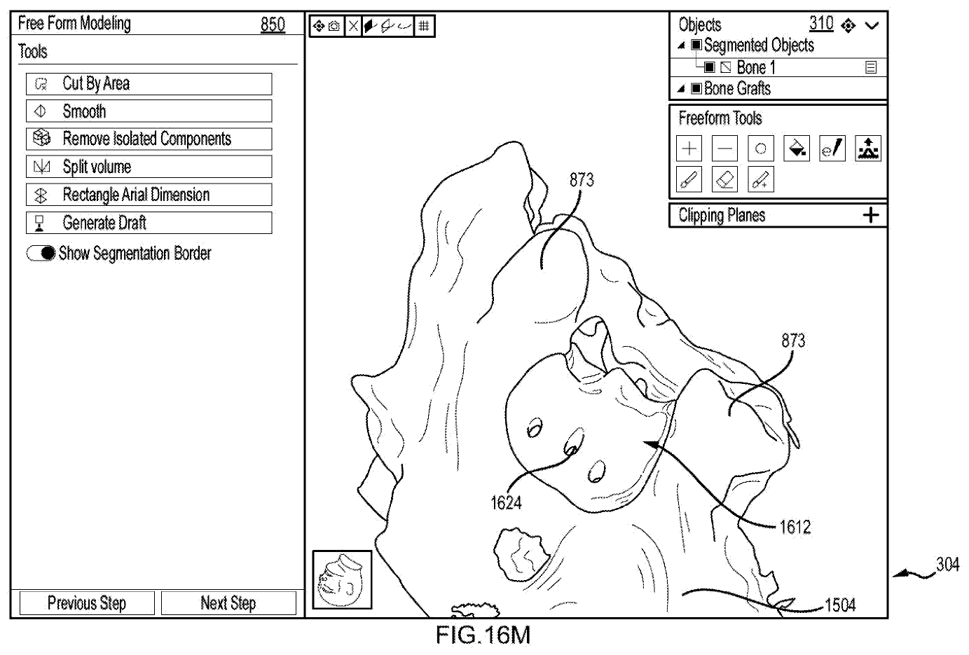

With reference to FIGS. 16A-M, CAD workflows will be discussed that enable design of custom abutments and crowns as a bone graft reference template. In other words, the bone graft object can be designed and located with reference to the selected location and orientation of the abutment object and crown object.

With reference to FIG. 16A, the CAD environment 304 comprises the toolbar 1500 that provides tools discussed above in connection with FIG. 15A. The CAD environment 3034 displays the model 1504 of the patient's oral cavity with the selected implant and sleeve objects 1524, 1544, and 1525, respectively, in position relative to the screw access object 316. The CAD environment 304 further includes the side panel 1502 comprising cross-sectional and top views of the selected implant 1524, abutment, and sleeve 1525 objects in position on the model 1504 of the patient's imaged oral cavity and the position of the gingival or soft tissue surface contour 1527 of the object 1508.

Referring to FIG. 16B, the CAD environment 304 comprises a free form modeling toolbar 850 comprising tools to cut a selected object by area, smooth a surface of a selected object, remove isolated components from a selected object, split a volume of a selected object, resample an axial dimension of a selected object, and generate a graft object. The CAD environment further includes a display of the model of the patient's oral cavity showing a model segment 1600 missing two teeth and possessing substantial bone loss.

Referring to FIG. 16C, the CAD environment 304 comprises a bone graft toolbar 1608 (resulting from the selection of the graft object generation tool) comprising tools to invert a graft region, protect a graft region, select parameter values for a graft object offset, maximum graft object thickness, graft object perimeter thickness, and graft object smoothness, a spline (selected), brush, or lasso tool to delineate and generate a graft object, restore default settings, reset region, define pattern, and create graft. The spline tool, by manipulating one or more control points 328 and intervening boundaries 348, has created in the model segment 1600 a highlighted area 1604 for bone graft object generation.

Referring to FIG. 16D, the CAD environment 304 further displays the selected position and orientation for the abutment and crown objects 1544 and 870, respectively, in the model segment 1600 relative to the highlighted area 1604 for the bone graft object.

Referring to FIG. 16E, the CAD environment 304 comprises a bone graft object 1612 in the highlighted area 1604 created in response to selecting the create graft tool.

Referring to FIGS. 16F-I, the CAD environments 304 includes a freeform modeling toolbar 850 comprising tools for cut a selected object by area and cut a screw hole in a selected object. The progressive CAD environments show various stages in changing the configuration of the bone graft object 1612, by one or more control points 1616, in one, two or three dimensions relative to the adjacent tooth like objects 873 and abutment objects and crown objects. For example, comparing the bone graft object's first configuration in FIG. 16F to that in FIG. 16I shows that the second configuration of FIG. 16I has more closely approached the margin line between the abutment object and the crown object. As shown by the CAD environments of FIGS. 16G and H, the one or more control points 1616 not only move the boundaries of the graft object closer to the margin line but also (as shown by the arrow of bone graft object displacement) can increase a thickness of the bone graft object around the base of the abutment object to ensure sufficient new bone growth to anchor the corresponding abutment object and/or implant securely in the patient's jaw. The CAD environment 304 of FIG. 16I further shows the position of the soft tissue 1508 surface profile relative to the abutment and crown objects and bone graft object to further assist the user in confirming that the bone graft object is configured properly.

Referring to FIGS. 16J-M, the user has selected the cut a screw hole tool that has provider further options to set parameter values for the cut screw hole including size or diameter and depth. The screw holes used to secure the bone graft corresponding to the bone graft object are created as a cut-type volume 1620, which is merged with the bone graft object to form a screw hole or orifice 1624. The CAD environments of FIGS. 16K-M show the final bone graft object configuration comprising three screw holes 1624 on the outer and inner jaw surfaces of the bone graft object, a bone graft object surface closely mirroring the margin line between the crown object and lip of the abutment object, and a bone graft thickness around the bases of the abutment objects that has sufficient thickness to form new bone growth having sufficient strength to resist mastication forces exerted on the crowns corresponding to the crown objects and abutments and implants corresponding to the abutment and implant objects.

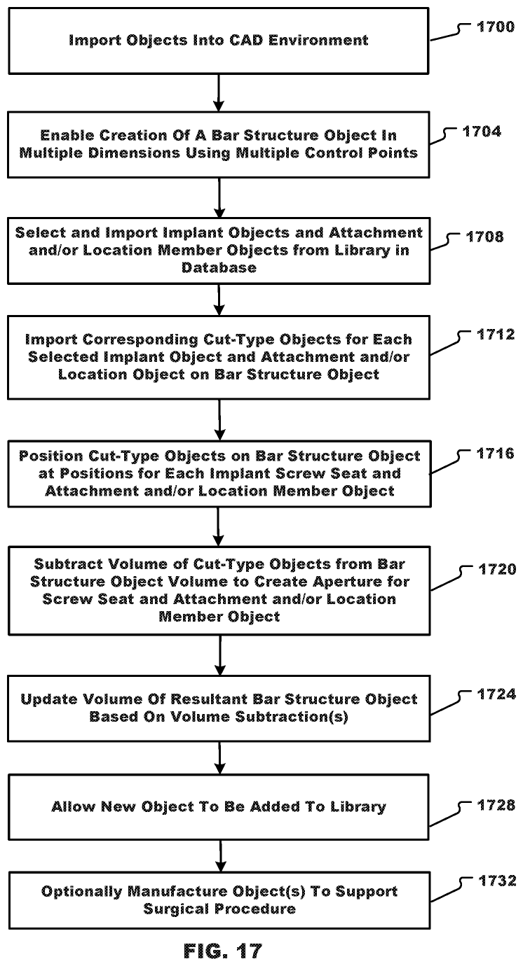

With reference now to FIGS. 17-25, various methods will be described in accordance with at least some embodiments of the present disclosure. The methods described herein may correspond to methods that can be performed in connection with any of the workflows previously described herein and may be performed by one or more components of a system 100 or computing device 200. Moreover, the order of steps illustrated in any particular method should not be construed as limiting. Rather, steps of any method may be performed in any order and/or may be combined with steps of other methods without departing from the scope of the present disclosure.

Referring initially to FIG. 17, a first method, which corresponds to the workflow shown in FIGS. 7A-F is illustrated in accordance with at least some embodiments of the present disclosure. The method begins by importing one or more objects into the CAD environment 304 (step 1700). The method continues by enabling the creation of a freeform bar structure object, where dimensions and/or surfaces of the freeform object are capable of being changed in multiple dimensions (step 1704). The freeform object may have one or more control points and/or rotation handles that enable manipulation of the freeform object or surfaces thereof in one, two, or three dimensions. Each of the control points of the freeform object may be configured for independent manipulation.

The method continues by the selection and importation into the CAD environment 304 of implant and attachment and/or location member objects from the database 240 (step 1708).

The method continues by importing corresponding cut-type objects for each selected implant object and attachment and/or location object on the bar structure object (step 1712 and the CAD environments of FIGS. 7A-7E).

The method continues by positioning the cut-type objects on the bar structure object at positions for each implant screw seat and attachment and/or locator object (step 1716 and the CAD environments of FIGS. 7A-7E). Each of the objects may have one or more control points and/or rotation handles that enable manipulation of the freeform object or surfaces thereof in one, two, or three dimensions.

The method continues by subtracting the volume of cut-type objects form the bar structure object volume to create an aperture for the screw seat and attachment and/or location member object (step 1720). The aperture may have any shape and dimensions but typically is configured to mate with the corresponding implant object and screw, attachment and/or location member object.

The method may continue by updating the volume of the resultant bar structure object based on the volume subtraction(s) (step 1724 and the CAD environment of FIG. 7F).

The method may then continue by allowing the user to add the resultant object to a collection of templates and/or a model library (step 1728). The method may also continue with the CAD tools 228 providing one or more electronic files to a manufacturing system 140 to enable the manufacturing system 140 to produce a physical component according to dimensions of the object in the electronic file received from the CAD tools 228 (step 1732).

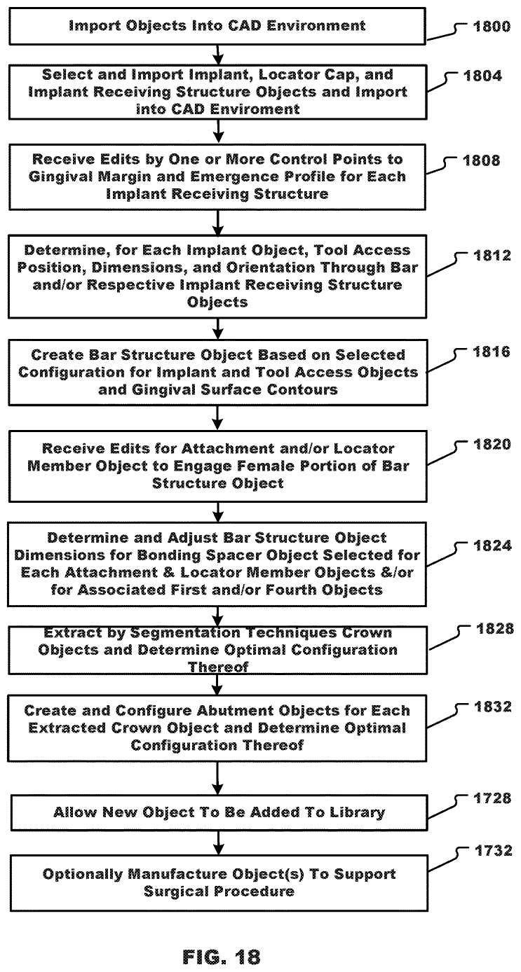

Referring to FIG. 18, a second method, which corresponds to the workflow shown in FIGS. 8A-Z is illustrated in accordance with at least some embodiments of the present disclosure. The method begins by importing one or more objects into the CAD environment 304 (step 1800 and the CAD environment of FIG. 8A). The object includes the first or fourth objects, depending on the application.

The method continues by the selection and importation into the CAD environment 304 of implant and implant driver objects and locator cap and implant receiving structure objects from the database 240 (step 1804 and CAD environment of FIG. 8B).

The method continues by receiving edits by one or more control points to the gingival margin and emergence profile for each implant receiving structure and updating the edited objects accordingly (step 1808 and the CAD environments of FIGS. 8E-8G). Each of the objects may have one or more control points and/or rotation handles that enable manipulation of the freeform object or surfaces or margin in one, two, or three dimensions.

The method continues by determining, for each implant object, tool access position, dimensions, and orientation through a bar structure object and/or respective implant receiving structure objects (step 1812 and the CAD environments of FIGS. 8H-8K). Each of the objects may have one or more control points and/or rotation handles that enable manipulation of the tool access object or surfaces thereof in one, two, or three dimensions.

The method continues by creating a bar structure object based on the selected configuration for the implant, implant receiving structure, and tool access objects and gingival surface contours (step 1816 and the CAD environments of FIGS. 8L and 8O).

The method may continue by receiving edits for attachment and/or locator member objects to engage a female portion of the (male portion of the) bar structure object (step 1820 and CAD environments of FIGS. 8M-8N). Each of the objects may have one or more control points and/or rotation handles that enable manipulation of the tool access object or surfaces thereof in one, two, or three dimensions.

The method may continue by determining and adjusting the bar structure object dimensions for each bonding spacer object selected for each attachment and locator member objects and/or for the associated first and/or fourth objects. (step 1824 and CAD environment of FIG. 8O).

The method may continue by extracting segmentation techniques (using a data model) crown objects and determining an optimal configuration thereof (step 1832 and the CAD environments of FIGS. 8U-8W). Each of the crown objects may have one or more control points and/or rotation handles that enable manipulation of the tool access object or surfaces thereof in one, two, or three dimensions.

The method may continue by creating and configuring abutment objects for each extracted crown object and determining the optimal configuration thereof (which may be done by a data model) (step 1832 and the CAD environments of FIGS. 8X-8CC).

The method may then continue by allowing the user to add the resultant objects to a collection of templates and/or a model library (step 1728). The method may also continue with the CAD tools 228 providing one or more electronic files to a manufacturing system 140 to enable the manufacturing system 140 to produce a physical component according to dimensions of the objects in the electronic file received from the CAD tools 228 (step 1732).

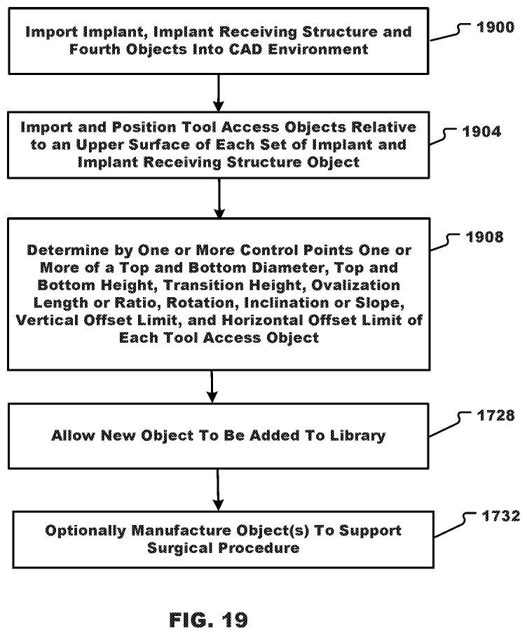

Referring initially to FIG. 19, a third method, which corresponds to the workflow shown in FIGS. 9A-K is illustrated in accordance with at least some embodiments of the present disclosure. The method begins by importing selected implant, implant receiving structures, and fourth objects into the CAD environment 304 (step 1900).

The method continues by the selection, importation, and placement into the CAD environment 304 of tool access objects relative to an upper surface of each set of implant and implant receiving structure objects (step 1904 and CAD environment of FIG. 9A).

The method continues by determining, by one or more control points or rotation handles, one or more of a top and bottom diameter, top and bottom height, transition height, ovalization length or ratio, rotation angle, inclination or slope, vertical offset limit, and horizontal offset limit of each tool access object (step 1908 and the CAD environments of FIGS. 9A-9K). Each of the tool access objects may have one or more control points and/or rotation handles that enable manipulation of the tool access object or surfaces thereof in one, two, or three dimensions.

The method may then continue by allowing the user to add the resultant object to a collection of templates and/or a model library (step 1728). The method may also continue with the CAD tools 228 providing one or more electronic files to a manufacturing system 140 to enable the manufacturing system 140 to produce a physical component according to dimensions of the object in the electronic file received from the CAD tools 228 (step 1732).

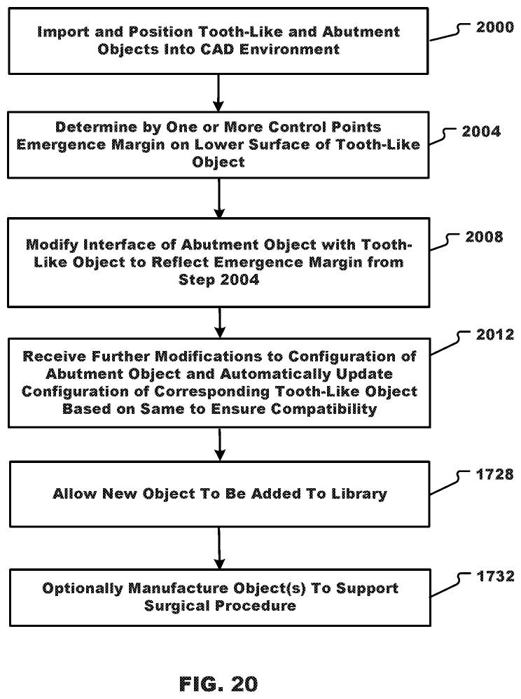

Referring initially to FIG. 20, a fourth method, which corresponds to the workflow shown in FIGS. 10A-F is illustrated in accordance with at least some embodiments of the present disclosure. The method begins by importing and positioning tooth-like and abutment objects into the CAD environment 304 (step 2000).

The method continues by determining, by one or more control points or rotation handles, the emergence margin on the lower surface of a tooth-like object (step 2004 and CAD environment of FIG. 10A).

The method continues by modifying the interface of the abutment object with tooth-like object to reflect the emergence margin from step 2004. (step 2008 and the CAD environment of FIG. 10B). The emergence margin may have one or more control points and/or rotation handles that enable manipulation of the margin in one, two, or three dimensions.

The method may then continue by receiving further modifications to the configuration of the abutment object and automatically update the configuration of the corresponding tooth-like object based on the modifications to ensure compatibility (step 2012 and CAD environments of FIGS. 10B-F). Each of the abutment and tooth-like objects may have one or more control points and/or rotation handles that enable manipulation of the tool access object or surfaces thereof in one, two, or three dimensions.

The method may also continue with the CAD tools 228 providing one or more electronic files to a manufacturing system 140 to enable the manufacturing system 140 to produce a physical component according to dimensions of the object in the electronic file received from the CAD tools 228 (step 1732).

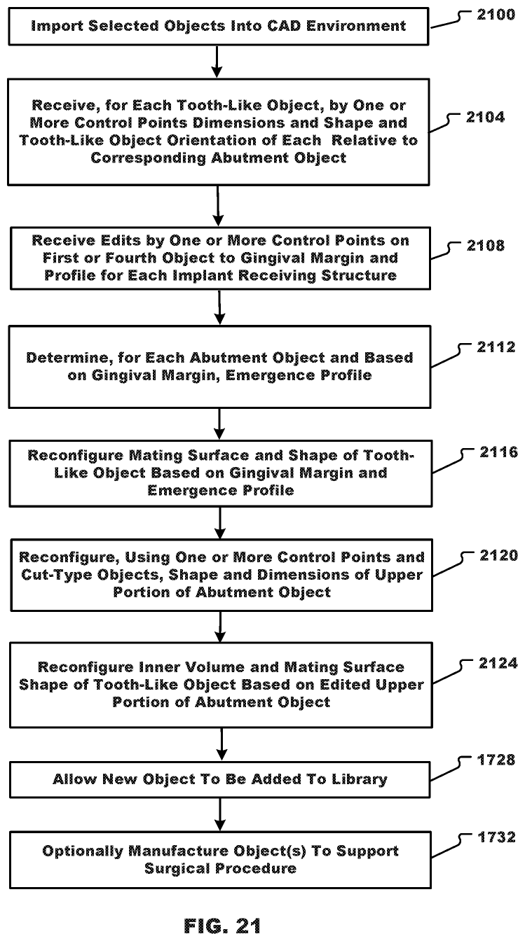

Referring to FIG. 21, a fifth method, which corresponds to the workflow shown in FIGS. 15A-Z is illustrated in accordance with at least some embodiments of the present disclosure. The method begins by importing one or more objects into the CAD environment 304 from the database (step 2100 and the CAD environments of FIGS. 15A-C). The object includes the first or fourth objects, depending on the application.

The method continues by receiving, for each tooth-like object, by one or more control points and/or rotation handles, dimensions and shape and orientation of each tooth-like object relative to a corresponding abutment object (step 2104 and CAD environments of FIGS. 15D-F).

The method continues by receiving edits by one or more control points on the first or fourth object to the gingival margin and profile for each implant receiving structure (step 2108 and the CAD environments of FIGS. 15G-H). Each of the objects may have one or more control points and/or rotation handles that enable manipulation of the freeform object or surfaces or margin in one, two, or three dimensions.

The method continues by determining, for each abutment object and based on the gingival margin, an emergence profile (step 2112 and the CAD environments of FIGS. 15I-R). Each of the objects may have one or more control points and/or rotation handles that enable manipulation of the tool access object or surfaces thereof in one, two, or three dimensions.

The method continues by reconfiguring the mating surface or interface between the abutment and tooth-like objects and the shape of the tooth-like object based on the gingival margin and emergence profile of step 2112 (step 2116 and the CAD environments of FIGS. 15S-T). Each of the objects may have one or more control points and/or rotation handles that enable manipulation of the freeform object or surfaces or margin in one, two, or three dimensions.

The method may continue by reconfiguring, using one or more control points or rotation handles and optionally cut-type objects, the shape and dimensions of the upper portion of the abutment object (step 2120 and the CAD environments of FIGS. 15U-15AA).

The method may continue by reconfiguring the inner volume and mating surface shape of the tooth-like object based on the edited upper portion of the abutment object (step 2124 and CAD environments of FIGS. 15BB-15EE). Each of the objects may have one or more control points and/or rotation handles that enable manipulation of the tool access object or surfaces thereof in one, two, or three dimensions.

The method may then continue by allowing the user to add the resultant objects to a collection of templates and/or a model library (step 1728). The method may also continue with the CAD tools 228 providing one or more electronic files to a manufacturing system 140 to enable the manufacturing system 140 to produce a physical component according to dimensions of the objects in the electronic file received from the CAD tools 228 (step 1732).

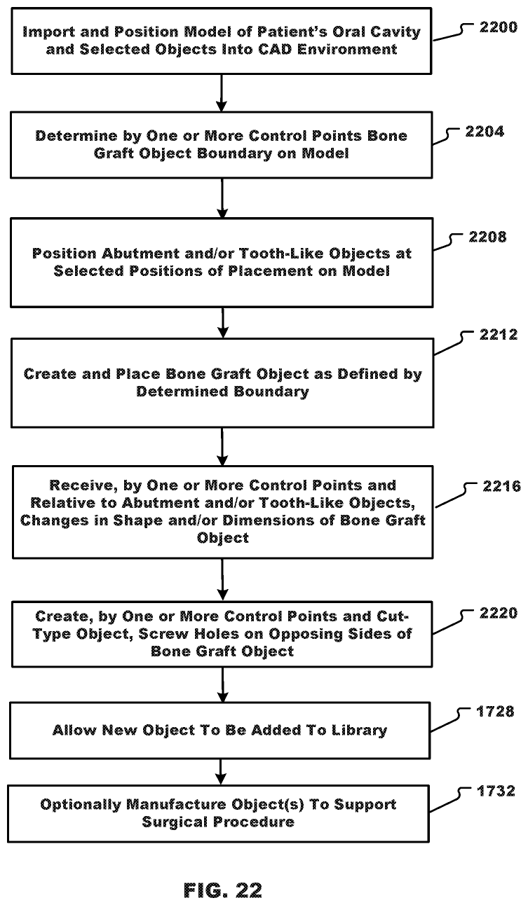

Referring to FIG. 22, a sixth method, which corresponds to the workflow shown in FIGS. 16A-M is illustrated in accordance with at least some embodiments of the present disclosure. The method begins by importing one or more objects into the CAD environment 304 from the database (step 2200 and the CAD environments of FIGS. 16A-B). The object includes the first or fourth objects, depending on the application. In an application, the selected objects are imported and positioned on a model of the patient's oral cavity.

The method continues by determining, by one or more control points and/or rotation handles, a continuous or semi-continuous boundary of a bone graft object on the model (step 2204 and CAD environments of FIGS. 16C-D). Each of the control points and/or rotation handles can enable manipulation of the freeform object or surfaces or margin in one, two, or three dimensions.

The method continues by importing and positioning, relative to the boundary, abutment and/or tooth-like objects at selected locations of placement on the model. (step 2208 and the CAD environment of FIG. 16D).

The method continues by creating and placing the bone graft object as defined by the determined boundary (step 2212 and the CAD environment of FIG. 16E).

The method continues by receiving, by one or more control points and/or rotation handles and relative to the abutment and tooth-like objects, changes in shape and/or dimensions of the bone graft object (step 2216 and the CAD environments of FIGS. 16F-I). Each of the control points and/or rotation handles can enable manipulation of the freeform object or surfaces or margin in one, two, or three dimensions.

The method continues by creating, by one or more control points and/or rotation handles and cut-type objects, screw holes on opposing sides of the bone graft object (step 2220 and the CAD environments of FIGS. 16J-M). Each of the control points and/or rotation handles can enable manipulation of the freeform object or surfaces or margin in one, two, or three dimensions.

The method may then continue by allowing the user to add the resultant objects to a collection of templates and/or a model library (step 1728). The method may also continue with the CAD tools 228 providing one or more electronic files to a manufacturing system 140 to enable the manufacturing system 140 to produce a physical component according to dimensions of the objects in the electronic file received from the CAD tools 228 (step 1732).

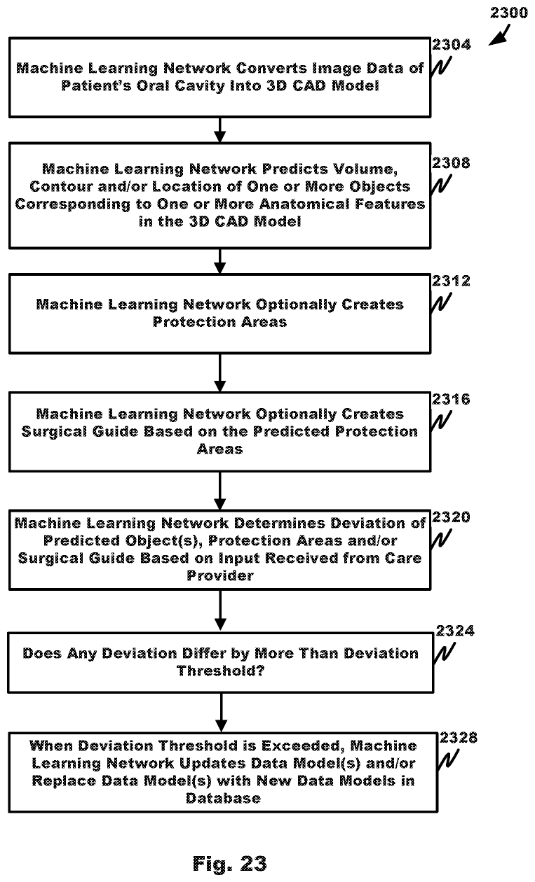

Referring to FIGS. 23-25, various machine learning network process flows will be discussed that support aspects of the present disclosure associated with generating, training, and applying self-evolving AI-based behaviors described herein. In the following description of the process flows 2300, 2400, and 2500, the operations may be performed in a different order than the order shown, or the operations may be performed in different orders or at different times. Certain operations may also be left out of the process flow, or other operations may be added to the process flow. It is to be understood that any computational device may perform the operations shown. The machine learning networks referenced in the process flows each correspond to one or more of the data models 237.

Referring to FIG. 23, the process flow 2300 is initiated by the machine learning network converting image data of a patient's oral cavity into a 3D CAD model (step 2304).

The process flow 2300 may continue by the machine learning network making a series of predictions, each with an associated probability of accuracy, regarding the volume, contour, and/or location of one or more objects corresponding to one or more anatomical features in the 3D CAD model (step 2308). The one or more objects may be, for example, nerves, nerve canals or pathways, blood vessels, blood vessel pathways, and the like).

The process flow may continue by the machine learning network optionally creating one or more protection areas for anatomical feature objects predictions having at least a threshold probability or likelihood of accuracy (step 2312). As will be appreciated, the protection areas indicate areas or volumes of the 3D CAD model of the patient's oral cavity that are off-limits or to be avoided by invasive surgical incisions (e.g., drill holes) or tools (e.g., drill bits and implants). A safety margin or factor may be used to expand the area or volume of the predicted location to further reduce the likelihood that the identified anatomical feature object is within the protection zone.

The process flow may continue by the machine learning network optionally creating a plurality of surgical guide objects, each having an associated probability of being the optimal design, based on one or more predicted protection areas (step 2316). The surgical guide objects selected for review by the care provider satisfying at least a threshold probability. As will be appreciated, a surgical guide object corresponds to a surgical guide that typically is a custom-made, 3D-printed, or milled template that fits over a patient's teeth, gums, or bone to precisely direct the location, depth, and angle of drill hole and implant placement. The guide may rest on teeth, mucosa, or bone, depending on the application. A typical surgical guide is made of resin and includes metal sleeves (or bushings) providing holes or pathways to guide the drill and place the implant. The thickness of the surgical guide may initially be generated with substantial conformity to the surface of the object or model of the patient's oral cavity. As with other objects in the CAD environment 304, the surgical guide may initially be created by manipulating a plurality of control points by selecting the contact surface on the anatomy surface of the patient's oral cavity.

The process flow may continue by the machine learning network monitoring editorial input from (or modifications by) the care provider not only as to which anatomical feature prediction and surgical guide object design is selected by the care provider but also the care provider's changes to the type, location, boundary, orientation, dimensions, and volume of each selected object corresponding to an anatomical feature or protection area and/or surgical guide object design (step 2320). Further deviation(s) can result from the care provider selecting a anatomical feature prediction and surgical guide object design having an associated lower likelihood or probability of being an accurate or optimal solution, respectively.

The process flow may continue by the machine learning network determining if the magnitude of any deviation, change or modification exceeds a respective deviation threshold (step 2324).

For each change or modification for which the associated magnitude exceeds a respective deviation threshold, the machine learning network updates the data model by changing one or more model parameters or hyperparameters and/or replaces the data model with a new data model in the database. As will be appreciated, each type or category of change or modification and each object changed or modified may have a different deviation threshold reflecting the relative importance of the object to a successful outcome for the patient.

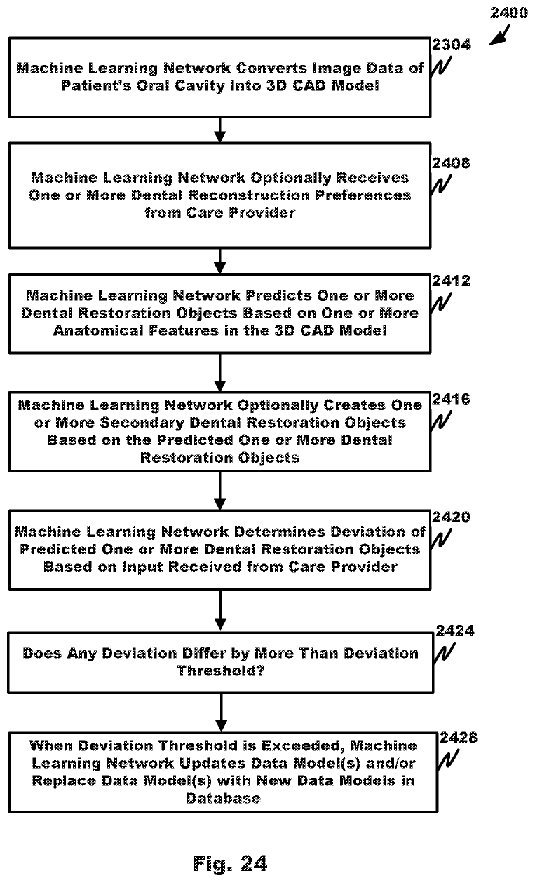

Referring to FIG. 24, the process flow 2400 is initiated by the machine learning network converting image data of a patient's oral cavity into a 3D CAD model (step 2304).

The process flow 2400 may continue by the machine learning network optionally receiving one or more dental reconstruction preferences from a care provider (step 2408). The preferences can include the type and/or minimum or maximum cost of dental restoration. Types of dental restorations include, for example, crowns or caps, bridge, dental implant with prosthetic tooth-like structures, inlays, onlays, removable or permanent overdentures, dental bonding, and veneers. Other preferences include type or model of implant, healing or permanent abutment, attachment member, locator member, sleeve and whether the components are to be stock or custom designed.

The process flow 2400 may continue by the machine learning network predicting, based on the preferences and one or more anatomical features in the 3D CAD model, a plurality of sets of one or more dental restoration objects or models, each having an associated probability of being the optimal solution (steps 2412 and 2416). The set of dental restoration objects or models include not only the visible dental restoration objects, such as the crown, overdenture, prosthetic tooth, and the like but also the less visible dental restoration objects (or secondary objects), such as objects corresponding to the dental implant(s), healing or permanent abutment, attachment member, cap, locator member, bar structure, bonding mechanism, bone graft, and the like. The predicted or recommended sets of one or more dental restoration objects or models includes the locations, orientations, volumes, and dimensions of each object or model. In an embodiment, the machine learning network performs one or more of the workflows described above to provide each predicted or recommended set of dental restoration objects and/or models. The one or more anatomical features in the 3D CAD model can be identified, located, and dimensionally and volumetrically quantified using the process flow 2300.

The process flow may continue by the machine learning network monitoring editorial input from (or modifications by) the care provider to the which set of one or more dental restoration objects or models is selected by the care provider but also to the type, location, boundary, orientation, dimensions, and volume of each dental restoration object in the selected set of dental restoration objects (step 2420). A further deviation results from the care provider selecting a set of one or more dental restoration objects or models having an associated lower likelihood or probability of being an optimal solution.

The process flow may continue by the machine learning network determining if the magnitude of any deviation, change or modification to the selected set exceeds a respective deviation threshold (step 2424).

For each change or modification for which the associated magnitude exceeds a respective deviation threshold, the machine learning network updates the parameters or hyperparameters of the data model and/or replaces the data model with a new data model in the database (step 2428). As will be appreciated, each type or category of change or modification and each object changed or modified may have a different deviation threshold reflecting the relative importance of the object to a successful dental restorative outcome for the patient.

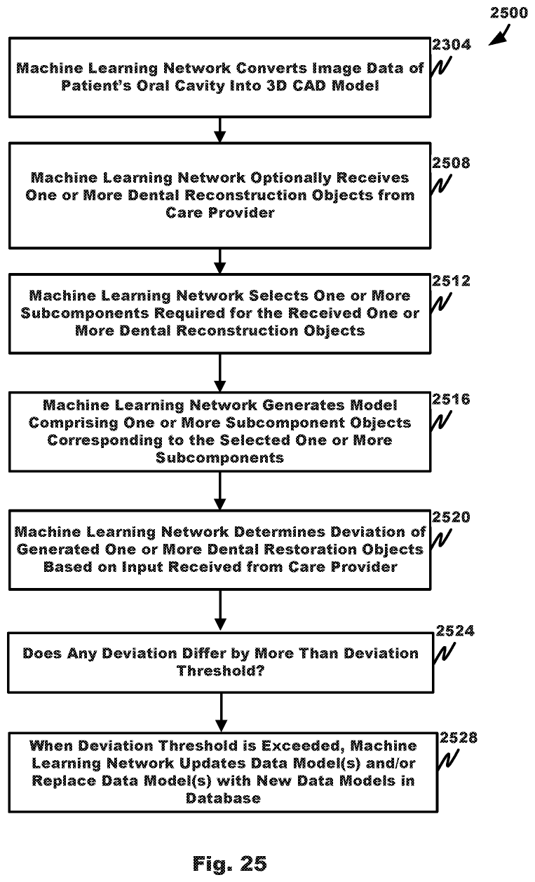

Referring to FIG. 25, the process flow 2500 is initiated by the machine learning network converting image data of a patient's oral cavity into a 3D CAD model (step 2304).

The process flow 250 may continue by the machine learning network receiving one or more dental restoration objects or models from a care provider (step 2508). Types of dental restoration objects include, for example, crowns or caps, bridge, dental implant with prosthetic tooth-like structures, inlays, onlays, removable or permanent overdentures, dental bonding, and veneers. In one application, the one or more dental restoration objects or models include a model of the visible portions of the dental restoration, such as an aesthetic appearance of a crown, prosthetic tooth, overdenture, or other restoration.

The process flow 2500 may continue by the machine learning network selecting different sets of one or more subcomponents required for a dental restoration comprising the received one or more dental restoration objects (step 2512). Each set having an associated likelihood or probability of being an optimal solution. The selection of each set may be based on an identified anatomical feature of the patient, care provider preference, and the like. The selection, for example, could include any of the selection process and options referenced in the workflows above. For example, a template 244, preference 248 or model library 252 may be used as the basis for the selection process. The one or more subcomponents can, for example, be an implant, healing or permanent abutment, sleeve, cap, attachment member, locator member, and/or bar structure.

The process flow 2500 may continue by the machine learning network generating a plurality of dental restoration models, each having an associated likelihood or probability of being an optimal solution. The plurality of dental restoration models can, in some embodiments, be based only on those sets of one or more subcomponents in step 2512 having at least a threshold likelihood of being the optimal selection. Each dental restoration model typically includes not only one or more subcomponent objects corresponding to the selected one or more subcomponent objects but also the received one or more dental reconstruction objects (step 2516). As an example, each model can not only common visible dental restoration objects, such as the crown, overdenture, prosthetic tooth, and the like but also different ones of the less visible dental restoration objects (or secondary objects), such as objects corresponding to the dental implant(s), healing or permanent abutment, attachment member, cap, locator member, bar structure, bonding mechanism, bone graft, and the like. The predicted or recommended model of include the locations, orientations, volumes, and dimensions of each subcomponent object or model. In an embodiment, the machine learning network performs one or more of the workflows described above beginning at a desired visible dental restoration outcome and working in reverse fashion to provide each predicted or recommended set of dental restoration objects and/or models.

The process flow may continue by the machine learning network monitoring editorial input from (or modifications by) the care provider not only as to which of the plurality of dental restoration models is selected but also to the type, location, boundary, orientation, dimensions, and volume of each dental restoration object in the selected set of dental restoration objects (step 2520). A further deviation results from the care provider selecting a dental restoration model having an associated lower likelihood or probability of being an optimal solution.

The process flow may continue by the machine learning network determining if the magnitude of any deviation, change or modification exceeds a respective deviation threshold (step 2524).

For each change or modification for which the associated magnitude exceeds a respective deviation threshold, the machine learning network updates the parameters or hyperparameters of the data model and/or replaces the data model with a new data model in the database (step 2528). As will be appreciated, each type or category of change or modification and each object changed or modified may have a different deviation threshold reflecting the relative importance of the object to a successful dental restorative outcome for the patient.

While the various aspects and embodiments of the disclosure are discussed with reference to CAD, it is to be appreciated that aspects and embodiments can be used with other software used for computer creation, modification, analysis, and/or optimization of a design. Additionally, other versions of CAD may be used with the aspects and embodiments, including 2D CAD, 3D CAD, and freeform CAD.

The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the foregoing has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A digital dental computing device, comprising:
a processor; and
memory including data that, when processed by the processor, enables the computing device to:
import overstructure and bar structure objects into a Computer-Aided Drafting (CAD) environment, the overstructure object corresponding to an overdenture and the bar structure object corresponding to a bar to connect the overdenture to an oral cavity of a patient;
facilitate a customization of a freeform cut-type object within the CAD environment by independent manipulation of one or more control points and/or rotation handles in at least two dimensions, wherein the one or more control points and/or rotation handles are defined at a surface of the freeform cut-type object and, when manipulated, result in a changed configuration of the freeform cut-type object in the at least two dimensions;
provide a library panel comprising a plurality of attachment member and/or locator member objects, the attachment member object corresponding to an attachment member that engages the overdenture to inhibit vertical displacement of the overdenture and the locator member object corresponding to a locator member that engages the overdenture to inhibit horizontal displacement of the overdenture;
receive, from the library panel, a selected object of the plurality of attachment member and/or locator member objects;
import the selected object of the plurality of attachment member and/or locator member objects into the CAD environment;
determine an overlapping volume in the CAD environment that is shared between the freeform cut-type object and the bar structure object; and
remove the overlapping volume from a volume of the bar structure object to define an aperture in the bar structure object, wherein the selected object is located in the aperture of the bar structure object.

2. The digital dental computing device of claim 1, wherein the data, when processed by the processor, enables the computing device to:
in response to the determined overlapping volume, determine a portion of the overstructure object to be removed to enable the overstructure object to matingly engage the aperture in the bar structure object; and
remove a volume of the portion of the overstructure object.

3. The digital dental computing device of claim 1, wherein the library panel comprises a plurality of attachment member objects and wherein the library panel comprises, for each of the plurality of attachment member objects, a plurality of a manufacturer field comprising manufacturer information for each selected attachment object, an attachment type field comprising attachment type information for a selected attachment object, an attachment subtype field comprising information regarding an attachment mechanism for the selected attachment object, and a secondary field comprising dimensional information for the selected attachment object, and an image of the selected attachment object, each of the manufacturer, attachment type, attachment subtype and secondary fields comprising multiple potential selectable options.

4. The digital dental computing device of claim 1, wherein the library panel comprises a plurality of locator member objects and wherein the library panel comprises, for each of the plurality of locator member objects, a plurality of a manufacturer field comprising manufacturer information for each selected locator object, a locator type field comprising locator type information for a selected locator object, a locator subtype field comprising information regarding an attachment mechanism for the selected locator object, a secondary field comprising dimensional information for the selected locator object, an image of the selected locator object, and a secondary support field comprising information regarding a support mechanism for the selected locator object, each of the manufacturer, locator type, locator subtype and secondary fields comprising multiple potential selectable options.

5. The digital computing device of claim 4, wherein the selected object of the plurality of attachment member and/or locator member objects comprises selected values in each of the manufacturer, attachment type, attachment subtype and secondary fields.

6. The digital computing device of claim 5, wherein the selected object of the plurality of attachment member and/or locator member objects comprises selected values in each of the manufacturer, attachment type, attachment subtype and secondary fields.

7. The digital computing device of claim 1, wherein the selected object is located in the overlapping volume before removal of the overlapping volume.

8. The digital computing device of claim 1, wherein the digital computing device import selected implant, implant receiving structure, into the CAD environment, the implant object corresponding to a dental implant and the implant receiving structure object corresponding to an implant receiving structure to engage the bar with the dental implant to connect the overdenture to an oral cavity of a patient; facilitate a customization of one or more of the implant, implant receiving structure, overstructure and bar structure objects within the CAD environment by independent manipulation of one or more control points and/or rotation handles in at least two dimensions, wherein the one or more control points and/or rotation handles are defined at a surface of the corresponding implant, implant receiving structure, overstructure and bar structure object and, when manipulated, result in a changed configuration of the corresponding implant, implant receiving structure, overstructure and bar structure object in the at least two dimensions; import a bonding object into the CAD environment, the bonding object corresponding to a bonding mechanism between an overdenture receiving structure and the implant receiving structure; position the bonding object on the implant receiving structure; and automatically change one or more dimensions of the bar structure object, overdenture receiving structure object, implant receiving structure object and/or overdenture based on a dimension of the bonding object to enable the bar structure to engage the overdenture.

9. A digital dental computing device, comprising:
a processor; and
memory including data that, when processed by the processor, enables the computing device to:
import selected implant, implant receiving structure, overstructure, and bar structure objects into a Computer-Aided Drafting (CAD) environment, the implant object corresponding to a dental implant, the overstructure object corresponding to an overdenture, the bar structure object corresponding to a bar, and the implant receiving structure object corresponding to an implant receiving structure to engage the bar with the dental implant to connect the overdenture to an oral cavity of a patient;
facilitate a customization of one or more of the implant, implant receiving structure, overstructure and bar structure objects within the CAD environment by independent manipulation of one or more control points and/or rotation handles in at least two dimensions, wherein the one or more control points and/or rotation handles are defined at a surface of the corresponding implant, implant receiving structure, overstructure and bar structure object and, when manipulated, result in a changed configuration of the corresponding implant, implant receiving structure, overstructure and bar structure object in the at least two dimensions;
import a bonding object into the CAD environment, the bonding object corresponding to a bonding mechanism between an overdenture receiving structure and the implant receiving structure;
position the bonding object on the implant receiving structure; and
automatically change one or more dimensions of the bar structure object, overdenture receiving structure object, implant receiving structure object and/or overdenture based on a dimension of the bonding object to enable the bar structure to engage the overdenture.

10. The digital dental device of claim 9, wherein the bar structure corresponds to a male bar and a portion of the overdenture engaging the bar comprises a female bar and wherein the implant receiving structure comprises one of an abutment and a sleeve.

11. The digital dental device of claim 9, wherein the data, when processed by the processor, enables the computing device to detect, by a data model, an emergence profile and/or gingival margin on a model of a portion of a patient's oral cavity, wherein the implant receiving structure is a freeform object, wherein a bottom of the implant receiving structure contacts a gingival portion of the model of the portion of the patient's oral cavity, and wherein a profile of the contacting portion of the implant receiving structure is customized by manipulation of the one or more control points and/or rotation handles to match the detected emergence profile and/or gingival margin.

12. The digital dental device of claim 9, wherein the data, when processed by the processor, enables the computing device to import a tool access object into the CAD environment and position the tool access object relative to the implant receiving structure and implant to enable tool access to the implant object, the tool access object being a freeform object, and facilitate a customization of the tool access object within the CAD environment by independent manipulation of one or more control points and/or rotation handles in at least two dimensions.

13. The digital dental device of claim 9, wherein the data, when processed by the processor, enables the computing device to identify, by segmentation techniques, an interface between an abutment object and the overdenture object and modify a dimension of the abutment object and a crown object, configured to engage the abutment object, based on the identified interface.

14. The digital dental device of claim 9, wherein the digital dental device facilitates a customization of a freeform cut-type object within the CAD environment by independent manipulation of one or more control points and/or rotation handles in at least two dimensions, wherein the one or more control points and/or rotation handles are defined at a surface of the freeform cut-type object and, when manipulated, result in a changed configuration of the freeform cut-type object in the at least two dimensions; provides a library panel comprising a plurality of attachment member and/or locator member objects, the attachment member object corresponding to an attachment member that engages the overdenture to inhibit vertical displacement of the overdenture and the locator member object corresponding to a locator member that engages the overdenture to inhibit horizontal displacement of the overdenture; receives, from the library panel, a selected object of the plurality of attachment member and/or locator member objects; imports the selected object of the plurality of attachment member and/or locator member objects into the CAD environment; determines an overlapping volume in the CAD environment that is shared between the freeform cut-type object and the bar structure object; and removes the overlapping volume from a volume of the bar structure object to define an aperture in the bar structure object, wherein the selected object is located in the aperture of the bar structure object.

15. A digital dental computing device, comprising:
a processor; and
memory including data that, when processed by the processor, enables the computing device to:
import selected abutment and tooth-like objects and model of a patient's oral cavity into a Computer-Aided Drafting (CAD) environment, the abutment object corresponding to an abutment, the tooth-like object corresponding to one of a crown and prosthetic tooth and each of the abutment and tooth-like objects being a free-form object;, and the model of the patient's oral cavity being a 3D CAD model based on image data of the patient's oral cavity;
facilitate, within the CAD environment and by independent manipulation of one or more control points and/or rotation handles in at least two dimensions, a customization of the position and orientation of the tooth-like object relative to the abutment object and the 3D CAD model of the patient's oral cavity;
determine, relative to the abutment object, a gingival margin and/or emergence profile in the 3D CAD model;
facilitate a customization of the gingival margin and/or emergence profile on the 3D CAD model by independent manipulation of one or more control points and/or rotation handles in at least two dimensions; and
thereafter transfer the gingival margin and/or emergence profile to an upper surface of the abutment object;
facilitate a customization of the abutment object based on the gingival margin and/or emergence profile by independent manipulation of one or more control points and/or rotation handles in at least two dimensions to change a lower profile of a lower portion of the abutment object; and
remove a volume from the prosthetic tooth-like to match the lower profile of the abutment object.

16. The digital dental computing device of claim 15, wherein the data, when processed by the processor, enables the computing device to determine the gingival margin and/or emergence profile based on the position and orientation of a scan body.

17. The digital dental computing device of claim 15, wherein the data, when processed by the processor, enables the computing device to facilitate a customization of an upper portion of the abutment object by independent manipulation of one or more control points and/or rotation handles in at least two dimensions to provide a customized upper portion of the abutment object and remove a volume of the tooth-like object to accommodate the customized upper portion.

18. The digital dental computing device of claim 15, wherein the digital dental computing device imports overstructure and bar structure objects into the CAD environment, the overstructure object corresponding to an overdenture and the bar structure object corresponding to a bar to connect the overdenture to an oral cavity of a patient; facilitates a customization of a freeform cut-type object within the CAD environment by independent manipulation of one or more control points and/or rotation handles in at least two dimensions, wherein the one or more control points and/or rotation handles are defined at a surface of the freeform cut-type object and, when manipulated, result in a changed configuration of the freeform cut-type object in the at least two dimensions; provides a library panel comprising a plurality of attachment member and/or locator member objects, the attachment member object corresponding to an attachment member that engages the overdenture to inhibit vertical displacement of the overdenture and the locator member object corresponding to a locator member that engages the overdenture to inhibit horizontal displacement of the overdenture; receives, from the library panel, a selected object of the plurality of attachment member and/or locator member objects; imports the selected object of the plurality of attachment member and/or locator member objects into the CAD environment; determines an overlapping volume in the CAD environment that is shared between the freeform cut-type object and the bar structure object; and removes the overlapping volume from a volume of the bar structure object to define an aperture in the bar structure object, wherein the selected object is located in the aperture of the bar structure object.

19. A digital dental computing device, comprising:
a processor; and
memory including data that, when processed by the processor, enables the computing device to:
import a selected abutment object, bone graft object, and model of a patient's oral cavity into a Computer-Aided Drafting (CAD) environment, the abutment object corresponding to an abutment, the model of the patient's oral cavity being a 3D CAD model based on image data of the patient's oral cavity, and the bone graft corresponding to a bone graft to restore bone in a portion of the patient's oral cavity; and
facilitate, within the CAD environment and by independent manipulation of one or more control points and/or rotation handles in at least two dimensions, a customization of a position, dimension, and/or orientation of the bone graft object based on a position and configuration of the abutment object relative to the 3D CAD model of the patient's oral cavity.

20. The digital dental computing device of claim 19, wherein the abutment object is used as a reference template for the customization of the bone graft object.
